(19) United States
(12) Patent Application Publication
(10) Pub. No.: US 2023/0191543 A1
(43) Pub. Date: Jun. 22, 2023

(54) SYSTEM AND METHOD TO PERFORM DISSIMILAR OPERATIONS IN A SINGLE MACHINE

(71) Applicant: SCOFAST LLC, Sequim, WA (US)

(72) Inventors: Craig F. FEIED, Honolulu, HI (US); Christopher G. GREIMES, Honolulu, HI (US)

(73) Assignee: SCOFAST LLC, Sequim, WA (US)

(21) Appl. No.: 17/814,485

(22) Filed: Jul. 22, 2022

Related U.S. Application Data
(60) Provisional application No. 63/224,773, filed on Jul. 22, 2021.

(51) Int. Cl. B23P 23/04; B21J 5/00; B23P 17/04; B23P 25/00

(52) U.S. Cl. CPC B23P 23/04; B21J 5/002; B23P 17/04; B23P 25/003

(57) ABSTRACT

A spatially coherent machine for manufacturing comprises, in one example, a workpiece holder configured to secure a workpiece, a toolholder with at least one axis of motion control configured to perform a subtractive machining operation on the workpiece using a machining tool, a heating element configured to perform a heating operation on the workpiece, and a forming element configured to perform a forming operation in which force is applied to the workpiece in an amount that causes plastic deformation of the workpiece material. The workpiece holder secures the workpiece during the heating, forming, and subtractive operations such that the forming and subtractive operations are performed in a spatially coherent manner.

### CROSS REFERENCE TO RELATED APPLICATIONS

This application claims the benefit of U.S. Provisional Application No. 63/224,773, filed Jul. 22, 2021, which is incorporated herein by reference in its entirety.

### FIELD

The invention relates to the performance of distinctly different types of operations in a single machine.

### BACKGROUND

Many additive, subtractive, deformative, and transformative techniques are known in the field of parts manufacturing. However, until the present time it has not been possible to perform certain operations together in the same machine. For example, parts that require forged elements as well as machined elements have required that forging operations be performed in forging machines, and that machining operations be performed in a lathe, mill, or other machining center. Parts that required cast elements as well as machined elements have required that casting operations be performed in a foundry or casting machine and then removed to turning, milling, or turn-mill equipment to be machined.

Similarly, parts that required forged elements as well as 3D printed elements have required that 3D printing operations be performed in additive manufacturing machines and forging operations be performed in forging machines. Parts that required transformative operations such as heat-treating as well as forming operations such as forging and subtractive operations such as machining have required that forging be performed in forging machines, subtractive operations be performed in a machining center, and heat treatments be performed in separate ovens dedicated to the purpose.

Whenever two operations must be performed on two different machines, additional labor and equipment costs are incurred because of the need to remove parts from one machine, transport them to another machine, load them, locate and align them, and perform the secondary operation. Labor costs may increase significantly if additional machine operators are required.

There is also a large cost associated with the difficulty of establishing adequate spatial alignment of workpiece and tooling in a secondary machine to precisely match the alignment in the primary machine. Each additional operation that requires part repositioning reduces the achievable part tolerances because of small errors in locating and aligning a part after repositioning. Another source of error arises because the various motion axes of one machine are not in perfect alignment with the various motion axes of another machine. Every time a part must be handled the likelihood of error rises, and the value lost to waste and failed quality metrics rises with it. Certain parts may require the addition and sometimes subsequent removal of special fiducial features to permit relocating, realigning, and workholding in a second machine. Other parts simply cannot be made by moving them from machine to machine in this way. Even if spatial coherence (maintenance of three-dimensional alignment and registration of a part within specified tolerances across multiple operations) can be established, re-establishing and maintaining the correct alignment and registration to within necessary tolerances may require exotic techniques that add cost and difficulty. In a practical sense it is impossible to achieve perfect coaxiality between two operations performed in two different machines.

When thermal energy is involved in manufacturing, moving parts from one machine to another may require allowing them to cool, which can result in changes in dimension and alignment that must be accounted for before a second operation can be performed, adding complexity, cost and waste. The requirement that parts be allowed to cool before moving to another machine can lead to other problems. For example, in certain materials the cooling process may result in hardening that can make subsequent machining difficult and costly to the point of being prohibitive.

When errors due to loss or degradation of spatial coherence occur, they may manifest as a part that appears to be correct but fails to pass subsequent close inspection, meaning the part must be remanufactured, consuming twice as much time, labor, and materials as planned. This problem is compounded when working with high-value alloys that are very difficult to machine due to high toughness and a high tendency to work hardening. If the failure is detected only after a job run is complete, it may require an entirely new machine setup, interrupting other scheduled jobs and causing a ripple effect that can have significant economic impact.

Machines used for forging typically require a significant amount of floor space to accommodate dedicated equipment such as forges and presses, and the movement of hot metal parts between those machines often requires special safety measures and standoff distances. Adding such traditional equipment and measures to a machining workflow or a 3D printing workflow thus entails additional cost and disruption to the existing workflow.

All of these difficulties are compounded when multiple steps must be performed requiring alternation between two different types of operations, or when more than two types of operations are to be performed, as when a part having elements that result from additive operations also requires forging and machining. In many scenarios these difficulties make it prohibitively expensive or even impossible to manufacture a desired part as a single component.

The need to perform multiple operations of fundamentally different types on a single workpiece is an important factor that raises costs, risks, and complexity and can prevent the manufacture of a desired product.

### SUMMARY

General Description

Heating elements heat things. Forming elements form things. Machining elements machine things Additive elements add things. Ordinarily such distinctly different operations are performed separately in separate machines. Disclosed herein is a system and method whereby the combination of two or more such elements configured to operate together in a spatially coherent manner produces an outcome that is new, useful, and demonstrably different from the outcome that results from independent elements performing the operations independently in separate machines.

One embodiment is a system and method for performing, in a single machine, a first operation (“the forming operation”) comprising the application of force and/or energy to form a workpiece or a portion thereof into a desired shape or condition through plastic deformation, such as by hot or cold forging, together with a second operation (“the non-forming operation”) selected from a group of operations comprising subtractive and/or additive manufacturing operations such as machining and 3D printing, the spatial alignment and registration (“spatial coherence”) of the workpiece and all axes of motion within the machine being maintained between and across operations, resulting in spatial, temporal and environmental coherence across operations, thus producing a new and useful result while reducing or eliminating delays, costs, waste, and difficulties associated with the performance of such operations in separate machines. Any number of heating, cooling, forming, subtractive, and additive operations may be performed in any combination and in any order, and additional operations may be combined within the same machine, including operations involving the transformation of physical, chemical, or biological attributes of a workpiece (“transforming operations”) as well as operations to locate/align, index, measure, inspect, or test a workpiece (“LIMIT operations”) together with any other operation whose integration into the same machine would be advantageous. The single machine in which these operations are performed may be a multi-module machine in which spatial coherence is established and maintained between modules.

The systems and methods disclosed are intended for use in fabrication and manufacturing activities using any combination of the techniques presented here in any sequence. Specific applications are described and specific techniques and configurations are given as examples, it being recognized that many additional techniques and applications thereof exist beyond those given as examples, and that new applications arising in the future will also benefit from the system and method. Those having ordinary skill in the art will understand that workpieces in general may be modified by any existing technique, whether presented here or not, and that new techniques will arise in the future, and that the ability to combine such different techniques with others in the same machine according to the system and method disclosed will be advantageous in many situations.

Additionally disclosed herein is the composition and use of a treatment fluid (“toughening fluid”) and a system and method by which parts manufactured from titanium alloys and other materials may be improved through application of a treatment fluid at certain points during manufacture.

Additionally disclosed herein is a system and method whereby a fluid applied to the workpiece is vaporized during heating of a workpiece and the resulting vapor is trapped close to the workpiece, displacing the gas mixture that previously surrounded the workpiece.

Material appearing in the background and technical field sections of this application is hereby included by reference as part of the description of the invention. This application claims the benefit of U.S. Provisional Application No. 63/224,773, filed Jul. 22, 2021, which is incorporated by reference in its entirety as part of the written description of the invention.

Observations

Throughout this specification, multiple examples are given of various aspects of machines incorporating and embodying the performance in a single machine of one or more forming operations in combination with at least one additional operation chosen from a group of operations comprising additive and subtractive operations, together with optional transformative operations and many other optional operations, all operations being performed in a spatially coherent manner. The general class of machines so constituted (i.e. the class of all machines making any use of the matter disclosed herein) thus all perform some combination of spatially coherent forming, additive, subtractive, and transformative (SCOFAST) operations within the same machine, and will be here known as SCOFAST machines. A SCOFAST machine includes not only the basic unit of the machinery, but also any adjunct or attachment necessary for the accomplishment of an operation of the machine, including all devices used or required to control, regulate, or operate the machine as well as all tools, dies, jigs, and other devices necessary to an operation of the machine or used in conjunction with the machine.

A SCOFAST machine is not the mere juxtaposition of old devices, each working out its own effect without the production of something novel: the product of a SCOFAST machine is demonstrably new, different and better when compared to the aggregate of the several results of the various operations performed separately in separate devices. The improvement arises from the maintenance of spatial coherence with a resulting new ability to perform additional operations during previously unavailable temporary states of the workpiece and the system, along with improved temporal control, thermal coherence, and environmental coherence.

For example, a SCOFAST machine that performs a turning operation followed by a grinding operation maintains spatial coherence across the two operations, and therefore produces a highly concentric surface finish. However, when the same workpiece undergoes the same turning operation in a first machine and is then removed to a second machine where it undergoes the same grinding operation, the unavoidable loss of spatial coherence makes it virtually impossible to obtain a high degree of concentricity in the surface finish. In applications where function depends upon surface effects, it may be impossible to meet required specifications when two such operations are performed in separate machines rather than a single machine where spatial coherence may be maintained.

After a first operation is performed in one machine, the part may be in a state that changes over time. If a secondary operation must be performed in a different machine, there are periods of time (lost time segments) during which secondary operations cannot be performed while the part is being removed from a first machine, moved to a second machine, and re-fixtured, realigned, and re-registered. Loss of those time segments prevents secondary operations from taking advantage of temporally changing states that immediately follow the first operation.

For many materials, including certain titanium alloys, both the thermal history and the history of deformation induced at various points along the historical temperature curve are important determinants of ultrastructure and of material properties. Inability to perform a second operation immediately following a first operation can have adverse effects on the final part. In some cases it increases the cost and difficulty of manufacturing parts, and in certain cases it can even prevent certain parts from being manufactured, particularly if irreversible transformations occur during the lost time segments.

The ability to perform secondary operations during the lifetime of a temporary state that is induced during a first operation and lasts only for a short period of time is an important advantage that arises when the various operations are performed within a single SCOFAST machine. Recapture of what would otherwise be lost material states existing within lost time segments is a distinguishing feature resulting from the integration of different types of operations into a single SCOFAST machine.

For all the reasons explained here and for others that will be apparent to those having ordinary skill in the art, the results of operations combined and configured to operate together in a spatially coherent manner within a SCOFAST machine are not the same as the results of the identical operations performed independently in several separate machines. Furthermore, the capabilities of such a SCOFAST machine are qualitatively and quantitatively different from the capabilities of the several machines operating separately.

It will further be apparent to one having ordinary skill in the art that the specific examples disclosed herein represent examples of species, genera, families, or orders within the class of SCOFAST machines; any species example given herein is intended to represent the genus that is thereby characterized, whether a single species or multiple species exemplifying that genus have been set forth here as examples.

It will likewise be evident to one having ordinary skill in the art that additional operations other than formative, additive, subtractive, and transformative (FAST) operations may profitably be used in conjunction with FAST operations. For example, it is contemplated that locating/aligning, indexing, measuring, inspection, and testing (LIMIT) operations often will be integrated into a SCOFAST machine. Any reference to a SCOFAST machine in this specification shall mean a SCOFAST machine optionally additionally comprising elements configured to execute LIMIT operations and/or such other additional operations as may be desired to be performed in conjunction with FAST operations in a spatially coherent manner.

An operation of a SCOFAST machine may comprise any of the methods and techniques appearing in any part of this specification or in any document incorporated by reference, together with additional methods and techniques known to those having skill in the relevant arts and such additional methods and techniques as may be discovered or invented in the future.

The system and method disclosed have applications in a variety of fields, and such applications necessarily bring together concepts and techniques from several different fields. A person having ordinary skill in the art in one field may not have the necessary skill in the art in another field to fully appreciate the implications for any particular application of the system and method disclosed. It is necessary that a person seeking to understand, use, and practice the disclosed system and method receive counsel from those having the requisite skill in the relevant fields. The specification therefore is directed not to an individual person having ordinary skill in a single art, but to a design and engineering team comprising members having the ordinary skill arising from education and experience relevant to a number of different fields. Teams so comprised will readily understand any terms of art used herein, and will recognize the wide applicability of the teachings, techniques, systems, and methods disclosed herein.

Embodiments are contemplated for applications involving mechanical engineering in all of its branches, and also acoustical engineering, manufacturing engineering, thermal engineering, mechatronics engineering, software engineering, instrumentation engineering, materials engineering, quantum engineering, nanoengineering, mining engineering, biological engineering, applied engineering, industrial engineering, reliability engineering, systems engineering, component engineering, manufacturing engineering, computer vision, industrial robotics, electrical engineering and other fields.

Throughout this specification reference is made to a number of United States Patent documents, many of which describe exemplary techniques that may describe, constitute, illustrate, or explain some required or optional component of a SCOFAST machine or some operation that may be performed in a SCOFAST machine. All United States Patent documents referenced in this application are hereby incorporated by reference in their entirety as part of the written description.

### BRIEF DESCRIPTION OF THE DRAWINGS

The invention is further described by way of example only with reference to the accompanying drawings in which various elements of a SCOFAST machine are exemplified and their use explained.

FIG. 1A: Primary Functional Modules of a SCOFAST machine.

FIG. 1B: Forming, transforming, and CCC elements.

FIG. 1C: CCC Module Interactions.

FIG. 2: SCOFAST Example: Spatially Coherent Forging and Machining in a “Forchine”.

FIG. 3A: Forchine Front View.

FIG. 3B: Forchine top View showing certain elements during an indexing operation.

FIG. 3C: Forchine front view detail showing coil in position for heating the workpiece.

FIG. 3D: Forchine top view after heating at start of forging operation.

FIG. 3E: Front view of Forchine showing part cutoff and retrieval slide.

FIG. 4A: Ti-6Al-4V Bolt made with single heating.

FIG. 4B: Ti-6Al-4V Bolt made with double heating.

FIG. 5A: Cutaway view of forchine headstock.

FIG. 5B: Spindle bearing support before augmentation.

FIG. 5C: Spindle bearing support with two types of augmentation.

FIG. 6: Induction heating coil detail showing internal insert.

FIG. 7A: Robotic Arm with terminal appendage as multi-tool holder.

FIG. 7B: Robotic arm with terminal appendage as spray welder.

FIG. 7C: Robot arm with terminal appendage as forming press.

FIG. 7D: Robot arm with terminal appendage as tool changer.

FIG. 8A: Active tool for bending barstock. Z-axis view towards barstock: Before bending operation.

FIG. 8B: Active tool for bending barstock. Z-axis view towards barstock: After bending operation.

FIG. 9A: Top view of dual longitudinal bed rail carriage tooling in a SCOFAST machine.

FIG. 9B: X-axis view of longitudinal overhead gantry tooling in a SCOFAST machine.

FIG. 9C: Z-axis view of transverse overhead gantry tooling in a SCOFAST machine.

FIG. 10: SCOFAST machine with dual multi-axis rotary active toolholders and tool changing towers.

FIG. 11: Casting, forging, and milling in a SCOFAST machine.

FIG. 12: Extrusion, forging, and milling in a SCOFAST machine.

FIG. 13: Punch forming and machining in a SCOFAST machine.

FIG. 14A: Horizontal machining center axes.

FIG. 14B: Vertical machining center axes.

FIG. 15A: Positioning error component of a linear Z axis.

FIG. 15B: Positioning error components of a rotary C axis.

FIG. 16: Hook with forged, machined, and bent features; side and front view.

FIG. 17: Measured stress-strain curves for Ti-6Al-4V alloy, by temperature and strain rate E.

FIG. 18: Measured stress-strain curves for Ti-6246 deformed at a high strain rate of 25 per second.

FIG. 19: Stress-Strain diagram for a material.

FIG. 20: Equipment variables and Process variables in forging.

FIG. 21: Exemplary alternate SCOFAST forchine geometry with axes labeled.

FIG. 22: Filament extrusion mechanism.

FIG. 23: Examples of common bearing types.

### DETAILED DESCRIPTION

### Concepts and Definitions

Throughout the entire specification, various terms and concepts are used with the meanings set forth herein. Additional terms may be defined throughout the specification, and such definitions also are taken to apply to the specification as a whole and in each of its parts, as if defined here. Terms used in the specification that are not explicitly or implicitly defined anywhere within the specification are terms of art whose meanings will be known to those skilled in the relevant art. In particular, such terms will be familiar to those capable of making use of the disclosures and teachings made herein. Each and every operation mentioned or described in the specification may be performed within a SCOFAST machine. The design requirements for a variety of embodiments of SCOFAST machines incorporating machine elements that enable the various operations mentioned herein, and/or such additional operations as may be desirable, will be understood by one having ordinary skill in the relevant arts.

When applied to a list of two or more, the terms “and” and “or” both shall be taken to mean “and/or” except where explicitly stated otherwise. The term “incorporated by reference” shall be taken to mean “incorporated here by reference in its entirety.”

Miscellaneous

Workpiece

In manufacturing, a workpiece is a material object that is to be manipulated in some way to become a finished part. In subtractive manufacturing, a workpiece often starts as an amount of raw material in some standard form, but a workpiece may also start as an amount of preformed material resulting from prior operations. In additive manufacturing, a workpiece may exist as a preformed substrate on which added material is deposited, or it may be said to come into existence when the first material is added to a workholder.

Machining Center

A machining center is a computer-controlled machine that can hold a workpiece and perform some combination of subtractive machining operations under machine control. Machining centers may optionally perform turning (lathe) operations along with milling, drilling, boring, tapping, and many other operations. Often a machining center is capable of bringing many different tools to bear upon a workpiece, thus multiple operations may be performed without disturbing the attachment of the workpiece. CNC lathes, CNC milling machines, and CNC turn-mill machines may all be referred to as machining centers.

Setup

A machine setup comprises all the work that must be done before the first operation can be started for a job. It includes the configuration, workplan creation, tool selection, fixturing, workholding, and all tools, toolholders, and materials needed to complete the operation. For a milling operation a setup includes such configuration elements as tool position, height offset, cutter compensation, diameter, flute length, length from holder, offsets, and others. Setup time is an important constraint that can affect manufacturing profitability.

Operation

The term operation means any combination of actions applied to a workpiece or to a machine or its working environment.

Operations Performed Separately

An operation or a method applied to a workpiece is considered to be performed or applied separately from another operation or method when a workpiece is repositioned with respect to a machine space between the two operations or methods, whether such repositioning is achieved by moving the workpiece between two different machines, by transferring the part from one zone of a machine to a different zone of that machine, by changing the machine configuration so that the point of origin of the axes or the dynamic behavior of the machine are thereby modified (e.g., by manually changing the machining head), or by any other modification that results in a change in a movement compensation table used in a numerical control system of the machine or that causes such a table to no longer reflect the behavior of the machine in its original configuration.

Tolerances

Part tolerance is an allowable amount of variation of a specified quantity, especially in the dimensions of a machine or part. Generally, tolerance is given in the form of measurement±tolerance, i.e., 2.0″±0.1″. The higher the tolerance, the greater the allowable variation from the desired measurement. Table I and Table II show standard tolerance grades as defined by the International Standards Organization in standard ISO-286.

TABLE I
ISO 286 - Tolerances IT01 to IT11

| Nominal size | | International tolerance grade | | | | | | | | | | | | |
|---|---|---|---|---|---|---|---|---|---|---|---|---|---|---|
| > | ≤ | IT01 | IT0 | IT1 | IT2 | IT3 | IT4 | IT5 | IT6 | IT7 | IT8 | IT9 | IT10 | IT11 |
| mm | | tolerance in μm | | | | | | | | | | | | |
| 0 | 3 | 0.3 | 0.5 | 0.8 | 1.2 | 2.0 | 3 | 4 | 6 | 10 | 14 | 25 | 40 | 60 |
| 3 | 6 | 0.4 | 0.6 | 1.0 | 1.5 | 2.5 | 4 | 5 | 8 | 12 | 18 | 30 | 48 | 75 |
| 6 | 10 | 0.4 | 0.6 | 1.0 | 1.5 | 2.5 | 4 | 6 | 9 | 15 | 22 | 36 | 58 | 90 |
| 10 | 18 | 0.5 | 0.8 | 1.2 | 2.0 | 3 | 5 | 8 | 11 | 18 | 27 | 43 | 70 | 110 |
| 18 | 30 | 0.6 | 1.0 | 1.5 | 2.5 | 4 | 6 | 9 | 13 | 21 | 33 | 52 | 84 | 130 |
| 30 | 50 | 0.6 | 1.0 | 1.5 | 2.5 | 4 | 7 | 11 | 16 | 25 | 39 | 62 | 100 | 160 |
| 50 | 80 | 0.8 | 1.2 | 2.0 | 3 | 5 | 8 | 13 | 19 | 30 | 46 | 74 | 120 | 190 |
| 80 | 120 | 1.0 | 1.5 | 2.5 | 4 | 6 | 10 | 15 | 22 | 35 | 54 | 87 | 140 | 220 |
| 120 | 180 | 1.2 | 2 | 3.5 | 5 | 8 | 12 | 18 | 25 | 40 | 63 | 100 | 160 | 250 |
| 180 | 250 | 2.0 | 3 | 4.5 | 7 | 10 | 14 | 20 | 29 | 46 | 72 | 115 | 185 | 290 |
| 250 | 315 | 2.5 | 4 | 6 | 8 | 12 | 16 | 23 | 32 | 52 | 81 | 130 | 210 | 320 |
| 315 | 400 | 3 | 5 | 7 | 9 | 13 | 18 | 25 | 36 | 57 | 89 | 140 | 230 | 360 |
| 400 | 500 | 4 | 6 | 8 | 10 | 15 | 20 | 27 | 40 | 63 | 97 | 155 | 250 | 400 |
| 500 | 630 | | | 9 | 11 | 16 | 22 | 32 | 44 | 70 | 110 | 175 | 280 | 440 |
| 630 | 800 | | | 10 | 13 | 18 | 25 | 36 | 50 | 80 | 125 | 200 | 320 | 500 |
| 800 | 1,000 | | | 11 | 15 | 21 | 28 | 40 | 56 | 90 | 140 | 230 | 360 | 560 |
| 1,000 | 1,250 | | | 13 | 18 | 24 | 33 | 47 | 66 | 105 | 165 | 260 | 420 | 660 |
| 1,250 | 1,600 | | | 15 | 21 | 29 | 39 | 55 | 78 | 125 | 195 | 310 | 500 | 780 |
| 1,600 | 2,000 | | | 18 | 25 | 35 | 46 | 65 | 92 | 150 | 230 | 370 | 600 | 920 |
| 2,000 | 2,500 | | | 22 | 30 | 41 | 55 | 78 | 110 | 175 | 280 | 440 | 700 | 1,100 |
| 2,500 | 3,150 | | | 26 | 36 | 50 | 68 | 96 | 135 | 210 | 330 | 540 | 860 | 1,350 |

TABLE II
ISO 286 - Tolerances IT12 to IT18

| Nominal size | | International tolerance grade | | | | | | |
|---|---|---|---|---|---|---|---|---|
| > | ≤ | IT12 | IT13 | IT14 | IT15 | IT16 | IT17 | IT18 |
| mm | | tolerance in mm | | | | | | |
| 0 | 3 | 0.10 | 0.14 | 0.25 | 0.40 | 0.60 | 1.00 | 1.40 |
| 3 | 6 | 0.12 | 0.18 | 0.30 | 0.48 | 0.75 | 1.20 | 1.80 |
| 6 | 10 | 0.15 | 0.22 | 0.36 | 0.58 | 0.90 | 1.50 | 2.20 |
| 10 | 18 | 0.18 | 0.27 | 0.43 | 0.70 | 1.10 | 1.80 | 2.70 |
| 18 | 30 | 0.21 | 0.33 | 0.52 | 0.84 | 1.30 | 2.10 | 3.30 |
| 30 | 50 | 0.25 | 0.39 | 0.62 | 1.00 | 1.60 | 2.50 | 3.90 |
| 50 | 80 | 0.30 | 0.46 | 0.74 | 1.20 | 1.90 | 3.00 | 4.60 |
| 80 | 120 | 0.35 | 0.54 | 0.87 | 1.40 | 2.20 | 3.50 | 5.40 |
| 120 | 180 | 0.40 | 0.63 | 1.00 | 1.60 | 2.50 | 4.00 | 6.30 |
| 180 | 250 | 0.46 | 0.72 | 1.15 | 1.85 | 2.90 | 4.60 | 7.20 |
| 250 | 315 | 0.52 | 0.81 | 1.30 | 2.10 | 3.20 | 5.20 | 8.10 |
| 315 | 400 | 0.57 | 0.89 | 1.40 | 2.30 | 3.60 | 5.70 | 8.90 |
| 400 | 500 | 0.63 | 0.97 | 1.55 | 2.50 | 4.00 | 6.30 | 9.70 |
| 500 | 630 | 0.70 | 1.10 | 1.75 | 2.80 | 4.40 | 7.00 | 11.00 |
| 630 | 800 | 0.80 | 1.25 | 2.00 | 3.20 | 5.00 | 8.00 | 12.50 |
| 800 | 1,000 | 0.90 | 1.40 | 2.30 | 3.60 | 5.60 | 9.00 | 14.00 |
| 1,000 | 1,250 | 1.05 | 1.65 | 2.60 | 4.20 | 6.60 | 10.50 | 16.50 |
| 1,250 | 1,600 | 1.25 | 1.95 | 3.10 | 5.00 | 7.80 | 12.50 | 19.50 |
| 1,600 | 2,000 | 1.50 | 2.30 | 3.70 | 6.00 | 9.20 | 15.00 | 23.00 |
| 2,000 | 2,500 | 1.75 | 2.80 | 4.40 | 7.00 | 11.00 | 17.50 | 28.00 |
| 2,500 | 3,150 | 2.10 | 3.30 | 5.40 | 8.60 | 13.50 | 21.00 | 33.00 |

Roundness

Roundness, or circularity, is the 2D tolerance that controls how closely a cross-section of a cylinder, sphere, or cone is to a mathematically perfect circle. Consider a cylinder whose purpose is to roll along a flat surface. A small flat on the OD of the cylinder would detract from how smoothly the shaft can roll. The flat spot can even be so large that the shaft cannot roll at all. In this case the flat represents a deviation from a perfect circle that can be measured quite accurately. An example of a more complex roundness error is lobing, which is an unintended form error from a centerless grinding operation. Roundness callouts on drawings have no reference to a datum, as roundness does not relate to the cross-section's location on the part.

Cylindricity

Cylindricity is the 3D version of roundness. It assesses how closely an object comes to a perfect cylinder, meaning that it is not only round, but also straight along its axis. The simplest example that demonstrates the need for cylindricity is a pin which is required to pass completely through a bore with a tight diametral tolerance. The pin may be inspected for diameter and found to be within tolerance. However, if the pin is bent, it has lost cylindricity and may not pass through the bore. Cylindricity measurements are used for elements or element sections that are intended to have the same diameter along the full length of the element being measured.

Coaxiality

Coaxiality is the tolerance for how closely the axis of one cylinder is aligned to another. Examples are a shaft having two diameters, or perhaps two bores located on opposite sides of a housing. In either case, the center of one element is expected to be along the same axis as the second element. Since each element is being assessed as an axis, coaxiality is a 3D measurement.

Concentricity

Concentricity is a special case of coaxiality that occurs when two features of are measured at the same cross-sectional plane, making it a 2D measurement. A simple example is comparing the ID and OD relative to each other on a hollow shaft or tube. Engineering drawings typically indicate which element is the measured surface and which is the datum surface.

Runout

Runout is a 2D measurement that can be either be taken in the axial direction or in the radial direction. When measuring in the radial direction, runout combines both roundness and concentricity errors into one composite measurement. If a part is perfectly round, the runout will equal the concentricity and if perfectly concentric the runout will equal the roundness error. Essentially, runout takes into account both the axis offset and the roundness of any object that rotates about an axis.

Total Runout

Total Runout is a 3D measurement which takes into account the entire surface of a part. Where runout measures only one cross-section relative to an axis, total runout takes the entire part into consideration, and all variations across the entire surface must fall within a specific tolerance.

Indexing

Indexing refers to a tool or a part being moved by a machine controller to a known position and orientation.

Locating and Aligning

Locating and aligning both refer to the process of locating the position, orientation, and extent of a workpiece with respect to the machine coordinate system. Relocating and realigning refer to re-establishing the position, orientation, and extent of a workpiece with respect to the machine coordinate system after the workpiece has been moved or disturbed by some action that is not under machine control.

Positioning Tolerances

The positioning tolerance for an axis is a manufacturer-specified quantity representing the maximum expected deviation along that axis between a position defined in the machine coordinate system and that position as measured in the real-world coordinate system in which a physical workpiece exists. When a machine controller moves a machine element (e.g., a tool) to a defined position in an axis, the element position may be off by the amount of the positioning tolerance in that axis. Positioning tolerances are defined separately for each axis. The positioning tolerance for an axis may be the same at every position along another axis, or it may vary at different positions within the machine workspace.

Repeatability Tolerances

The repeatability tolerance for an axis is the maximum measured deviation between multiple instances of moving to the same position on that axis. Repeatability tolerances are defined separately for each axis. Repeatability tolerances determine the maximum deviation between two parts made using the same operations under machine control.

Spatial Coherence, Position, and Orientation

Spatial Coherence

Spatial coherence relates to the maintenance of spatial and motional relationships between and among multiple points in a multibody system as the system evolves over time and different bodies occupy different loci.

Within the field of machine operations, we define spatial coherence so that it describes the accuracy and precision with which different tools may be located and moved relative to a workpiece across multiple operations and sub-operations. Spatially coherent operations are those sets of operations for which the zero-locations, orientations, paths, and coordinate systems of workpieces and tools are defined with respect to a common workspace and are uniform across all machine elements and all operations (allowing for coordinate system transformations).

Workpiece location and orientation may be invariant or they may be transformed deterministically under the control of the system in which the operations are performed.

Operations that are performed “in a spatially coherent manner” are performed in a common operational workspace, such that the zero points, axes, locations, orientations, and movement paths of each operation are defined with respect to the common workspace. Locations, orientations, and extents that differ only by rigid transformation (i.e., rotations, translations, reflections, and scale changes) of a machine reference (e.g., zero point and axes) are spatially coherent. Spatial coherence across a series of operations implies that any location, extent, orientation, or path defined with respect to one operation is also defined with respect to each of the operations.

Spatial coherence is quantitative. If all points, locations, extents, orientations, constraints (e.g., parallelism, squareness, colinearity, coaxiality, coplanarity) and paths within a system of physical structures were calibrated to maintain their spatial relationships without any deviation whatsoever through the entire manufacturing life of the workpiece, that manufacturing process would have perfect spatial coherence. The greater the deviation of those spatial relationships across operations, the lower the spatial coherence.

Spatial coherence is not absolute, since it is impossible to locate a physical point in physical space with perfect precision and it is impossible to remove all sources of geometric error. Instead, spatial coherence is assessed relative to the machine precision available for the operations that will be performed. Spatial coherence within a machine is established when a workpiece is first secured in a workholder and located and aligned within a machine, and is maintained so long as the workpiece remains secured in the workholder and all movement and operations in the machine are performed under machine control, so that the machine tolerances defined for movement and repeatability in each axis continue to be met with respect to the workpiece. At any moment we can compare the actual workpiece position/orientation/extent to the controller's internal tracking of workpiece position/orientation/extent. As soon as the deviation between the two is greater than the machine tolerances for repeatability in any axis, subsequent operations will not be spatially coherent with respect to earlier operations. This generally occurs only when a workpiece is disturbed by a human or other agent not under machine control.

The description of geometric errors of machine tools is based on the view of a machine tool as a kinematic composition of different linear and rotary axes. The geometric errors of the different axes cause relative displacements between tool and workpiece. How the different errors add up depends on the arrangement of the axes and the operations to be performed.

It's important to recognize that the loss of spatial coherence that occurs when a workpiece is transferred between two machines is not a simple loss of absolute precision with respect to the static workpiece position in one, two, or three dimensions. Locating errors are defined as deviations of positions, orientations, and extents between different axis motions. For example, parallelism or squareness deviations may exist between the movements of two linear axes in the two machines. Offsets of a rotary axis from its nominal position in the coordinate system of the workpiece may differ between two machines. Although such location errors often may be described by a single parameter per axis, the deviation each parameter causes in the workspace may be position dependent, as when an angular deviation exists between two axes that are intended to be coaxial. Loss of spatial coherence may manifest as loss of tolerances in linear dimensions, parallelism, squareness, roundness, cylindricity, coaxiality, concentricity, runout, and/or total runout.

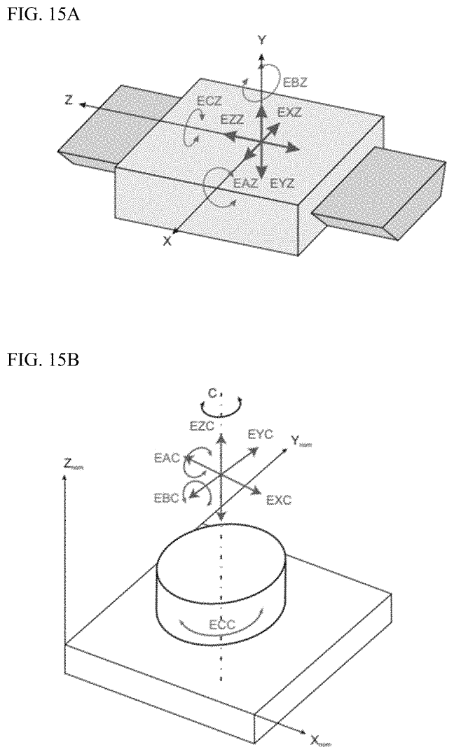

Linear axes can have 6 component errors in general, one for each possible degree of freedom in space. For example, the six component errors of a simple linear Z axis are illustrated in FIG. 15A as: EXZ: Straightness of Z in X direction (horizontal straightness); EYZ: Straightness of Z in Y direction (vertical straightness); EZZ: Positioning of Z; EAZ: Tilt motion of Z around X (Pitch); EBZ: Tilt motion of Z around Y (Yaw); and ECZ: Roll of Z. Each and every linear axis of motion of each machine element contributes similar error components to the overall location error.

Similarly, each rotary axis of motion contributes six additional error components, one for each possible degree of freedom in space. For example, the six component errors of a simple rotary C axis are illustrated in FIG. 15B as: EXC: Radial motion of C in X direction; EYC: Radial motion of C in Y direction; EZC: Axial motion of C; EAC: Tilt motion of C around X; EBC: Tilt motion of C around Y; and ECC: Angular positioning error of C.

The net geometric error increases with the number of axes involved, thus even if perfect workpiece alignment were possible across different machines, the net geometric error increases when a workpiece undergoes operations in two different machine workspaces, each with its own set of motion axes. The greater the number of operations performed independently (each in its own machine space having its own intrinsic geometric error), the greater the net geometric error affecting the overall result. The deviation of one set of axes from another (where they are intended to be the same) introduces additional geometric error that can be an order of magnitude larger than the simple cumulative error due to the larger number of axes involved. This error may propagate nonlinearly, and the cumulative error is an important factor limiting the specifications that can be met in an overall manufacturing process.

When operations instead are integrated into a SCOFAST machine, machine elements and all operations share a single machine workspace and a common defined set of axes. Calibration and alignment to a common workspace and a smaller total number of axes reduce the magnitude of inter-axis positioning error components. Since certain machine elements and motion axes (such as workholders and spindles) are shared across operations, the net geometric error will of necessity be reduced. What error remains will be consistent, since it results from machine calibration alone, without the new and unconstrained error that is introduced each time a workpiece is removed from one machine and placed into another. Limits of allowable geometric error for each axis of motion within a machine are defined as manufacturer's machine tolerances and are maintained through alignment and calibration procedures. Since the total geometric error for a series of operations is a function of the various motions (axes) that are involved in those operations, it is the combined geometric errors of all the motion axes involved in a series of operations that defines the precision and tolerances that can be achieved.

The simplest way to achieve spatial coherence across different types of operations is to incorporate the machine elements performing the different operations into a common machine, to calibrate all the elements together within a common workspace, and to execute the several operations under machine control on a workpiece secured in a common workholder on a common axis within the common workspace. Spatial coherence allows the precision of a part to be determined by the tolerance specifications of the machine, which arises from the spatial integration and machine control of workholders, toolholders, force sources, transforming elements, motion axes, and other machine elements.

If two operations are performed under machine control on a workpiece secured in a workholder that has the same absolute position and orientation throughout both operations, the two operations are spatially coherent. Furthermore, they will be defined here as having occurred in a single machine. The precision and repeatability of parts made by those operations will be defined by the positioning and repeatability tolerances of the machine performing the operations.

If a workpiece is removed from a first workholder in a first workspace and placed in a second workholder in a second workspace, then locating/aligning is required to establish a position and orientation with respect to the second workspace. In this case, operations performed with respect to the first workspace are not spatially coherent with operations performed with respect to the second workspace.

If a workholder containing a workpiece is removed from a first workspace and installed in a second workspace, so that the position and orientation with of the workpiece with respect to the second workspace depends on workholder locating/aligning, then operations performed with respect to the first workspace are not spatially coherent with operations performed with respect to the second workspace.

If a conveyer or a robotic arm is used to move a workpiece from one machine to another, or from one zone of a machine to another, spatial coherence generally is lost, even when the transfer is accomplished under machine control by the second machine controller. This is because conveyors and robotic arms usually cannot hold the tolerances required for machine operations. The final deviation (i.e., the deviation between the actual position/orientation/extent of the workpiece and the machine controller's internal representation of the workpiece position/orientation/extent) virtually always exceeds tolerance specifications for the second machine or zone, thus spatial coherence has been lost.

Transporting and relocating/realigning a part in a second machine invariably introduces error, uncertainty, delays, and costs. However, the value of combining certain operations in a spatially coherent manner is particularly evident in cases where relocating/realigning is not just inaccurate and slow, but difficult or even impossible, such as when extremely accurate coaxiality/concentricity is required, when removal of the part from the first machine results in warping or springback, when the part is principally defined by multi-axial compound curves having no natural fiduciaries, or when secondary workholding is difficult (e.g., when an organically shaped workpiece must be parted off from continuous barfeed stock that was used to secure the workpiece during the first operation).

Spatial coherence is a measure of one important factor controlling the maximum achievable specified precision in parts manufacturing. Loss of spatial coherence will limit the kinds of operations that may be used and the level of accuracy that will be achieved. When a first operation is performed in a first machine and the workpiece is subsequently removed and then installed and located/aligned in a second machine where a second operation is performed, spatial coherence is lost completely: the two operations occur in completely different contexts. The overall accuracy achieved in the manufacturing process will depend on locating and aligning the workpiece accurately in the second machine, and also on any differences between the relative location, extent, orientation, axial alignment, and movement paths of tools with respect to workpieces in the two machines. The loss of spatial coherence is such that certain features cannot feasibly be manufactured in this way. For example, when two operations are performed on a workpiece that has been moved between two different independent machines, the workpiece features produced will invariably exhibit a loss of concentricity, coaxiality, and colinearity, along with angular errors and other geometric errors that accumulate in proportion to the number of axes involved. When a workpiece is removed from one rotary machine and moved to a second rotary machine, if the coaxial deviation between two centers is held to 0.01 mm and the radial motion error of the tip of a workpiece secured in one of the centers is just 0.0016 mm then the resulting angular locating/aligning deviation is +/−5 minutes of arc. [Lou, Z. et al. (2018) ‘An Analysis of Angular Indexing Error of a Gear Measuring Machine’, Applied Sciences, 8, p. 169. doi: 10.3390/app8020169, which is incorporated here by reference] (Lou et al., 2018).

When the operations are instead integrated into a SCOFAST machine, the machine elements are calibrated within a common workspace and act upon a workpiece held in a common workholder at a deterministic location and orientation within that workspace. The result in the latter case is guaranteed to be different in the precision that can be met across operations. Among other things, coaxiality is assured, thus concentricity error can be minimized. Measurement and inspection can distinguish between parts that were made by operations integrated within a SCOFAST machine and parts that were made by independent operations performed separately.

For example, when a grinding operation is performed on a turned workpiece without removing the workpiece from the machine and workholder that were used to turn the workpiece, spatial coherence is maintained and a highly concentric surface finish can be achieved. Removing the workpiece from the first machine to another machine for grinding causes loss of spatial coherence that makes it virtually impossible to obtain the same degree of concentricity in the surface finish. In some applications this is a poor cosmetic outcome. In applications where function depends upon microscopic surface effects (e.g., biomachining, optics, or nanoelectronics) even a miniscule loss of spatial coherence between these operations may strongly affect the functional outcome of the operation.

The integration of machine elements that leads to spatial coherence also leads to preservation of certain attributes of state between operations, including spatial attributes such as position, orientation, extent, concentricity, coaxiality, parallelism, and squareness, together with other attributes that may be less apparent. For example, since workholding is unchanged, clamping forces and the stresses and deformations related to clamping forces are also unchanged. If spatial coherence means that operations can be performed with less delay between them, thermal and chemical states may be maintained within a certain range across operations. Additional attributes that are maintained under most conditions of spatial coherence but often vary when a part is removed from one machine and placed into another include environmental factors such as temperature, humidity, gas or vapor composition, impinging wavelengths of light, photon flux, electromagnetic fields, chemical exposures, and others.

One important beneficial effect of performing multiple operations in a single SCOFAST machine is access to previously unavailable workpiece states. This is of particular interest when dealing with irreversible or incompletely reversible progressions of states, such as chemical and thermal transformations. For example, workpieces comprising certain materials and components can be heated just once, briefly, without being damaged. If such a workpiece is heated and subjected to a first operation performed in a first machine, and the workpiece is then removed from the first machine and moved to a second machine where it must be relocated/realigned before a second operation can be performed, the thermal states that exist immediately following the first operation are not accessible for the second operation. The integration of both operations into a single SCOFAST machine makes those previously inaccessible thermal states suddenly available for performance of a second operation. Since the material cannot be heated a second time, this spatially coherent integration can make it possible to manufacture parts that could not otherwise be fabricated.

When operations that previously required separate machines are instead performed within a single SCOFAST machine, the results may be new and different with respect to the kinds of operations that can be performed, the manner in which they may be performed, the outcome of those operations, the precision that can be achieved, and certain important attributes of the resulting parts.

Thermal Coherence

The integration of different operations together with spatial coherence minimizes delays between operations by removing the need for a workpiece to be moved from one machine to another. Since thermal energy gains from or losses to the environment are a function of time, spatial coherence therefore helps to minimize thermal energy gains or losses between operations, improving thermal consistency. For example, after a workpiece is heated and a first operation is performed at a certain temperature, the thermal energy of the workpiece decreases over time. If, during that cooling process, a second operation must be performed in a specific range of temperatures, the window of opportunity in which to perform the second operation may be narrow. By minimizing delays, spatial coherence increases the likelihood that a given operation may be performed successfully within a required time and temperature window, leading to outcomes that are new and useful.

Even when operations do not depend on a window of thermal opportunity, spatially coherent operations that result in improved thermal coherence may be beneficial because any environmental thermal effects that act upon the common workspace will affect all operations performed within that workspace. In contrast, operations performed independently in different machines will be subject to different thermal effects that can affect the size, shape, and material properties of a workpiece and of tools and machine elements, thus will produce different results as compared to operations combined in a spatially coherent manner within a SCOFAST machine.

Temporal Control

Spatial coherence across operations is associated with other benefits beyond the precision with which parts may be manufactured. When multiple disparate operations are integrated into a single machine it becomes possible to exercise a high degree of temporal control and to minimize delays between operations performed within the same machine. The timing between operations is managed as a simple function of CNC control, and the range of possible timings includes very rapid sequences that are not available when multiple operations require movement between machines. Improved inter-operation timing is an independent reason why a new and improved result is obtained from operations combined within a SCOFAST machine, as compared to independent operations performed in the same sequence in a series of separate machines.

In a certain practical sense, distance is time. When a first and second operation are performed on a workpiece in the same machine (“the combined scenario”), the amount of time that passes between the end of the first operation and the start of the second operation may be minimized. However, when the first operation is performed in a first machine and the second operation is performed in a second independent machine that is some distance away (“the independent scenario”), some amount of additional delay is inevitable: the process of removing the workpiece from the first machine, moving it to the second machine, and relocating/realigning the workpiece in the second machine invariably leads to additional time delay between the first and second operation.

For a molecular scale SCOFAST machine, the time between operations may be on the order of nanoseconds. At the opposite end of the scale, the time between operations may be on the order of hundreds of seconds. However, in each case the minimum time delay achievable is improved when a workpiece can be operated upon in situ, without being removed from one machine and transferred to another. When a delay occurs between two operations, any attributes of the workpiece or of the environment that are changing over time will exert different effects depending on whether the two operations are performed in rapid sequence in the same machine, or with an added time delay in two independent machines. Such temporal differences in time-varying attributes can result in completely different outcomes for the combined scenario compared to the independent operations scenario.

This is particularly the case when attributes of a workpiece that change over time do so irreversibly. For example, cross-linking and other catalyzed processes cannot be reversed. Many chemical reactions are effectively irreversible. Many materials can only be heated and cooled once, or a limited number of times. Certain materials undergo embrittlement if reheated, due to incorporation of contaminant molecules. Others undergo surface reactions when reheated. Other materials may lose their shape if reheated. Other materials may undergo unwanted physical changes, such as hardening, softening, or toughening.

It will be apparent that in certain scenarios, the combination of two operations in a SCOFAST machine allows the operations to be performed in rapid succession on a workpiece having any type of irreversibly changing attributes, where it would otherwise be impossible to do so. One practical result is that multiple disparate operations requiring a particular thermal state may be performed in rapid succession during a single heating and cooling cycle, where it would otherwise be impossible to do so. This is critically important when a material cannot be heated twice. One example of such a situation is described and illustrated in the “Forchine” embodiment described later in this specification, in which a grade 5 titanium bolt is manufactured with a machining operation that must be initiated within seconds after a forging operation. The same bolt cannot be made by separate operations because both the forging and machining operations must be performed at a high temperature, and the threads become brittle and crumble if the material is heated twice.

The combination of multiple operations in a single SCOFAST machine may enable the fabrication of many parts that could not otherwise readily be manufactured. For example, in one embodiment a part to be made is a transparent ceramic cup having a precision ground interior and highly specified precision threads. In making the part a first operation is heating, a second operation is hot press forming, a third operation is thread cutting, and a fourth operation is precision grinding. Thread cutting must be performed when the hot formed ceramic has cooled and cured to exactly the correct consistency. If the ceramic is too hot, the material will simply be pushed aside rather than being cut. If the material is too cold, the material will shatter when thread cutting is attempted. Before the threads are cut, the cup is too soft to be removed from its original workholder and remounted without being deformed. It is not possible to re-heat the cup after curing and cooling because it will deform or shatter and because oxygen embrittlement will occur. This ceramic cup is used in optical applications, with a requirement that the ground finish must be highly concentric with the threads. Since the forming and thread cutting must be performed in a single thermal cycle and the threads must be cut at a critical temperature, it is apparent that the temporal alignment of thread cutting is critical. Similarly, since the ground finish must be perfectly concentric with the threads cut into the wall of the cup it is apparent that the spatial alignment of the forming, threading, and grinding operations is critical. The results of the operations when performed within a SCOFAST machine and combined in a spatially coherent manner will produce the desired part. The results of the operations when performed separately in separate machines will not produce the desired part, due to loss of spatial coherence and the accompanying loss of temporal and thermal control.

Another example of new and improved results arising from operations combined in a SCOFAST machine is a manufacturing process where catalytic processes are employed. In one such embodiment a catalyzed resin such as an epoxy is injected into a precision die and allowed to cure to a defined degree of hardness. The die is opened and precision machining operations are performed on the exposed portions of the workpiece while it remains in a workable range of hardness. If machining operations are attempted too early, the workpiece will be too soft and will deform. If machining operations are attempted too late, the workpiece will be too hard and will shatter or crumble. The epoxy cannot be re-liquified and the workpiece will lose its shape if it is removed from the fixture and relocated/realigned in another device while the material is soft enough to machine. The combination of resin casting and machining in a SCOFAST machine produces a different result from that obtained when resin casting and machining operations are performed separately in different machines.

Single Machine

When machine elements responsible for SCOFAST/LIMIT operations are combined with machine support elements and workholding elements and each element is aligned and configured in such a manner that the position, orientation, motion paths, calibration, and error ranges for each axis and each machine element are all defined and calibrated in terms of a common workspace and operate solely under machine control with a common set of machine tolerances, they are considered to be integrated into a single SCOFAST machine (“single machine”).

Establishing Spatial Coherence

Within a machine, a workpiece is initially placed into a workholder and the position, orientation, and extent of the workpiece with respect to the coordinate system of the machine are determined through a process of locating and aligning the workpiece. This process may involve adjusting the position or orientation of the workpiece (e.g., centering in a chuck). It may also involve subtractive operations in which surfaces of the workpiece are made to fit a defined extent. Once a workpiece has been fully located/aligned and its extent is fully defined, any deviation between the position, orientation, and extent as defined within the machine controller and the physical position, orientation, and extent of the workpiece as measured in the real world will be within the defined machine tolerances for positioning in each axis. From this point forward, all operations performed within the machine that are fully under machine control will be spatially coherent with each other.

Whenever a workpiece is moved in any way that is not under direct machine control, spatial coherence is lost. Even if the workpiece is subsequently relocated/realigned, congruence with its original position and orientation cannot be achieved and subsequent operations will not be spatially coherent with operations performed prior to workpiece disturbance. This is easily seen when two operations requiring coaxiality are performed with loss of spatial coherence between them: close part tolerances (such as concentricity of elliptical features along a crankshaft) that can be held so long as the workpiece is not disturbed in its setup will be unachievable if the workpiece is manually moved, no matter how carefully the workpiece is relocated/realigned.

Determining Spatial Coherence

A first operation and a second operation are performed in a spatially coherent manner if any of the following three requirements are met:
1. The two operations are performed under machine control upon a workpiece held continuously in a workholder that does not move from the start of the first operation to the end of the second operation.
2. The two operations are performed under machine control upon a workpiece held continuously in a workholder such that any movement of the workpiece is entirely under the control of a machine controller that carries out the two operations.
3. The first operation is performed in a first machine by a first machine controller and the second operation is performed in a second machine by a second machine controller;
   wherein the first machine and the second machine may be the same machine; and
   wherein the first machine controller and the second machine controller may be the same controller; and
   wherein the first machine controller and the second machine controller agree at all times on workpiece attributes comprising the position, orientation, and extent of the workpiece (allowing for coordinate system transformations); and
   wherein any movement of the workholder, workpiece, and all other elements of each machine is at all times under machine control; and
   wherein, at the start of the second operation, any deviation between the workpiece attributes as defined by the second controller and the workpiece attributes as measured in the real world is within the defined tolerances of the second machine both for positioning and for repeatability along each axis of the second machine.

Conversely, if none of the three conditions are met, the two operations are not spatially coherent with respect to each other.

Other Benefits Associated with Spatial Coherence

Environmental Coherence

Another benefit associated with spatial coherence is new or improved results due to environmental coherence. This benefit derives from the fact that the results of an operation depend to a certain extent on the environment in which the operation is performed, and many aspects of that environment may vary over space and time (spatiotemporally), sometimes varying significantly over a relatively small space and/or time difference. Ambient temperature is an important environmental attribute that often requires machine compensation due to thermal expansion and contraction of machine elements. Others include electrostatic fields, magnetic fields, electrical fields, electromagnetic fields (including visible light, infrared light, ultraviolet light, radio frequency energy, microwave energy, and every other portion of the electromagnetic spectrum). The polarization of certain fields may exhibit significant spatiotemporal variation. Other attributes that may vary spatiotemporally include the type, distribution, and intensity of such elements as impinging radiation (whether ambient or resulting from work with radioisotopes), particulate matter of every kind, aerosols, chemical vapors, fungi, bacteria, viruses, humidity, barometric pressure, gas partial pressures, temperature, acoustic energy, vibration, air flow, convection, thermal radiation, thermal conductivity, electrical conductivity, electrochemical effects, atmospheric pH, clamping forces, gravitational forces, and other attributes. The environment also varies spatiotemporally with respect to the effects of pseudoforces such as pseudogravitational forces, centrifugal and centripetal forces, the Coriolis and Eotvos forces, and others.

The magnitude of an environmental attribute effect may depend on the specific environment in which operations are performed. For example, the rotation of the earth produces a Coriolis/Eotvos effect for which the direction and magnitude of deflection depend on the object's position and path on Earth. Scenarios in which this deflection vector differs sufficiently between two positions and orientations to alter the outcome of an operation depending upon where it is performed are uncommon. However, for operations performed in regions of higher angular velocity, such as in a centrifuge or within a rotating space station, the Coriolis/Eotvos effect may be of significantly greater magnitude and may vary significantly over a small distance and with small changes of path orientation.

Integration of operations into a SCOFAST machine allows each operation to experience a common set of unified machine attributes, including some that commonly vary between machines even if they are independent of position or spatiotemporal environmental variability. For example, independent machines may vary in terms of thermal and electrical baselines and conductivity, electrostatic fields, electrochemical effects, airflows, convection flows, electrical currents, fields, clamping forces, acceleration profiles, vibrational modes, damping, rigidity, harmonics, deflection under forces, particulates, and many other attributes.

Reduced Workpiece Movement

In some scenarios, a new and improved result may arise simply because combining operations in a SCOFAST machine permits the elimination of workpiece movement. For example, if a soufflé or any other delicate foam must be moved between operations, collapse may ensue either due to the motion itself or due to loss of environmental coherence (e.g., thermal shock).

Ecological Coherence

In biochemically or biologically-oriented machines, the number of attributes that may affect the outcome of operations is even larger. Machine ecology, sterility, trace elements, catalytic enhancers or inhibitors, state history, light spectrum, and many other factors can exert significant effects in response to small differences. A common shared ecology across spatially coherent operations can remove many sources of variability. For example, in one embodiment a bio-manufacturing process requires multiple cycles, each comprising a series of operations in which biologically active material is deposited, pressed into a rough form (first shape), etched (biologically or chemically), grown, and mechanically machined to a next shape. After several cycles, the results from these operations when performed as combined operations integrated into a unified SCOFAST machine are expected to be distinctly different from the results of the operations performed independently in different machines having different ecologies and requiring handling and transport between steps. In biological systems, each inter-machine transfer risks disruptions due to handling, exposure to suboptimal transitional spaces, physical forces, thermal shock, contamination, and other unavoidable elements of the process.

Safety

The combination of operations within a SCOFAST machine may result in improved results due to improved safety, since the risk of exposure or release of a dangerous substance is higher when transfers are required to perform operations in separate devices, compared to the risk when operations are integrated into a SCOFAST machine and no transport or handling is required. Substances that may be risky to move from place to place include parts at high temperatures, elements that are highly reactive, strong acids and bases, oxidizing and reducing agents, radioactive materials, infectious materials, explosives, toxic agents, and other hazardous materials. When a medical or pharmacologic product is manufactured using materials that are infectious or hazardous, the bio-risk multiplies every time the material is handled for transfer. Multiple operations performed without translocation in a single SCOFAST machine are intrinsically safer than operations performed in different machines where manual transfer of materials is required. The risk of material contamination that degrades an operation also increases with each transfer. This was evidenced in the manufacture of vaccines against SARS-CoV2 in 2021, when transfers of material for operations to be performed in different machines resulted in accidental contamination leading to the destruction of more than fifty million doses of vaccine.

CNC Axes

The position and orientation of any object within a workspace may be defined by coordinates with respect to some set of axes, whether rectangular, circular, spherical, or of other type. Coordinate systems may be defined for any purpose, and a position and orientation may be transformed freely from any axis system to any other.

When describing the capabilities of computer numerically controlled (CNC) machines of any kind, a convenient set of axis coordinate systems often is used to describe the available degrees of freedom for the position, orientation, and motion of a workpiece, tool, field, or form of energy. Such descriptions are commonly used in the fields of machining and of 3D printing, but may equally be applied to any object, force, or operation. In particular, CNC machines are sometimes identified by the number of axes in which controlled movement of tools and/or workpieces may occur simultaneously. Up to 12 axes are conventionally described, though additional arbitrary axes may be added to any machine design. 3-axis machines provide linear positioning in three dimensions but no angular positioning. 5-axis machines simultaneously control linear positioning in 3 dimensions and angular positioning with rotation around two axes. 9-axis machines simultaneously control linear positioning along 3 axes and angular positioning around each one, with additional simultaneous control of three additional linear axes, enabling both turning and milling in the same workspace. 12-axis machines typically possess an additional head with simultaneous control of linear position and angular rotation around each of the three secondary linear axes, enabling operations such as pinch milling, multi-component additive manufacturing, simultaneous operations of different types, and a host of otherwise-difficult or otherwise-impossible operations that will be apparent to one having ordinary skill in the arts.

When labeling CNC axes, the first three axes conventionally are X, Y, and Z linear axes. In a horizontal machining center, the Z axis conventionally is aligned with the spindle, the Y axis is aligned with the axis of the local gravitational field, and the X and Z axes are parallel to the machine bed, as shown in FIG. 14A. In a vertical machining center, the Z axis conventionally is in line with the machine's spindle, and the X and Y axes are parallel to the surface of the worktable as shown in FIG. 14B. In each case the second three axes are the A, B, and C rotary axes, which rotate around the X, Y, and Z axes respectively according to the right hand rule. Movement of workpiece and tools along and around these axes allow for tools and workpieces to be relatively oriented at different angles and in different positions. This increases the number and variety of operations for which a given tool may be used, thereby decreasing the number of tool changes required. A commonly-referenced third set of axes are the X2, Y2, and Z2 axes, which are secondary linear axes that are parallel to the X, Y, and Z axes, respectively and are managed by separate commands in a CNC machine. Another programming axis of convenience, referred to as the U axis, is defined with reference to the rotational axis of the spindle in a turning machine such as a lathe. This axis defines movement perpendicular to the machine's spindle, thus movement in the U axis controls the machined diameter of a part. A fourth set of axes are the A2, B2, and C2 rotary axes, which rotate around the X2, Y2, and Z2 axes, respectively. The foregoing notwithstanding, each machine manufacturer defines and names the axes for each specific machine, and many naming and control variations exist.

Any number of workpiece and tooling axes may be controlled within a SCOFAST machine, and operations may be performed along any arbitrary axis.

Additive Finishing Operations

Additive finishing (AF) operations are supplementary operations performed to complete or enhance additive manufacturing (AM) operations by altering the molecular, metallurgical, chemical, microstructural, ultrastructural, structural, mechanical, and/or other bulk, layer, surface, and/or finish properties of material that has been deposited during an additive operation. The dimensions of a workpiece created or augmented through additive manufacturing operations may change as a result of additive finishing operations, but altering a workpiece from an initial shape to a new shape is not the primary purpose of additive finishing operations.

Additive finishing operations may serve to alter porosity, density, layer adhesion, grain cohesion, stress patterns, hardness, toughness, ductility, strength, fatigue strength, elastic modulus, elongation at break, compression at break, yield strength, stress-strain curve, thermal conductivity, electrical conductivity, corrosion resistance, roughness, or other material properties, or any combination of the above. Additive finishing operations may be used to improve internal and/or surface defects such as balling, porosity, cracks, powder agglomeration, thermal stress, incomplete fusion, shrinkage porosity, gas porosity, liquefaction cracking, and others.

Examples of additive finishing operations include debinding, sintering, laser sintering, compressive sintering, directed energy deposition, heat treatment (HT), solution heat treatment (SHT), hot isostatic pressing (HIT), cold isostatic pressing, compaction, densification, heating, cooling, annealing, electromagnetic exposure, photonic exposure, peening, hammering, pinning, blasting, bead blasting, shot blasting, pressing, roll pressing, polishing, laser polishing, laser peening, laser shot peening, laser shock peening, rolling, ring rolling, shaped rolling, ring forging, deep cold rolling, forging, extruding, ultrasonic peening, mechanical peening, shot peening, hammer peening, gas exposure, solution treatment, solution heat treatment, and others. Additive finishing operations are here considered distinct from both forming operations and transforming operations, and activities categorized as part of an additive finishing operation are excluded by definition from the categories of forming or transforming operations. The results obtained are defined by the additive process for which they are used. When applied to an additive workpiece, they are supplementary to the additive operation.

Additive finishing operations may be performed during layer deposition, or after each layer of additive deposition, or periodically during an additive operation or series of additive operations, or after an additive operation or series of additive operations has completed, or any combination of the above. Additive finishing operations may be closely integrated with additive manufacturing operations (e.g., within a SCOFAST machine) or they may be performed as a part of post-processing activities that are carried out separately from additive operations per se.

Certain techniques useful in performing additive finishing operations on a workpiece that has been additively manufactured to a preliminary form are presented in X. Peng, L. Kong, J. Y. H. Fuh, and H. Wang, “A Review of Post-Processing Technologies in Additive Manufacturing,” Journal of Manufacturing and Materials Processing, vol. 5, no. 2, Art. no. 2, June 2021, doi: 10.3390/jmmp5020038 (Peng et al., 2021), which is incorporated here by reference, and in U.S. Pat. No. 10,220,434B2, which is incorporated here by reference.

Formative Operations/Forming

Forming is the process of altering the form of a workpiece by applying force to the workpiece, with or without otherwise altering its energy content, causing it to undergo plastic deformation and thereby to change from an initial shape (whether well-defined or amorphous) to a new desired shape. Forming does not primarily involve removal of material, though material may be lost during forming, such as when flash is removed after forging or casting. Forming and forming operations as here defined exclude additive finishing operations, which are categorized separately. Alterations in workpiece form or properties that result from an additive finishing operation are not evidence of forming as defined here, regardless of whether force was applied and/or plastic deformation occurred during the additive finishing operation.

Forming operations apply or utilize forces sufficient to induce plastic deformation of a material, resulting in alterations in the shape and other properties of the workpiece. The energy content of a workpiece may be altered before forming or during forming, making the workpiece plastic enough or fluid enough to reduce the forces required to induce a change of shape. A forming operation may proceed by altering the energy content of a workpiece sufficiently that it undergoes plastic deformation or liquification (melting) and flow deformation in response to intrinsic or ambient forces, without any need for extrinsic force application. For example, the shape and movement of softened or molten material are subject to ambient gravitational forces when melted within the earth's gravitational field. In a microgravity environment other forces, such as surface tension or ambient magnetic fields, may exert a predominant effect. Extrinsic forces may also be applied to induce, constrain or alter the shape and movement of softened or molten material. Containers (dies or molds) may constrain the final shape.

When material shape change is brought about through plastic deformation it may be performed in a variety of ways, such as forging, stamping, press forming, deep drawing, coining, punching, bending, curling, rolling, expanding, hemming, seaming, flanging, piercing, upsetting, compressing, hammering, swaging, cutting, spinning, embossing, extruding, molding, and other forming operations. Rolling techniques that may be integrated into a SCOFAST machine include, but are not limited to: forge rolling, hot rolling, cold rolling, roll forging, roll bending, roll forming, flat rolling, ring rolling, structural shape rolling, and others.

In addition to altering the shape of a workpiece, forming operations often alter the microscopic structure of the workpiece material and may be used to modify material properties.

Although much of the discussion of forming focuses on examples involving metal forming, a variety of non-metallic materials may similarly be formed through casting and/or deformation and many metalworking techniques may be adapted to operations involving non-metallic materials. Except for details of the specific attributes and behaviors of specific materials, each reference to a specific metallic or non-metallic material should be taken as a generic reference to metallic and non-metallic materials capable of plastic deformation or of melting.

Some techniques useful in forming operations are presented in U.S. Pat. No. 4,260,346A (Improved powder press), U.S. Pat. No. 7,021,401B2 (Electric Hammer with air cushion), U.S. Pat. No. 10,343,227B2 (Crimping tool), U.S. Pat. No. 1,211,193A (Forging-machine for making hollow bodies), U.S. Pat. No. 1,545,364A (Nail and method of producing same), U.S. Pat. No. 2,771,850A (Hydraulic stamping press), U.S. Pat. No. 3,342,051A (Incremental dieless forming), U.S. Pat. No. 3,357,218A (Hydraulic press), U.S. Pat. No. 3,496,619A (roller bearing races), U.S. Pat. No. 5,068,779A (Digital control for hydraulic press), U.S. Pat. No. 5,806,362A (Handheld tool for applying force), U.S. Pat. No. 6,520,077B1 (Screw press), U.S. Pat. No. 6,722,270B2 (Hydraulic press), U.S. Pat. No. 6,973,780B2 (Hydraulic press), U.S. Pat. No. 7,102,316B2 (Mechanical press), U.S. Pat. No. 7,191,848B2 (Rolling hammer drill), U.S. Pat. No. 7,353,686B2 (Press), U.S. Pat. No. 7,908,963B2 (Hydraulic press), U.S. Pat. No. 8,522,636B2 (Rectilinear motion device), U.S. Pat. No. 8,844,436B2 (Hydraulic press units), U.S. Pat. No. 9,044,913B2, U.S. Pat. No. 9,889,621B2, U.S. Pat. No. 10,786,847B2, U.S. Pat. No. 10,238,120B2 (Dough forming pressing plate), US20050126246A1 (Solid shapes extrusion), US20080141668A1 (Electrohydraulic drawing press drive), and US20090131235A1 (Ball bearing for spindle turning device), each of which is incorporated here by reference.

Additional exemplary systems and methods useful in SCOFAST forming operations are described in non-United States Patent documents CN102049461B (Multidirectional numerical control hydraulic press for metal plasticity forming) and CN111215898A (Electric arc additive synchronous ultrasonic hot rolling and rapid cooling), each of which is incorporated here by reference.

Additional exemplary systems and methods useful in SCOFAST forming operations are presented in the following non-patent documents, each of which is incorporated here by reference: K. Osakada, K. Mori, T. Altan, and P. Groche, “Mechanical servo press technology for metal forming,” CIRP Annals, vol. 60, no. 2, pp. 651-672, January 2011, doi: 10.1016/j.cirp.2011.05.007; and Marciniak, Z., Duncan, J. L. and Hu, S. J. (2005) Mechanics of sheet metal forming. 2. ed., transferred to digital print. Oxford: Butterworth-Heinemann.

Deformation

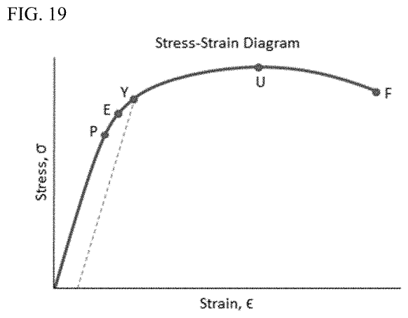

Deformation refers to the change in size or shape of an object. Displacements are the absolute change in position of a point on the object. Deflection is the relative change in external displacements on an object. Strain is the relative internal change in shape of an infinitesimally small cube of material and can be expressed as a non-dimensional change in length or angle of distortion of the cube. Strains are related to the forces acting on the cube, which are known as stress, by a stress-strain curve. In the generic stress-strain curve shown in FIG. 19, the vertical axis is the force (stress) necessary to produce the elongation or compression (strain) on the horizontal axis. In this figure, P is the proportionality limit, which represents the maximum value of stress at which the stress-strain curve is linear. E is the elastic limit, which represents the maximum value of stress at which there is no permanent set. Even though the curve is not linear between the proportionality limit and the elastic limit, the material is still elastic in this region and if the load is removed at or below this point the specimen will return to its original length. Y is the yield point, which represents the value of stress above which the strain will begin to increase significantly as a function of stress. The stress at the yield point is called the yield strength. For materials without a well-defined yield point, it is typically defined using the 0.2% offset method in which a line parallel to the linear portion of the curve is drawn that intersects the x-axis at a strain value of 0.002. The point at which the line intersects the stress-strain curve is designated as the yield point. U corresponds to the ultimate strength, which is the maximum value of stress on the stress-strain diagram. The ultimate strength is also referred to as the tensile strength. After reaching the ultimate stress, specimens of ductile materials will exhibit necking, in which the cross-sectional area in a localized region of the specimen reduces significantly. F is the fracture point or the break point, which is the point at which the material fails and separates into two pieces. The relationship between stress and strain is generally approximately linear and reversible (elastic deformation) up until the yield point. Above the yield point, some degree of permanent distortion remains after unloading; this distortion is termed plastic deformation. The determination of the stress and strain throughout a solid object is given by the field of strength analysis for materials and for a structure by structural analysis.

Elastic Deformation

Elastic deformation is the reversible deformation of an object in response to an applied force: when the force is removed, the object returns to its original size and shape. Elastic deformation may be used in a SCOFAST machine in a variety of scenarios, such as when some part of a workpiece may be elastically deformed to gain access to an area that otherwise would be inaccessible or difficult to access.

Plastic Deformation

Plastic deformation is the permanent deformation of an object in response to an applied force: when the force is removed, the object does not return to its original size and shape. Plastic deformation transforms solid materials from one shape into another. An initial shape that may be simple (e.g., a rod, billet or sheet blank) undergoes plastic deformation in response to forces applied by tools (e.g., hammers or dies) to produce a workpiece having a different geometry and often having different material properties. A sequence of such processes may be used to form material progressively from a simple geometry into a complex shape. Deformation processes are frequently used in conjunction with other operations, such as casting, machining, grinding, and heat treating in order to bring about a desired alteration from source material to a finished part. When a series of such operations are performed in a SCOFAST machine rather than in separate spatially incoherent machines, the advantages are significant and will be immediately apparent to one having ordinary skill in the art. In metals, deformation processes involve primarily metal flow and do not depend on long-term metallurgical rate processes.

Substantial Plastic Deformation

Substantial plastic deformation is plastic deformation of a workpiece resulting in a length change in a linear dimension of at least about 1 mm, or a change in an angular dimension of at least about 0.01 radians.

Bulk Forming Vs Sheet Forming

Forming (deformation) processes can be conveniently classified into two broad groups: bulk-forming processes and sheet-forming processes. In bulk forming processes, the initial workpiece has a low ratio of surface area to volume, such as in a billet, rod, or slab. In sheet forming processes, the initial workpiece has a high ratio of surface area to volume (a sheet material). Table III lists some attributes that distinguish bulk forming from sheet forming.

Bulk forming (bulk deformation) refers to the use of raw materials or workpieces having a low ratio of surface area to volume (bulk materials). Rolling, forging, extrusion and drawing are examples of bulk forming processes. In bulk forming, the ratio of surface area to volume may increase significantly. In contrast, sheet forming (sheet deformation) refers to the use of raw materials or workpieces having a high ratio of surface area to volume (sheet materials). Bending, folding, stretching, flanging, drawing, and contouring are examples of common sheet forming process, although these forming processes may equally be applied to bulk materials. In sheet forming the ratio of surface area to volume does not change appreciably.

A key difference between the two types of processes is that bulk forming changes one shape of a solid material into another shape via plastic deformation, leading to an appreciable increase in an initially low ratio of surface area to volume. In contrast, sheet forming applies force to change the geometry of a material but typically does not appreciably change its shape, and does not appreciably change an initially high ratio of surface area to volume. The ratio of elastic to plastic deformation is generally low in bulk forming, whereas in sheet forming the amount of elastic deformation may sometimes be of the same order of magnitude as the plastic deformation or higher. In bulk forming, the input material is in a form having a generally low ratio of surface area to volume (e.g., billet, rod, wire, bar, slab, or partially-formed workpiece having a low ratio of surface area to volume) and a considerable increase in the surface-to-volume ratio occurs in the bulk forming process. In sheet forming, a sheet blank having a high ratio of surface area to volume is plastically deformed into a more complex three-dimensional configuration, generally without any significant change in overall sheet thickness and surface characteristics and with no significant increase in the ratio of surface area to volume.

ASTM standards define plate as material 5.00 mm and over in thickness and over 250 mm in width. Sheet material is material less than 5.00 mm in thickness and at least 600 mm in width. Strip is cold-rolled sheet material less than 5.00 mm in thickness and under 600 mm in width. Bars include rounds, squares, and hexagons, of all sizes as well as flats over 5 mm in specified thickness and not over 150 mm in specified width together with and flats over 6 mm in specified thickness, from 150 to 200 mm inclusive in specified width.

TABLE III
Attributes of bulk forming vs sheet forming

| Bulk deformation | Sheet forming |
|---|---|
| Workpiece initially has a low area to | Workpiece initially has a high area |
| volume ratio | to volume ratio |
| Applied forming stresses may be | Applied forming stresses are planar |
| three dimensional | |
| A significant change in shape occurs | The geometry of a sheet undergoes |
| through plastic deformation. | modification in response to a force, |
| Geometry may also change. | but there is no significant change |
| | in the shape. |
| Area to volume ratio increases | No significant increase in area to |
| significantly | volume ratio |
| Billet, rod, slab, wire, and other forms | Sheet |
| having a low area to volume ratio | |
| Appreciable change in both shape | No significant change in shape or |
| and material cross-section | material cross-section |
| Plastic deformation much greater | Plastic deformation and elastic |
| than elastic deformation | deformation may be of comparable |
| | magnitude |

Lubricants

A lubricant is used when forming to reduce friction and wear, to serve as a thermal barrier reducing heat transfer from a workpiece to a die, and to serve as a parting compound preventing the part from sticking in a die. Lubricants may be liquids, solids, or powdered solids. Examples of solid lubricants used in forming include graphite, molybdenum compounds, and boron nitride. Examples of liquid lubricants include water, cutting fluids, petroleum products, synthetic fluids, and oils derived from natural sources, such as olive oil, safflower oil, or any other biologically-derived oil. Coolants such as liquid nitrogen may also serve as a lubricant. As a lubricant vaporizes it may also be a source of reactive or inert atmosphere, displacing ambient gases such as oxygen and carbon dioxide. Lubricants whether in liquid or vapor form may also serve as a source of a desired combining material for selected material transformations.

Forming Force

Flow stress is a measure of the force per unit area that must be applied to induce or maintain continuous plastic deformation of a material. A material starts flowing (plastic deformation) when the applied force (in uniaxial tension without necking and in uniaxial compression without bulging) reaches the value of the yield stress or flow stress for the material under the conditions that apply. The flow stress (Y) can be expressed as a function of the temperature (T), the strain (ε), and the strain rate (\dot{ε}).

Y=f(T,ε,\dot{ε})

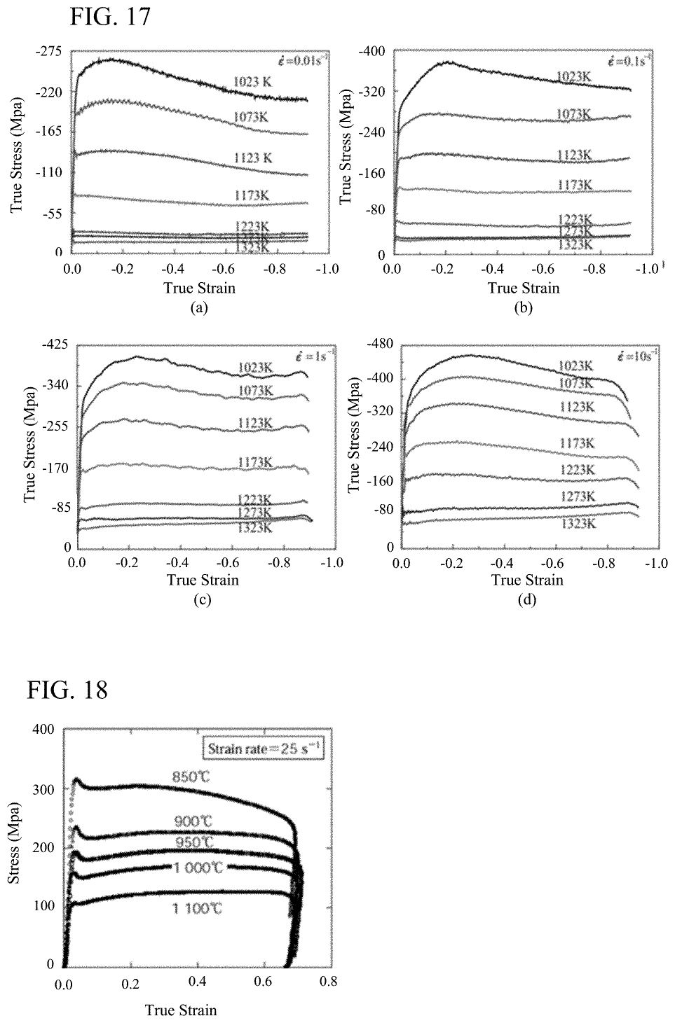

When metals are formed at temperatures above the recrystallization temperature of the material, the effect of the absolute strain on flow stress is small and the influence of strain rate is high. The flow stresses of materials usually are determined experimentally for a desired combination of strain, strain rate, and temperature conditions. Where published stress strain curves already exist, the required force may be estimated directly from the stress-strain curve for the desired strain rate and temperature. Stress-strain curves for the most commonly used commercial titanium alloy, Ti-6Al-4V, are seen in FIG. 17. Titanium Alloy 6246 is another alpha-beta titanium alloy that is heat treatable and deep hardenable, with high mechanical strength and excellent retention of properties up to 460° C. in service, making it useful in high-temperature service environments such as aircraft engines. Measured stress-strain curves for Titanium alloy Ti-6246 are shown in FIG. 18. Stress-strain curves are known for a vast number of metals, metallic alloys, ceramics, plastics, glasses, and other materials.

Flow stress (Y) is the largest determinant of the total forming force (F) required for plastic deformation. However, the force required is increased through friction when metal must flow into dies, as in forging operations. Larger frictional surfaces and more complex die shapes both result in greater friction. F may then be estimated as:

F=Y*A*K

Where Y is the flow stress (force per unit area) required to induce or maintain plastic deformation of the material at the desired forging temperature and strain rate, A is the projected area of the forging (including flash), and K is a friction factor adjusted for shape complexity. For simple shapes without flash, K is in the range of 1 to 5. The presence of flash may increase K by another 1 to 3 points. For more complex shapes K may be in the range of 8 to 12.

Yield strength is the flow stress above which complete elastic recovery no longer occurs and plastic deformation begins, corresponding to the yield point Y in a stress-strain curve as shown in FIG. 19: Stress-Strain diagram for a material.

Within a SCOFAST machine, each tool performing an operation resulting in plastic deformation therefore must apply or receive a total forming force F greater than the yield strength of the material applied over the area of the workpiece material at the temperature and strain rate of the desired deformation, adjusted for frictional effects.

The nominal yield strength of a specific metallic material at a desired temperature may be estimated from the known yield strength at any other temperature given the specific heat of the material and a measurement of Young's modulus of elasticity at the two temperatures, as shown in Table IV.

TABLE IV
Estimating material yield strength at temperature T
${σ}_{y} ( T ) = {[ \frac{{E}_{T}}{{E}_{0}} ( 1 - \frac{{\int }_{{T}_{0}}^{T} {C}_{p} ( T ) d T}{{\int }_{{T}_{0}}^{{T}_{M}} {C}_{p} ( T ) d T} ) ]}^{0.5} {σ}_{y} ( {T}_{0} )$

| | |
|---|---|
| σ_{y}(T) | the unknown yield strength of the material at temperature T |
| σ_{y}(T₀) | is the known yield strength of the material at temperature T₀ |
| Cₚ(T) | the specific heat of the material at temperature T |
| E_{T} | Young's modulus for the material at temperature T |
| E_{T0} | Young's modulus for the material at temperature T₀ |
| T_{M} | the melting point of the material |
| T₀ | the starting temperature at which the yield strength is known |

The derivation of this equation is found in W. Li, X. Zhang, H. Kou, R. Wang, and D. Fang, “Theoretical prediction of temperature dependent yield strength for metallic materials,” International Journal of Mechanical Sciences, vol. 105, pp. 273-278, January 2016, doi: 10.1016/j.ijmecsci.2015.11.017 (Li et al., 2016), which is incorporated here by reference.

Young's modulus is easily measured at any temperature and the specific heat of a material is easily found or easily measured, thus the predicted yield strength at any temperature is readily estimated. The experimental yield strength at room temperature for some common materials is shown in Table V.

TABLE V
Yield strength for selected materials at room temperature

| | | Ultimate Tensile | Yield Strength |
|---|---|---|---|
| Material | Alloy | Strength S [symbol] (psi) | S [symbol] (psi) |
| Ultra-high-strength steel | AISI 4340 | 287,000 | 270,000 |
| Stainless steel (age | AM 350 | 206,000 | 173,000 |
| hardenable) | | | |
| High-carbon steel | AISI 1095² | 200,000 | 138,000 |
| Graphite-epoxy composite | — | 200,000 | — |
| Titanium | Ti—6Al—4V | 150,000 | 128,000 |
| Ceramic | Titanium carbide | 134,000 | — |
| | (bonded) | | |
| Nickel-based alloy | Inconel 601 | 102,000 | 35,000 |
| Medium-carbon steel | AISI 1060 (HR)³ | 98,000 | 54,000 |
| | AISI 1060 (CD)⁴ | 90,000 | 70,000 |
| Low-carbon, low-alloy | AISI 4620 (HR) | 87,000 | 63,000 |
| steel | AISI 4620 (CD) | 101,000 | 85,000 |
| Stainless steel (austenitic) | AISI 304 (annealed) | 85,000 | 35,000 |
| Yellow brass | C 26800 (hard) | 74,000 | 60,000 |
| Commercial bronze | C 22000 (hard) | 61,000 | 54,000 |
| Low-carbon (mild) steel | AISI 1020 (CD) | 61,000 | 51,000 |
| | AISI 1020 (annealed) | 57,000 | 43,000 |
| | AISI 1020 (HR) | 55,000 | 30,000 |
| Phosphor bronze | C 52100 (annealed) | 55,000 | 24,000 |
| Gray cast iron | ASTM A-48 (class 50) | 50,000⁵ | — |
| Gray cast iron | ASTM A-48 (class 40) | 40,000 | — |
| Aluminum (wrought) | 2024-T3 (heat treated) | 70,000 | 50,000 |
| Aluminum (wrought) | 2024 (annealed) | 27,000 | 11,000 |
| Aluminum (perm. mold | 356.0 (sol'n. treated; | 38,000 | 27,000 |
| cast) | aged) | | |
| Magnesium (extruded) | ASTM AZ80A-T5 | 50,000 | 35,000 |
| Magnesium (cast) | ASTM AZ63A | 29,000 | 14,000 |
| Thermosetting polymer | Epoxy (glass reinforced) | — | 10,000 |
| Thermoplastic polymer | Acrylic (cast) | — | 7000 |

[symbol]

indicates data missing or illegible when filed

The practical force that must be applied and received in a SCOFAST machine operation will be greater than the nominal yield strength of the material by an amount that depends on the rate of strain and any frictional effects that may exist.

Forming Titanium

Slow deformation speeds may be advantageous when forming titanium and other exotic alloys because slower speeds correspond to lower strain rates. The degree to which a particular titanium grade or alloy can be formed at a given temperature is reflected in its uniform elongation in a tensile test at that temperature. The uniform elongation dictates the minimum bend radius as well as the maximum stretch which the alloy can sustain without fracturing. In this respect, annealed Grade 1, Grade 11 and Grade 17 exhibit maximum formability. These are followed by grades 2, 7, 16, 3, 12, 4 and 5. Bend radii for these alloys in sheet and plate product form, as defined by ASTM specifications (B265), are given in Table VI.

TABLE VI
Room temperature bend radius for
annealed titanium sheet and plate

| | Bend Radius | |
|---|---|---|
| ASTM Grade | 0.070″ thick | 0.070″ to ⅜″ thick |
| 1 | 3 T | 4 T |
| 17 | 3 T | 4 T |
| 11 | 3 T | 4 T |
| 2 | 4 T | 5 T |
| 16 | 4 T | 5 T |
| 7 | 4 T | 5 T |
| 3 | 4 T | 5 T |
| 12 | 4 T | 5 T |
| 4 | 5 T | 6 T |
| 5 | 9 T | 10 T |

Smaller radii may be achieved by heating to reduce the material yield strength and improve grain flow. The minimum bend radius for any given grade of titanium is approximately one-half of the ASTM specified bend radius for that grade.

When forming at room temperature, a loss of 15 to 25 degrees in included bend angle is expected due to springback of the titanium after forming. The higher the strength of the alloy, the greater the degree of springback to be expected. Compensation for springback is made by overforming. Hot sizing of cold formed titanium alloy parts may also be employed. Hot sizing may virtually eliminate springback provided the hot sizing temperature is high enough to allow stress relief

As with other metals, the ductility of titanium increases with temperature, enabling forming operations at elevated temperatures that would be impossible at room temperature. The effect of elevated temperature on bend radius of annealed Grade 5 sheet is shown in Table VII.

TABLE VII
Effect of temperature on minimum
bend radius of grade 5 titanium

| | Minimum Bend |
|---|---|
| Temperature F. (C.) | Radius |
| 70 (21) | 9 T |
| 400 (204) | 8 T |
| 600 (316) | 8 T |
| 800 (427) | 8 T |
| 1000 (538) | 6 T |
| 1200 (649) | 5 T |
| 1400 (760) | 3 T |
| 1500 (816) | 2 T |

Springback is virtually eliminated when forming grade 5 at about 625° C.-675° C., and critical mechanical properties are not adversely affected at that temperature. Oxidation of surfaces may become a factor at temperatures exceeding about 550° C., necessitating protective fluids, gas or vapor protection, or subsequent descaling. Heating for hot forming can be accomplished by induction coils, furnace, radiant heating, direct flame impingement, laser, or other methods. Provisions may be required to allow heated metal to cool evenly to prevent surface checking and internal stresses. It may be necessary to adjust for thermal contraction of warm formed or hot-formed parts.

Drawing Lubricants

Conventional forming lubricants generally are not effective when used with titanium. Effective lubricants include polyethylene or polypropylene in dry-film or strippable form, boron nitride, high-pressure grease-oil, and suspensions of acrylic resin in trichloroethylene containing molybdenum disulfide with PTFE.

Deeper draws, lower loads and less distortion in the finished part are obtainable by drawing titanium hot. Temperatures in the range 200°-325° C. may be preferred for unalloyed titanium. Titanium alloys, such as Grade 5 which have low ductility and are difficult to draw at room temperature, often can be drawn hot, in the range of 480°-650° C. Hot forming lubricants may contain graphite, molybdenum disulfide, boron nitride, or other suitable materials and may be applied over zinc phosphate conversion coatings.

Forging

Forging means bringing about the controlled bulk plastic deformation of a workpiece through the application of force. In forging processes, a material may be drawn (length increases and cross-section decreases), upset (length decreases and cross-section increases), or pressed or squeezed into open or closed compression dies (multidirectional flows). Forgings generally have a higher strength-to-weight ratio compared to cast parts of the same material. This is due to the fact that forging leads to denser microstructures, more defined grain patterns, and reduced porosity, making such parts much stronger than a casting. A part that is forged and subsequently machined thus has an advantageous performance envelope compared to a part that is machined from a casting. Within a SCOFAST machine, a part that is cast or 3D printed may advantageously subsequently be forged and/or machined.

Forging operations may be performed either with or without the addition or removal of thermal energy. Forging processes can be performed at various temperatures; however, they are generally classified by whether the metal temperature is above or below the recrystallization temperature of the material being forged. If the temperature is above the material's recrystallization temperature it is deemed hot forging. If the temperature is below the material's recrystallization temperature but above 30% of the recrystallization temperature on an absolute scale such as the Kelvin scale, it is referred to warm forging. If the temperature is below 30% of the recrystallization temperature on an absolute scale then it is considered cold forging.

Forging can produce a piece that is stronger than an equivalent cast or machined part. As the metal is shaped during the forging process, its internal grain texture deforms to follow the general shape of the part. As a result, the texture variation is continuous throughout the part, giving rise to a piece with improved strength characteristics. Many materials may be forged cold, but tougher metals such as iron, steel, and titanium are more frequently hot forged. Hot forging requires significantly less force and results in significantly less work hardening compared to cold forming, facilitating subsequent machining operations. Where hardening is desired other methods of hardening the piece may be employed, such as heating followed by temporally controlled cooling.

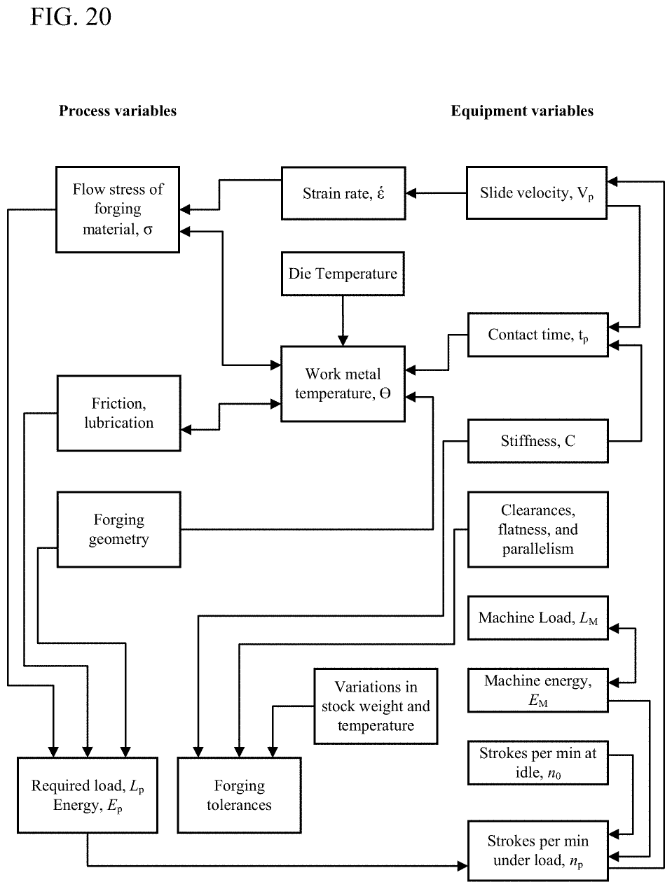

The design of specific machine elements for the performance of forging operations within a SCOFAST machine depends on many factors, as shown in FIG. 20: Equipment variables and Process variables in forging. Many aspects of the design, selection, and integration of forging elements that may advantageously integrated into a SCOFAST machine are presented in Altan, T. and Shirgaokar, M. ‘Selection of Forging Equipment’ (Altan and Shirgaokar), which is incorporated here by reference.

Substantial Forging

Substantial forging is forging that results in a dimensional change of about 1 mm or greater in a dimension of a workpiece.

Grade 5 Titanium Billet Forge Test

The grade 5 titanium billet forge test consists of first heating and then upset forging a cylindrical billet of grade 5 titanium that is 0.5 inches in diameter and 0.75 inches long. In the test an induction heater raises the temperature of the billet to about 900 C and a forging press exerts a force sufficient to upset forge the billet to a final length of about 0.5 inches.

Die Forging

The compressive deformation of material between dies. In a Forchine, the face of a main spindle collet may serve as one face of a closed die.

Cold Forging

Cold forging is the application of force to induce plastic deformation of metal at a temperature below 30% of its recrystallization temperature on an absolute scale. Cold forming most often is performed at ambient temperatures. Cold forging increases tensile strength, yield strength, and hardness while reducing ductility. Workpieces may be heat treated after cold forging to improve ductility and reduce residual surface stress.

Warm Forging

Increased forming temperatures below the recrystallization temperature but above 30% of the recrystallization temperature (on an absolute scale) can reduce the force required to achieve plastic deformation and can also affect the extent to which the workpiece is hardened during forming.

Hot Forging

Hot forging is performed by heating a workpiece above its recrystallization temperature and applying force to deform it into a desired shape. Temperature control may be important because the thermal profile of the process entire may strongly affect the metallurgical and structural properties of the newly forged part, and also because temperature strongly affects die life, need for lubrication, and part quality. Several temperatures are commonly measured and controlled in order to achieve the desired results, including the starting material temperature, the die entry temperature, the die temperature, and the in-process temperature (the temperature of the metal or other material during the forming process).

The optimum temperature for hot forging is dependent on the base material, the geometry of the part being forged, the available forging force, and the strain rate desired. A certain amount of iterative testing is required for best results. A range of nominal temperatures for forging a variety of metals is shown in Table VIII.

TABLE VIII
Nominal forging temperatures for common metals

| Material | Degrees Celsius |
|---|---|
| Carbon steel-0.50% carbon content | 1230 |
| Stainless steel (Nonmagnetic) | 1150 |
| Stainless steel (Magnetic) | 1095 |
| Nickel | 1095 |
| Titanium | 955 |
| Copper | 900 |
| Brass (many alloy types with | 815 |
| varying ratios of copper and zinc) | |
| Commercial bronze (90% copper | 900 to 419.53 |
| and 10% tin) | |
| Aluminum | 300-480 |
| Zinc | 419.53 |
| Lead | 327.46 |
| Tin | 231.93 |

The lower limit of the hot working temperature for a given material is roughly determined by its recrystallization temperature, which typically is approximately 60% of the melting temperature for that material on an absolute temperature scale. The upper limit for hot working is determined by multiple metallurgical factors, such as oxidation, grain growth, or an undesirable phase transformation. In practice materials are usually heated to the upper limit first to reduce flow stress as much as possible and to maximize the amount of time available for hot working. Hot forging may be performed in controlled atmospheres to minimize oxidation and other unwanted reactions at the surface of a workpiece, or to foster desired reactions such as surface treatments.

The temperature at which forging is performed varies by material and by application. For example, cold forming in steel is often performed at temperatures from 0-650 C. This process is primarily useful for low-carbon steel, and most effective when applied to rotational shapes. Warm forging in steel is often performed at temperatures from 650 C-950 C. Warm forging may be used with any steel, but again is most effective when applied to axially symmetric shapes. At temperatures above 950 C, hot forging may be used for any steel and is effective for any shape. Any or all of these operations may be performed in a SCOFAST machine.

For certain materials and certain parts, a part may be heated and forged more than once, and multiple dies may be used in the process. For example, a workpiece may be forged using a series of dies progressing from the raw material to the final form, each impression causing metal to flow into a rough shape in accordance to the needs of later cavities (“edging”, “fullering”, or “bending”). The piece is gradually worked through successive die cavities (“blocking” cavities) into a shape that more closely resembles the final product.

Thermal degradation is an important factor in tool life; more rapid forging can result in lower contact times and less tool heating, leading to a doubling of tool life. Conversely, in isothermal forging the die is heated to approximately the temperature of the billet to avoid surface cooling of the part during forging. Isothermal forging is required in order to forge super alloys and certain other metals that are very sensitive to surface cooling.

A typical die-forging forming workflow often involves induction heating, feeding, positioning, manipulation, and heat treatment of parts after forging; these steps are readily performed in a SCOFAST machine, in which case they may be preceded or followed by machining operations and other SCOFAST-LIMIT operations as described herein.

A distinction is made between open- and closed-die forging. In open-die forging the metal is incompletely constrained by the die. In closed-die forging (impression forging, “flashless forging”, or “true closed-die forging,”) the metal is constrained between die halves and the die cavities are completely closed to prevent the forged workpiece from forming waste flash.

A variation of die forging incorporates casting a forging preform from liquid metal. After the casting has solidified (but while still hot) it is forged in a die to a near-final shape before machining and other finishing operations. Forging improves the mechanical properties of the material and can add features that may be difficult to cast. Another variation of die forging incorporates creating a preform by spraying metal droplets into shaped collectors, where the desired preform shape is built up before forging.

Any solid metal or alloy may be forged. The characteristics of each material strongly affect the difficulty and outcomes of forging. The most readily forged common materials are aluminum, copper, and magnesium. More force is required to forge steels, nickel, and titanium alloys. Key factors include the material's molecular composition, crystal structure and mechanical properties within the temperature range at which forging will occur. For example, the force required for forging is significantly decreased when steel is heated sufficiently to facilitate a transition from ferrite to the more ductile austenite.

Impact Forging

In impact forging (e.g., drop forging or hammer forging) the energy required for deformation is transferred to a workpiece through rapid deceleration of a mass such as a hammer. In impact die forging, repeated blows against the die force the workpiece material to flow gradually into the shape of the die. In closed-die forging the blows continue until the die halves eventually meet. The impact mass (hammer) delivers one or more blows to gradually deform the material and close the die. Impact forging apparatus may continue to apply some amount of force after impact.

Press Forging

Press forging works by slowly applying a continuous pressure or force, as contrasted with the rapid application of impact force in drop forging (drop-hammer forging). Forging dies are closed in a single high pressure stroke. Forces may be generated by screw drives, hydraulic cylinders, or by other means. The slow application of force in press forging results in a lower strain rate, and tends to work the interior of the part more evenly when compared to hammer forging. Forming times range from 30 msec to several seconds. Presses may transfer some amount of energy through an initial impact followed by the application of a more important static force.

A dual press has opposing rams, and a dual double-action press has opposing rams, each having an additional inner plunger configured so that the inner pair of plungers come together to hold a workpiece in place, while the outer pair of plungers subsequently are actuated to provide the pressing force. Elements of a hydraulic press having upper and lower double action are described in U.S. Pat. No. 8,082,771B2, which is incorporated here by reference. Elements of a hydraulic press useful for lateral extrusion are described in United States Patent document US20040129053A1, which is incorporated here by reference.

When incorporated within a SCOFAST machine, a dual double-action hydraulic press can continue to be aligned vertically or it may be rotated by an arbitrary angle, since the workpiece is held in place rather than being retained by gravity on a horizontal bed. When used in this manner the inner pair of plungers extend to rest against a workpiece that is already secured in a workholder, thus serving as locators rather than as positioning support for the workpiece. When the outer plungers are activated the forces are thus concentric with respect to the workpiece, being entirely received by the structural members of the press module rather than being transmitted through the workholder and the machining center.

Within a SCOFAST machine a press may move under machine control relative to the machining center and the workpiece.

From another perspective, the functional elements of a milling center may be added to a pressing machine to form a SCOFAST machine having both pressing and milling functions, the elements being arranged such that machining workpiece holder may hold a workpiece within the pressing (baling) compartment of the press and all machining tools may bear upon the workpiece therein. Such presses are commonly used for powder products forming, plastic products forming, extrusion metal forming (cold or hot), sheet drawing, transverse pressing, bending, penetration, and correction processes. Any operation that can be performed in a press may thus be performed in a SCOFAST machine so constructed, permitting the combination of operations ordinarily performed in a press with those ordinarily performed in a machining center.

Upset Forging

Upset forging is a process in which the diameter of a workpiece is increased by compressing its length, by which means a length of smaller diameter bar may be converted into a shorter length of larger diameter bar. In the upsetting process a hammer or ram applies force against the end of a rod or stem to widen and change the shape of the end. The technique is suitable for manufacturing a part from small diameter bar when the part has certain features larger than the small diameter bar. Engine valves, couplings, bolts, screws, and other fasteners are examples of parts readily produced using this technique.

Upset forging often is performed in crank presses or hydraulic presses that commonly are aligned vertically or horizontally, but may be aligned in any arbitrary direction. The workpiece is wire, rod, or bar stock of any size, the forces required for upsetting increasing with the diameter of the workpiece. A series of upsetting operations may employ split dies that contain multiple cavities, the dies opening and the workpiece moving from one cavity to another for sequential operations to produce the desired form by stages.

Certain considerations are important when performing upset forging as an operation in a SCOFAST machine. The length of unsupported metal that can be upset in one blow without injurious buckling is estimated as three times the diameter of the bar. Lengths of stock greater than three times the diameter may be upset successfully without support, provided that the diameter of the upset is not more than 1.5 times the diameter of the stock. In an upset requiring stock length greater than three times the diameter of the stock, and where the diameter of the cavity is not more than 1.5 times the diameter of the stock, the length of unsupported metal beyond the face of the die generally should not exceed the diameter of the bar. When forming bolt heads on long bolts, a die that supports the bolt shaft may be used. The final diameter after upset forging may be many times greater than the diameter of the original barstock.

Drop Hammer Forging

Drop hammer forging is forging by means of an anvil or base aligned with a hammer that is raised and then dropped on metal, in order to forge or stamp the metal. The process is most often used with metal heated to increase its plastic formability.

Multidirectional Forging

Multidirectional Forging is a technique in which the force axis of the press is angled relative to the workpiece to apply force along arbitrary axes other than those defined by the major faces of the workpiece.

Roll Forging

Roll forging is a process for simultaneously reducing the cross-sectional area and changing the shape of heated bars, billets, or plates. A workpiece passes through opposing rolls to form a metal part. Although both roll forging and roll forming use rolls to modify the form of a material, roll forging is a metal forging process that modifies the dimensionality of a bulk material, while roll forming is a metal forming process that changes the shape of a workpiece without significantly altering its dimensionality. The terms are sometimes used interchangeably.

Roll forging passes a workpiece between two cylindrical or semi-cylindrical rolls having shaped grooves. The precisely shaped geometry of these grooves forge the part to the specified dimensions. In roll forging the thickness of the workpiece is reduced and the length is increased. Due to the grain alignment that occurs during this process, roll forging can produce parts having mechanical properties that are superior to those obtained through many other processes.

Rolled Ring Forging

Rolled ring forming is a process by which seamless circular parts such as bearing races and large ring gears are fabricated.

Net-Shape Forging

Net-shape forging is the production of a final piece whose shape is completely created through forging, without a requirement for additional machining to achieve the final shape.

Near-Net-Shape Forging

Near-net-shape forging is the production of a workpiece with a shape similar to that of the final part to be made. Additional operations are required to modify the forged workpiece in order to achieve the final shape. It is particularly advantageous to perform such operations in a SCOFAST machine due to the maintenance of spatial coherence and the reduction in handling.

Forming

Roll Forming

Roll forming, also spelled roll-forming or rollforming, is a type of rolling involving the continuous bending of a material into a desired cross-section without significantly altering the thickness of the material. Roll-forming is here distinguished from roll forging: although both roll forging and roll forming use rolls to modify the form of a material, roll forging modifies the dimensionality of a bulk material, while roll forming changes the shape of a workpiece without significantly altering its dimensionality. The terms are sometimes used interchangeably. Both roll forming and roll forging are readily integrated into a SCOFAST machine.

In roll forming a material passes through one or more consecutive sets of rolls, or through the same rolls multiple times with slightly different roll geometry for each pass, each pass performing an incremental part of a desired bend pattern until the desired profile is obtained. The geometric possibilities are broad and may include enclosed shapes as long as the cross-section is uniform. Although the purpose of roll-forming is not to alter the dimensionality of a workpiece, dimensionality may be altered incidentally, and roll-forming may alter material properties of the workpiece by causing work-hardening, micro-cracks, or thinning at bends.

Roll Bending

Roll bending is a process in which a material is passed through a series of rollers configured to bend a bar, tube, sheet, or other workpiece into a circular arc. Within a simple roll-bending jig three rollers freely rotate about three parallel axes that are arranged with uniform horizontal spacing. Two outer rollers cradle the bottom of the material while an inner adjustable roller applies force to the upper aspect of the material.

As the workpiece moves through the rollers, the inner roller is lowered and forced against the workpiece, causing the bar to undergo both plastic and elastic deformation. The portion of the bar between the rollers will take on the shape of a cubic polynomial approximating a circular arc. As the workpiece advances, the portion of the bar between the rollers at each point takes on the shape of a cubic curve modified by the end conditions imposed by the adjacent sections of the bar. When either end of the bar is reached, the force applied to the center roller is increased and the direction of the rollers is reversed to run the workpiece through the rollers in the reverse direction. If the process is continued, the workpiece gradually becomes a complete circular arc.

Thread Rolling and Knurling

Thread rolling is the formation of threads by plastic deformation using special dies, and knurling is the formation of surface grooves to provide a gripping texture on an otherwise smooth surface.

Drawing

Drawing is a metalworking process that uses tensile forces to stretch a deformable material such as metal, glass, ceramic, or plastic. As the material is drawn, it becomes thinner. When drawing sheet material, forces are applied to produce plastic deformation over a curved axis or surface. When drawing wire, bar, or tube, tension is used to draw the material through a reducing die, reducing its diameter and increasing its length. Drawing may be performed hot or cold. Drawing manufacturing examples include, but are not limited to: deep drawing, shallow drawing, bar drawing, tube drawing, wire drawing, hot drawing, and fiber drawing.

Swaging

Swaging is a process in which the dimensions of a workpiece are altered using compressing dies into which the item is forced. Swaging may be used to compress one element into or around another, securing them together. Swaging manufacturing examples include, but are not limited to: tube swaging, rotary swaging (roller swaging), butt swaging, and heat swaging.

Hydroforming

Hydroforming is a specialized type of die forming that uses a high pressure hydraulic fluid to press working material into a die. In some variants of hydroforming the liquid is confined to a bladder (flexforming) or is sequestered behind an elastomeric blanket, as in hydropress forming. Some techniques useful in hydroforming are described in U.S. Pat. No. 2,713,314A, which is incorporated here by reference.

Stretch Forming

Stretch forming is a hot or warm forming technique in which a heated metal sheet is stretched over a mold and then allowed to cool while held in the shape of the mold.

Rubber Pad Forming

Rubber pad forming is a metalworking process in which a sheet material is pressed between a die and one or more elastic pads that often are made of polyurethane. Pressure is applied to force the elastic pads against the sheet material, which is driven into the die and forced to conform to the die contours, thus forming the desired part. The elastic pads can have a general purpose shape or they may be machined to form an elastic die or punch.

Explosive Forming

Explosive forming is a metalworking technique in which an explosive charge is used to produce the forming force.

Electromagnetic Forming

Electromagnetic forming (EM forming or magneforming) is a type of high-velocity, cold forming process for electrically conductive metals, most commonly copper and aluminum. The workpiece is reshaped by high-intensity pulsed magnetic fields that induce a current in the workpiece and a corresponding repulsive magnetic field, repelling portions of the workpiece. The workpiece can be reshaped without any contact from a tool, although in some instances the piece may be pressed against a die or former. The technique is sometimes called high-velocity forming or electromagnetic pulse technology.

To perform electromagnetic forming a special heavy work coil is placed near the metallic workpiece, the system releases an intense current pulse and the varying current in the coil generates a varying magnetic field. A changing magnetic field induces a circulating electric current within the nearby conductive workpiece through electromagnetic induction. The induced current in the conductor creates a corresponding magnetic field around the conductor. Because of Lenz's Law, the magnetic fields created within the conductor and work coil strongly repel each other. This repulsion force serves to press the workpiece into the die. During forming, the magnetic pulse and the extreme speed of deformation transform the metal into a visco-plastic state that increases formability without directly affecting the native strength of the material. The high work coil current (typically tens or hundreds of thousands of amperes) creates ultrastrong magnetic forces that easily overcome the yield strength of the metal work piece, causing permanent deformation. The metal forming process occurs extremely quickly (typically tens of microseconds) and, because of the large forces, portions of the workpiece undergo high acceleration reaching velocities of up to 300 m/s.

Hot Metal Gas Forming

Hot metal gas forming (HMGF) is a method of die forming in which a metal tube is heated to a pliable state, near to but below its melting point, then pressurized internally by a gas in order to form the tube outward into the shape defined by an enclosing die cavity. High temperatures allow the metal to elongate without rupture.

Bending

Bending

Some exemplary systems and methods useful for bending are presented in U.S. Pat. Nos. 4,309,600A, 4,356,718A, 4,979,385A, 5,007,264A, 6,434,993B1, and 6,446,482B1, each of which is incorporated here by reference.

Two-Point Bending

Two-point bending is a manufacturing process that applies force to a material between two dies, most often to produce a V-shape, U-shape, or channel shape bend along a straight axis in ductile materials. The two dies have a length at least as long as the dimension of the material that will form the bottom of the bend. One die (the “punch”) has a radiused tip that makes contact with the workpiece along the bottom of the bend where the inside radius of the bend will be formed. The other die (“the die”) has a notch forming a V, U, or channel shape in which the outer radius of the bend will be formed.

Air Bending

Air bending is a bending technique in which the punch is pressed into the workpiece, which makes contact with the upper edges of the outer die and is forced into the die by the punch, but in which the workpiece never makes contact with the bottom of the outer die. The shape of the bend is then defined by the tension in the workpiece, the ductility of the material, the shape of the punch radius, the width of the gap in the die, and the depth to which the punch is pressed, but not by the shape of the bottom of the die. Because the bottom die channel shape does not affect the shape of the bend, either a V-shaped or square opening may be used in the bottom die. Air bending requires less bend force than other related bending techniques.

Bottoming

Bottoming is a bending technique in which the punch forces the workpiece against the bottom of the opening in the bottom die. The punch and die are shaped precisely to accommodate the thickness of the workpiece when the punch is bottomed out and the workpiece has been fully formed.

Coining

Coining is similar to bottoming. Material is forced into the bottom die with high force, causing plastic deformation throughout the sheet and minimal elastic recovery. Coining can produce very tight radii.

Three-Point Bending

Three-point bending is a highly precise technique using a die with an adjustable-height bottom tool to achieve bend angles with 0.25 deg. precision.

Folding

In folding, clamping beams hold one side of a sheet material and move to fold the sheet around a fixed tool to create a bend profile, permitting the fabricating of parts with positive and negative bend angles. Wiping is similar to bending but is performed with a fixed clamp and a moving tool.

Rotary Bending

Rotary bending uses a tool comprising a freely rotating cylinder with the final formed shape cut into it and a matching bottom die. On contact with the sheet, the tool rotates as the forming process bends the sheet.

Elastomer Bending

Elastomer bending uses deformable pads in place of a bottom die.

Straightening

Straightening is the process of removing bends from a material so that an axis of the material is as straight as possible. One method used for straightening is “bumping,” a process in which a force is exerted on a slightly curved bar using a die to deform a section of the bar and thus to gradually work out small amounts of curvature over long lengths of the bar. Another method of straightening a curved bar is hot-stretching the bar to remove curvature. Another method of straightening is rolling at an angle between a straight and a concave roller so that the bar is flexed sufficiently to counteract non-uniform stresses, spun so the residual stresses will be uniform, and advanced so the entire bar passes through the rollers and is straightened from end to end. The bar may also be heated to reduce the yield strength necessary to overcome residual stresses.

Some exemplary systems and methods useful for straightening are presented in U.S. Pat. Nos. 3,047,046A, 6,077,369A, and 8,834,653B2, each of which is incorporated here by reference.

Other Forming

Press Brake Forming

Press Brake Forming is sheet forming using a device to clamp a first section of a sheet material while inducing bending deformation along a line demarking the section from a second section, so that the second section assumes an angle other than 180 degrees relative to the first section.

Flow Forming

Flow Forming is an incremental metal-forming technique in which a disk or tube of metal is formed over a mandrel by one or more rollers using pressure. The roller deforms the workpiece, forcing it against the mandrel and lengthening it axially while thinning it radially. Some techniques for flowforming tubes are presented in U.S. Pat. No. 7,601,232B2, incorporated here by reference.

Embossing

Embossing is a method in which sheet material is forced into a shallow depression, causing stretching.

Coining

Coining is a method in which a pattern is compressed or squeezed into the material.

Drawing

Drawing is a method in which a section of material is stretched into a different shape via controlled material flow under tension. Drawing techniques that may advantageously performed within a SCOFAST machine include, but are not limited to, bar drawing, deep drawing, fiber drawing, hot drawing, shallow drawing, tube drawing, wire drawing, and additional examples that are set forth within this specification, together with such similar elements as will be known to those having skill in the relevant arts and others yet to be invented.

Stretching

Stretching is a method in which the edges of a section of sheet material are secured and a tensioning force is applied to the surface, causing an increase in surface area with no inward movement of the secured edges.

Ironing

Ironing is a method in which a section of sheet material is squeezed and reduced in thickness.

Reducing

Reducing (also known as Necking) is a method in which compressive force is applied to gradually reduce the diameter of the open end of a vessel or tube.

Curling

Curling is a method whereby a section of sheet material is deformed into a tubular profile, such as a door hinge.

Hemming

Hemming is a method in which an edge of sheet material is folded over onto itself to add thickness along the edge.

Shearing

Shearing is the mechanical cutting of materials without the formation of chips. It is often used to prepare materials between 0.025 and 20 mm (0.001 and 0.8 in). When the cutting blades are straight, the process is called shearing.

Piercing & Blanking

Piercing and blanking are methods whereby a tool is forced through a supported section of sheet material, making a hole in the material. In piercing operations, the punch-out is the scrap and the left-over strip is the workpiece, whereas blanking operations considers the punch-out the workpiece. Both operations are usually performed on some form of mechanical press.

Grob Forming

In grob forming a preformed workpiece having a hollow or a major cavity is secured around a close fitting tool mandrel having surface features that are not initially found in the preform. Rollers facing the mandrel (typically but not necessarily arranged in pairs on either side) rotate around one axis each to exert a deforming force on the pre-form according to their geometry and that of the tool mandrel, causing plastic deformation of the workpiece by touching the outer-most point of their circle. The mandrel is rotated synchronously with some period relative to that of the rotating rollers, so that the rollers come into contact with the workpiece and roll axially over the workpiece in a series of sequential angular displacements. At the same time as the rotating movement, the axial relationship between the mandrel and the rollers changes so that at each rotation of the rollers, the workpiece is formed with a stroke in the axial direction.

Spin Welding

Spin welding combines formative and additive operations; a first part is joined to a second part through the application of force pressing the two parts together and relative motion with friction between the two parts, producing heat and plastic deformation of the parts followed by melting in the area of direct contact to weld the two parts together. Often one part is fixed and the other spins, causing surface friction and abrasive wear against the fixed component. Friction between the two components generates heat and causes the contact surfaces to deform and melt. When motion stops, the weld joint re-solidifies under pressure. The technique is applicable to a wide variety of materials including metals, ceramics, glass, and thermoplastics. The technique may be used to join two materials previously heated by a means other than friction, such as induction heating, leading to a reduction in the force and speed required for spin welding.

Additive Operations/Accreting

Additive manufacturing is the process of creating a workpiece through the addition of material, either creating a workpiece de novo or adding material to an existing workpiece. Additive operations as defined here include additive finishing operations. Some techniques useful for additive and related operations in manufacturing are described in U.S. Pat. Nos. 1,934,891A, 2,871,911A, 3,556,888A, 4,066,480A, 4,575,330A, 4,665,492A, 4,752,352A, 4,818,562A, 4,842,186A, 4,857,694A, 4,863,538A, 4,944,817A, 4,963,627A, 5,038,014A, 5,121,329A, 5,257,657A, 5,303,141A, 5,340,433A, 5,387,380A, 5,398,193A, 5,426,964A, 5,506,046A, 5,514,232A, 5,555,176A, 5,572,431A, 5,590,454A, 5,622,216A, 5,658,520A, 5,665,439A, 5,700,406A, 5,740,051A, 5,881,796A, 5,887,640A, 5,900,207A, 6,028,410A, 6,253,116B1, 6,274,839B1, 6,280,784B1, 6,280,785B1, 6,376,148B1, 6,405,095B1, 6,519,500B1, 6,827,251B2, 7,040,377B2, 7,291,364B2, 7,917,243B2, 7,968,626B2, 8,066,922B2, 8,070,473B2, 8,132,744B2, 8,215,371B2, 8,383,028B2, 8,650,926B2, 8,726,802B2, 8,765,045B2, 8,876,513B2, 8,888,940B2, 9,079,337B2, 9,085,041B2, 9,174,388B2, 9,215,882B2, 9,586,298B2, 9,596,720B2, 9,636,941B2, 10,016,921B2, 10,065,241B2, 10,166,603B2, 10,421,142B2, 10,427,352B2, 10,456,978B2, 10,478,897B2, 10,518,490B2, 10,562,227B2, 10,688,581B2, 10,696,034B2, 10,875,288B2, US20060006157A1, US20070252305A1, US20090090161A1, US20100330144A1, US20110045115A1, US20120092105A1, US20150307385A1, U.S. Pat. No. 9,215,882B2, US20170129180A1 US20180065208A1, US20180318934A1, US20180326547A1, and US20200331062A1, each of which is incorporated here by reference.

Many methods are known whereby a workpiece may be created by addition of material. ASTM F2792-12a generically defines seven process classifications for additive manufacturing, specifically Binder Jetting, Directed Energy Deposition, Material Extrusion, Material Jetting, Powder Bed Fusion, Sheet Lamination, and Vat Photopolymerization. However, many variants of these broad categories exist, as well as additive processes that do not fit easily into one of those categories. In some methods, raw material is extruded into a desired shape, in others it is poured, injected, or otherwise caused to flow into a cavity or mold whose shape defines the shape of the workpiece, and in others it is added by a process of iterative addition, such as layering, spraying, sputtering, or solidification. Virtually any method by which new material may be added to a workpiece may be performed as an operation within a SCOFAST machine, including the addition of material by extruding, pultruding, pouring, casting, molding, solidifying, freezing, welding, brazing, fusing, shrink-fitting, gluing, 3D printing, spraying, painting, dipping, and additional examples that are set forth within this specification, together with such similar elements as will be known to those having skill in the relevant arts and others yet to be invented.

Examples of techniques used in additive manufacturing and suitable for use in a SCOFAST machine include but are not limited to: extrusion deposition, vat polymerization (SLA & DLP), powder bed fusion (SLS, DMLS & SLM), material jetting (MJ), binder jetting (BJ), direct energy deposition (DED, LENS, LBMD), sheet lamination (LOM, UAM), solid ground curing (SGC), three-dimensional (3D) microfabrication, liquid additive manufacturing (LAM), laser metal deposition-wire (LMD-W), ultrasonic consolidation (UC), computed axial lithography, continuous liquid interface production (CLIP), stereolithography (SLA), electron beam melting (EBM), electron beam freeform fabrication (EBF3), localized pulsed electrodeposition (L-PED), fused filament fabrication (FFF), robocasting, MiG welding 3d printing, direct ink writing (DIW), extrusion based additive manufacturing of metals (EAM), extrusion based additive manufacturing of ceramics (EAC), composite filament fabrication (CFF), powder bed and inkjet head 3d printing (3DP), selective heat sintering (SHS), computed axial lithography, magnetically assisted slip casting, projection micro-stereolithography (PμSL), chemical vapor deposition (CVD), bioprinting, and additional examples that are set forth within this specification, together with such similar elements as will be known to those having skill in the relevant arts and others yet to be invented. Virtually any material may be used in additive operations within a SCOFAST machine.

Examples of additive manufacturing operations combined with subtractive manufacturing operations within the same machine are found in U.S. Pat. No. 10,377,002B2, which is here incorporated by reference.

Extrusion Additive Manufacturing

Extrusion-based additive manufacturing (EAM) also referred to as material extrusion (ME), fused filament fabrication (FFF) or fused deposition modeling (FDM) is a 3-D printing process that feeds a deformable material through an extruder head that is optionally heated sufficiently to melt a thermoplastic material if necessary. The head and/or a supporting structure (“platform”) on which the workpiece is accreted are positioned and moved relative to one another under computer control, and material is deposited in precise layers at precise locations to build up a final form. In order to mechanically form each successive layer, drive motors are controlled to selectively move the base member and dispensing head relative to each other in a predetermined pattern that may be represented as movement along “X” and “Y” axes as material is being dispensed. Relative vertical movement along a “Z” axis may also be carried out before, during, and after the formation of each layer to achieve desired layer shape and thickness.

Deformable material may be supplied in the form of filament, rods, pellets, slurry, or combinations of materials that are combined immediately before or during deposition. Any extrudable substance may be used in this manner. Simple thermoplastic polymers in common use for this purpose include acrylonitrile butadiene styrene (ABS), polycarbonate (PC), polylactic acid (PLA), high-density polyethylene (HDPE), PC/ABS, polyethylene terephthalate (PETG), polyphenylsulfone (PPSU) and high impact polystyrene (HIPS). A vast number of other substances may be used in extrusion additive manufacturing, including composite materials with polymeric matrix and short or long hard fibers, ceramic slurries and clays, green mixtures of ceramic or metal powders and polymeric binders, food pastes, and biological pastes such as those containing live or dead cells (bioprinting). Examples of materials that are advantageously used in a 3-D printing process include thermoplastic polymers such as PLA, ABS, ABSi, HDPE, PPSF, PC, PETG, Ultem 9085, PTFE, PEEK, recycled plastics, and others; polymer matrix composites such as GFRP, CFRP, and others; ceramic slurries and clays such as Aluminum oxide, zirconia, Zirconium dioxide, kaolin, and others; green ceramic/binder mixtures such as zirconia, calcium phosphate, and others; green metal/binder mixtures such as stainless steel, titanium, inconel, and others; green metal/ceramic/binder mixtures such as stainless steel, iron, tricalcium phosphate, yttria-stabilized zirconia, and others; food pastes such as chocolate, sugar, protein, fat, and others; biological materials such as bioink cellular suspensions and others; and conductive polymer composites such as composites with carbon black, graphene, carbon nano tubes or copper nanoparticles, and others; together with other materials that are mentioned in this specification, and additional materials that may be known to those having skill in the relevant arts or that may be invented or discovered in the future.

Extrusion-additive three dimensional printing may be used to print or add material to workpieces that are highly flexible, such as fabrics, clothing, and wearable and/or implantable devices. Some techniques for printing flexible materials are presented in U.S. Pat. Nos. 10,105,246B2 and 10,696,034B2, each of which is incorporated here by reference.

Thermoplastics

Thermoplastic polymers remain the most popular class of additive manufacturing materials. Acrylonitrile butadiene styrene (ABS), polylactic acid (PLA) and polycarbonate (PC) each offer distinct advantages in different applications. Water-soluble polyvinyl alcohol (PVA) is typically used to create temporary support structures, which are later dissolved away.

Metals

Many different metals and metal alloys are used in additive manufacturing, from precious metals (e.g., gold and silver) to strategic metals (e.g., stainless steel and titanium).

Ceramics

A variety of ceramics have also been used in additive manufacturing, including zirconia, alumina and tricalcium phosphate. Layers of different materials may be fused to create entirely new classes of products.

Biochemical Materials

Biochemical healthcare applications include the use of hardened material from silicon, calcium phosphate and zinc to support bone structures as new bone growth occurs. Bio-inks containing stem cells may be used to print biological organs.

Concretes

Concrete and cement mixtures may be used in additive manufacturing of dwellings and other structures.

Welding

Welding is a technique whereby thermal energy is added to a localized area of a metal workpiece at a rate higher than the rate at which the energy is conducted away, causing the temperature to rise high enough in a small area for localized melting to occur. When two metal parts in contact are simultaneously heated in this way, melting occurs in each part and a pool of molten material forms at the junction. When the area cools, the metal solidifies and the two parts are thereby joined together.

When a weld pool has formed, additional metal in the form of wire, rod, powder, pellet, or other form may be added to the molten pool, adding mass to the area. In this manner a metal object can be additively modified, depositing layers of metal one after another to achieve the desired form. Many useful variations are achieved by varying the source of thermal energy and the means of delivering and controlling it, and by varying the mechanism for delivery of additional metal. Besides metal, it is possible to weld other substances, such as certain glasses and plastics and other substances that undergo reversible phase changes between solid and liquid form in response to manipulation of energy levels.

Well-known examples of welding techniques for manufacturing include, but are not limited to: shielded metal arc welding (SMAW) also known as “stick welding,” gas tungsten arc welding (GTAW) also known as tungsten inert gas (TIG) welding, gas metal arc welding (GMAW) also known as metal inert gas (MIG) welding, Flux-cored arc welding (FCAW), Submerged arc welding (SAW or SubArc), Electroslag welding (ESW), laser beam welding, laser-hybrid welding, electron beam welding, plasma welding, resistance welding, forge welding, ultrasonic welding, explosion welding, friction welding, friction stir welding, magnetic pulse welding, cold welding, diffusion bonding, exothermic welding, high frequency welding, microwave welding, hot pressure welding, induction welding, roll welding, spot welding, butt welding, flash welding, projection welding, upset welding, shot welding, gas welding, spray welding, oxyfuel welding, roll bonding, metal deposition through welding, metal deposition through sputtering, metal deposition through sintering, and metal deposition through other forms of additive manufacturing.

Brazing

Brazing is a joining process traditionally applied to metals (but also applicable to certain other materials, such as ceramics) in which molten filler (the braze alloy) flows into a joint and forms a bond with each surface. When the molten filler metal solidifies, it bridges the joint and serves to join the two sides together.

When brazing is used to join metals, the joint is heated above the melting point of the filler metal but is kept below the melting temperature of the parts to be joined. This distinguishes brazing from welding, where high temperatures are used to melt the base metals together. Brazing may be used to join dissimilar metals that could not be welded together. Brazing may also be used to deposit filler metal onto a substrate in one or more passes, building up a mass as an additive process. Brazing techniques used with filler metals having melting temperatures below 450 C is usually referred to as soldering.

Filler metals most often are alloys selected for compatibility with substrates, wetting ability, and melting point. Common filler metals include aluminum-silicon, copper, copper-silver, copper-zinc (brass), copper-tin (bronze), gold-silver, nickel alloys, silver, and amorphous brazing foil using combinations of nickel, iron, copper, silicon, boron, phosphorus, and other materials.

A filler metal, while heated slightly above melting point, may be protected by a suitable atmosphere which is often a flux used to prevent oxides from forming while the metal is heated. The flux also serves the purpose of cleaning any contamination left on the brazing surfaces. Flux can be applied in any number of forms including flux paste, liquid, powder or pre-made brazing pastes that combine flux with filler metal powder. Flux can also be applied using brazing rods with a coating of flux, or a flux core. In either case, the flux flows into the joint when applied to the heated joint and is displaced by the molten filler metal entering the joint. Phosphorus-containing brazing alloys can be self-fluxing when joining copper to copper. Fluxes are generally selected based on their performance on particular base metals. To be effective, the flux must be chemically compatible with both the base metal and the filler metal being used. Atmospheres in which a brazing operation may be performed include air (usually with flux), combusted fuel gas, ammonia, nitrogen, hydrogen, noble gases, inorganic vapors and vacuum. Brazing may be performed using any sufficient source of thermal energy, such as a torch, furnace, or induction coil.

To achieve a sound brazed joint, the filler and substrate materials should be metallurgically compatible, and the joint design should incorporate a gap into which the molten braze filler can be drawn or distributed by capillary action. The required joint gap is dependent on many factors, including the brazing atmosphere and the composition of the base material and braze alloy. The heat required for brazing may be delivered by any desired means, including torch, furnace, induction, dip, resistance, infrared, blanket, electron beam, laser, and others. Induction brazing is of particular convenience when brazing is performed in a SCOFAST machine.

Shrink Joining

Joining elements together by means of shrink-fitting is an additive process exploiting thermal expansion and contraction: two elements are fabricated with dimensions such that they may be fit together with minimal clearance when one is thermally expanded relative to the other. When the two are at the same temperature, a slight negative clearance exists thus the two pieces are joined together. Shrink-fit joining may be performed in a SCOFAST machine together with forming, machining, and other operations.

Casting

Casting operations are additive manufacturing operations in which a metal is melted and the molten liquid subsequently solidifies within a mold of the desired shape. Since plastic deformation of the metal does not occur during casting, it is not possible to control the grain shape or orientation during a casting operation, but the grain size can be controlled by adjusting the cooling rate, selecting the correct alloys, and applying thermal treatments. Some methods and techniques for casting are presented in U.S. Pat. Nos. 1,607,677A, 3,495,650A, 4,446,907A, 4,779,665A, 6,065,526A, 6,135,196A, 3,866,666A, 7,210,517B2, 4,142,639A, 4,832,110A, 3,495,650A, 8,434,544B2, 6,978,823B2 and 5,579,825A, each of which is incorporated here by reference.

Some additional exemplary systems and methods useful for casting are presented in non-United States patent document CN201720411U, which is incorporated here by reference.

The heat required to melt materials such as metals and glasses for casting may be applied externally, molten material being supplied as a raw material, or the thermal energy may be supplied in situ as a SCOFAST operation. Thermal energy may be added by any means, however melting by means of induction heating is particularly convenient within a SCOFAST machine since the heat is generated in the material or the crucible itself and the likelihood of workplace accidents due to heat or flame is therefore reduced. Induction melting is cleaner than melting with a flame because there is no combustion residue. Precise control of the energy applied in induction melting leads to reproducible results of uniform quality.

Rotational Casting

Rotational casting is the process of casting materials whose distribution is effected through the use of rotation to produce centrifugal force. Some exemplary systems and methods useful for rotational casting are presented in U.S. Pat. No. 7,628,604B2, US95071XA, and US141119XA, each of which is incorporated here by reference, and in non-United States patent document CH95071D, which is incorporated here by reference.

Lost-Material Casting

Lost-material casting is a process of casting materials into a mold that has been formed around a model of the part to be cast, where the model is made of a substance that can be removed through combustion, liquefaction, vaporization, or displacement before or during the casting process. Many different materials can be used in this manner, including foams, waxes, and plastics.

For example, a model of a desired part may be formed using a combustible, meltable, or vaporizable sacrificial material. The model may then be optionally machined, smoothed, finished, or otherwise modified, before being embedded in a mold container that is filled with casting plaster or another refractory material that is allowed to cure. The mold container is then heated sufficiently to melt, vaporize, or burn away the sacrificial model, after which a molten material is poured or injected into the mold and allowed to cool. In some embodiments the molten material itself supplies the heat necessary to remove the sacrificial material during the casting process.

The sacrificial model of the desired part may be made using any of a variety of techniques. It may itself be cast from a master mold (e.g., 3-D printed and/or machined mold sufficiently durable for casting wax, but not capable of casting metal directly). The sacrificial model itself may be 3D printed and/or machined de novo from a sacrificial material.

Other methods of casting that may be adapted for use within a SCOFAST machine include but are not limited to sand casting, plaster mold casting, shell molding, investment casting, evaporative-pattern casting, full-mold casting, expendable mold casting, non-expendable mold casting, die casting, thixoforming (semi-solid metal casting), centrifugal casting, continuous casting, squeeze casting, chill casting, slush casting, spin casting, and centrifugal rubber mold casting.

Within a SCOFAST machine it may be advantageous to perform an additive casting operation and subsequent additive finishing operations. Certain techniques for additive finishing after casting are presented in U.S. Pat. No. 3,106,002A, which is incorporated here by reference. Certain techniques for forming to a final shape after casting are presented in U.S. Pat. No. 10,668,529B1, which is incorporated here by reference.

Extrusion

Extrusion is a forming process in which a material is forced through a die of the desired cross-sectional shape to create objects having a fixed cross-sectional profile. Extrusion can create very complex cross-sections, and can be used with brittle materials because the extruded material encounters only compressive and shear stresses. Commonly extruded materials include metals, polymers, ceramics, concrete, clay, and foodstuffs. The products of extrusion may be referred to as “extrudates.” When the raw materials of extrusion are unformed, as in liquids, powders, slurries, or pastes, extrusion may be considered an additive process. When the raw materials used for extrusion are solids, high pressing forces may be necessary to extrude the material through plastic deformation, thus extrusion may be considered a forming process.

Hole Flanging

Hole flanging is a special type of extrusion in which extrudates containing internal cavities may be formed using progressive extrusion dies that initially provide die support for an internal cavity that is not fully closed, gradually collapsing outer features together to close the cavity and provide external support from the extrudate as internal support from the die ends.

Extrusion techniques that may be used advantageously in a SCOFAST machine include, but are not limited to: hot extrusion, cold extrusion, friction extrusion, microextrusion, direct extrusion, indirect extrusion, hydrostatic extrusion, impact extrusion, equal channel angular extrusion, sheet/film extrusion, blown film extrusion, overjacketing extrusion, hole flanging, and helical extrusion.

Sintering

Sintering (frittage) is the process of compacting and forming a solid mass of material from individual particles by the application of pressure and/or heat, without melting the material to the point of liquefaction. Sintering is most often used as an additive finishing operation. Fusion occurs when atoms in the materials diffuse across the boundaries of the particles, fusing the particles together and creating a solid piece. The density, porosity, and grain structure of the final product may be controlled during sintering. Because the sintering temperature does not have to reach the melting point of the material, sintering is a particularly important process for materials with extremely high melting points such as tungsten and molybdenum. Sintering is commonly used in the manufacture of parts composed of metals, ceramics, plastics, and other materials. Sintering manufacturing examples include, but are not limited to: liquid phase sintering, electric current assisted sintering, spark plasma sintering, capacitor discharge sintering, electro sinter forging, pressureless sintering, microwave sintering, selective laser sintering, direct metal laser sintering, and hydrogen sintering. Within a SCOFAST machine it may be advantageous to perform a sintering operation and subsequently to perform forging and/or other forming operations. Certain techniques for forming after sintering are presented in U.S. Pat. No. 6,599,467B1, which is incorporated here by reference.

Laser Sintering

In laser sintering a laser sinters thermoplastic powders to cause particles to adhere to one another.

Direct Metal Laser Sintering

In Direct Metal Laser Sintering (DMLS), a laser sinters each layer of metal powder so that the metal particles adhere to one another. DMLS machines produce high-resolution objects with desirable surface features and mechanical properties.

Direct Metal Laser Melting (DMLM) and Electron Beam Melting (EBM)

The DMLM and EBM processes are distinct from sintering because materials being fused are fully melted. With DMLM, a laser completely melts each layer of metal powder while EBM uses high-power electron beams to melt the metal powder. Both technologies are advantageous for manufacturing dense, non-porous objects.

Powder Injection Molding

Powder Injection Molding, also referred to as “Low Pressure Powder Injection Molding” is a modified sintering process in which a desired material in powder form is mixed with binder material to create a “feedstock” that is then shaped and solidified using injection molding. The molding process allows high volume, complex parts to be shaped in a single step. After molding, the part undergoes transformation via conditioning operations to remove the binder (debinding) and densify the powders. The method is sometimes referred to as “hot casting” but does not necessarily require heat. It may be used to form parts from any solid materials, including but not limited to natural minerals, oxides, carbides, metals, ceramics, plastics, multicomponent composite synthetic materials, and any combination of such materials. When the powdered material used is a metal, the process may be referred to as Metal Injection Molding. Methods and Techniques for powder injection molding are described in U.S. Pat. No. 4,197,118, which is incorporated here by reference.

Liquid-State Sintering

Liquid-state sintering is a special form of sintering in which at least one but not all elements are in a liquid state. Liquid-state sintering is commonly used in the manufacture of cemented carbide and tungsten carbide parts.

Injection Molding

Injection molding manufacturing operations include, but are not limited to: metal injection molding, thin-wall injection molding, reaction injection molding, thermoplastic injection molding, overmolding, insert molding, cold runner molding, hot runner molding, extrusion blow molding, injection blow molding, and stretch blow molding.

Electroforming

Electroforming is a metal forming process in which parts are fabricated through electrodeposition on a model referred to as a mandrel. The process involves passing direct current through an electrolyte containing salts of the metal being electroformed. The anode is the solid metal being electroformed, and the cathode is the mandrel, onto which the electroform gets plated (deposited). The process continues until the required electroform thickness is achieved. The mandrel is then either separated intact, melted away, or chemically dissolved.

Before electrodeposition begins, conductive (metallic) mandrels are treated to create a mechanical parting layer, or are chemically passivated to limit electroform adhesion to the mandrel and thereby allow its subsequent separation. Non-conductive (glass, silicon, plastic) mandrels require the deposition of a conductive layer prior to electrodeposition. Such layers can be deposited chemically, through vacuum deposition techniques (e.g., gold sputtering), by combustion deposition, or through other methods. The surface of the mandrel forms one surface of the form, the part growing from the mandrel into the electrolyte solution.

Binder Jetting

The binder jetting process is the same as that of material jetting, except that the print head lays down alternate layers of powdered material and a liquid binder.

Directed Energy Deposition

The process of directed energy deposition (DED) is carried out in the same manner as that of material extrusion, but can be used with a wider variety of materials, including polymers, ceramics and metals. An electron beam gun or laser mounted on a four- or five-axis arm melts either wire or filament feedstock or powder.

Wire Arc Additive Manufacturing

Wire arc additive manufacturing, also known as Directed Energy Deposition-Arc (DED-arc), uses arc welding power sources and manipulators to build 3D shapes through arc deposition. This process commonly uses wire as a material source and follows a predetermined path to create the desired shape. This method of additive manufacture is usually performed using robotic welding equipment.

Material Extrusion

Material extrusion is one of the most well-known additive manufacturing processes. Spooled polymers are extruded, or drawn through a heated nozzle mounted on a movable arm. In one common geometry the nozzle moves in two axes horizontally while the bed moves vertically, allowing the melted material to be built layer after layer. Proper adhesion between layers occurs through precise temperature control or the use of chemical bonding agents.

Material Jetting

With material jetting, a print head moves back and forth while material is ejected toward a receiver, in the manner of the head on a 2D inkjet printer. In material jetting, the print head typically moves on x-, y- and z-axes to create 3D objects. Layers harden as they cool or are cured by ultraviolet light or by some other method.

Sheet Lamination

Laminated object manufacturing (LOM) and ultrasonic additive manufacturing (UAM) are two sheet lamination methods. LOM uses alternate layers of paper and adhesive, while UAM employs thin metal sheets conjoined through ultrasonic welding. LOM excels at creating objects ideal for visual or aesthetic modeling. UAM is a relatively low-temperature, low-energy process used with various metals, including titanium, stainless steel and aluminum.

Vat Polymerization

In vat photopolymerization, also known as stereolithography (SLA), an object is created in a vat of a liquid resin photopolymer. Exposure to a source of energetic photons having a range of frequencies that is defined for the particular resin system induces photopolymerization of the resin to cure a microtine layer having a shape that is precisely defined by an exposure control apparatus.

Additive Finishing

Additive finishing operations are an important and often essential part of additive manufacturing. Within a SCOFAST machine, such supplemental operations may be classified as a subset of additive operations.

Subtractive Operations & Machining

Subtractive operations are those in which material is removed from a workpiece to produce a desired shape. The term subtractive manufacturing is used to distinguish traditional machining techniques from those used in 3D printing and other accretive manufacturing techniques, which collectively are referred to as additive manufacturing. Commonly used techniques for removing material from a workpiece include abrasive flow machining (AFM), abrasive jet machining (AJM), bead blasting, biomachining, blanking, blasting, boring, broaching, burning, burnishing, carving, chemical machining, chemical stripping, cutting, deburring, drilling, electrical chemical machining (electrochemical machining, ECM), electrical discharge machining (EDM), electron beam machining (EBM), etching, filing, flame cutting, grinding, honing, lapping, laser ablation, laser cutting, lathe turning, milling, photochemical machining, planing, plasma cutting, polishing, punching, reaming, sand blasting, sanding, sawing, scissoring, shaping, shearing, stamping, tapping, turning, ultrasonic machining, water-jet cutting, and others.

Within a SCOFAST machine, subtractive operations may begin with a workpiece comprising raw material or it may be advantageous to perform subtractive operations on a workpiece comprising a part that has been partially realized through one or more additive, subtractive, or formative processes or a combination thereof.

Some systems and methods useful for subtractive operations are presented in U.S. Pat. Nos. 4,354,305A, 4,419,912A, 4,698,480A, 4,893,440A, 5,042,126A, 5,052,089A, 5,058,261A, 5,160,824A, 5,205,806A, 5,636,949A, 5,775,853A, 6,558,231B1, 6,576,858B1, 6,593,541B1, 6,806,435B2, 6,868,304B2, 6,896,143B2, 6,904,652B2, 7,039,992B2, 7,101,256B2, 7,112,121B2, 7,134,173B2, 7,185,412B2, 7,237,310B2, 7,240,412B2, 7,473,160B1, 7,518,329B2, 7,941,240B2, 8,020,267B2, 8,215,211B2, 8,887,360B2, 9,095,954B2, 9,156,116B2, 9,272,385B2, 9,339,889B2, 9,364,912B2, 9,902,034B2, 9,943,920B2, 10,065,241B2, 10,137,522B2, 10,195,649B2, 10,596,666B2, 10,663,947B2, US20020137611A1, US20050082165A1, US20070246372A1, and US20140076115A1, each of which is incorporated here by reference.

Additional exemplary systems and methods useful for subtractive operations are presented in non-United States Patent documents CN109909746A, CN201579591U, DE102018108145A1, and WO1993009901A1, each of which is incorporated here by reference.

Some additional exemplary systems and methods useful for formative, additive, subtractive, or transformative operations, particularly those involving the action of lasers, are presented in U.S. Pat. No. 5,463,200A (Workpiece marking), U.S. Pat. No. 4,673,795A (Laser processing with imaging), U.S. Pat. No. 5,866,870A (Laser beam welding), U.S. Pat. No. 6,462,306B1 (Multiple laser beam control), U.S. Pat. No. 6,664,507B2 (Simultaneous laser and gas metal arc welding), U.S. Pat. No. 6,720,519B2 (Laser drilling), U.S. Pat. No. 6,774,338B2 (Powder-fed laser fusion welding), U.S. Pat. No. 6,856,634B2 (Laser machining controller), U.S. Pat. No. 7,012,216B2 (Laser welding wand), U.S. Pat. No. 7,112,761B2 (Laser welding gas lens), U.S. Pat. No. 7,307,237B2 (Laser welding nozzle with feeder extension), U.S. Pat. No. 7,947,922B2 (multiple beam micro-machining), U.S. Pat. No. 7,880,117B2 (Laser drilling high density submicron cavities), U.S. Pat. No. 8,143,552B2 (Laser machining system), U.S. Pat. No. 8,729,424B2 (Multiple heat source welding), U.S. Pat. No. 8,809,734B2 Thermal laser processing system), U.S. Pat. No. 9,592,571B2 (Laser welding), and U.S. Pat. No. 10,730,139B2 (Laser welding), each of which is incorporated here by reference.

Machining

Machining is a process in which a tool is used to remove material from a workpiece. To perform the operation, relative motion occurs between the tool and the work. This relative motion is achieved in most machining operation by means of a first motion, called “cutting speed” and a second motion called “feed”. The shape of the tool and its penetration into the work surface, combined with these motions, produce the desired shape of the resulting work surface. A tool may have a single cutting edge or multiple cutting edges. A tool may move in a simple curvilinear path with respect to the workpiece or it may rotate, vibrate, or oscillate while moving along a simple curvilinear path in a process known as “active tooling”. Traditional machining operations include those performed on lathes, shapers, planers, drilling machines, milling machines, grinding machines, saws, presses, turret lathes, screw machines, multi-station machines, gang drills, production milling machines, gear-cutting machines gear shapers, gear hobbers, broaching machines, rotary broaching machines, lapping machines, honing machines, boring machines, multi-axis machining centers, and others.

Hot Machining

Within a SCOFAST machine, operations may be performed at any temperature. It is generally taught that a workpiece should be kept as cool as possible when machining, to prevent distortion and increased tool wear associated with heat. However, it sometimes is advantageous to perform machining after heating the workpiece rather than after cooling it. The advantages of this method of machining (“high-temperature machining”) can be substantial. At elevated temperatures, and particularly at elevated temperatures greater than 60% of the absolute recrystallization temperature of the workpiece material (“hot machining”), a machine tool may cut the workpiece with greatly reduced force compared to the same tool cutting the same material at a lower temperature, thereby reducing or eliminating chatter and vibration and resulting in cleaner and more consistent machined surfaces as well as reduced tool wear. Machining operations that are difficult or impossible at room temperature may be significantly easier when using the hot machining method.

Tools used in warm (30%-60% of the absolute recrystallization temperature) or hot (at or above 60% of the absolute recrystallization temperature) forming and machining must be made of a material suitable for use at such elevated temperatures. Carbon steel tools having carbon content ranging from 1 to 1.2 percent tends to lose cutting ability at temperatures above 200 C, a temperature easily generated simply through the friction of high speed cutting. Higher temperature tolerance is achieved with the use of high-speed tool steel, such as steel alloys containing about 18 percent tungsten, about 4 percent chromium, about 1 percent vanadium, and about 0.5 percent to 0.8 percent carbon. Cutting tools cast from certain nonferrous alloys containing cobalt, chromium, and tungsten may retain cutting ability even when heated until glowing red. Tungsten carbide tools are of particular use in hot machining. Certain ceramic oxides and specialty materials such as diamond are also of use.

Machining Center

A machining center is a type of milling or mill-turn machine fitted with automatic tool-changing facilities and capable of several axes of control. The tools are generally housed in one or more magazines and may be changed by commands from the machine tool program. Different faces of a workpiece can be machined by a combination of operations without removing the workpiece. A horizontal turning-milling machining center has its primary workpiece turning axis aligned horizontally, while a vertical turning milling machining center has its primary workpiece turning axis aligned vertically. Examples of vertical turning milling machining centers are described in United States patents U.S. Pat. No. 8,887,361B2 and US20140020524A1, each of which is incorporated here by reference.

Turret Lathes

Turret lathes have several features that distinguish them from engine lathes, and comprise many elements that may be advantageous in a SCOFAST machine. The first is a tool turret, which takes the place of the tailstock on a horizontal engine lathe. A variety of turning, drilling, boring, reaming, and thread-cutting tools may be fastened to the tool turret, which can be rotated about one or more axes. The turret is moved along the machine spindle axis or a parallel axis so that tools are brought to bear on a workpiece that is secured to the machine spindle. A second distinguishing feature of the turret lathe is an additional turret mounted on the cross slide. This turret also can be rotated about the axis normal to the cross slide plane and optionally around other axes, and permits the use of a variety of turning tools. An additional similar tool holder or turret may be mounted to the rear of the cross slide, and multiple cross slides may exist, sliding in parallel axes, orthogonal axes, or arbitrarily oriented axes.

Turret lathes sometimes are described as bar machines (screw machines) or as chucking machines. A bar machine is designed for machining small threaded parts, bushings, and other small parts that can be created from bar stock fed through the machine spindle. Automatic bar machines produce parts continuously by automatically replacing of bar stock into the machine spindle. A chucking machine is designed primarily for machining larger parts, such as castings, forgings, or blanks of stock that cannot be continuously fed through the spindle.

Back-Processing

Back-processing is a set of techniques used to gain machining access to the aspect of a workpiece that is oriented towards the workholding collet. One technique is the provision of a secondary collet that may secure the workpiece from the side opposite the primary collet. The workpiece being held by the secondary collet, the primary collet may release the work, which is then moved away from the primary collet so that the “back” side of the workpiece may be reached by tools. Another technique is the use of a reversing tool configured to grip the workpiece, remove it from a collet, rotate it end for end, and replace it in the collet. Depending on the machine design, such operations may result in a loss of spatial coherence between operations that are performed before the transfer and those performed afterward.

Abrasive Flow Machining

Abrasive flow machining, also known as abrasive flow deburring or extrude honing, is an interior surface finishing process characterized by flowing an abrasive-laden fluid around or through a workpiece. This fluid is typically very viscous. AFM smooths and finishes rough surfaces, and is often used to remove burrs, polish surfaces, form radii, and remove material, particularly in areas of obstructed access such as interior surfaces, slots, holes, cavities, and those involving other geometries that are difficult to reach. Abrasive flow machining is described in U.S. Pat. No. 3,521,412, incorporated here by reference.

Abrasive Jet Machining

Abrasive jet machining, also known as abrasive micro-blasting, pencil blasting and micro-abrasive blasting, is an abrasive blasting machining process that uses abrasives propelled by a high velocity gas to erode material from the workpiece. Common uses include cutting heat-sensitive, brittle, thin, or hard materials, especially to cut intricate shapes or form specific edge shapes. Material is removed by fine abrasive particles that may be of any size but usually about 0.001 in (0.025 mm) in diameter, driven by a high velocity fluid stream; common gases are air or inert gases. Pressures for the gas commonly are in the range from 25 to 130 psig (170-900 kPa or 4 bars) with speeds commonly as high as 300 m/s (1,000 km/h). Some techniques useful in abrasive jet machining are described in U.S. Pat. No. 4,893,440A, 8,308,525B2, 9,108,297B2, 9,138,863B2, 9,586,306B2, US20130267152A1, and US20210237226A1, each of which is incorporated here by reference.

Biomachining

Biomachining is the machining process of using lithotrophic bacteria to remove material from metal parts through an activity known as bioleaching. Biomachining is contrasted with chemical machining methods such as chemical milling and physical machining methods such as turning and milling. Certain bacteria, such as Thiobacillus ferrooxidans, Thiobacillus thiooxidans, and others, utilize the chemical energy from oxidation of a metal, such as iron, copper, or any other metal to fix carbon dioxide from the air. A metal object that is exposed to a culture fluid containing these metal-metabolizing bacteria will have material removed from its surface. Biomachining is typically performed in the same manner as chemical milling: the area to be cut is marked out as a negative image with an inert maskant that protects areas that are not to be cut. The part is then exposed to culture fluid with environmental and flow/mixing controls used to adjust the activity of the biological etchant. Some techniques for bioleaching are described in U.S. Pat. No. 7,837,760B2, which is incorporated here by reference. Some techniques for milling a workpiece via biomachining are described in United States Patent document US20170341203A1, which is incorporated here by reference. Biomachining techniques are readily extensible to biomilling of plastics, wood, composites, and any other substance for which a bioagent can be found or created that is capable of softening or removing material from a surface of that substance.

Continuous Dress Creep Feed Grinding (CDCF)

Continuous dress creep feed grinding (CDCF) is a precision grinding technique that offers a high material rate removal in tough materials, eliminating a need for high-tool-wear milling and deburring. In CDCF, grinding wheels are continuously dressed at a constant rate that is automatically adjusted for, allowing high material removal rates and high tool predictability.

Electron-Beam Machining

Electron beam machining (EBM) is a technique is used for cutting fine holes and slots in any material. In a vacuum chamber, a beam of high-velocity electrons is focused on a workpiece. The kinetic energy of the electrons, upon striking the workpiece, changes to heat, which vaporizes minute amounts of the material. The vacuum prevents the electrons from scattering, due to collisions with gas molecules. EBM is used for cutting holes as small as 0.001 inch (0.025 millimeter) in diameter or slots as narrow as 0.001 inch in materials up to 0.250 inch (6.25 millimeters) in thickness. EBM is also used as an alternative to light optics manufacturing methods in the semiconductor industry. Because electrons have a shorter wavelength than light and can be easily focused, electron-beam methods are particularly useful for high-resolution lithography and for the manufacture of complex integrated circuits. Welding can also be performed with an electron beam.

Electrical-Discharge Machining

Electrical-discharge machining (EDM) involves the direction of high-frequency electrical spark discharges from a graphite or soft metal tool, which serves as an electrode, to disintegrate electrically conductive materials such as hardened steel or carbide. The electrode and workpiece are immersed in a dielectric liquid, and a feed mechanism maintains a spark gap of from 0.0005 to 0.020 inch (0.013 to 0.5 millimeter) between the electrode and the workpiece. As spark discharges melt or vaporize small particles of the workpiece, the particles are flushed away, and the electrode advances. The process is highly accurate and is advantageously used for machining dies, molds, holes, slots, and cavities of almost any desired shape.

Electrochemical Machining

Electrochemical machining (ECM) resembles electroplating in reverse. In this process metal is dissolved from a workpiece with direct current at a controlled rate in an electrolytic cell. The workpiece serves as the anode and is separated by a gap of 0.001 to 0.030 inch (0.025 to 0.75 millimeter) from the tool, which serves as the cathode. The electrolyte, usually an aqueous salt solution, is pumped under pressure through the inter-electrode gap, thus flushing away metal dissolved from the workpiece. As one electrode moves toward the other to maintain a constant gap, the anode workpiece is machined into a complementary shape. The advantages of ECM are lack of tool wear and the fact that a softer cathode tool can be used to machine a harder workpiece. Applications of ECM can be found in the aircraft engine and automobile industries, where the process is used for deburring, drilling small holes, and machining extremely hard turbine blades. Variants of ECM include electrolytic grinding, which includes about 90 percent ECM with 10 percent mechanical action; electrochemical arc machining (ECAM), in which controlled arcs in an aqueous electrolyte remove material at a fast rate; and capillary drilling, in which acid electrolytes are used to machine very fine holes.

Ion Beam Machining

In ion beam machining (IBM) a stream of charged atoms (ions) of an inert gas, such as argon, is accelerated in a vacuum by high energies and directed toward a solid workpiece.

The beam removes atoms from the workpiece by transferring energy and momentum to atoms on the surface of the object. When an atom strikes a cluster of atoms on the workpiece, it dislodges between 0.1 and 10 atoms from the workpiece material. IBM permits the accurate machining of virtually any material and is used in the semiconductor industry and in the manufacture of aspheric lenses. The technique is also used for texturing surfaces to enhance bonding, for producing atomically clean surfaces on devices such as laser mirrors, and for modifying the thickness of thin films and membranes.

Laser Machining

Laser machining (LM) is a method of cutting metal or refractory materials by melting and vaporizing the material with an intense beam of light from a laser. Laser machining is costly in energy since material must be melted and vaporized to be removed. LM is particularly advantageous when it is necessary to cut small holes (e.g., 0.005 to 0.05 inch) in materials that are difficult to machine by traditional methods. Advantageous applications include laser drilling and cutting of diamonds, ceramics, and substrates for integrated circuits, and many others. Laser machining may be combined with mechanical machining in a SCOFAST machine. Some useful methods and apparatus for combined mechanical and laser machining are discussed in U.S. Pat. No. 10,220,469B2, which is incorporated here by reference.

Laser-Assisted-Machining

Laser-assisted machining is a thermally assisted machining process in which a specific area of a workpiece is heated by a laser beam immediately before the cutting process to reduce flow stress and improve chip formation. This method is particularly advantageous when machining difficult-to-cut materials, such as titanium alloys. The power of the laser and its movement are critical parameters.

Oxy-Fuel Cutting

Oxy-fuel cutting is a cutting method using an oxygen/fuel gas flame to preheat a metal to its ignition temperature. A high-powered oxygen jet is then directed at the metal, creating a chemical reaction between the oxygen and the metal to form iron oxide, also known as slag. The high-powered oxygen jet removes the slag from the kerf.

Plasma Arc Machining

Plasma arc machining (PAM) is a method of cutting metal with a plasma-arc or tungsten inert-gas-arc, torch. The torch produces a high-velocity jet of high-temperature ionized gas (plasma) that cuts by melting and displacing material from the workpiece. Temperatures obtainable in the plasma zone range from 20,000° to 50,000° F. (11,000° to 28,000° C.). The process may be used for cutting most metals, including those that cannot be cut efficiently with an oxyacetylene torch.

Ultrasonic Machining

In ultrasonic machining (USM), material is removed from a workpiece with particles of abrasive that vibrate at high frequency in a water slurry circulating through a narrow gap between a vibrating tool and the workpiece. The tool, shaped like the cavity to be produced, oscillates at an amplitude of about 0.0005 to 0.0025 inch (0.013 to 0.062 millimeter) at 19,000 to 40,000 hertz (cycles per second). The tool vibrates the abrasive grains against the surface of the workpiece, thus removing material. Ultrasonic machining is used primarily for cutting hard, brittle materials that may be conductors of electricity or insulators. Other common applications of USM include cutting semiconductor materials (such as germanium), engraving, drilling fine holes in glass, and machining ceramics and precious stones. A variant is ultrasonic twist drilling, in which an ultrasonic tool is rotated against a workpiece without an abrasive slurry. Holes as small as 80 micrometers or even smaller may be drilled by this type of USM.

Chemical Machining

In chemical machining (CM, CHM) metal is removed from selected areas by controlled chemical action. Masking tape can be used to protect areas not to be removed. The method is related to the process used for making metal printing and engraving plates. Two types of chemical machining processes include chemical blanking, which is used for cutting blanks of thin metal parts, and chemical milling, which is used for removing metal from selected or overall areas of metal parts.

Photochemical Machining

Photochemical machining (PCM) is an extension of CHM that uses a series of photoactivation and chemical etching techniques to produce components and devices in metals.

Water Jet Machining

In the water-jet machining process, water or another fluid is forced through tiny nozzles under very high pressures to cut through materials such as polymers, brick, and paper. Water-jet machining has several advantages over other methods: it generates no heat, the workpiece does not deform during machining, the process can be initiated anywhere on the workpiece, no premachining preparation is needed, and few burrs form during the process. An abrasive may be added to the fluid to improve the rate of material removal, especially in finishing work. Although the process is called water-jet machining, any fluid may take the place of water. Gaseous mixtures and vapors may also be used alone or with an abrasive.

Honing

Rigid or flexible honing tools may be used in place of cutting tools for many different operations such as cross-hole deburring, cylindrical honing, surface finishing, edge-blending and cleaning. By integrating flexible hones to the machining process, complex parts with cross-drilled holes and other difficult-to-access features can be deburred, honed, and surface finished all within the same SCOFAST machine.

Transformative Operations/Treating

Transformation Operations

Transformation (transformative, transforming, treatment) operations are those resulting in the alteration of physical, chemical, or other properties of a workpiece through some form of treatment. Transforming operations and treatments as here defined exclude similar additive finishing operations that are supplementary to additive operations. Such operations are classified as a subset of additive operations, since they may be used for special purposes and often yield results that are principally defined by the additive process to which they are applied.

Physical treatments are those which bring about some alteration in the state or the physical attributes of a substance without causing a change in chemical bonds or valences. Chemical treatments are those which bring about a change in the chemical properties of the substance owing to changes in the chemical bonds or valences of the substance. Physiochemical treatments are those which bring about both non-chemical and chemical alterations in the state, physical attributes, and properties of the substance.

Transformative operations include thermal treatments, physical treatments, chemical treatments, photonic treatments, radiation treatments, other types of treatment now known or that may be discovered in the future, and any combinations thereof. Treatment may be accomplished through exposure to stress, impact, acoustic energy, heat, cold, atomic or molecular compounds in any state of matter and at any temperature and pressure, vacuum, magnetic fields, electrical fields, electromagnetic fields, and/or gravitational or pseudogravitational fields, such exposure being accomplished by any means and in any combination and/or order. Transformation may also refer to treatments resulting in a surface coating that alters the effective properties of a workpiece, whether that surface coating originates from the workpiece itself or whether it incorporates an external source of material (as in operations such as sputter coating or carburizing that may be both additive and transformative).

Some examples of transformative operations include hardening, surface hardening, toughening, tempering, softening, annealing, coating, passivating, plating, anodizing, magnetizing, demagnetizing, aging, curing, marking, etching, cross-linking, cooking, carburizing, carbonizing, nitriding, fumigating, de-bubbling, degassing, fermenting, boiling, frying, roasting, sautéing, freezing, hydrating, dehydrating, and others.

Some exemplary systems and methods useful in transformative operations are presented in U.S. Pat. Nos. 3,450,606A, 3,765,994A, 4,304,978A, 4,477,292A, 4,902,580A, 5,492,263A, 5,785,777A, 5,980,723A, 6,528,123B1, 6,620,735B2, 6,797,147B2, 6,896,787B2, 6,936,349B2, 7,011,719B2, 7,128,985B2, 7,166,205B2, 7,347,924B1, 7,580,179B2, 7,820,300B2, 8,021,758B2, 8,197,892B2, 8,663,807B2, 8,945,366B2, 9,034,166B2, 9,413,861B2, 9,420,713B2, 9,506,160B2, 9,556,068B2, 9,617,639B2, 9,683,305B2, 9,970,080B2, 9,985,345B2, 10,099,506B2, 10,174,436B2, 10,330,832B2, 10,392,718B2, 10,626,517B2, 10,760,176B2, 10,782,741B2, US20070026205A1, US20080274375A1, US20110083895A1, US20110089039A1, US20160289858A1, US20170253986A1, US20190062885A1, US20210022261A1, and US20200198291A1, each of which is incorporated by reference.

Additional exemplary systems and methods useful in transformative operations are presented in Non-United States Patent documents KR100914858B1, and WO2002038334A1, each of which is incorporated here by reference.

Thermal Treatments

Thermal treatments involve the use of heating or chilling to achieve a desired result such as hardening or softening of a material, altering its susceptibility, altering the force needed to cause plastic deformation, or for some other purpose. Common heat treatment techniques known to those having ordinary skill in the art include annealing, case hardening, precipitation strengthening, tempering, borodizing, carburizing, carbo-nitriding (cyaniding), oxide enhancement, normalizing, quenching, heat solution treatment, and diffusion treatments using elements such as aluminum, copper, chromium and tin.

Thermal energy may be added to or removed from the workpiece as a whole, or to portions of the workpiece, or to stock or partly formed parts being added to the workpiece, or to workholders or tools, or to the ambient environment surrounding the workpiece, or to liquids or gasses flooding the workpiece. Thermal energy may be added to some elements within a SCOFAST machine while being removed from others.

Induction Heating

In induction heating, one or more induction coils are used to generate an alternating magnetic field that impinges upon a workpiece. This magnetic field produces eddy currents in a metal workpiece, which heat the workpiece up to the desired temperature. Induction heating can be very precisely controlled by adjusting the power, frequency, and geometry of the induction heater. The short heating times and spatially limited controlled heating of induction heating make it well suited to operations performed within a SCOFAST machine. Nearly any material may be heated by induction heating; nonconductive materials are heated indirectly, for example by heating a crucible or a conductive liquid that is in contact with the material to be heated. Metals readily heated by induction include copper and copper alloys, brass, aluminum, iron, steel, stainless steel, tungsten, chrome, nickel, nickel alloys, cobalt, carbon fiber, graphite, silicon, platinum, silver, and gold. Some exemplary techniques for induction heating and related techniques are disclosed in U.S. Pat. Nos. 7,767,941B2, 7,652,231B2, 4,119,825A, 9,924,567B2, 6,555,801B1, 3,156,807A, 2,783,351A, and 2,649,529A, each of which is incorporated here by reference.

Induction heating is a particularly convenient method for heating a workpiece within a SCOFAST machine, partially because the thickness of the heated layer from the surface of the metal to some point below the surface is inversely proportional to the frequency of the applied alternating current. Higher frequencies produce thinner skins. Frequencies are considered low frequency (0-7 kHz), mid-frequency (7-40 kHz) or high frequency (40-500 kHz). Frequencies above 500 kHz are ultra-high frequency. Multiple frequencies may be used simultaneously for induction heating. Since each frequency acts upon a workpiece at a different depth, this may facilitate more uniform heating in parts having complex geometries. A consideration of constructive and destructive field interference permits delivery of spatially-focused energy through the use of overlapping fields generated by multiple precisely placed induction coils. Adjusting the relative amplitude, frequency, phase, and duty cycle of the various coils results in alterations in the speed, depth, and extent of heating.

Annealing

Annealing is a process by which a distorted cold worked lattice structure undergoes thermally mediated relaxation to a structure that is less strained, or is strain free. When metallic materials undergo cold working, the hardness, tensile strength, and electrical resistance increase, while ductility decreases. There is also a large increase in the number of dislocations, and certain planes in the crystal structure are severely distorted. Most of the energy used to cold work the metal is dissipated in heat, but some of that energy is stored in the crystal structure as internal energy associated with lattice defects created by the deformation.

During annealing, a material is heated to an annealing temperature and is held there for a period of time, then gradually cooled to room temperature. The annealing process may be divided into three stages, referred to as recovery, recrystallization, and grain growth.

The recovery stage is primarily a low temperature process, and the property changes produced do not cause appreciable change in microstructure or the properties, such as tensile strength, yield strength, hardness and ductility. The principal effect of recovery is the relief of internal stresses due to cold working. When a load which causes elastic deformation followed by plastic deformation is released, not all the elastic deformation disappears. This is due to the spatial orientation of crystal lattices, some elements of which are blocked from moving back to their original positions. As the temperature is gradually increased, most of these elastically displaced elements are freed up to return to their original positions, relieving most of the internal stresses. Electrical conductivity is increased appreciably during recovery. Since the mechanical properties of the metal are essentially unchanged, the main purpose of heating in the recovery range is stress relieving cold worked alloys to prevent stress corrosion cracking or to minimize the distortion produced by residual stresses. Commercially, this low temperature treatment in the recovery range is known as stress relief annealing or process annealing.

Recrystallization is a stage in which the recrystallization temperature of the material is reached and minute new crystals appear in the microstructure. These new crystals have the same composition and lattice structure as the original undeformed grains and are uniform in dimensions. The new crystals generally appear at the most drastically deformed portions of the grain (typically at grain boundaries and slip planes). The cluster of atoms from which the new grains are formed is called a nucleus. Recrystallization takes place by a combination of nucleation of strain free grains and the growth of these nuclei to absorb the entire cold worked material. During recrystallization there is a significant drop in tensile strength and hardness, and a large increase in the ductility of the material.

The term recrystallization temperature does not refer to a definite temperature below which recrystallization will not occur, but rather refers to the approximate temperature at which a highly cold worked material completely recrystallizes in one hour. In a material that has a mixture of different crystal grain formations, multiple recrystallization temperatures exist.

In grain growth, the last stage of annealing in metals, grain boundaries slowly grow to the original grain size, with a further decrease in the tensile strength and hardness of the material.

Annealing is used to alter the properties of metals with regard to hardness, toughness and internal stresses, in order to attain optimal material properties. Any method of heating may be used for annealing a workpiece, however induction heating is of particular usefulness when annealing is performed as a SCOFAST operation because heat is generated directly in the workpiece, allowing very precise control, homogeneous heat distribution, and an even depth of penetration in the workpiece. In contrast to thermal hardening, the temperature of the workpiece being annealed is reduced slowly. Soft annealing is of particular value as a pre-treatment to reduce metal hardness and increase toughness and ductility prior to forming operations. Stress-relief annealing uses lower temperatures to minimize or eliminate stresses created during machining or forming.

Densification

Densification is a physical treatment that results in an increase in the density of a material. Densification often is applied to near-net-shape workpieces that have been made through extrusion, molding, casting, or 3D printing using substrates that contain a secondary gaseous or liquid material or solid binder material along with the workpiece material of interest. Removal of the secondary material leaves a porous workpiece in which the pores may be large or may be as small as a single molecule, depending on the secondary material that was removed. Application of heat and/or force leads to pore collapse with a resulting increase in the density of the workpiece.

Hardening

Hardening is a physical treatment often accomplished through heat treatment, and often applied to metals in order to improve mechanical properties and increase hardness, resulting in a tougher and more durable component. When accomplished through heat treatment, the material is heated above its critical transformation temperature and then cooled. The process alters the microstructure of the metal, and process parameters may be modified to select for microstructures that add strength and toughness. One method for surface hardening iron or steel is through focused heating (e.g., by energy transfer from a laser beam) to induce diffusion of carbon from cemented alleles of ledeburite or perlite into soft interlamellar ferrite regions.

Induction Hardening

Induction hardening is a hardening process in which heat is generated directly in the workpiece. A principal advantage of this type of heat treatment is that the material quickly reaches the desired temperature. Another advantage is that there is no requirement for open flames or sustained heated environments. After heating, the component then goes through a quenching process using a liquid or gas to remove heat, leading to the development of metallurgic structures having properties that may be advantageous.

After quenching, a metal part may undergo tempering, a low-temperature heat treatment process that reduces brittleness and hardness but increases toughness. The combination of hardening and tempering is adjusted to achieve a desired hardness/toughness ratio.

When induction hardening is performed, the hardening depth in the workpiece may be controlled by adjusting the electrical power output of the induction machine, the frequency of the inductor current, the geometry of the inductor coil, the coupling distance of the inductor coil elements, the flow rate and material properties of coolant and lubricating fluid, and other attributes of the equipment and the operation. Surface hardening (case hardening) is of special interest because it can increase wear resistance without reducing the ductility of the bulk of the material or rendering it brittle.

Hardening Spring Steel

After hot forming, spring steel is sub-critically annealed at about 640 to about 700° C. to have a hardness of 225 BHN. Normalizing is done at about 850 to about 880° C. Oil quenching is done at about 830 to about 860° C., and tempering is performed at about 400 to about 550° C. depending on mechanical properties required.

Cryogenic Treatment

Cryogenic treatment can exert significant transformative effects on certain materials. For example, in steel cryogenic treatment converts certain retained austenite structures in the metal into martensite, which initially is very hard and brittle but becomes tempered to provide better toughness properties as the metal returns to room temperature. Cryogenic treatment of high alloy steels, such as tool steels, also results in the formation of very small carbide particles dispersed within the martensite structure between the larger carbide particles present in the steel. These smaller particles act to strengthen steel in a manner analogous to concrete made from large aggregate versus concrete made from very small aggregate. The smaller aggregate makes a much stronger concrete mix, and the small, hard carbide particles within the martensite matrix help support the matrix and resist penetration by foreign particles, reducing abrasive wear.

Carbide inserts and form tools may also show an increase in wear resistance from cryogenic treatment. This may result from slight shrinkage of the carbide inserts during the cool-down phase of the treatment, creating some plastic flow within the micro-voids in between the carbide and the binder. When the carbide returns to ambient temperature, it leaves compressive stresses on the surface of the voids. These compressive stresses, in turn, tend to counteract localized weakening caused by the voids, thereby resulting in an overall improvement in wear resistance.

Force Treatment

Peening (Hammering)

Peening is a cold work process in which kinetic energy transfer is used to reduce metal stress, improving fatigue and stress fracture resistance. Traditional peening is performed using hammers to strike the surface of a part repeatedly.

Shot Peening

Shot peening, also known as shot blasting or bead blasting, is a form of peening that is performed using beads known as shot. In shot peening, small spherical shot bombards the surface of the part to be finished. The shot acts like a peen hammer, dimpling the surface and causing compression stresses under the dimple. As the media continues to strike the part, it forms multiple overlapping dimples throughout the metal surface being treated. The surface compression stress strengthens the metal, ensuring that the finished part will resist fatigue failures, corrosion fatigue and cracking, and galling and erosion from cavitation. Shot peening may be performed using beads of ceramic, glass, steel, or any other material having the desired physical properties. Ultrasonic peening may be performed using a liquid medium to transmit impulses, causing the transfer of kinetic energy into a target material.

Surface Treatments

Examples of surface treatments that may advantageously be performed within a SCOFAST machine include electroplating, electroless plating, oxide coating, anodizing, passivation, electropolishing, annealing, carburizing, nitriding, precipitation hardening, thermal deburring, brazing, wet blasting, vapor honing, honing, coating, powder-coating, painting, dyeing, toughness treatments, treatment with atmospheric plasma, degreasing compounds, grit blasting, laser ablation, surface coating, polishing, waxing, de-waxing, and others.

Surface Alloying by Laser or Electron Beam

In laser or electron-beam surface alloying, a layer surface material is melted and a second substance is allowed to mix with the surface material before cooling, leading to the formation of a different alloy on the surface of the workpiece.

Passivation

Passivation means to alter the chemical structure of a metal at or just below the surface in such a way that it is rendered more chemically stable and has less tendency to react with other elements in an undesirable way. Benefits of passivation may include increased hardness, reduced corrosion susceptibility, and improved cosmetic appearance.

Conversion Coating

A conversion coating is one in which the surface chemistry of the existing material of the part is altered or “converted,” as distinguished from a coating comprising a different material that is added to the surface of the part.

Anodizing

Anodizing is a conversion coating technique for passivating the surface of an aluminum, titanium, or magnesium part. A top layer of metal, typically approximately 5 microns thick, is cleaned and stripped (e.g., using some combination of physical treatments, solvents, detergents, strong alkali solutions, and strong acid solutions). The part is given a positive electrical charge (the “anode” in anodizing) and exposed to another liquid referred to as the electrolyte. The part attracts negatively charged ions in the electrolyte, which bond with the metal surface, creating an oxide layer that is more resistant to corrosion, wear, and surface scratches. Colored dyes may be incorporated into the oxide by adding them to the electrolyte. Selected areas may be anodized through a process known as pattern anodizing or brush anodizing.

Bluing

Bluing is a passivation conversion coating that may be used for ferrous metals. The part is cleaned as for anodizing and then exposed to a series of chemical solutions resulting in the deposition of magnetite (Fe3O4), which in thin coatings appears as the familiar blue surface that is often found on gun barrels.

Black Oxide Finish

A black oxide finish is a conversion coating of magnetite (Fe3O4) that is thicker and darker in color than the finish used for bluing.

Cold Black Oxide

A cold black oxide finish, sometimes referred to as “cold bluing,” is a finish that looks similar to a magnetite conversion coating, but actually is not a conversion coating but rather a deposited layer of copper selenium compound.

Black Oxide for Copper

Black oxide for copper is a conversion coating of cupric oxide. Other “black oxide” coatings are available for many other metals, some as conversion coatings and some as deposited layers of another substance.

Parkerizing

Parkerizing is a matte grey surface conversion coating that is more robust than bluing.

Galvanizing

Galvanizing refers to coating a part with a sacrificial anodic material, most commonly zinc. Galvanizing may be accomplished via dip, spray, electrodeposition, or other methods. Hot dip galvanizing refers to dipping steel or iron parts into molten zinc. The zinc coating serves as a sacrificial anode as well as a physical barrier to provide corrosion protection on ferrous metals.

Yellow Zinc Plating

Yellow Zinc Plating is a plated layer of zinc with an electroplated layer of chrome over it.

Chrome Plating

Chrome plating is a common plating process that can be applied to metals and metallized non-metal materials. Chrome plating commonly uses nickel and chromium. Hard chroming is a related process that deposits a thicker layer of chrome and results in Rockwell hardness between 68 C and 72 C.

Nickel Plating

Nickel plating can be used for a decorative finish, for corrosion protection, and to increase surface hardness and abrasion resistance. Nickel is also used as a base coat for a later application of chromium. The use of nickel as a plating material is not considered as hazardous as that of chromium.

Other Coatings

Coatings are used to increase wear resistance, to increase oxidation resistance, to reduce friction, to increase resistance to metal fatigue, to increase resistance to thermal shock, to improve chemical resistance, to alter conductivity, and for many other purposes. Coatings may be uniform or composite, and may be geometrically characterized as monolayer, multilayer, nanolayer, nanocomposite, or gradient. A multilayer structure is composed of multiple layered monolayer structures, each layer potentially having different properties. Nanolayer structures are multilayer structures where each layer is at the atomic level of thickness. Nanocomposite coatings typically combine a tough binder phase with a hard bound component (e.g., cobalt with carbide). Gradient coatings are typically elastic at depth, becoming harder and more wear resistant closer to the surface.

Coatings may be applied in liquid, vapor, gas, powder, or solid form, as dissolved matter in solution, as particulate matter in suspension, and in other forms.

Coatings may be applied by immersion (dipping), brushing, rolling, spraying, spin coating, flow coating, electrodeposition, electrostatic deposition, aerosol coating, atomized spray coating, water-bath film coating, and by other methods.

Coating thickness may be inspected destructively, predictively, or through non-destructive technologies such as quantitative assessment of magnetic force, magnetic induction, eddy current, refractive index, extinction coefficient, transmittance, capacitance, and other attributes. Other quantitative technologies include auger electron spectroscopy, x-ray fluorescence, x-ray spectroscopy, ultrasonic pulse-echo, beta backscatter, laser triangulation, and others.

Vapor Deposition

Coatings may be applied by the chemical vapor deposition (CVD) method: the substrate is heated and exposed to a gas stream. The gases react or decompose on the hot substrate, where they form a coating layer having optimum layer adhesion and a consistent layer distribution. Ex: Titanium tetrachloride+hydrogen+nitrogen surrounding a hot surface=>titanium nitride coating+HCL. Temperatures used are typically on the order of 1000 C.

Alternatively, a physical vapor deposition (PVD) method places the part in a vacuum chamber and introduces material vaporized by some means such as by heating, arc discharge, cathodic sputter, or some other means. The vaporized material spreads through the vacuum and adheres wherever it comes into contact with the substrate. Deposition is typically line-of-sight from the source to the target. For example, if a desired coating is sprayed uniformly onto the interior surfaces of an open hollow ceramic vessel and then a part is suspended within the vessel in a SCOFAST machine, after which the ceramic vessel is sealed against an ancillary collet plate and placed under vacuum with the part inside, and an induction coil is activated to heat the entire contents of the ceramic vessel to a temperature sufficient for vacuum vaporization of the coating, then the coating will be vaporized in a distribution 360 degrees around the part and symmetric PVD coating will occur. Nearly any metal may be used for PVD coating.

Chemical Surface Treatment

Chemical surface treatment is the exposure of a workpiece surface to a substance that causes alteration of workpiece material properties at or near the surface of the workpiece. One example of such a treatment is the heating of a material in an atmosphere comprising titanium tetrachloride, hydrogen, and nitrogen, leading to the chemical formation of titanium nitride (which is deposited on the surface of the heated material) and HCL, and also leading to physical changes in the micro-structure of the bulk material arising from its having been heated and subsequently cooled, as well as changes in the material properties due to the migration of hydrogen into the material.

Energy Treatment

Transformative operations may involve the transfer of energy in any form, from any energy source. Some examples of energy sources include radiation sources, photonic sources, kinetic sources, electrical sources, electrostatic forces, magnetic sources, electromagnetic sources, gravitic sources, nuclear forces, and others.

Physical, Chemical, and Physiochemical Treatments

Chemical changes are those in which chemical bonds are altered, producing new substances with properties different from those of the original substances. A physical change is any change in the state of matter that does not result in a chemical change in the substances themselves. Physiochemical change encompasses both physical and chemical changes. Any physical, chemical, or physiochemical change may be brought about as an operation in a SCOFAST machine. Within a SCOFAST machine, treatments may be endothermic, exothermic, or euthermic, or may proceed through states comprising any combination of the above.

Treatments may alter the three dimensional structure of atoms and molecules and of groups of atoms and molecules within the bulk material and on its surface, as, for example, in a crystalline lattice (pure or having impurities distributed within it in some manner) or in a glass, or an amorphous solid.

Vibration can induce vibratory modes and relative stress zones within a workpiece, where the physical properties of the material are different in different zones. Within a SCOFAST machine, treatments may comprise vibration at any frequency.

Manipulation of energy content to alter the properties of a material can alter the efficiency and effectiveness of operations that can be performed within any given machine. For example, heating or cooling a tool or a material before cutting may improve tool life, alter cutting characteristics, or render the material susceptible to cutting tools that otherwise would not be able to machine that metal effectively. The use of energy manipulation can also make possible new operations that otherwise would have been impossible. For example, heating a material may make it possible to forge, stamp, or bend that material in a machine that otherwise would not have been capable of such operations, or in a manner that would not otherwise have been possible, or with different results than would otherwise have been achieved. Energy manipulation may also cause or facilitate other treatments, such as chemical treatments.

With respect to metals, the manufacture of raw stock materials and the customary heavy coldworking processing steps used in their production introduce molecular defects of particular kinds, having characteristic distributions that together result in particular physical properties including hardness, surface hardness, elasticity, deformation, and failure. Further metal working steps necessarily introduce additional defects, often with nonuniform spatial distribution through the workpiece. The final physical properties of a finished product may be strongly affected by these fundamental and accumulated defects. Such defects may be modified, removed, or mitigated through specific treatment processes. For example, in titanium-niobium alloys, beta to omega transformation can occur thermally via rapid cooling from the single bcc beta phase field or by subsequent isothermal aging, producing ellipsoidal or cuboidal omega particles that are homogeneously distributed throughout the beta matrix. Beta to omega transition may also be induced mechanically via high strain-rate compressive loading (shock loading), producing non-uniformly distributed omega plates. In one embodiment, treatments such as those here described (for example, those by which beta to omega transformation may be induced) are performed as operations within a SCOFAST machine.

Other SCOFAST Operations

Locating Imaging Measuring Indexing Testing (LIMIT)

Locating, imaging, measuring, indexing, and testing (LIMIT) operations include those used to quantify and manage machine state as well as operations used in management of operations performed upon a workpiece. Automated measuring, indexing and locating may be carried out by the use of calibrated measuring probes and/or other devices making contact with the object(s) to be measured, and/or by non-contact methods using imaging, interferometry, time-of flight calculations, geometric analysis and other techniques that will be known to those having ordinary skill in the art, or that may be developed or discovered in the future. Other examples of LIMIT techniques and operations include visual inspection, machine vision applications, pattern recognition, infrared thermometry, trace element detection, infrared imaging, ratio pyrometry, ultrasound imaging, ultrasound measuring, laser imaging, laser measuring, radiographic inspection techniques, leak testing, tensile testing, coordinate measuring, spectrometric analysis, and many other techniques that are now known or may be developed in the future. In many embodiments, LIMIT operations are advantageously performed within a SCOFAST machine.

By detecting whether a part is in-spec or out of spec after machining and before removing the part from the machine, many advantageous outcomes may be achieved. Tool wear or movement can be corrected immediately (and indeed continuously), reducing wastage. A part failing to meet specifications might be able to be re-machined to resolve the issue, or it might be able to be machined to a different specification or even into a completely different part. For example, a long bolt that is out of specification at the end of the shaft could be converted to a shorter bolt in situ. Jobs could be set up to produce a larger part requiring extremely close tolerances resulting in a relatively high rejection rate in combination with a smaller part having more relaxed tolerances. Every larger part that fails to pass could be re-machined to the smaller one without incurring additional handling costs.

LIMIT operations that result in classifying parts before removal from the machine allows good parts and bad to be segregated from the start, reducing inspection and sorting costs. Parts that can be delivered at two different tolerances may be inspected in situ, stamped or laser-marked as to which tolerance they meet, and segregated as they leave the machine, all in a single operation.

Machine vision often has difficulty with measurement of tolerances when machined surfaces are bright and reflective. For this reason, separate measuring stations using contact probes (sometimes dozens or even hundreds of probes) are often used. Even when robotic handling is used to convey, sort, and align the parts for measurement the added cost and complexity can be so high that setup costs may be justified only in very large production runs of a uniform part.

Within a SCOFAST machine a machined part may be treated to change the color and/or reflectivity of the surface before image inspection, with the surface treatment being subsequently removed by means of treatments herein described or by any other method, the part remaining the whole time in a precisely-known location with precisely known alignment. Furthermore, each feature of the part may be imaged and measured as soon as it is created, without the presence of later elements to confuse the image processor.

Imaging will inherently be more precise while the part remains in situ because the location and alignment of the part is already known to a high degree of accuracy. Measurements can be made with reference to fixed positions on the machine, rather than relying upon the detection of fiducial features and measurements of the part relative to itself

Some exemplary systems and methods useful for locating, imaging, measuring, indexing, and testing are presented in U.S. Pat. Nos. 4,819,195A, 4,974,165A, 5,390,128A, 7,321,841B2, 7,587,082B1, 7,623,036B2, 8,411,929B2, 8,731,719B2, 9,188,973B2, 9,420,205B2, 9,863,751B2, 9,869,623B2, 9,958,854B2, 10,328,411B2, 10,401,144B2, and US20200025561A1, each of which is incorporated by reference.

Some exemplary techniques useful for assessing, quantifying, and mitigating machine state are presented in U.S. Pat. Nos. 7,525,443B2, 8,393,836B2, 8,924,003B2, 9,176,003B2, 9,223,304B2, 10,514,676B2, 10,525,550B2, 10,838,392B2, and US20170355005A1, each of which is incorporated here by reference.

Motion

Motion is a change in linear or angular position with respect to some reference frame. A motor is a device that applies force or otherwise causes a transfer of energy resulting in motion. In some scenarios a motor may also be known as an effector or actuator. Motion within a SCOFAST machine may be initiated, increased, maintained, decreased, and/or stopped by the action of one or more motors of any kind (for example, linear, rotary, reciprocating, or of any other geometry) whether powered by electricity, magnetism, electromagnetism, pneumatic pressure and/or flow, hydraulic pressure and/or flow, internal combustion, external combustion, thermal transfer, chemical reaction, spring action, biomechanical or other biological action, electrostatic forces, atomic forces, nuclear strong or weak forces, gravitational forces, or any other means now known or that may be discovered in the future. Some exemplary systems and methods useful with respect to initiating, maintaining, detecting, and controlling motion in a SCOFAST machine are presented in U.S. Pat. Nos. 2,809,736A, 3,563,106A, 3,888,168A, 4,270,404A, 4,432,333A, 5,092,539A, 5,093,052A, 5,270,625A, 5,317,221A, 5,370,011A, 5,472,065A, 5,613,403A, 5,836,205A, 6,223,648B1, 6,553,855B2, 6,616,031B2, 6,922,991B2, 6,941,783B2, 4,319,168A, 7,077,621B2, 7,100,870B2, 7,401,548B2, 7,560,888B2, 7,578,212B2, 7,726,124B2, 8,266,976B2, 8,322,242B2, 8,522,636B2, 8,870,967B2, 10,236,762B2, and 10,024,405B2, each of which is incorporated here by reference.

Motors

In a SCOFAST machine, a motor is any type of device providing a motive force. The motors within a SCOFAST machine may be of any size and of any type.

Machine Control

Within a SCOFAST machine, any workholder or tool may be positioned and moved arbitrarily within the work space. Such mechanical movements are preferably achieved through drive control signals transmitted from a motion controller to drive motors so arranged as to provide a desired number of degrees of freedom in motion.

Control signals may originate within a digital computer/controller CAD/CAM system. Alternatively control signals may originate within an analog system for specifying positions and toolpaths. Alternatively control signals may be manually generated by a user of a SCOFAST machine. Alternatively control signals may originate within another machine. In some embodiments control signals may originate within a computer hosting an artificial intelligence program. In one embodiment of such a system the design of an article to be formed is initially created on a computer, with commercially available software being utilized to convert the three-dimensional shape into data that is transmitted as drive signals through a computer-aided machine (CAM) controller through a motion controller or drive controller to the aforesaid drive motors. The creation and/or execution of such control signals is machine control, and a computer or other device that performs machine control functions is a machine controller.

Machine control may be manual or automated, and a machine may be controlled through mechanisms that are analog, digital, or hybrid. Automated machine control most often is numeric control (NC) or computer numeric control (CNC), in which a series of coded messages control the position and motion of machine elements.

Numerical control code for the operation of a mechanical system may be manually created by a human or it may be generated by other means, such as automatic generation by tracking the physical positioning of machine elements, automatic generation by a computer executing a software program, automatic generation from a CAD file, automatic generation by reverse engineering from images or models of a finished part, automatic generation by an AI system or a machine learning system, or complete or partial automated generation or optimization by any other method, or by any combination of methods. Any reference herein to numeric control, CNC control, G-Code, machine programming, machine control, or any programmed or automated movement of any workpiece, tool, or machine component should be understood as exemplary of machine control by any method.

The specific sequence of steps that produce a desired manufacturing result may be determined and optimized by a human or by a deterministic software process following established rules written by an expert. However, such a sequence may also be optimized or generated de novo through artificial intelligence and machine learning techniques or by any other statistical or mathematical process, however expressed. Examples include fuzzy logic, single and multiple regression techniques, machine classifiers, supervised learning, unsupervised learning, reinforcement learning, linear regression, logistic regression, decision tree, svm, naive bayes, knn, k-means, random forest, dimensionality reduction algorithms, gradient boosting algorithms, gbm, xgboost, lightgbm, catboost, regression algorithms, instance-based algorithms, regularization algorithms, decision tree algorithms, Bayesian algorithms, clustering algorithms, association rule learning algorithms, artificial neural network algorithms, deep learning algorithms, dimensionality reduction algorithms, ensemble algorithms, and other machine learning algorithms such as will be known to those having ordinary skill in the arts together with others that may be discovered or invented in the future.

A machine controller may be configured to operate a machine based on data stored in its own control unit, data that is self-generated, or data received from other controllers that are configured to perform engineering design and product design, drafting, computer-aided design (CAD) and computer-aided manufacturing (CAM) functions.

Some exemplary systems and methods useful for machine control are presented in U.S. Pat. Nos. 4,884,373A, 4,963,805A, 5,363,308A, 6,400,998B1, 6,493,607B1, 6,606,528B1, 7,392,109B2, 7,847,506B2, 7,983,786B2, 8,011,864B2, 8,024,068B2, 8,244,386B2, 9,011,052B2, 9,421,657B2, 9,459,616B2, 9,465,380B2, 9,869,990B1, 9,880,542B1, 9,939,800B2, 10,007,254B2, 10,228,681B2, 10,289,096B2, 10,324,445B2, 10,401,823B2, 10,558,193B2, 10,684,605B2, 10,732,611B2, 10,928,802B2, US20090228138A1, and US20210018887A1, each of which is incorporated here by reference.

Adaptive control is the automatic monitoring and adjustment of machining conditions in response to variations in operation performance. One example of adaptive control is the monitoring of torque to a machine tool's spindle and servomotors. The control unit of the machine tool is programmed with data defining the minimum and maximum values of torque allowed for the machining operation. If, for example, a blunt (dull) tool causes the maximum torque to be exceeded, a signal is sent to the control unit, which corrects the situation by reducing the feed rate, altering the spindle speed, changing the tool, stopping the operation, or by other means.

G-Code

G-code (also known as RS-274) is the most widely used computer numerical control (CNC) programming language. It is used mainly in computer-aided manufacturing to control automated machine tools, and has many variants. G-code instructions are provided to a machine controller (industrial computer) that tells the motors or actuators where to move, how fast to move, and what path to follow. One common scenario is that in which, within a machining center such as a lathe or mill, a workpiece is secured in a fixed or rotating holder such as a collet or vise, while a series of static or rotating cutting tools are moved according to G-code instructions through a series of toolpaths, the tools cutting away material from the workpiece. In another common scenario G-code instructions further control workpiece positioning: a workpiece is additionally precisely positioned (according to G-code instructions) in any of up to nine canonical axes around three canonical dimensions relative to a toolpath. Additional axes may be defined as desired, and either workpiece or tools can move relative to each other during the machining process. The same concept also extends to noncutting tools such as forming or burnishing tools, photoplotting, additive methods such as 3D printing, and measuring instruments. A variety of machine programming languages and control codes other than G-code may be used for the same purposes. Mechanical systems using elements such as cams and sensing stops may equally be used to achieve the same machine control.

Thermal Compensation

Within a SCOFAST machine it may be advantageous to compensate for thermal expansion, both for controlling radial runout and for controlling spindle growth in the axial direction. Spindle growth may be estimated algorithmically using temperature and time, or it may be measured directly through a gap sensing method that can adjust position in real-time in response to any detected changes. Some exemplary techniques for correcting thermal displacement are presented in U.S. Pat. Nos. 6,651,019B2, 7,245,983B2, 8,255,075B2, and 10,185,304B2, each of which is incorporated here by reference.

Data

Data collection and aggregation may also be advantageous within a SCOFAST machine. Sensor data may arise directly from workpieces, workholders, tools, toolholders, actuators, spindles, switches, torque sources, and other working elements of the machine. Sensor data additionally may be gathered by observation using dedicated sensing, imaging, detecting, and measuring devices that may form part of a SCOFAST machine or may be external to the machine. Data may be gathered from any type of sensor, whether such a sensor is now known or whether it is developed or discovered in the future.

Data may be aggregated per process, per machine component, per machine, across machines, and on the basis of any combination of criteria applied to any combination of data elements. Data may be stored and utilized within a computer forming a part of a SCOFAST machine, or it may be communicated to an external computer system that interfaces with a SCOFAST machine. Data is advantageously used for closed-loop “smart” processes that can make on-the-fly adjustments to a manufacturing cycle, and also for real-time analysis and retrospective analysis. For example, sensors capturing tool vibration and torque data may be used to adjust drilling parameters as a tool drills through multiple layers of different materials, such as the stacked layers of aluminum and carbon fiber reinforced plastics (CFRP) that are common in the aerospace industry. In another example, continuous monitoring of vibration and torque can enable the immediate detection of tool damage and the quantification of tool wear, both of obvious advantage when manufacturing high-value parts requiring close tolerances. In another example, continuous monitoring of hole diameter during boring can enable compensation to achieve micron-level tolerances. Techniques and mechanisms for tool, spindle, workpiece, and sensor data collection and connectivity are advantageous in facilitating such data collection and aggregation.

Assembly

Assembly of parts may be carried out in the same spatially coherent machine in which one or more of the separate parts are manufactured. An example of assembly in a SCOFAST machine is the manufacture of a special bolt with corresponding hex nut. The hex nut is manufactured by a combination of forming, machining, and transforming (treatment) operations, and is held by a retaining tool at the moment of cutoff. The machine then manufactures the corresponding bolt by a combination of forming, machining, and transforming operations. Before the bolt is released, the previously manufactured nut is threaded onto the bolt so that the two are secured together when the bolt is cut off and collected. Measuring and testing operations may also be performed before and/or after the bolt is cut off, with obvious implications for part quality.

Force Handling Strategies

Besides the spatial position, orientation, rotation, toolholding, and active tooling capacity of a tool, the force generation and force receiving capacity of tools must be taken into account when determining what operations may be carried out with each combination of workholders and toolholders. Higher-force operations such as bulk forging require more force handling than lower-force operations such as milling and heating. Pressing forces are generated by a force generator and are transmitted through a workpiece and/or tools to a force receiver. Force generators and force receivers also exert forces on a machine bed, frame, or other unifying element (the “frame”) in such a manner that the net force in a direction is zero when no work is being performed in that direction.

The forces required in forming operations, subtractive operations, and other operations may be generated, transferred, countered, dampened, or absorbed in and through the action of workholders, workpiece positioners, toolholders, tool positioners, frames, beds, and/or other elements of a SCOFAST machine.

Many applications for SCOFAST machines do not involve large forces. For example, food elements, biocellular structures, plastics, and other materials having a low yield strength will readily be formed and machined with little concern for the strength and rigidity of SCOFAST machine elements. However, forming operations involving metals and other materials with high yield strengths may require the application and transmission of forces significantly greater than those for which additive or machining elements usually are designed. In an embodiment in which an existing machine design comprising an additive and/or subtractive workcenter is redesigned or retrofitted to handle SCOFAST operations, it may be necessary to augment both force creating elements and force transmitting and receiving elements of the machine.

Force Creation Strategies

Conversion of Pneumatic or Hydraulic Drives

When converting pneumatic or hydraulic equipment to a SCOFAST machine, higher pressures and flow rates may be required to deliver the forces and speed desired for an operation. Increased flow rates may be obtained by adding additional pumps, replacing pumps with higher capacity pumps, increasing the size of flow channels and fittings, and increasing valve capacity. Increased pressure may be obtained by increasing cylinder size, adding additional cylinders, changing pressure control valves, increasing pump pressures, and replacing pumps with higher pressure pumps. Improved control may result from conversion of a pressurized reservoir system to a variable flow servo pump driven system, permitting high pressure and high flow when forging and lower pressures and flows at other times.

In some cases the geometry of an original system may not permit increasing cylinder size or adding additional cylinders in a straightforward manner. A variety of mechanical linkages and other strategies may be used to deliver additional force to the desired system element. For example, an additional rear seal and connecting rod may be added to an existing cylinder, allowing delivery of additional force from a cylinder that is geometrically in-line.

Traditional hydraulic presses use pressurized fluid accumulators and servo control valves to provide hydraulic force. The use of servo motor pumps in control mode with no accumulator may significantly improve the energy efficiency, stroke times, and forming capabilities of a hydraulic press. Mechanical servo drives may also be used. Advantages of mechanical servo drives include accuracy, repeatability, variability of programmed stroke speed and length, and lower operating costs.

The tonnage of a hydraulic cylinder is the static force exerted when the forces are balanced and the cylinder is therefore at standstill exerting its maximum pressure. The force is equal to the cylinder hydraulic pressure (force per unit area) multiplied by the cylinder cross sectional area.

Conversion of Screw Drives

The rated capacity of existing screw-type drives may often be increased by altering the materials used, improving the drive frame mounts, changing the ball size and preload, or converting from a ball drive to a helical block drive. Larger capacity motors may be used, and motors may be optimized with respect to torque ratings. Additional drives may be added in series and in parallel.

Force Receiving Strategies

To increase the amount of force that can be delivered to a workpiece when performing forging or other force-forming operations, a variety of strategies may be used to increase the ability of spindle bearings and other machine components to receive and transmit the necessary loads. Such strategies may be required when forging and other forming capability is retrofitted into lightweight machines that otherwise would not tolerate the loads even for low-force forming operations. These approaches may also be used in new system designs to increase the forming capacity of the machine in a cost-effective manner. Some examples of such techniques are presented here. It will be apparent to one skilled in the art that the system and method disclosed may incorporate any such techniques as may exist now as well as any that may be developed in the future.

In many scenarios it is advantageous to deliver forming forces to a workpiece held in a workholding device such as a collet or other work holder that is secured to a spindle. When a forming force is applied to the workpiece, spindle bearings may receive axial forces, radial forces, or a combination of radial and axial forces. If the spindle bearings are not designed for the forces that they receive, early bearing failure may result. Force transmitted to the spindle bearings is conveyed through any intervening mechanical elements (e.g., spindle bearing mounts) and back to the frame.

Bearing Support

In turning and machining systems a spindle normally is supported by bearings intended to provide extremely accurate positioning and support in all directions. When forging and pressing forces are directed to a workpiece that is secured to any spindle in a SCOFAST machine, those forces may be applied to the workpiece in any direction. When the forces are applied to the workpiece along an axis that is not coincident with the spindle axis, the forces may be considered with respect to the vector component that is projected along the spindle axis (“axial forces”) and the vector component projected along an axis that is transverse to the spindle axis (“radial forces”). The ability of the spindle to resist both axial and radial forces is of importance when performing forming operations in a SCOFAST machine. Many machining center designs utilize spindle bearings that have high ability to resist radial forces, but a lesser ability to support axial forces in both axial directions. Forging, pressing, and other forming operations performed within a SCOFAST machine must be calibrated to the force handling capacity of the particular spindle axes that will receive the forces. Force handling capacity can be augmented by a variety of strategies, including replacing bearings with stronger bearing designs or stronger materials, changing the bearing size or type, and adding additional bearings of the same type or of complementary types (e.g., adding thrust bearings in addition to angular-contact, radial, or roller bearings). Bearing life may be reduced under high-load conditions, thus SCOFAST machine designs may include elements that facilitate adjustment and replacement of bearings.

The load that is transmitted through the spindle and thus through spindle bearings may be reduced by adding external support similar to that provided by a steady rest or a follower in a turning center (e.g., bringing temporary non-circumferential bearings into contact with the workpiece or some machine component), by adding active counter-forces similar to that provided by counter-blow hammers in forging, and through other strategies that will be apparent to one having ordinary skill in the relevant arts.

An axial-support collet may be added at the rear of a headstock, anchored to the headstock or to a frame element and configured to clamp the barstock during axial loading operations, thus reducing the amount of force handled by the spindle bearings. A bar-stock feeder itself may be configured to periodically provide axial (e.g., forward) pressure on the barstock, preloading the spindle bearings in opposition to the forming force.

Bearings

A bearing is a machine element that constrains relative motion to only the desired motion, and reduces friction between moving parts. In machining applications, bearings affect the speed, rotation, vibration, precision, and temperature of the machine tool, which in turn alters the quality of the final product. Recognized standards for bearing precision include AFBM Std 20-1977 (ABEC) and DIN 620 (P). These standards define ordinary bearing precision levels for many common applications as ABEC1-3 and PN. An increased precision class standard for high operating accuracy, high speed, and quiet running is ABEC5/P5. Incrementally higher requirements for operating accuracy, speed, and noise are ABEC7/P4 and ABEC9/P2.

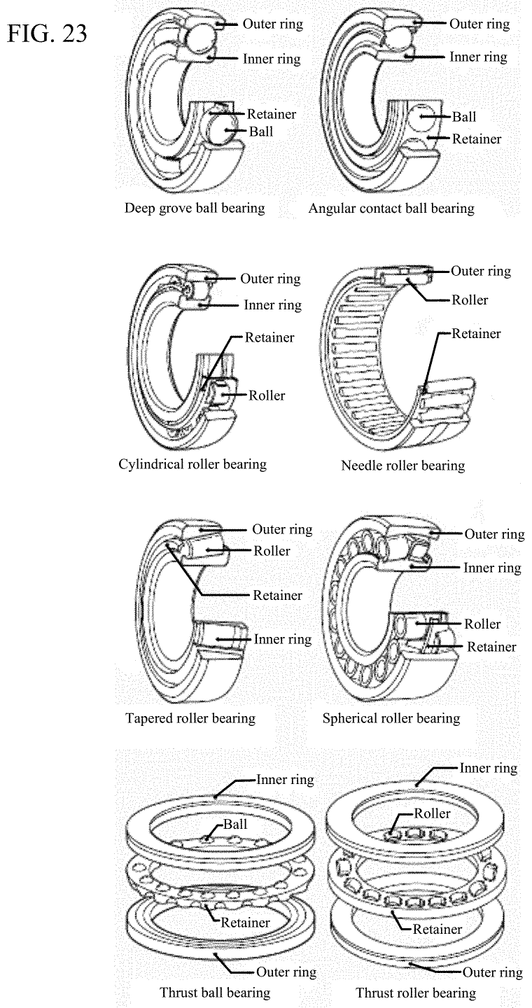

Spindle bearings are typically composed of a ring or series of rings with a ball or other rolling element that streamlines the motion of the spindle in the desired direction. Depending on the equipment and desired motion, bearings can be engineered to control and facilitate the movement of spindles while transmitting and distributing both axial and radial forces. They must be able to withstand the load pressure, temperature, and high speed of machine tool spindles, as well as the elevated loads associated with forming operations. Some common bearing types are shown in FIG. 23. Radial and axial load handling capacity may be increased by changing bearing material, size, type, number, and configuration.

Some exemplary systems and methods related to bearings are presented in U.S. Pat. Nos. 3,026,156A, 3,353,875A, 3,389,625A, 4,815,903A, and 10,335,860B2, each of which is incorporated here by reference. Additional examples are presented in non-United States Patent documents CN104526546A, CN109909746A, CN203926434U, JP2005088132A, and WO2013110337A1, each of which is incorporated here by reference.

Angular-Contact Bearings

Angular-contact ball bearings are the most common spindle bearing. They are rolling bearings and consist of one or more rows of rolling balls between concentric grooved rings. They are useful for both radial and axial loads in one direction, and their axial load carrying capacity is determined by the angle at which the load contacts the bearing. The greater the angle, the higher the axial load capacity.

Radial or Deep-Groove Bearings

Popular in industrial machinery, radial bearings are rolling bearings primarily used for load bearing on the radial axis. Like angular-contact bearings, they are composed of an inner and outer ring with rolling balls between them; however, radial bearings can also carry loads in both axial directions, making them more versatile than angular-contact bearings.

Roller Bearings

Roller bearings enhance motion through the use of rolling cylinders instead of balls. They are used to support primarily radial loads and axial loads parallel to the axis in one direction. They are useful in moderate to high-speed applications to reduce friction and enhance equipment speeds.

Thrust Bearings

Thrust bearings have rolling elements which primarily support the axial loads of rotating devices. Several styles of bearings are available in thrust configurations. Whereas radial-load bearings locate ball or roller races on the opposing inner and outer bearing rings, most thrust bearings have raceways machined into the faces of mating rings. Engineered to specifically support heavy, high precision thrust loads, thrust ball bearings offer exceptionally precise axial support parallel to the drive shaft, but most thrust bearings offer little support for radial or moment loads. The rolling element may be a ball, roller, or needle, depending on the application.

Tapered Roller Thrust Bearing—The angle created between the bearing axis and the line of contact between the raceway and the tapered roller determines the degree of thrust this bearing can accommodate. If this angle is greater than 45°, the bearing is better suited for axial loads. Once the angle between the bearing axis and roller axis reaches 90° the bearing can only sustain axial loads. These bearings require a cage, and sometimes a flange, to retain the roller assembly.

Heavy-duty tapered roller thrust bearings are also manufactured with a second row of opposing tapered rollers. By altering the shape of a raceway, this type of “screw-down” bearing resists mild or moderate angular misalignment.

Cylindrical Roller Thrust Bearing—This type of bearing fans the cylindrical rollers around the bearing axis in a perpendicular, radial fashion. These rollers must be crowned or end-relieved to reduce stress between the rollers and outer wall of the house washer raceway. They do not require much axial space to be deployed, and also come in double-row variations. While suitable for substantial axial loads, they are not recommended for a radial load.

Spherical Roller Thrust Bearing—The rolling elements are barrel-shaped and the raceways closely resemble the cone-and-cup design found in standard tapered roller bearings. This provides the bearing with self-aligning capabilities which is beneficial in applications where shaft deflection or shock loads can occur. They support heavy axial thrust in one direction (though variants exist for both directions), and can also tolerate moderate radial loads. As with tapered roller thrust bearings, the angle between the roller axis and the bearing axis determines the ratio of axial/radial loading.

Thrust Ball Bearing—Thrust ball bearings cannot transmit any radial loading. This type is susceptible to misalignment, and manufacturers frequently include a shaped groove on the housing washer to reduce this possibility. While excellent for high speed applications, their performance suffers under heavy loads.

Needle Roller Thrust Bearing—Needle roller thrust bearings are valued for their minimal height and high number of rolling elements. As such, they are occasionally implemented without a shaft or housing washer; when suitable the rolling elements are in direct contact with the rotating components. These can accommodate very high axial and shock loads, but absolutely no radial load.

Hydrodynamic Thrust Bearing—A robust lubricant or air cushion under high pressure supports the axial load, due to bearing geometry and lubricant viscosity. During rotation, the fluid is drawn to the bearing pad and creates a minimal-friction fluid buffer. The load is supported on wedges of fluid created by the pad's geometry. Seals and a special type of cage are needed to maintain lubricant pressure and dispersion, respectively. Hydrodynamic bearings are manufactured with a tilting pad, which permits uneven thrust loads across the bearing, but maintains the fluid seal despite this misalignment.

Hydrostatic Thrust Bearing—A lubricant or air cushion is pumped through the bearing assembly to maintain positive pressure. This overcomes some of the inertia and torque problems experienced by hydrodynamic bearings, but this assembly requires a continuously operating pump which should be factored into the bearing's energy efficiency. Hydrostatic bearings which utilize an air cushion have tolerances as low as 0.2 μm, making them a reasonable choice for precision machining.

Magnetic thrust bearings—Magnetic thrust bearings support loads by magnetic levitation. Permanent magnets are suitable for light loads, but electromagnets are required for moderate to heavy loads. Magnets may be outfitted with both permanent magnets and electromagnets to support static and dynamic loads, respectively. Magnetic bearings are extremely low friction devices which do not need lubrication and are largely maintenance-free. This type of bearing does not support misaligned loads.

Specialized Bearings

Ball screw support bearings are designed to provide maximum axial rigidity and improved feeding accuracy for use with precision ball screws. They are high accuracy angular contact thrust bearings that are superior to combinations of standard angular contact bearings or arrangements of radial and thrust bearings for ball screw applications.

Arcuate clamshell bearings: United States patent U.S. Pat. No. 9,863,467B2, incorporated here by reference, describes a bearing design (an “arcuate clamshell bearing”) exemplary of a class of bearing designs that may be applied or removed to add bearing support as necessary. Other examples are presented in U.S. Pat. Nos. 8,523,442B2, 8,998,489B2, and 9,771,929B2, each of which is incorporated by reference.

Double direction bearings can accommodate axial loads in both directions, and in a separable design. Double direction bearings can handle high axial forces and have a high rigidity.

Precision tapered roller bearings allow adjustment of axial preload during installation, and provide high rigidity and support high spindle loads. A pure rolling bearing design helps reduce torque and heat in the bearing operation.

Slewing rings and turntable bearings can accommodate axial, radial and moment loads. They are not mounted in a housing or on a shaft, but are instead mounted directly to a seating surface via mounting holes.

Examples of swashplate pivot bearings, rocking bearings, and related elements are described in U.S. Pat. Nos. 5,390,584A, 6,676,294B2, 7,793,582B2, and 9,046,084B2, each of which is incorporated here by reference.

Counterimpact

When forging or other forming operations deliver force to a workpiece through an impact, offsetting forces may be delivered to the opposite side of the workpiece, for example through an opposing impact delivered to the barstock from which the workpiece is being manufactured and to which it remains attached. Such a countervailing impact may be delivered directly to the back end of the feedstock, or it may be delivered through a clamp applied to the bar, the workholder, or the workpiece itself. The delivery of an opposing force in synchronization with a forging blow can serve to reduce the amount of force applied to a collet spindle and therefore transmitted through the spindle bearings. Excess energy and forces that would have been transmitted to the frame and foundation through the spindle bearings are redirected and instead perform work in the form of recoil.

Other

Successful forging depends upon the force applied to a workpiece and the speed with which that force is delivered. Additional energy may be transferred if a significant mass is rapidly decelerated through impact with a workpiece. Useful forging may be successfully performed in conjunction with machining in a SCOFAST machine having relatively low pressing capacity. For example, a combination of impact together with hydraulic pressing at a nominal linear force of just 2000 lbs can be sufficient to hot-forge a grade 5 titanium bolt head having an area less than one square inch.

Actuators such as linear actuators and servo motors may be controlled with great rapidity and precision, and optical sensors can sense location and motion with great precision. A configuration in which a rapid and precise actuator is configured to track and follow the motion of another machine element permits multiple force sources to be combined either additively or subtractively, in the same or in different axes. For example, a hammer may be retracted immediately after a gravity strike to prevent adhesion, or additional pressing force may be applied immediately after an impact force. Impacts from opposite directions may be delivered simultaneously.

Compact servo motors using compact helical drives are capable of delivering very large linear forces, permitting many operations to be performed within a SCOFAST machine much smaller than the total size of all the individual machines that would otherwise be required for the same sequence of non-spatially coherent operations.

Deflection and Vibration Handling Strategies

When forces are generated and applied within a machine, unwanted deflection may occur. When deflection is periodic, vibration may result. Static and dynamic stiffness (force per unit deflection) and damping (a unitless ratio) may limit the tolerances achievable when a high-force operation is performed within a machine. Dynamic stiffness and damping vary with geometry and according to the vibration mode. Strategies for increasing effective stiffness and/or damping may include designing operations to take best advantage of geometries, changing from compliant bearings to stiff hydrostatic bearings, modifying a machine to add static bracing or dynamic damping, and selecting tools, speeds, and feeds to fit the dominant vibrational frequencies for a particular operation. Algorithmic solutions to reduce chatter may be implemented entirely in software.

Press Frame

Press forces ultimately are transmitted to a frame, which in a traditional press commonly is in the form of a columnar frame, welded frame, H-frame, C-frame, or multilayer steel tape winding frame, but which in a SCOFAST machine may take on any form.

Active Cancellation

Within a SCOFAST machine an analyzing function receiving input from one or more sensors can detect movement and harmonic vibration and can deliver signals to a programmable controller causing the workpiece and tools to move in such a manner as to counter the harmonic vibration. Active cancellation tools provide a source of harmonic vibration that may be applied to the workpiece or to another tool along any axis in order to dampen or counter vibrations.

Some exemplary systems and methods useful for modulating stiffness, damping, deflection, and vibration are presented in U.S. Pat. Nos. 4,395,904A, 5,459,383A, 6,900,609B2, 6,903,529B2, 8,322,698B2, 9,221,143B2, 9,429,936B2, and US20120010744A1, each of which is incorporated here by reference.

Additional exemplary systems and methods useful for managing stiffness, damping, deflection, and vibration are presented in the following non-patent documents, each of which is incorporated here by reference:
Ford, D. et al. (2014) ‘Active vibration control for a CNC milling machine’, Proceedings of the Institution of Mechanical Engineers, Part C: Journal of Mechanical Engineering Science, 228(2), pp. 230-245. doi: 10.1177/0954406213484224.
Jasiewicz, M. and Miądlicki, K. (2019) ‘Implementation of an Algorithm to Prevent Chatter Vibration in a CNC System’, Materials, 12(19). doi: 10.3390/ma12193193.
Muhammad, B. B. et al. (2018) ‘Active Damping of Milling Vibration Using Operational Amplifier Circuit’, Chinese Journal of Mechanical Engineering, 31(1), p. 90. doi: 10.1186/s10033-018-0291-9.
Pawelko, P. et al. (2021) ‘A new measurement system to determine stiffness distribution in machine tool workspace’, Archives of Civil and Mechanical Engineering, 21(2), p. 49. doi: 10.1007/s43452-021-00206-6.
Røsjordet, J. and Hovland, G. (2019) ‘Methods for Experimentally Determining Stiffness of a Multi-Axis Machining Centre’, Modeling, Identification and Control: A Norwegian Research Bulletin, 40, pp. 11-25. doi: 10.4173/mic.2019.1.2.
Tlusty, J., Ziegert, J. C. and Ridgeway, S. (1999) ‘Stiffness of Structures and Drives in Fast Milling Machines’, SAE Transactions, 108, pp. 671-677.

Machine Design and Configuration

The design of a particular embodiment depends on many variables. Those parts of the machine involved in forming must meet requirements of the process for which they will be used. A specified part to be manufactured through a series of operations imposes certain specific requirements on the machine used to perform each operation. Requirements that must be met may include rigidity, parallelism, flatness, clearances, sustained and burst rate of energy delivery, machine speed, cycle time, tool wear, geometry, and others that will be known to those having ordinary skill in the art.

For a given material, a specific forming operation (e.g., hot closed-die forging, warm-forward or backward extrusion, upset forging, or any other forming operation) may require or benefit from a certain variation of the forming load over the slide displacement (or stroke). For a given part geometry, the absolute load values will vary with the flow stress of the given material as well as with frictional conditions.

It is advantageous that a forchine should be configurable with respect to the speed of forming and recovery strokes.

Unit Work Taxonomy

It will be apparent that operations performed within a SCOFAST machine may be described by a variety of taxonomies, such as the Unit Work taxonomy in which operations are characterized as mass-change operations, phase-change operations, structure-change operations, deformation operations, or consolidation operations. Mass-change processes are those that remove or add material by mechanical, electrical, or chemical means, including machining, grinding, electrodischarge machining, electrochemical machining and all other subtractive operations, along with secondary deposition by 3D printing, plating, sputtering, vacuum deposition, and other additive operations. Phase-change processes are those that produce a solid part from material originally in the liquid or vapor phase, such as the casting of metals, the manufacture of composites by infiltration, and the injection molding of polymers. Structure-change processes are those that alter the microstructure of a workpiece, either throughout its bulk or in a localized region, such as is produced through heat treatments for surface hardening or through phase changes in the solid state, such as precipitation hardening. Deformation processes are those that alter the shape of a solid workpiece without changing its mass or composition, such as by rolling, forging, deep drawing, or ironing. Consolidation processes are those that combine materials such as particles, filaments, or solid sections to form a desired solid part or component, including 3D printing and related processes such as powder sintering, ceramic molding, and polymer-matrix composite pressing, along with others such as welding or brazing. Any unit work process may advantageously be performed within a SCOFAST machine.

A wide variety of unit work processes that may be instantiated within a SCOFAST machine may incorporate diverse groups of equipment, tooling designs, interface materials, and workzone mechanisms. Process equipment may belong to the groups of mechanical, thermal, chemical, photonic, electrical, and other equipment, as well as to combinations of the groups. Tooling elements may include cutting tools, grinding media, dies, molds, forms, patterns, electrodes, lasers, and any other tooling element now known or that may be developed in the future. The array of interface materials typical of unit processes includes such examples as lubricants, coolants, insulators, electrolytes, hydraulic fluids, reagents, liquids, gases, and others. Operative mechanisms found in the workzones of such unit processes include such examples as deformation, solidification, fracture, conduction, convection, radiation, diffusion, erosion, vaporization, melting, microstructure change, phase transformations, chemical reactions, and many others.

Modeling & Presentation

Certain processes and operations of a SCOFAST machine may advantageously be designed, modeled, tested, and modified within a virtual reality or augmented reality environment. In such an environment many aspects of a SCOFAST machine and its configuration for specific purposes may be performed through bidirectional virtual interactions involving three-dimensional models of the machine, the workpiece, and the part to be made. Such an environment may advantageously be used before operations are executed for planning, for virtual trial runs, for testing edge conditions, for configuration, and for other purposes that will be understood by those having ordinary skill in the arts. Such environments may further be advantageously used both during the performance of operations and during subsequent review of completed operations, whether successful or failed. SCOFAST models and operations may be represented in a virtual reality headset, in an augmented reality headset, in a tank-type or cave-type display, in a holographic form, or in any other form utilizing any number of perceived dimensions for the display. Sensory communication may involve any combination of sensory modalities including haptic, visual, auditory, olfactory, gustatory, vestibular, proprioceptive, vibrational, and other. Signals may be delivered via cranial nerves or through any motor or sensory nerves of the human body. Remote machine controls may be effectuated through any kind of interface, including GUI and non-GUI interfaces, touch interfaces, proximity sensors of all kinds, remote manipulator (“waldo”) interfaces that sense and translate free movement into machine controls, and such other interface modalities as may now exist together with those that may be discovered or invented in the future. Some exemplary systems and methods useful for modeling, presentation, and virtual interaction are presented in United States patent document US20190362646A1, which is incorporated here by reference.

Material, Workpiece, and Tool Handling

Raw Materials

Depending on the operations to be performed, raw materials used in a SCOFAST machine may comprise billets, bars, rods, sheets, plates, wires, tubes, pipes, powders, pellets, shavings, fibers, shredded material, slurries, pastes, solids, semi-solids, liquids, vapors, gases, plasmas, sprays, suspensions, solutions, or any other form or combination of forms.

Some exemplary systems and methods useful for material handling in a SCOFAST machine are presented in U.S. Pat. Nos. 3,266,348A, 3,703,112A, 4,130,289A, 4,324,162A, 4,742,740A, 4,914,992A, 4,961,358A, 4,976,572A, 5,058,466A, 5,088,181A, 5,744,778A, 5,911,804A, and 6,185,818B1, each of which is incorporated by reference.

Some systems and methods useful in workpiece and tool handling are presented in U.S. Pat. Nos. 3,844,028A, 4,281,447A, 4,369,563A, 4,784,421A, 5,303,622A, 5,372,568A, 5,465,638A, 5,474,514A, 6,413,022B1, 6,430,796B1, 6,641,511B2, 7,637,856B2, 7,665,197B2, 7,980,159B1, 8,132,835B2, 8,215,214B2, 8,360,945B2, 8,397,375B2, 8,672,820B2, 8,789,446B1, 8,974,357B2, 9,021,704B2, 9,321,109B2, 9,333,609B2, 9,508,148B2, 10,076,841B2, 10,207,381B2, 10,361,060B2, 10,814,476B2, US20060075625A1, US20100268371A1, and US20120296469A1, each of which is incorporated here by reference.

Workpiece and Tool Holding & Manipulation

Workpieces and tools are positioned in a working area of a SCOFAST machine and secured by means of one or more workholding or toolholding devices. Workholding and toolholding devices comprise collets, chucks, clamps, vises, grippers, vacuum holders, magnetic holders, electromagnetic holders, concentric grippers, adhesive fixturing systems, robotic grippers, gravitic holders, thermal holders, and any other mechanisms capable of securing a tool or a workpiece and supporting the forces necessary for a subsequent operation, including other such mechanisms that are described herein or may be known to those having skill in the art, together with those that may be invented or discovered in the future.

A workholding device may be fixed in position or it may be capable of being translated along any axis and/or rotated through any angle relative to any axis. A workholder together with the mechanism whereby workholder translation and rotation occur (workpiece positioning elements) may be rigidly fixed to a structural member of the SCOFAST machine or it may be free-standing and flexibly connected to the SCOFAST machine. An industrial robot may serve as a workholder and workpiece positioning element. Both workpieces and tools may be secured and manipulated by any means and any mechanisms now known or that may be developed in the future.

Robotic Manipulators and Grippers

Robots are devices designed to move components, tools, and materials by specific motions and through defined paths. Robots can have memories (stored sets of instructions) and may be equipped with mechanisms that automatically perform many tasks such as the loading and unloading of parts, assembly, inspection, welding, painting, and machining, each axis of motion usually being driven by an engine such as an electric, hydraulic, or pneumatic effector. The terminal joint (“wrist”) is usually fitted with an “end effector,” a terminal appendage element to which devices are added to help perform specific required operations. These devices can include grippers for material handling, powered tools, welders, or any other tool or device. Robots may be fitted with tactile or visual sensing devices that can determine the proximity of the object to be manipulated.

Exemplary techniques for robotic arms and grippers are presented in U.S. Pat. Nos. 4,111,027A, 4,309,600A, 5,541,485A, U.S. 62/799,414, 6,493,607B1, 8,935,004B2, 9,126,337B2, 9,132,555B2, 9,205,563B2, 9,415,511B2, 9,630,321B2, 9,636,827B2, 9,770,829B2, 9,902,034B2, 9,925,672B2, 10,005,191B2, 10,131,054B2, 10,562,182B2, 10,618,174B2, and 10,675,763B2, each of which is incorporated here by reference.

Flippers

Flippers are devices designed to rotate a workpiece end-for-end. Flippers are commonly used to remove a workpiece from a workholder, rotate the workpiece end-for-end, and replace the workpiece in the workholder.

Tools and Tool Handling

A tool is any device that exerts an effect on a workpiece to bring about some change in the workpiece. Examples of commonly used tools include forming dies, forming tools, force generators, impact tools, presses, additive tools, subtractive tools, transformative tools, measuring tools, testing tools, indexing tools, active tools, fixed tools, and many additional examples that are set forth within this specification, together with such similar elements as will be known to those having skill in the relevant arts and others yet to be invented.

Static tools (“fixed tools”) are tools that exert their actions on a workpiece solely through a combination of workpiece motion (e.g., rotation in a lathe or oscillation in a scraper) and positioning of the tool.

Live tools (“active tools”) are powered tools that exert their actions through delivery of additional energy beyond the energy imparted through workpiece motion and tool positioning. This additional energy most often comes through added motion or activity of the tool itself. Many live tools deliver energy to a workpiece through tool movement such as rotary, oscillatory, vibratory, hammering, pressing, or other forms of powered tool movement. Live tools may incorporate their own drives, or they may be driven by various spindles and powered sub-spindles within the machining center.

Any number of active and/or fixed tools may be positioned arbitrarily with respect to the workpiece and may be translated along any axis and rotated through any angle relative to any axis, limited solely by the presence of other tools and the desired toolpath. Each toolholder and the mechanism whereby tool translation and rotation occur (tool positioning elements) may be rigidly fixed to a structural member of the SCOFAST machine or it may be free-standing and flexibly connected to the SCOFAST machine. An industrial robot may serve as a toolholder and tool positioning element.

During an operation, the workpiece and any tools may be moved relative to each other, the movement of each being controlled and regulated by the action of one or more programmable controllers.

Tool-Changing

A SCOFAST machine may have one or more elements configured to effect the loading and unloading or parts and/or tools from spindle collets, workholding devices, tool positioners, tool holders, tool spindles, and other workholding and tool holding elements of the machine. Many different arrangements of tool holding and tool positioning elements are possible. Some exemplary systems and methods useful for tool and part holding, positioning, changing, loading, and unloading are presented in U.S. Pat. Nos. 3,054,333A, 3,355,797A, 3,825,245A, 4,090,287A, 4,302,144A, 5,093,978A, 6,857,995B2, 7,137,180B2, 8,650,994B2, 8,887,363B2, 9,902,034B2, and 9,914,189B2, each of which is incorporated here by reference.

Some additional exemplary systems and methods useful for tool and part holding, positioning, changing, loading, and unloading are presented in non-United States patent document JP6576662B2, which is incorporated here by reference.

Other

Geometries

Many different machine geometries are known to be useful in manufacturing. For example, turning machines may be designed with the principal turning axis vertical or horizontal; if horizontal they commonly have a flat bed or an angled bed. A SCOFAST machine may be constructed using any machine geometry. Illustrations and examples given in one geometry are exemplary only, and may be modified as desired to fit any other geometry.

Conversion to a SCOFAST Machine Through Retrofitting

Any existing or previously described machine capable of performing forming, additive, subtractive, or transformative operations may be converted to a SCOFAST machine by the modification of existing elements and the addition of new elements.

New SCOFAST Machine Designs

New SCOFAST machine designs may comprise elements of or be based upon any non-SCOFAST machine described herein, or any other machine now known or that may be developed in the future.

Hydraulic Pressure

For a hydraulic press having a total piston cross sectional area of A, the pressure in PSI corresponding to tonnage T is found by the following calculation:

PSI=(T*2000 pounds/ton)/A.

Machining Fluid

When parts are machined, a layer of steam (“vapor barrier”) forms at the juncture of the cutting tool and the work piece and acts as a heat insulator that traps thermal energy in the area where the edge of the cutting tool comes in direct contact with the work piece. The resulting hot zone may become hot enough to deform parts, crack tooling, and alter the material properties of the workpiece. High pressure coolant penetrates the vapor barrier to remove heat from areas where low-pressure irrigation may not penetrate. Rapid cooling of metal chips may also improve chip breakaway. High-pressure coolant also flushes chips away from the cutting zone rapidly enough to prevent re-machining. Under some circumstances this may yield better parts, permit increased speeds and feeds, and extend cutting tool life significantly.

Some techniques for cooling and lubricating tools and workpieces and for managing machining fluids during machining are presented in the following United States patent publications, each of which is incorporated here by reference: U.S. Pat. Nos. 3,577,808A, 4,076,442A, 5,028,176A, 5,595,462A, 5,678,466A, 5,951,216A, 6,210,086B1, 6,874,977B2, 8,568,198B2, 8,821,212B2, 9,616,540B2, 10,807,209B2, US20150107818A1, and US20180104750A1.

Additional techniques useful for cooling and lubricating tools and workpieces and for managing machining fluids during machining are presented in the following non-patent publications, each of which is incorporated here by reference:
K. Busch, C. Hochmuth, B. Pause, A. Stoll, and R. Wertheim, “Investigation of Cooling and Lubrication Strategies for Machining High-temperature Alloys,” Procedia CIRP, vol. 41, pp. 835-840, 2016, doi: 10.1016/j.procir.2015.10.005;
E. García-Martínez, V. Miguel, A. Martinez-Martinez, M. C. Manjabacas, and J. Coello, “Sustainable Lubrication Methods for the Machining of Titanium Alloys: An Overview,” Materials (Basel), vol. 12, no. 23, November 2019, doi: 10.3390/ma12233852;
S. Gariani, I. Shyha, F. Inam, and D. Huo, “Evaluation of a Novel Controlled Cutting Fluid Impinging Supply System When Machining Titanium Alloys,” Applied Sciences, vol. 7, no. 6, p. 560, May 2017, doi: 10.3390/app706056.

Treatment Fluid

In some embodiments a machining fluid may also comprise a material or substance used as part of a treatment operation within a SCOFAST machine. For example, solution annealing (“solution heat treating,” “solution treating” is performed by exposing a workpiece to a chemical solution (treatment fluid) during heating and/or cooling. One example of such a machining and treatment fluid is a toughening fluid: a chemical mixture that may be used as a machining fluid and also serves as a treatment solution to facilitate increased toughness as a result of changes in the physical properties of a workpiece that occur during forming, machining, and transforming.

Clean and Dirty Areas of a Machine

Clean and dirty areas are defined with respect to contamination with some specified material at some specified level of contamination. Anything can be a contaminant, including gases, vapors, liquids, solids, inert materials, reactive materials, biological materials, living organisms, dead organisms, molecules, and even non-material things such as fields, forces, and subatomic particles. If the contaminant is not otherwise specified, it often is presumed to be particulate matter.

If no contaminating material is specified, a dirty area is thus an area that is not controlled for particulate matter. Similarly, if no contaminating material is specified then a clean area is an area in which controls are in place to reduce the level of particulate contaminants such as dust, microbes, aerosol particles, viruses, vapor particles, or other contaminants. A SCOFAST machine may advantageously comprise clean areas, dirty areas, or a combination of clean and dirty areas.

A clean area may be specified by the number of allowable airborne particles per cubic meter at a specified particle size as shown in Table IX. For example, the ambient air outside in a typical city environment contains 35,000,000 particles per cubic meter that are 0.5 micron and larger in diameter, corresponding to a classification of ISO 9.

TABLE IX
ISO 14644-1 Cleanroom Standards

| | | | | | | | FED STD |
|---|---|---|---|---|---|---|---|
| | Maximum partides/m³ | | | | | | 209E |
| Class | >=0.1 μm | >=0.2 μm | >=0.3 μm | >=0.5 μm | >=1 μm | >=5 μm | equivalent |
| ISO 1 | 10 | 2 | | | | | |
| ISO 2 | 100 | 24 | 10 | 4 | | | |
| ISO 3 | 1,000 | 237 | 102 | 35 | 8 | | Class 1 |
| ISO 4 | 10,000 | 2,370 | 1,020 | 352 | 83 | | Class 10 |
| ISO 5 | 100,000 | 23,700 | 10,200 | 3,520 | 832 | 29 | Class 100 |
| ISO 6 | 1,000,000 | 237,000 | 102,000 | 35,200 | 8,320 | 293 | Class 1,000 |
| ISO 7 | | | | 352,000 | 83,200 | 2,930 | Class 10,000 |
| ISO 8 | | | | 3,520,000 | 832,000 | 29,300 | Class 100,000 |
| ISO 9 | | | | 35,200,000 | 8,320,000 | 293,000 | Room Air |

Within a manufacturing machine, a clean area often is specified by the number and size of particles that are detected on a residual particle analysis. The area is washed with a cleaning fluid that is passed through a millipore filter, and any debris is weighed and examined microscopically for particle size and cluster size. The degree of cleanliness required for an operation within a SCOFAST machine is determined by the part being manufactured and the application envisioned for that part. Where tight clearances or highly specified orifices are envisioned (e.g., engine assemblies, telescopes, micro-flow channels, and other demanding applications) allowable residual particle size may be restricted to 250 microns or less, with total particle load limited to a milligram or less. Biological applications may have significantly tighter restrictions involving both surface cleanliness and air cleanliness specifications, often corresponding to one of the ISO 14644-1 classes.

Within a machine, a zone means a volume of space. To exclude a substance from a zone means to exclude that substance completely or partially from the zone, to displace that substance from the zone, or to otherwise reduce the amount of that substance within the zone.

Working Zones are zones within a SCOFAST machine in which modules execute their functions or in which operations are performed on a workpiece. Working zones may be open, partially enclosed, completely enclosed, partially sealable, or completely sealable.

Clean working zones are working zones configured to exclude one or more specified unwanted substances. Dirty working zones are working zones in which such specified substances are not excluded. The substance or substances to be excluded or not excluded vary according to the workpiece and the operations to be performed. In one example, a substance excluded from a clean working zone and permitted in a dirty working zone is oxygen. In another example, a substance excluded from a clean working zone and permitted in a dirty working zone is oil. In another example, a substance excluded from a clean working zone and permitted in a dirty working zone is metal chips.

A dirty working zone may be converted into a clean working zone by removing and excluding the substance(s) that are unwanted with respect to a particular operation.

Tolerances

Mechanical tolerances for SCOFAST operations and parts manufactured in a SCOFAST machine may be described and specified using mechanical tolerance grades shown in Table I and Table II and in other tolerance standards as set forth in non-patent document ISO-286 Mechanical Tolerance Standards, International Organization for Standardization, Geneva, Switzerland, 2010 and incorporated here by reference. When applying ISO-286 mechanical tolerance grades from IT6 to IT18, the standard tolerances are multiplied by the factor 10 at each fifth step. This rule applies to all standard tolerances and may be used to extrapolate values for IT grades not given.

Materials

SCOFAST machine operations may be performed on workpieces comprising any material or combination of materials, without limitation, using tools comprising any material or combination of materials, without limitation. Some exemplary materials of interest for SCOFAST machines and their operations are presented in U.S. Pat. No. 6,635,354B2, incorporated here by reference.

Ductility

Ductility is the ability of a material to be molded or shaped, such as a metal's ability to be easily drawn into wire or hammered into a thin plate.

Fabricality

Fabricality refers to a metal's ability to be used to create machinery, structures, and other equipment, via being shaped and assembled.

Formability

Formability is a material's susceptibility to be formed into various shapes.

Interstitial Elements

Interstitial Elements are “impurities” that are found in pure metals, sometimes altering the properties of the metal in advantageous or disadvantageous ways.

Exotic Metal Alloys

The more exotic of relatively common metal component materials are classified in ISO group S, containing heat-resistant superalloys (HRSA) and titanium alloys. For machining, these can be split into several sub-groups, depending upon composition, condition and properties. The chemical nature and metallurgical composition of an S-classified alloy determine the physical properties and machinability of the alloy. Chip control is generally demanding because of chip segmentation. Specific cutting force (SCF) is a measure of how hard it is to cut a material; for S-type alloys the SCF may be more than twice that of steel. HRSA materials are particularly demanding to cut because they retain high strength at elevated temperatures and they are highly susceptible to work-hardening.

Nickel-, iron- or cobalt-based alloys are sub-groups of HRSA, having unique capabilities for component use mainly in aerospace, energy and medical industries, as their advantageous properties do not change much until close to their melting point and are very anti-corrosive.

Titanium alloys are also divided into sub-groups with varying machinability grading. Titanium alloys have high toughness, low thermal conductivity, high retained strength at elevated temperatures, highly sheared thin chips, and a strong tendency for galling. Cutting is very sensitive to small changes in tool geometries. Machining titanium alloys generally requires a narrow contact area on the rake-face and high cutting forces concentrated close to the cutting edge.

Many difficulties may arise when attempting to machine exotic metal alloys. Some alloys have a relatively high level of carbides, increasing abrasiveness and tool wear. Excessive cutting speeds may result in chemical reactions between the chip and the tool material, causing cutting edge fractures and material smearing/welding. Some alloys also work-harden readily, giving rise to diffusion-type wear and burr formation. The pattern of chip formation may be cyclic, resulting in cutting forces that vary over time.

In difficult-to-machine materials, most cutting is performed with carefully selected cutting inserts. Successful cutting action is largely dependent on the approach of the cutting edge to the workpiece. The lead/entering angle of the cutting edge, in combination with the insert geometry, dominates performance, tool life, security and final results. Because of the hardness of these materials, plastic deformation of the cutting edge is an important issue that influences the selection of tool material. A high degree of insert hot hardness, the right level of insert toughness and sufficient adhesion of the insert coating are the primary requirements. Successful cuts in HRSA are characterized by a positive cutting geometry, a sharp cutting edge, a strong edge and a comparatively open chipbreaker.

Tool Material

Certain characteristics are important in the choice of cutting tool material. The hardness and strength of the cutting tool must be maintained at elevated temperatures (hot hardness). Cutting tools must be tough enough that tools don't chip or fracture. Wear resistance is important. Tool steel, cast alloys, high speed steel, cemented carbide, diamond, cubic boron nitride, cermets, and ceramics (e.g., silicon nitride, alumina) are materials commonly used for cutting tools and tool inserts when machining, but tools used for operations within a SCOFAST machine may be made of any material now known or that may be discovered in the future

Some examples of materials commonly used in manufacturing for which the systems and methods disclosed in this specification may prove particularly advantageous include, but are not limited to, those listed here as examples.

Metals

Some examples of metals for which it may be particularly advantageous to perform operations in a SCOFAST machine are here given as examples.

Titanium

Titanium unalloyed has a tensile strength ranging from 275 to 590 MPa, the strength being increased with increasing oxygen content and/or increasing iron content. Many useful alloys are known, each with its own distinct properties. Commercially available titanium alloys may have a tensile strength as high as 1250 MPa (e.g., for the high strength alloy Ti-15Mo-5Zr-3AI). Commercially pure titanium is stable up to temperatures of approximately 300° C. due to its specific strength and creep resistance. Certain titanium alloys may exhibit high strength even at temperatures up to approximately 500° C.

High-Strength Titanium Alloys

High-strength titanium alloys include Ti-6Al-4V titanium alloy (often referred to as “grade 5 titanium”) and other titanium alloys having a tensile strength of 100 ksi (690 Mpa) or greater and a 0.2% yield strength of 90 ksi or greater. Ti 6Al-4V is the most popular titanium alloy, ideal for parts that require high strength while remaining lightweight. It possesses high corrosion resistance and fair weldability and formability. Ti 6Al-4V is also heat treatable, unlike “pure” grades of titanium. Ti 6Al-4V has a machining cost factor of 6.0 when compared to steel 12L14. It produces a fair weld and forges roughly. Ti 6Al-4V can also be annealed, heat treated, and aged.

Ti 6al-4v Eli

Ti 6Al-4V Eli, also known as Grade 23, is a popular titanium alloy, ideal for parts that require strength and toughness while remaining lightweight. It is extremely biocompatible, making it the material of choice when fatigue and corrosion resistances are necessary. Ti 6Al-4V Eli's reduced interstitial element content (oxygen, nitrogen, carbon, and iron) results in better ductility and fracture resistance than Ti 6Al-4V, but slightly less strength. Ti 6Al-4V Eli has a machining cost factor of 6.0 when compared to steel 12L14. It can be hot and cold formed, heat treated, annealed, forged, and aged. Ti 6Al-4V Eli is considered fairly weldable.

Greek Ascoloy

Greek Ascoloy is a stainless steel alloy, ideal for parts that require extremely high heat resistance. It possesses similar properties to other stainless steels, with the addition of superior creep and stress resistance. Greek Ascoloy possesses excellent tensile and impact strength and good corrosion resistance. Greek Ascoloy has a machining cost factor of 4.0 when compared to steel 12L14. It can be welded with most common methods. Greek Ascoloy can also be forged, annealed, tempered, and hardened.

Carpenter 49

Carpenter 49 (“Carp 49”) is a nickel-iron alloy, ideal for parts that require high magnetic permeability. It possesses maximum permeability and low core loss, as well as the highest saturation flux density of any other nickel alloy. Carp 49 has a fair resistance to weather and moisture corrosion. Carp 49 has a machining cost factor of 6.0 when compared to steel 12L14. It can be easily welded, brazed, and soldered, as well as hot and cold worked. Carp 49 cannot be hardened by heat treatment, but can be annealed.

Hastelloy

Hastelloy is a high-performance nickel-molybdenum alloy, ideal for parts that require the highest corrosion resistance. It has outstanding resistance to pitting, stress, oxidation, chemicals, acids, and saltwater. Hastelloy also retains good ductility after prolonged high temperatures. Hastelloy has a machining cost factor of 10.0 when compared to steel 12L14. It has excellent ductility and therefore can be readily welded and formed by hot and cold working. Hastelloy is typically heat treated and can be annealed.

HyMu 80

HyMu 80 is a nickel-iron alloy, ideal for parts that are used to shield against magnetic fields. It possesses maximum electromagnetic permeability and minimum hysteresis loss. HyMu 80 is ductile and requires heat treating. HyMu 80 has a machining cost factor of 10.0 when compared to steel 12L14. It can be readily welded, formed, and cold worked. HyMu 80 can be annealed by heat treatment.

Nitronic 60

Nitronic 60 is an all-purpose stainless steel alloy, ideal for parts that require wear and gall resistance at a lower cost. It has a slightly lower corrosion resistance than some other stainless steel alloys, but has much higher stress cracking, chloride pitting, seawater, and gall resistances. Nitronic 60 has a relatively low hardness compared to other nickel alloys, but has a much higher heat resistance due to a thin, adherent oxide film. Nitronic 60 has a machining cost factor of 9.0 when compared to steel 12L14. It can be readily welded. Nitronic 60 does not respond to heat treatment, but can be cold worked or case hardened to improve hardness.

Copper Alloy 110

Copper alloy 110 is an extremely popular copper alloy with many applications due to its high corrosion resistance, conductivity, and finish. It has the highest electrical conductivity of any metal, except silver. When exposed to the elements, it forms a thin protective patina that is relatively impermeable. Copper 110 is ideal when extensive machining is not required, as it has an extremely low machinability compared to other copper alloys. Copper 110 has a machining cost factor of 3.0 when compared to steel 12L14. It is excellent for hot and cold forming, as well as soldering. Copper 110 is not easily welded or brazed.

Tellurium Copper Alloy 145 (TeCu)

Tellurium copper alloy 145 (TeCu) is considered a free-machining copper alloy, ideal for parts that require extensive machining, corrosion resistance, or high conductivity. It produces short, clean chips that are easily removable. Tellurium copper machines more quickly and efficiently than pure copper. TeCu has a machining cost factor of 0.8 when compared to steel 12L14. It is good for hot and cold working, forging, brazing, and soldering, but is not ideal for welding. TeCu can be annealed.

Beryllium Copper Alloy 172 (BeCu 172)

Beryllium copper alloy 172 (BeCu 172) is one of the highest strength copper alloys, ideal for parts that require high strength and electrical conductivity. It has excellent corrosion and galling resistance. Beryllium copper 172 is also non-magnetic and has a very low permeability, making it a suitable choice for magnetic housings. BeCu 172 has a machining cost factor of 3.0 when compared to steel 12L14. It is good for soldering, brazing, forging, welding, and hot and cold working. BeCu 172 can be annealed.

Beryllium Copper Alloy 173 (BeCu 173)

Beryllium copper alloy 173 (BeCu 173) is a free-machining copper alloy, ideal for parts that require very high strength and stiffness. It has excellent electrical conductivity and is one of the highest strength copper alloys. Beryllium copper is also suitable for environments that require high corrosion resistance, such as marine environments. BeCu 173 has a machining cost factor of 1.0 when compared to steel 12L14, making it a better economic choice than BeCu 172. It is good for soldering, brazing, welding, and hot and cold working, but is not ideal for forging. BeCu can be annealed.

Beryllium Copper Alloy 175 (BeCu 175)

Beryllium copper alloy 175 (BeCu 175) is a free-machining copper alloy, ideal for parts that require high strength and stiffness. It has excellent electrical conductivity. Beryllium copper is also suitable for environments that require high corrosion resistance, such as marine environments. BeCu 175 has a machining cost factor of 1.5 when compared to steel 12L14. It is good for soldering, brazing, welding, and hot and cold working, but is not ideal for forging. BeCu 175 can be annealed.

Brass Cda 353 (Brass 353)

Brass CDA 353 (Brass 353) alloy is a leaded free-machining alloy (FMA), ideal for parts that require strength, corrosion and wear resistance, and excellent machinability. It is well suited for parts with knurling or threading, as well as moving parts that are subject to frictional forces. Brass 353 has a machining cost factor of 0.7 when compared to steel 12L14. It is not ideal for welding or hot working, but is excellent for soldering and possesses better formability than Brass 360. Brass 353 can be annealed.

Brass Cda 360 (Brass 360)

Brass CDA 360 (Brass 360) alloy has the highest machinability of all copper alloys, extremely popular for parts that require strength, weight, or a polished surface finish. Available in round, square, hex, and tube stock at low costs, Unlike steel, 360 also forms a thin protective patina that does not rust. Brass 360 has the highest machinability of all copper and brass alloys. It has a machining cost factor of 0.6 when compared to steel 12L14 It has fair hot forming properties and is not ideal for cold forming, welding, soldering, and brazing. Brass 360 can be forged and annealed.

Aluminum Alloy 2011 (Al 2011)

Aluminum alloy 2011 (Al 2011) has the highest machinability of all aluminum alloys, suitable for complex and detailed parts. Considered a free-machining alloy (FMA), it can be quickly machined to very close tolerances and produces an excellent surface finish. Aluminum 2011 is a great economical choice due to its machinability and production of fine, easily removable chips. Aluminum 2011 is the standard for relative machinability compared to all other aluminum alloys. It has a machining cost factor of 0.6 when compared to steel 12L14. It can be forged or hot worked but is not ideal for welding or soldering. 2011 can be heat treated, annealed, aged, and tempered. It can be anodized but results in a darker and less corrosion resistant finish than Aluminum 6061.

Aluminum Alloy 2024 (Al 2024)

Aluminum alloy 2024 (Al 2024) is an exceptionally high mechanical strength alloy, suitable for parts that require more strength while remaining lightweight. It also has excellent fatigue and cracking resistance, making it a desirable material for aircraft components. Aluminum 2024 can be machined to a high finish. Aluminum 2024 has a machining cost factor of 0.7 when compared to steel 12L14. It can be forged and hot worked, but is not ideal for welding or soldering. 2024 responds well to heat treatment, annealing, and tempering. It can be anodized, but results in a darker and less corrosion resistant finish than Aluminum 6061.

Aluminum Alloy 6061 (Al 6061)

Aluminum alloy 6061 (Al 6061) is an extremely popular alloy, excellent for jobs that require forming or welding. It is the most commonly available aluminum alloy and provides a clean surface finish. Unlike other aluminum alloys, 6061 has a high corrosion resistance. Aluminum 6061 has a machining cost factor of 0.8 when compared to steel 12L14. It can be forged, hot worked, and readily welded, as well as heat treated, annealed, and aged. It anodizes well and provides a bright, colorful finish.

Aluminum Alloy 7075 (Al 7075)

Aluminum alloy 7075 (Al 7075) is the strongest of available aluminum alloys, excellent for jobs that require extreme strength while remaining lightweight. It possesses great cracking resistance and increases in strength as temperature decreases, making it ideal for the aerospace industry. Aluminum 7075 has a machining cost factor of 0.9 when compared to steel 12L14. It can be forged and heat treated, but is not ideal for welding. 7075 can be heat treated, annealed, and aged. It is not as ideal for anodizing compared to Aluminum 6061 and may produce a yellowish tint when clear anodizing.

Plastics

Operations within a SCOFAST machine may be performed on workpieces comprising any kind of plastic material. Some examples of plastics commonly used in manufacturing where it may prove advantageous to perform operations in a SCOFAST machine are here given as examples.

Acetal

Acetal is a versatile low-cost plastic, ideal for parts that require high mechanical strength and rigidity, while machining to very tight tolerances. It has good dimensional stability and chemical resistance, making it long-wearing. Unlike nylon, it has a very low moisture absorption rate, making it suitable for use in wet environments. Acetal has a machining cost factor of 0.7 when compared to steel 12L14.

Delrin

Delrin is a versatile low-cost plastic in the acetal family, ideal for parts that require strength and resilience, while machining to very tight tolerances. It has excellent dimensional stability and friction resistance, making it long-wearing. Unlike nylon, it has a very low moisture absorption rate, making it suitable for use in wet environments. Delrin has a machining cost factor of 0.7 when compared to steel 12L14.

Nylon

Nylon is a versatile low-cost plastic, ideal for parts that require high compressive strength and friction resistance, while machining to very tight tolerances. It can be used in place of metal in some applications, allowing for longer-wearing parts that require lower maintenance than its metal counterpart. Nylon generally is stronger, withstands higher temperatures, and is more cost efficient than PTFE, PEEK, and UHMW. Nylon has a machining cost factor of 0.8 when compared to steel 12L14.

Polyether Ether Ketone (PEEK)

Polyether ether ketone (PEEK) is a popular high strength plastic resin, ideal for parts that require strength and stiffness. It has an extremely high resistance to heat, moisture, and chemicals and can withstand multiple cycles in hot water or steam. PEEK also performs well in ultra-high vacuum environments. PEEK has a machining cost factor of 0.9 when compared to steel 12L14.

Polytetrafluoroethylene (PTFE)

Polytetrafluoroethylene (PTFE) (more commonly known as Teflon) is an extremely resilient plastic, ideal for screw machine parts that require high impact strength and durability. It has excellent resistance to frictional wear, weathering, flame, heat, chemical, and radiation. Unlike nylon, it has a very low moisture absorption rate, making it suitable for use in wet environments. PTFE/Teflon has a machining cost factor of 1.2 when compared to steel 12L14.

Polyvinyl Chloride (PVC)

Polyvinyl chloride (PVC) is a low-cost plastic, ideal for parts that require strength while remaining lightweight. It is highly machinable to close tolerances and has excellent corrosion, flame, and water resistance. PVC also has high strength, impact resistance, and toughness. PVC has a machining cost factor of 1.1 when compared to steel 12L14.

Ultra-High Molecular Weight Polyethylene (UHMW)

Ultra-High Molecular Weight polyethylene (UHMW) is a high-density plastic, ideal for screw machine parts that require extremely high resistance to wear and abrasion. It has the highest impact strength of any thermoplastic and is highly resistant to most corrosive materials. UHMW is self-lubricating and performs well in extraordinarily low temperatures, but begins to soften in higher temperatures. Unlike nylon, it has a very low moisture absorption rate, making it suitable for use in wet environments. Ultem has a machining cost factor of 0.7 when compared to steel 12L14.

Ultem

Ultem is a popular high strength plastic resin, ideal for parts that require strength and excellent thermal and dielectric properties. It has an extremely high resistance to heat and moisture and can withstand multiple cycles in hot water or steam. Ultem also has one of the highest dielectric strengths of any thermoplastic, making it suitable for applications in the aerospace and electronics industries. Ultem has a machining cost factor of 0.7 when compared to steel 12L14.

Biomaterials

Some exemplary systems and methods useful for working with biomaterials are presented in U.S. Pat. Nos. 9,114,032B1, 9,517,128B2, 10,441,689B2, 10,933,579B2, 10,442,182B2, 10,486,412B1, US20140335145A1, US20150017131A1, US20160106142A1, US20190291350A1, US20190389124A1, US20200080060A1, US20200140801A1, and US20200330644A1, each of which is incorporated here by reference.

Foodstuffs

Some exemplary systems and methods useful for working with foodstuffs are presented in U.S. Pat. Nos. 9,723,866B2, 10,178,868B2, 10,349,663B2, 11,000,058B2, US20160106142A1, US20160135493A1, US20170295816A1, US20180116272A1, and US20210112845A1, each of which is incorporated here by reference.

### DESCRIPTION OF EACH FIGURE

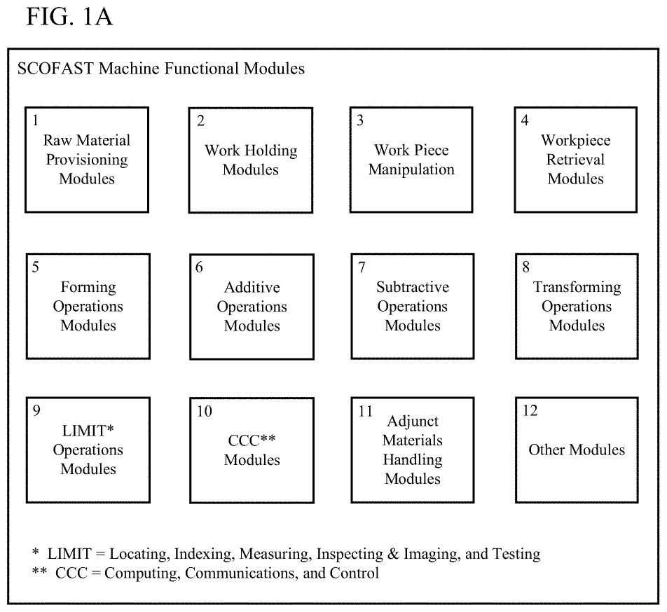

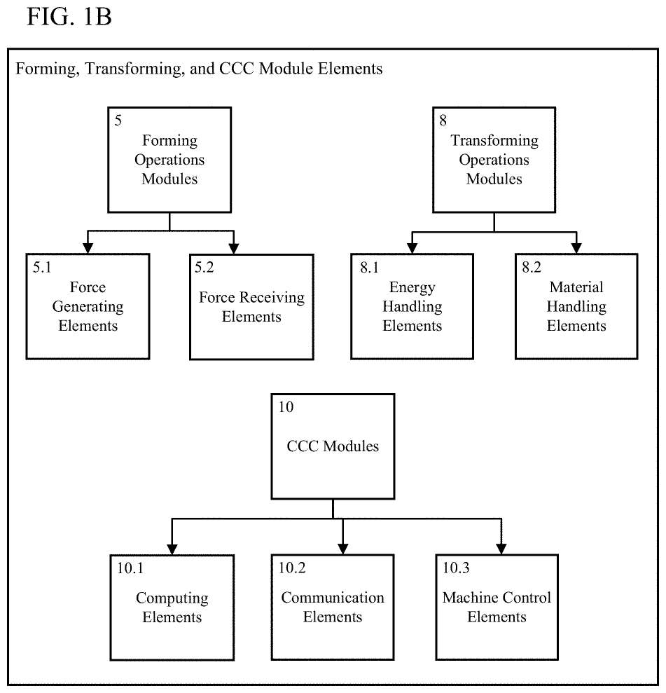

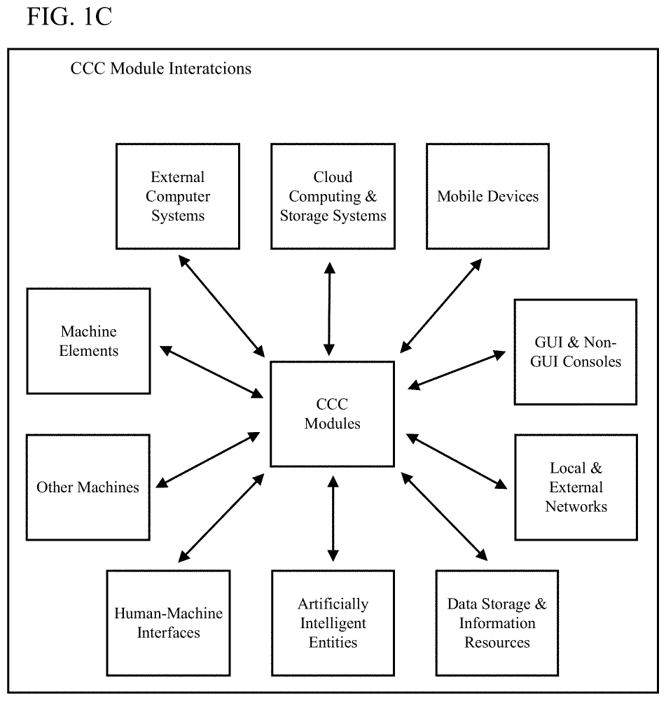

FIG. 1A, 1B, 1C: SCOFAST Machine Modules

The basic functional modules are shown for an exemplary SCOFAST machine that receives raw materials in some form, secures and manipulates them using workholders, manipulates their energy content if desired, performs desired operations including forming, additive, subtractive, and/or transformative operations in a spatially coherent manner, and optionally performs additional operations such as locating, indexing, measuring, imaging, and/or testing operations, and/or any other operations that may be advantageously performed within a SCOFAST machine. A SCOFAST machine may comprise zero or more of each type of module together with additional modules of other types, all modules operating upon materials and workpieces in a spatially coherent manner within a single SCOFAST machine. These figures show schematically that modules supporting manufacturing processes requiring multiple operations of different types are integrated into a single machine in a spatially coherent manner, facilitating the maintenance of spatial alignment and registration across operations and thus reducing cost, waste, time, effort, complexity, and risk, and enabling the manufacture of parts that otherwise would be too costly, too difficult, or even impossible to manufacture.

FIG. 1A: Primary Functional Modules of a SCOFAST Machine

[1] Raw Material Provisioning Modules comprise raw materials and the mechanisms, machine elements, and methods by which raw materials are presented to and received into a machine in a form that can be received and supported by Work Holding Modules. Examples include, but are not limited to handling systems for billets, bars, sheets, plates, wires, tubes, pipes, powders, pellets, shavings, solids, slurries, pastes, semi-solids, liquids, and many additional examples that are set forth within this specification, together with such similar elements as will be known to those having skill in the relevant arts and others yet to be invented.

[2] Work Holding Modules comprise mechanisms, machine elements, and methods that hold, support, and/or secure raw materials and/or workpieces, whether moving or stationary, including but not limited to collets, chucks, rotary tables, molds, forging molds, casting molds, injection molds, dies, extrusion dies, plates, baths, tables, grippers and clamps of all kinds, and many additional examples that are set forth within this specification, together with such similar elements as will be known to those having skill in the relevant arts and others yet to be invented.

[3] Workpiece Manipulation Modules comprise mechanisms, machine elements, and methods that move and orient material and/or workpieces within a machine, including but not limited to bar feeders, pumps, screws, robotic arms, pistons, shafts, plungers, grippers, rollers, chutes, inclined planes, indexes, actuators of all kinds, switches, relays, computers, software, ball screws, helical screws, rotary tables, collets, chucks, fluids and other mediums for delivering energy that results in movement of a workpiece or material, such as air, sound, magnetic flux, electromagnetism, gravity, sound waves, light, and many additional examples that are set forth within this specification, together with such similar elements as will be known to those having skill in the relevant arts and others yet to be invented.

[4] Workpiece Retrieval Modules comprise mechanisms, machine elements, and methods that retrieve a workpiece from a work holding module and/or remove the workpiece from the machine, optionally separating the workpiece from a base or from a remaining portion of raw material. Examples include but are not limited to cut-off blades, saws, bits, drills, chutes, grippers, collets, robotic arms, tubes, conveyors, air, liquids and flippers, and many additional examples that are set forth within this specification, together with such similar elements as will be known to those having skill in the relevant arts and others yet to be invented.

[5] Forming Operations Modules comprise mechanisms, machine elements, and methods that serve to alter the form of a workpiece through the application of force to induce plastic deformation of the workpiece, or in some other manner other than through simply adding or removing material. Examples include but are not limited to presses, dies, punches, spacers, molds, rollers, hammers, torque providers, and the like, together with such elements belonging to other modules as may additionally play a role in forming, such as collets and chucks when providing an opposing force, for example when used as a portion of a die or mold, or to anchor a workpiece that is undergoing any kind of deformation including by bending or by twisting, and many additional examples that are set forth within this specification, together with such similar elements as will be known to those having skill in the relevant arts and others yet to be invented.

[6] Additive Operations Modules comprise mechanisms, machine elements, and methods that add material to a workpiece, or that render a workpiece into a specific form or shape through accretion. Examples include but are not limited to 3D printing, welding, laser deposition, electron beam deposition, jet deposition, chemical vapor deposition, bioprinting, stereolithography, ultrasonic consolidation, and many additional examples that are set forth within this specification, together with such similar elements as will be known to those having skill in the relevant arts and others yet to be invented.

[7] Subtractive Operations Modules comprise mechanisms, machine elements, and methods that render a workpiece into a specific form or shape through removal of material from the workpiece. Examples include but are not limited to grinders, cutting heads, bits, drills, sanders, nozzles, water jets, lasers, electron beams, electricity, liquids, etching chemicals, punches, dies, shears, saws, air, sand, beads, liquids, lubricants, and many additional examples that are set forth within this specification, together with such similar elements as will be known to those having skill in the relevant arts and others yet to be invented.

[8] Transforming Operations Modules comprise mechanisms, machine elements, and methods that serve to temporarily or permanently transform properties of a workpiece. Examples include but are not limited to the addition or removal of energy by any means, the application of chemical substances, whether liquid, solid, or gaseous, the application of force for any purpose other to induce plastic deformation, the use of vacuum or gases at any pressure, and many additional examples that are set forth within this specification, together with such similar elements as will be known to those having skill in the relevant arts and others yet to be invented.

[9] LIMIT Operations Modules comprise mechanisms, machine elements, and methods that serve in locating, indexing, measuring, imaging, inspecting, and/or testing a workpiece or any attribute or portion thereof. Examples include but are not limited to cameras, computers, software, probes, DROs, actuators, ball screws, helical screws, magnetic readers, switches, relays, infrared sensors and emitters, LIDOR, microwaves, sound waves, radio waves, all spectrums of light, electromagnetic fields, pressure sensors, micrometers, calipers, scales, LEDs, measuring stops, timers, temperature sensors, stress sensors, other sensors, and many additional examples that are set forth within this specification, together with such similar elements as will be known to those having skill in the relevant arts and others yet to be invented.

[10] CCC Modules comprise mechanisms, machine elements, and methods that serve to regulate and/or control the operation of the machine and/or of each of its elements, modules, and functions, including but not limited to such functions as computing, communication, and machine control, including position control, orientation control, motion control, thermal control, material control, intake control, output control, activation, deactivation, level of action, sequence of action, and many additional examples that are set forth within this specification, together with such similar elements as will be known to those having skill in the relevant arts and others yet to be invented.

[11] Adjunct Material Handling Modules comprise mechanisms, machine elements, and methods that deliver, collect, recycle, or dispose of liquids, solids and gases used in the operation of a SCOFAST machine. For example, coolants may be applied to a tool or a workpiece, then retrieved, filtered, heated or cooled, and used again; material removed from a workpiece during a subtractive operation may be collected, cleaned and reintroduced back into a raw material provisioning operation; and gases used to displace air or used as a substrate in a transforming operation may be collected, refined, and re-used. Examples further include but are not limited to the many additional examples that are set forth within this specification, together with such similar elements as will be known to those having skill in the relevant arts and others yet to be invented.

A SCOFAST machine may comprise modules such as those shown in FIG. 1A and FIG. 1B in any number, combination, and arrangement, together with such additional other modules as may be desired or required in the performance of a desired combination of operations in a spatially coherent manner. The fact that a particular mechanism or function is not shown as a module does not exclude such a mechanism or function from participation in a SCOFAST machine operation. The fact that a particular mechanism or function is shown as a module does not require such a mechanism or function to exist or to participate in a particular SCOFAST machine operation.

SCOFAST machine modules may depend on certain machine elements for the accomplishment of the module function. For example, Forming Operations will require machine elements that deliver forces sufficient to cause plastic deformation of a workpiece along with other machine elements that receive such forces. Similarly, certain Transforming Operations will require machine elements that alter the energy content of a workpiece, and also machine elements that handle adjunct material participating in transforming operations.

FIG. 1B: Forming, Transforming, and CCC Elements

FIG. 1B shows examples of some machine elements required in forming (5), transforming (8), and CCC (10) operations. The elements shown are exemplary, and are not meant to restrict the numbers or types of machine elements that may be active in performing an operation within a SCOFAST machine. Any machine element may participate in any operation within a SCOFAST machine.

Force Generating Elements (5.1) comprise mechanisms, machine elements, and methods that apply force to a workpiece. Examples include but are not limited to presses, forges, screw drives, electric presses, hydraulic presses, pneumatic presses, gravity presses, combination presses, crank presses, dies, molds, hammers, any source of force as may be useful in the action of Forming Operations Modules, and many additional examples that are set forth within this specification, together with such similar elements as will be known to those having skill in the relevant arts and others yet to be invented.

Force Receiving Elements (5.2) comprise mechanisms, machine elements, and methods that receive, support, and transmit forces generated by modules such as Subtractive Operations Modules and Forming Operations Modules through the action of Force Generating Elements. Examples include but are not limited to headstocks, tailstocks, carriages, slides, spindles, machine bases, brackets, bearings, base plates, rollers, shafts, mounts, followers, steady rests, and many additional examples that are set forth within this specification, together with such similar elements as will be known to those having skill in the relevant arts and others yet to be invented.

Energy Handling Elements (8.1) comprise mechanisms, machine elements, and methods that serve to maintain or alter the energy content of a workpiece. Examples include but are not limited to gas torches, electric torches, ovens, infrared heaters, flame heaters, bath heaters and coolers, furnaces, lasers, radiation sources, sound sources, refrigerators, freezers, cooled liquids or gases, heated liquids or gases, vibrators, presses, pumps, and many additional examples that are set forth within this specification, together with such similar elements as will be known to those having skill in the relevant arts and others yet to be invented.

Materials Handling Elements (8.2) comprise mechanisms, machine elements, and methods that form part of the Adjunct Materials Handling Elements (11) and participate in a transforming operation. Examples include sprayers, jets, nozzles, collectors, pumps, reservoirs, filters, purifiers, field generators, powder coaters, plasma generators, gas control systems, vacuum systems, high pressure systems, ion generators, and many additional examples that are set forth within this specification, together with such similar elements as will be known to those having skill in the relevant arts and others yet to be invented.

Computing Elements (10.1) comprise processors, computer programs, algorithms, interfaces, analog computing elements, digital computing elements, calculating engines, image processors, pattern recognition systems, analog to digital converters, digital to analog converters, program storage mechanisms, data storage mechanisms, cloud storage devices, cloud-based processing systems, local computing systems, remote computing systems, mobile computing systems, quantum computing systems, GUI and non-gui interfaces, and additional examples that are set forth within this specification, together with such similar elements as will be known to those having skill in the relevant arts and others yet to be invented.

Communications Elements (10.2) comprise wired communications systems, wireless communications systems, network communications systems, point-to-point communications systems, broadcast communications systems, distributed communications systems, electronic communication systems, biological communications systems, neuronal communications systems chemical communication systems, photonic communication systems, quantum communication systems, switches, routers, firewalls, packet inspectors, protocols, and additional examples that are set forth within this specification, together with such similar elements as will be known to those having skill in the relevant arts and others yet to be invented.

Machine Control Elements (10.3) comprise mechanical controls, electronic controls, analog controls, digital controls, switches, sensors detecting or measuring any physical, chemical, or biological state or change of state, cams, actuators, valves, flow controls, pressure controls, current controls, voltage controls, thermal controls, motion controls, position controls, force controls, power controls, speed controls, distance controls, time controls, and additional examples that are set forth within this specification, together with such similar elements as will be known to those having skill in the relevant arts and others yet to be invented.

FIG. 1C: CCC Module Interactions

FIG. 1C illustrates typical interactions involving CCC Module elements. CCC Elements may interact with a wide variety of internal and external elements and systems, including any elements within a SCOFAST machine, other SCOFAST machines, other non-SCOFAST machines, external computer systems, software programs, internal and external data storage systems, cloud-based systems, storage resources, computing resources, data resources, information resources, equipment resources, mobile devices, external communications systems, wired and wireless communications systems, internal and external network systems, local and wide area networks, GUI and non-GUI consoles, artificial intelligences, human-machine interfaces, brain-machine interfaces, biological systems, chemical systems, and additional examples that are set forth within this specification, together with such similar elements as will be known to those having skill in the relevant arts and others yet to be invented.

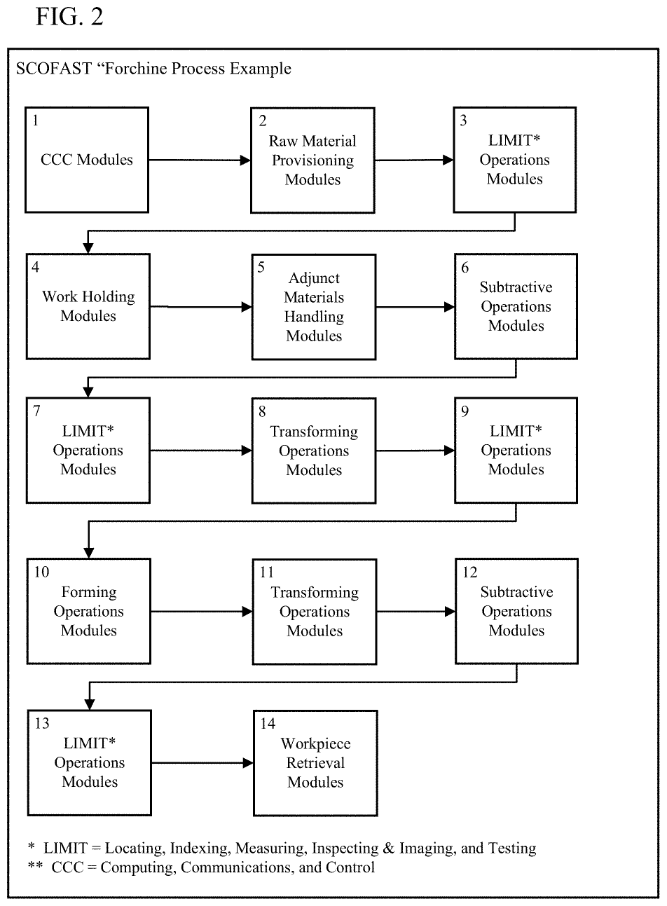

FIG. 2: SCOFAST Example: Spatially Coherent Forging and Machining in a “Forchine”

FIG. 2 illustrates a manufacturing process performed by a sequence of operations within a SCOFAST machine. In this example the SCOFAST machine is a forging and machining “Forchine” that comprises the functionality of a forging machine together with that of a turret lathe in a single spatially coherent SCOFAST machine. The operation illustrated is the complete automated manufacture of a precision titanium alloy bolt from barstock by forging a head and then machining the remainder of the bolt and treating the bolt to adjust its material properties, without removing the bolt from the machine workholder.

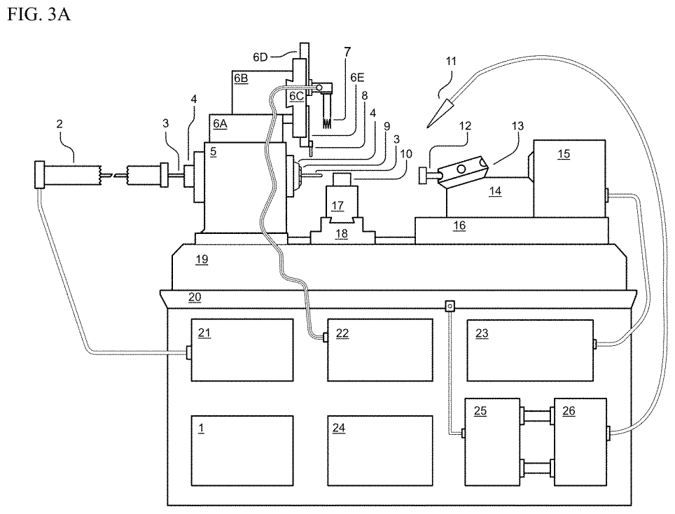

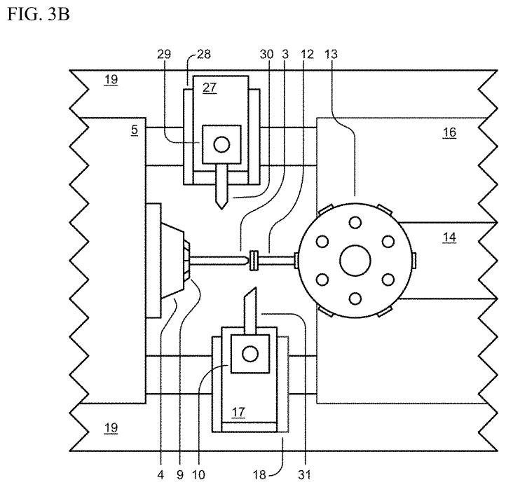

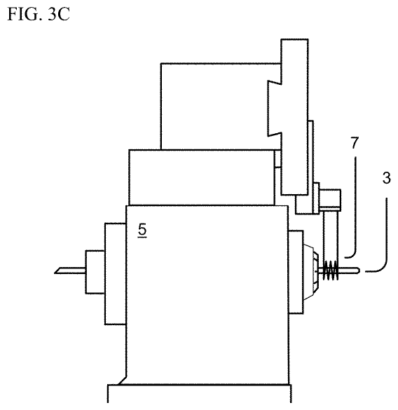

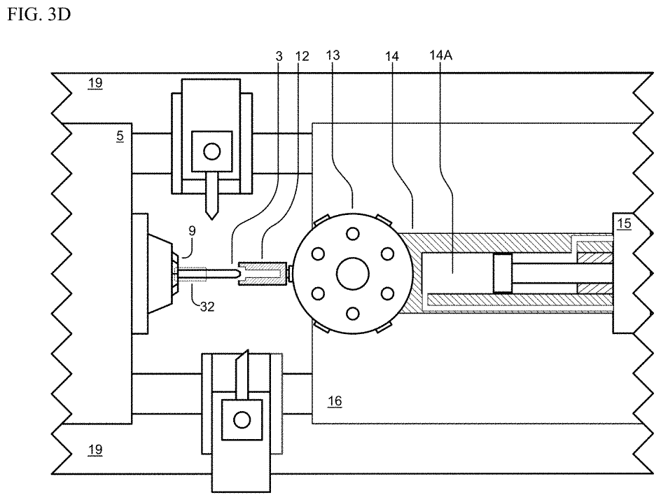

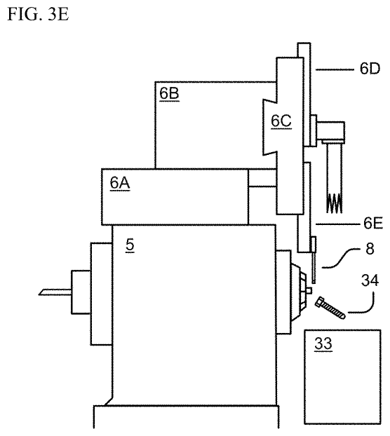

FIG. 3A, 3B, 3C, 3D, 3E: SCOFAST “Forchine” Embodiment for Manufacture of a Titanium Bolt

These figures show an example of a physical embodiment of a simple SCOFAST machine instantiated as a forchine that is used to manufacture a precision bolt through a combination of forging, machining, and transforming operations. The geometry of this SCOFAST machine embodiment is similar to that of a traditional horizontal turret screw machine lathe, with the modification of certain traditional elements and the addition of new machine elements enabling forging, machining, and transforming operations to be performed in a spatially coherent manner.

FIG. 3A: Forchine Front View

FIG. 3A is a front view of a Forchine embodiment. FIG. 3A illustrates the following components as indicated by the associated reference numerals:

[1] Control & communications module.

[2] Pneumatic barstock feeder.

[3] Barstock.

[4] Workholding spindle (“Spindle”).

[5] Headstock containing spindle bearing mounts, spindle bearings, and spindle drive (not shown).

[6] Upper Tool Positioner.

[6A] Upper Tool Positioner Base.

[6B] Upper Tool Positioner Z-axis slide.

[6C] Upper Tool Positioner X-axis slide.

[6D] Upper Tool Positioner Y-axis slide 1 with toolholder holding induction heating coil.

[6E] Upper Tool Positioner Y-axis slide 2 with toolholder holding cutting tool.

[7] Induction heating coil.

[8] Cutting tool.

[9] Workholding collet (“Collet”) held in nose of spindle.

[10] Front cross slide toolholder.

[11] Hose and nozzle for delivery of machining and/or treatment fluids.

[12] Tool mounted on turret tool bonnet.

[13] Turret tool bonnet capable of holding multiple tools including indexers, forging dies, threaders, machining tools, measuring devices, and other tools.

[14] Tool turret slide containing one or more hydraulic cylinders.

[15] Tool turret base

[16] Tool turret carriage.

[17] Front cross slide.

[18] Front cross slide carriage.

[19] Forchine bed and frame.

[20] Machining fluid collection tray.

[21] Pneumatic pump for barstock feeder.

[22] Induction heating system.

[23] Hydraulic pump for hydraulic machine operations including forging operations.

[24] Other Forchine elements.

[25] Recovery and recycling system for machining fluid.

[26] Pump for machining and/or treatment fluid.

FIG. 3B: Top View Showing Certain Elements During an Indexing Operation.

FIG. 3B is a top schematic view of certain elements of the forchine shown in FIG. 3A, including the headstock, too turret, and front and rear cross-slides. The top slide assembly [6A-6E], induction heating coil [7], and tool [8] have been removed to better expose elements of interest. FIG. 3B illustrates the following components as indicated by the associated reference numerals:

[3] Barstock “Workpiece” protruding from collet.

[4] Spindle nose.

[5] Headstock.

[9] Collet.

[10] Front cross slide toolholder

[12] Indexing tool in turret bonnet toolholder.

[13] Turret bonnet.

[14] Turret slide advanced toward workpiece for indexing.

[16] Turret carriage.

[17] Front cross slide.

[18] Front cross slide carriage.

[19] Forchine bed and frame.

[27] Rear cross slide

[28] Rear cross slide carriage.

[29] Rear cross slide tool holder.

[30] Tool in rear cross slide tool holder.

[31] Tool in front cross slide tool holder

FIG. 3C: Front View Detail Showing Coil in Position for Heating the Workpiece

FIG. 3C is a forchine partial front view detail of headstock [5] showing the induction heating coil [7] in position over the workpiece [3] during an operation involving heating a zone of the workpiece. FIG. 3C illustrates the following components as indicated by the associated reference numerals:

FIG. 3D: Top View after Heating at Start of Forging Operation

FIG. 3D is a forchine top view detail early in a forging operation. The dashed line [32] indicates the heated zone of the workpiece [3]. A portion of the heated zone is inside the collet. Tool [12] is a forging die cut away to show the die cavity. Forging die [12], turret slide [14, cutaway] and turret bonnet [13] are moving toward the collet, driven by one or more hydraulic cylinders [14A] located within the turret slide and having a piston shank anchored to the tool turret base [15]. At the end of movement, the forging die will close completely against collet [9].

FIG. 3E: Front View of Forchine Showing Part Cutoff and Retrieval Slide

FIG. 3E is a front view of the Forchine during a part retrieval operation. Forged, machined, and threaded bolt [34] is cut away from the barstock by cutoff tool [8] in top tool slide [6]. Part retrieval slide [33] comes forward to receive the finished part.

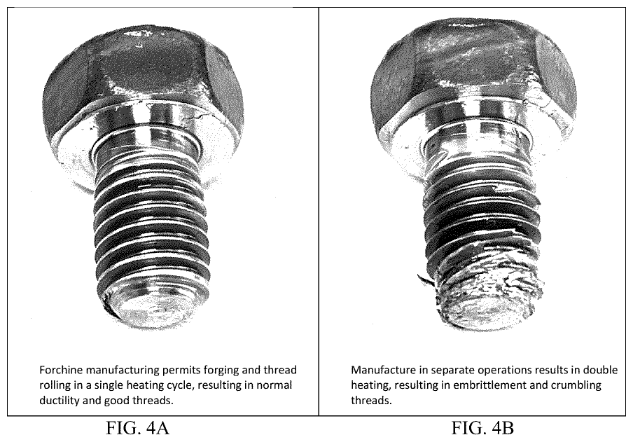

FIGS. 4A, 4B Single Vs Double Heating During Manufacture of a Ti-6Al-4V Bolt

FIGS. 4A and 4B are photographs illustrating a titanium alloy bolt with hexagonal head that was manufactured in a SCOFAST machine configured to perform hot forging and machining. Photograph [A] shows a bolt that was heated just once and has good threads. Photograph [B] shows a bolt manufactured in the same manner except that the barstock material was heated twice, resulting in brittle and crumbling threads. This illustrates the fact that certain operations can be performed successfully when combined in a SCOFAST machine but cannot be performed successfully separately.

FIG. 5A, 5B, 5C: Increasing Axial Load Capacity with Thrust Bearings

FIGS. 5A-C are cutaway views of one example of a forchine headstock together with schematic views of examples of spindle bearing augmentation to increase axial loading capacity. The ordinary spindle bearings shown in FIG. 5B are designed primarily to support radial and moment loads. Their ability to support axial forces such as may be involved in forging, pressing, and other forming operations depends on the bearing size, type, and material. Deep channel bearings may support up to 60% of rated radial loads in the axial direction. Other precision bearing types may support only minimal axial loads.

If a spindle will receive high axial loads during forming operations in a SCOFAST machine, spindle bearing designs intended for radial loads may need to be upgraded in size, type, or material to handle the higher axial loads. Alternatively, thrust bearings may be added to handle axial forces. Two types of preloaded thrust bearings are shown fitted at spindle nose and spindle tail in FIG. 5C.

FIG. 5A: Cutaway View of Forchine Headstock

FIG. 5A is a cutaway view of an actual forchine headstock. This forchine is based on a screw lathe, and the spindle shown is capable of withstanding axial loads up to 60% of the rated radial loads. In order to perform operations creating axial loads greater than 60% of the rated radial loads, axial forces must be redirected or spindle support must be augmented in some manner. FIG. 5A illustrates the following components as indicated by the associated reference numerals:

[1] Spindle tail

[2] Spindle nose

[4] Rear spindle bearing

[5] Front spindle bearing

FIG. 5B: Spindle Bearing Support Before Augmentation

FIG. 5B is a cutaway view of a spindle mount showing an ordinary arrangement of spindle bearings and spindle. FIG. 5B illustrates the following components as indicated by the associated reference numerals:

[1] Spindle tail

[2] Spindle nose

[3] Spindle mount

[4] Rear spindle bearing

[5] Front spindle bearing

FIG. 5C: Spindle Bearing Support with Two Types of Augmentation

FIG. 5C is a cutaway view of a spindle mount illustrating examples of the addition of thrust bearings at the spindle nose and at the spindle tail. FIG. 5C illustrates the following components as indicated by the associated reference numerals:

[1] Spindle tail

[2] Spindle nose

[3] Spindle mount

[4] Rear spindle bearing

[5] Front spindle bearing

[6] Front preload adjustment shim

[7] Front thrust bearing base plate secured to spindle mount

[8] Front thrust bearing secured to spindle

[9] Rear preload adjustment shim

[10] Rear thrust bearing base secured to spindle mount

[11] Rear thrust bearing secured to spindle

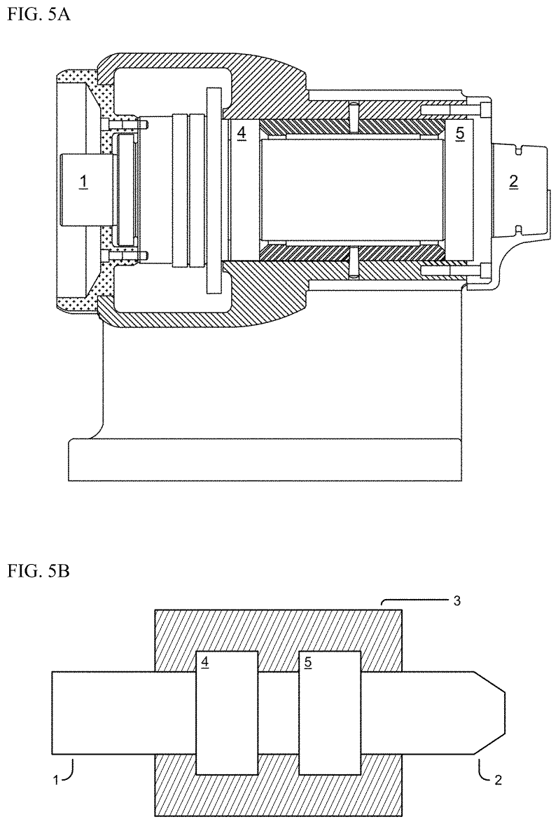

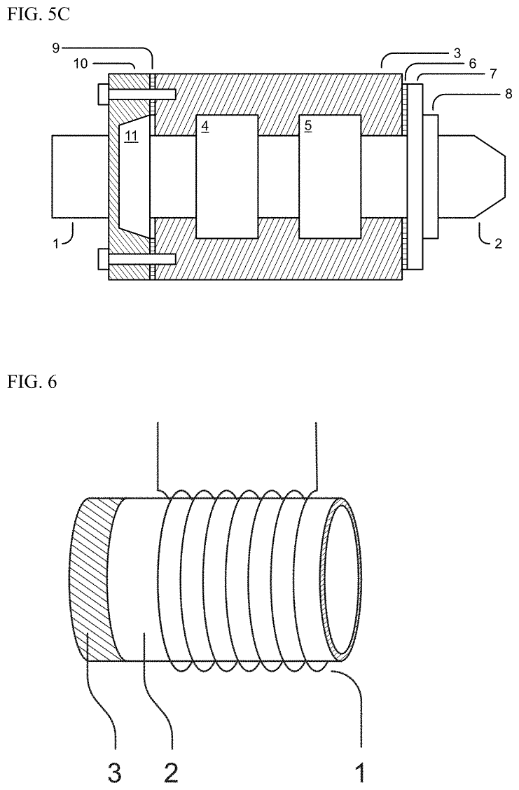

FIG. 6: Induction Heating Coil Detail Showing Internal Insert

FIG. 6 is a detail view of an induction heating coil [1] illustrating a sleeve [2] within the coil. The coil may consist of solid wire or of hollow tubing made of a conductive substance and having any cross-sectional shape (not shown). Cooling liquid may be passed through the coil tubing by a coolant pump system (not shown). The internal sleeve comprises a ceramic or any other material or combination of materials selected to achieve desired properties such as wear resistance, temperature resistance, thermal expansion properties, and/or any other property. The sleeve may also include metallic elements capable of altering the electromagnetic field pattern produced by the coil. The size of the inner opening of the sleeve is selected to maintain a desired standoff (coupling) distance between coil and workpiece. When the coil is placed in position over a workpiece, an optional flange [3] may make contact with the collet (or other workholding device) that secures the workpiece. The flange may be constructed so as to make a partial or complete seal against the collet. It may be made of the same substance as the sleeve or of a different substance. FIG. 6 illustrates the following components as indicated by the associated reference numerals:

[1] Coil

[2] Internal sleeve

[3] Flange

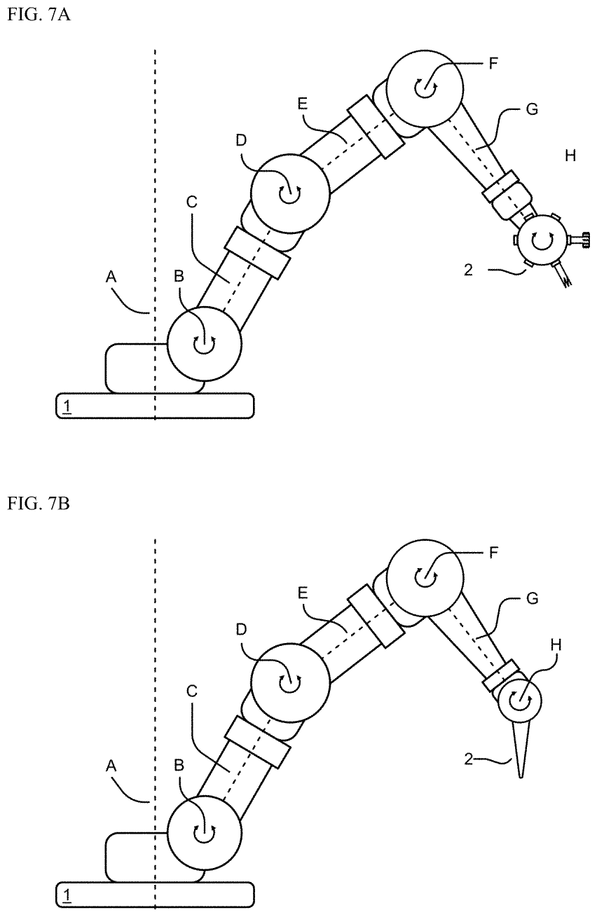

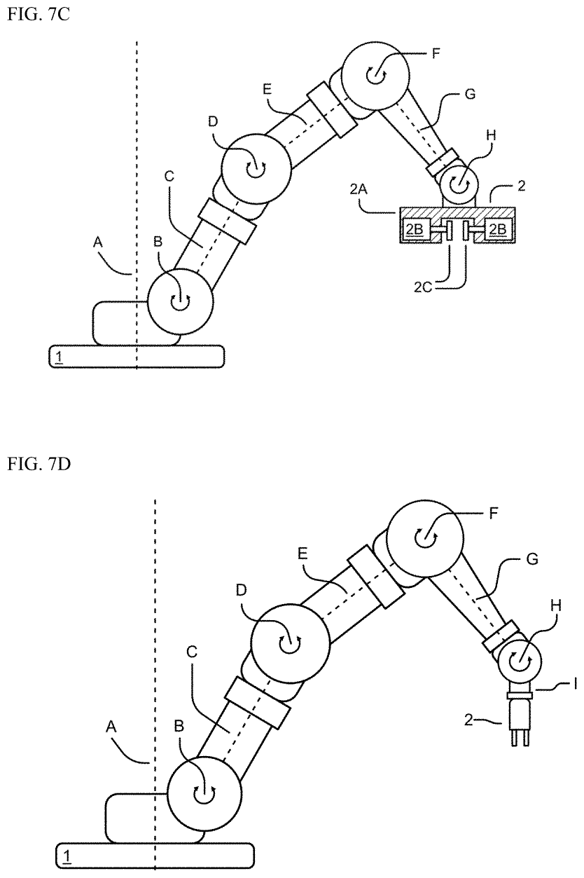

FIG. 7A, 7B, 7C, 7D: Robotic Arm

FIGS. 7A-D are examples of a multi-axis robotic arm such as may comprise an element within a SCOFAST machine. Label [1] indicates the base of the arm. The base may be aligned and secured to another element of a SCOFAST machine in a known spatial relationship, maintaining spatial coherence as the arm moves relative to the base. Labels [A-H] indicate axes of movement. Label [A] indicates rotation around an axis normal to the base, shown as a dotted line. Labels [C], [E], and [G] each indicate rotation around the longitudinal axis of a different arm segment, each axis being shown as a dotted line. Labels [B], [D], [F], and [H] each indicate rotation around an axis perpendicular to the longitudinal axis of the immediately proximal arm segment. With the robotic arm in the position shown, each of the rotational axes [B], [D], [F], and [H] are aligned perpendicular to the plane of the page. Label [2] indicates the terminal appendage.

FIG. 7A: Robotic Arm with Terminal Appendage as Multi-Tool Holder

FIG. 7A shows a robot arm with a terminal appendage in the form of a multi-tool holder capable of holding active tooling used in subtractive operations. FIG. 7A illustrates the following components as indicated by the associated reference numerals:

[A-H] Rotational axes

[1] Robotic arm base secured to SCOFAST machine frame

[2] Terminal appendage as active tooling with induction coil and milling tool installed

FIG. 7B: Robotic Arm with Terminal Appendage as Spray Welder

FIG. 7B shows a robotic arm with the terminal appendage in the form of a spray welder used to deposit layers of metal in additive operations. FIG. 7B illustrates the following components as indicated by the associated reference numerals:

[A-H] Rotational axes

[1] Robotic arm base secured to SCOFAST machine frame

[2] Terminal appendage as additive spray welding tool

FIG. 7C: Robot Arm with Terminal Appendage as Forming Press

FIG. 7C shows a robotic arm with the terminal appendage in the form of a C-arm forming press used in forming operations. Since the robotic arm can place the press in virtually any position and orientation, forming operations may be performed in virtually any axis. FIG. 7C illustrates the following components as indicated by the associated reference numerals:

[A-H] Rotational axes

[1] Robotic arm base secured to SCOFAST machine frame

[2] Terminal appendage as a forming press

[2A] Press frame

[2B] Force generators and receivers (e.g., hydraulic cylinder or electrical screw drive)

[2C] Forming dies

FIG. 7D: Robot Arm with Terminal Appendage as Tool Changer

FIG. 7D shows a robotic arm with the terminal appendage in the form of a gripper and tool changer used to move tools between and among tool holders, spindle collets, other toolholding and workholding elements, and tool supply racks. The terminal appendage may be equipped with any type of holding device, such as a vacuum gripper, or any number of “digits” that may be moved together and apart to grip and hold tools and parts securely. Virtually any tool may be installed by the robotic arm through the use of quick-change tool holders and collets. The arm may also function to pick off parts during cutoff, to grip and flip parts in a collet or other workholding device, and to perform other similar functions that will be obvious to those having ordinary skill in the relevant arts. FIG. 7D illustrates the following components as indicated by the associated reference numerals:

[A-I] Rotational axes

[1] Robotic arm base secured to SCOFAST machine frame

[2] Terminal appendage as a tool changer/gripper

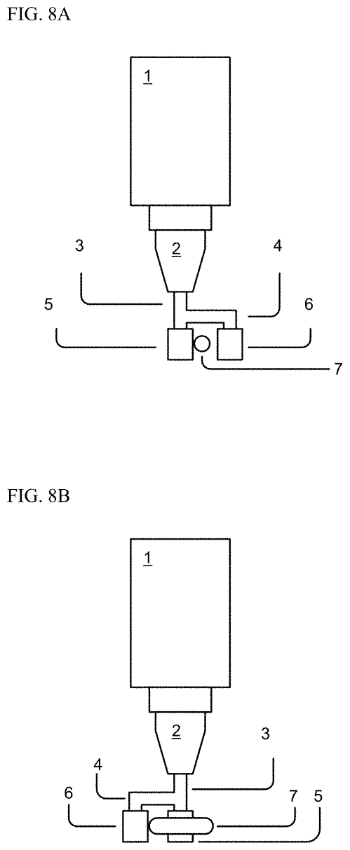

FIGS. 8A, 8B Active Tool for Bending Barstock. Z-Axis View Towards Barstock

An example of active tooling used for bending that can be fitted to any axis of a SCOFAST machine and brought to bear on a workpiece by moving from a rest position towards the workpiece into a working position. The figure shows a view along the central axis of the workholding spindle looking towards the workpiece. In the position shown, the tooling is mounted on an overhead slide directly over the main workholding spindle. The position shown could also represent tooling mounted on a secondary z-axis slide. If the tooling were mounted on a cross slide then the figure would be rotated 90 degrees or 270 degrees. If the tooling were mounted on a bottom slide then the figure would be rotated 180 degrees and the entire tool would come up from below the workpiece. FIGS. 8A-B illustrate the following components as indicated by the associated reference numerals:

[1] Tool spindle high torque motor

[2] Toolholder mechanism

[3] Central shaft

[4] Bending arm [5]

[5] Central shaft roller [4]

[6] Bending arm roller

[7] Barstock

FIG. 8A: Before Bending Operation

The tool has been moved into position over the workpiece, with the central shaft roller (5) just touching the workpiece (7) and the bending arm roller (6) making no contact.

FIG. 8B: After Bending Operation

Here the tool spindle motor (1) has been activated and has rotated the central shaft (3), bringing the bending arm roller (6) into contact with the workpiece (7) and delivering sufficient torque to bend the workpiece around the central shaft roller (5).

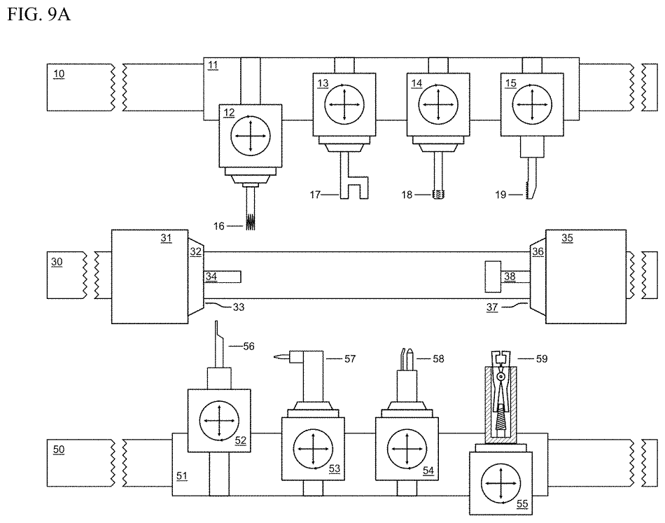

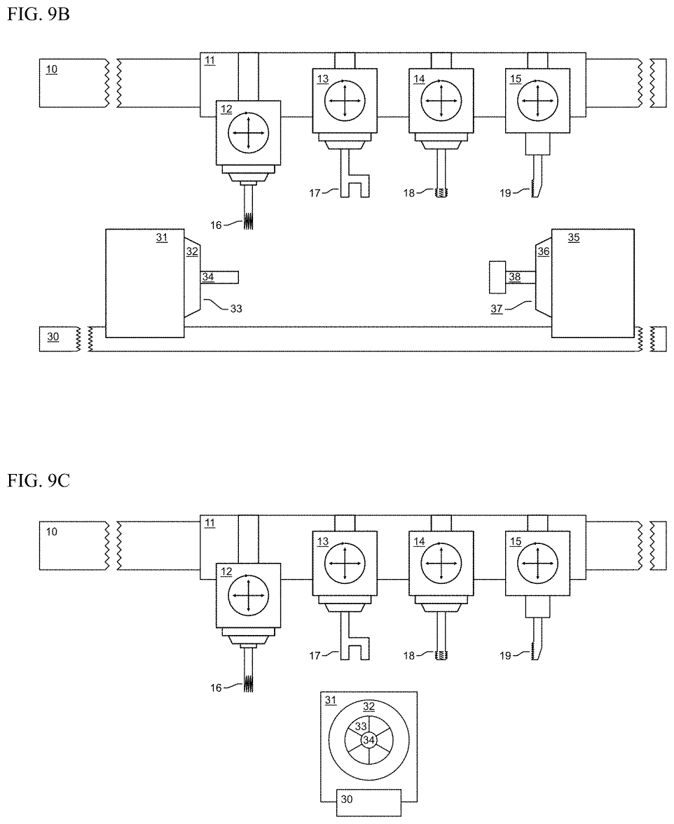

FIG. 9A, 9B, 9C: Carriage and Gantry Tooling

Examples of multi-axis SCOFAST machine embodiments configured with exemplary active and fixed tooling geometries are shown in FIGS. 9A-C. The axis of the main (workholding) spindle is the Z-axis, which lies in the horizontal plane. The horizontal axis perpendicular to the Z-axis is the X-axis, and the vertical axis is the Y-axis. In these embodiments one tool from each tool carriage can be simultaneously brought to bear on the workpiece. Each tool can be positioned in X, Y, and Z axes with respect to the workpiece, and each tool can additionally be rotated around a tool-specific A axis that provides yaw with respect to the tool and around a tool-specific B axis that provides pitch with respect to the tool. Each active tool can additionally spin around the axis of its respective spindle, providing roll with respect to the tool. A workpiece can also be rotated around the Z-axis and the entire workholding main spindle carriage may be moved in the Z-axis. Each active or fixed tool can thus be brought to bear upon a workpiece at any point and at any arbitrary relative angle.

FIG. 9A: Top View of Dual Longitudinal Bed Rail Carriage Tooling in a SCOFAST Machine

Top-down view that illustrates an embodiment comprising a longitudinal bed rail cross-slide carriage geometry. In this geometry two main spindles are configured such that one or both of the left and right main spindle carriages move along the Z-axis. In addition to all the usual multi-axis machining operations, each main spindle carriage can deliver and receive sufficient force in the Z-axis to accomplish a wide range of advantageous forging operations. Front and rear cross-slide carriages also move parallel to the z-axis to position a variety of active and passive tooling for desired SCOFAST operations.

FIG. 9B: X-Axis View of Longitudinal Overhead Gantry Tooling in a SCOFAST Machine

Example of a longitudinal overhead gantry geometry. In a longitudinal overhead geometry label [10] indicates the gantry and label [11] indicates an overhead gantry carriage. Labels are otherwise identical to those for a longitudinal bed rail geometry as shown in FIG. 9A. Any number of active and passive toolholders may be mounted on such a gantry, and tools may be changed on the fly using tool-changing modules. More than one gantry may exist. Each gantry may move in the X-axis direction, while tool carriage [11] moves in the Z-axis direction along the gantry.

FIG. 9C: Z-Axis View of Transverse Overhead Gantry Tooling in a SCOFAST Machine

Example of a transverse overhead gantry geometry. In a transverse overhead geometry label [10] indicates the gantry and label [11] indicates an overhead gantry carriage. Labels are otherwise identical to those for a longitudinal bed rail geometry as shown in FIG. 9A.

The examples shown are merely illustrative of a single class of rectilinear geometries; it will be apparent to those having ordinary skill in the arts that many other geometries are possible and that elements of the illustrated geometries may be instantiated together with each other and with elements representing other geometries, in any number and combination. Multiple gantries and rails may be used and tool-changing modules may be incorporated if desired. FIGS. 9A-C illustrate the following components as indicated by the associated reference numerals:

[10] Rear bed rail (A)/Overhead gantry (B, C)

[11] Rear tool carriage (A)/Gantry tool carriage (B, C)

[12] Tool spindle

[13] Tool spindle

[14] Tool spindle

[15] Tool spindle

[16] Induction heating coil

[17] Bending tool

[18] Milling tool

[19] Sawing tool

[30] Center bed rail

[31] Left main spindle carriage

[32] Left main spindle

[33] Left main spindle collet

[34] Workpiece

[35] Right main spindle carriage

[36] Right main spindle

[37] Right main spindle collet

[38] Forging die

[50] Front bed rail

[51] Front tool carriage

[52] Tool spindle

[53] Tool spindle

[54] Tool spindle

[55] Tool spindle

[56] Cutting tool

[57] 3D printhead tool

[58] Spray welding tool

[59] Double-action die forging/swaging tool

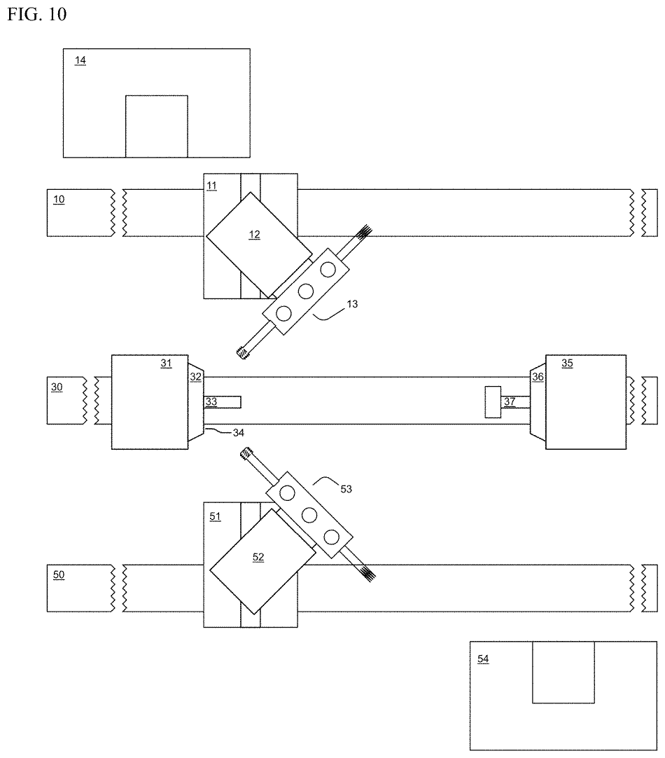

FIG. 10: Overhead View of SCOFAST Machine with Dual Multi-Axis Rotary Active Toolholders and Tool Changing Towers

FIG. 10 is a top view of a SCOFAST machine geometry configured with dual workholding spindles, dual multi-axis active toolholders, and dual toolchanging tool management towers. Other SCOFAST-LIMIT machine elements are shown elsewhere. It will be evident to one having ordinary skill in the art that the general geometric relationships illustrated here in a horizontal bed are equally relevant to a flat-bed, slant-bed, vertical-bed, or other machine frame. FIG. 10 illustrates the following components as indicated by the associated reference numerals:

[10] Rear bed rail

[11] Rear tool carriage

[12] Tool spindle motor

[13] Powered toolholder for active and passive tools

[14] Rear tool management tower/tool changer

[30] Center bed rail

[31] Left main spindle carriage

[32] Left main spindle

[33] Workpiece

[34] Left main spindle collet

[35] Right main spindle carriage

[36] Right main spindle

[37] Forging die

[50] Front bed rail

[51] Front tool carriage

[52] Tool spindle motor

[53] Powered toolholder

[54] Front tool management tower/tool changer

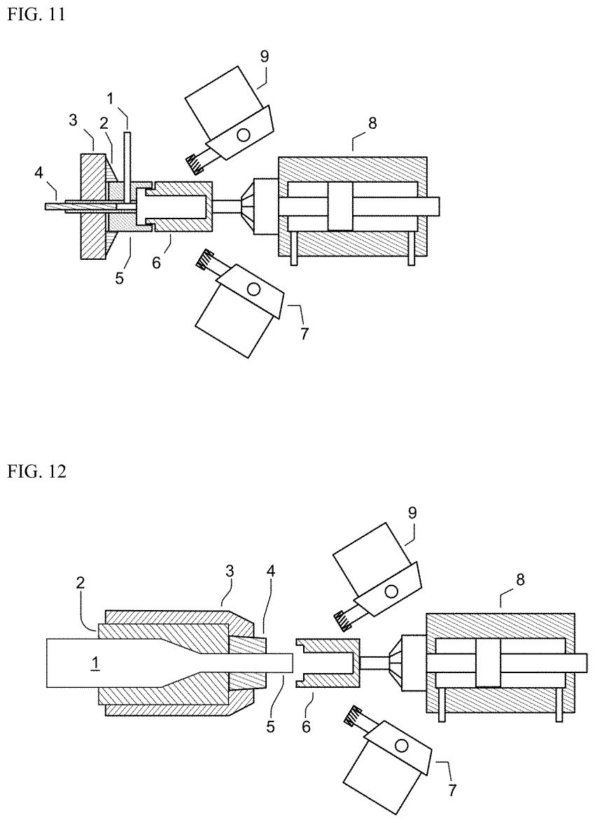

FIG. 11: Casting, Forging, and Milling in a SCOFAST Machine

FIG. 11 shows a schematic cutaway representation of certain elements of a SCOFAST machine that is configured to perform spatially coherent casting, forging, and machining. FIG. 11 illustrates the following components as indicated by the associated reference numerals:

[1] Feed tube for molten casting material

[2] Collet

[3] Turning Spindle

[4] Casting compression ram

[5] Die base held in turning spindle collet

[6] Die body held in forging collet in secondary workholding spindle

[7] Active tooling with milling head

[8] Hydraulic forging ram

[9] Active tooling with milling head

FIG. 12: Extrusion, Forging, and Milling in a SCOFAST Machine

FIG. 12 is a schematic cutaway representation of certain elements of a SCOFAST machine that is configured to perform spatially coherent extrusion, forging, and machining. FIG. 12 illustrates the following components as indicated by the associated reference numerals:

[1] Billet of material being extruded

[2] Extrusion die

[3] Spindle

[4] Collet

[5] Extruded workpiece

[6] Forging die

[7] Active tooling with milling head

[8] Hydraulic forging ram

[9] Active tooling

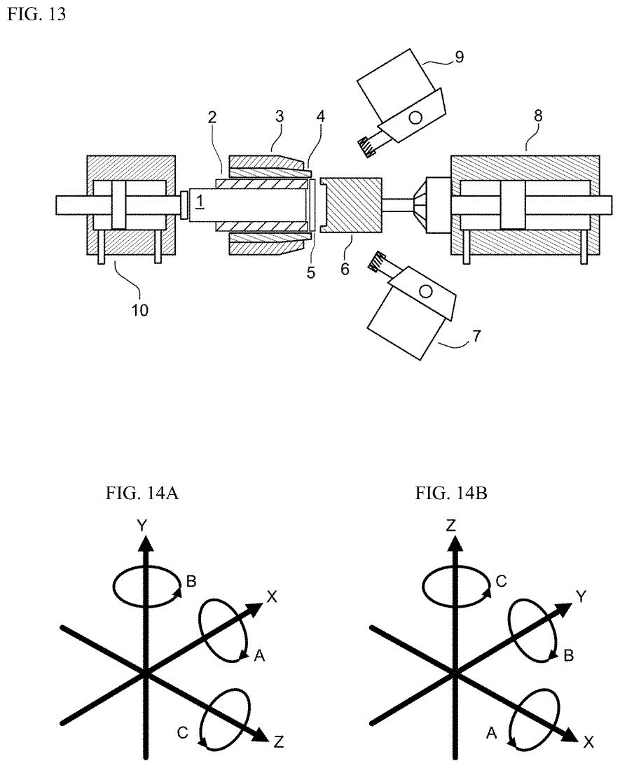

FIG. 13: Punch Forming and Machining in a SCOFAST Machine

FIG. 13 is a schematic cutaway representations of certain elements of a SCOFAST machine that is configured to perform spatially coherent punch forming and machining. FIG. 13 illustrates the following components as indicated by the associated reference numerals:

[1] Forming punch

[2] Clamping sleeve

[3] Spindle

[4] Collet

[5] Workpiece

[6] Punch forming die

[7] Machining tool head

[8] Hydraulic press

[9] Machining tool head

[10] Hydraulic punch press

FIGS. 14A and 14B: Common Machining Axes.

FIG. 14A shows one common conventional designation for the axes of a horizontal machining center, such as a screw machine or a turret lathe. Axis Z is the main workholding spindle axis, Axis Y is vertical, and axis X is perpendicular to a plane defined by axis Y and axis Z. Axes A, B, and C are rotational axes defined by the right-hand rule with respect to X, Y, and Z. FIG. 14B similarly shows one common conventional designation for the axes of a vertical machining center, such as a conventional mill. In this case the vertical axis is referred to as axis Z, while the X and Y axes are orthogonal and define a plane perpendicular to the Z axis.

FIGS. 15A and 15B: Positioning Error Components for Axes of Motion

FIGS. 15A-B illustrate the six error components that exist for each motion axis in a multi-axis machine. FIG. 15A shows the error components for a linear axis and FIG. 15B shows the error components for a rotary axis.

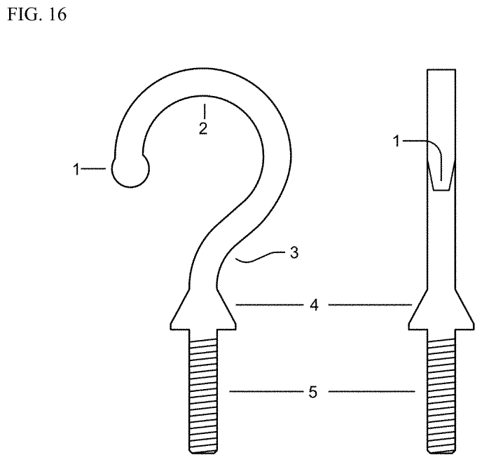

FIG. 16: Hook with Forged, Machined, and Bent Features; Side and Front Views

FIG. 16 shows side and front views of a simple part that is difficult or expensive to make using traditional discrete machinery, but is easily and inexpensively manufactured using a SCOFAST machine comprising forging, bending, and machining functions. The part is a screw hook having an inner curve [2] and an outer curve [3] with a uniform diameter for the body of the hook (the “base diameter”), a threaded shaft [5] that is slightly smaller than the base diameter, a chisel nose [1] that is larger in one dimension than the base diameter and tapered in another dimension, and a flared base flange [4] that is radially larger than the base diameter along its entire length. FIG. 16 illustrates the following components as indicated by the associated reference numerals:

[1] Chisel nose

[2] Inner curve of hook body

[3] Outer curve of hook body

[4] Flange

[5] Threaded shaft

FIG. 17: Measured Stress-Strain Curves for Ti-6Al-4V Alloy, by Temperature and Strain Rate \acute{ε}

Experimentally measured stress-strain curves for the most commercially important alloy of titanium across a range of temperatures and at a range of strain rates are shown in FIG. 17. Curves such as these are measured empirically for each material to be formed, permitting configuration of a SCOFAST machine for each operation to be performed and informing the design of SCOFAST machines to suit a range of operations. This material is from Gao et al., 2018, which is here incorporated by reference.

FIG. 18: Measured Stress-Strain Curves for Ti-6246 Deformed at a High Strain Rate of 25 Per Second

FIG. 18 shows an empirical stress-strain curve for an important titanium alloy measured across a range of temperatures at a single strain rate.

FIG. 19: Stress-Strain Diagram for a Material

FIG. 19 is a generic stress-strain diagram. The vertical axis is the force (stress) that produces the elongation or compression (strain) on the horizontal axis. P is the proportionality limit. E is the elastic limit, above which a permanent deformation will persist. Y is the yield point, above which plastic deformation increases significantly with small increases in stress. F is the fracture point.

FIG. 20: Equipment Variables and Process Variables in Forging

Some of the interrelationships between and among manufacturing processes and machine variables describing the performance requirements and specifications of a SCOFAST machine are shown in FIG. 20.

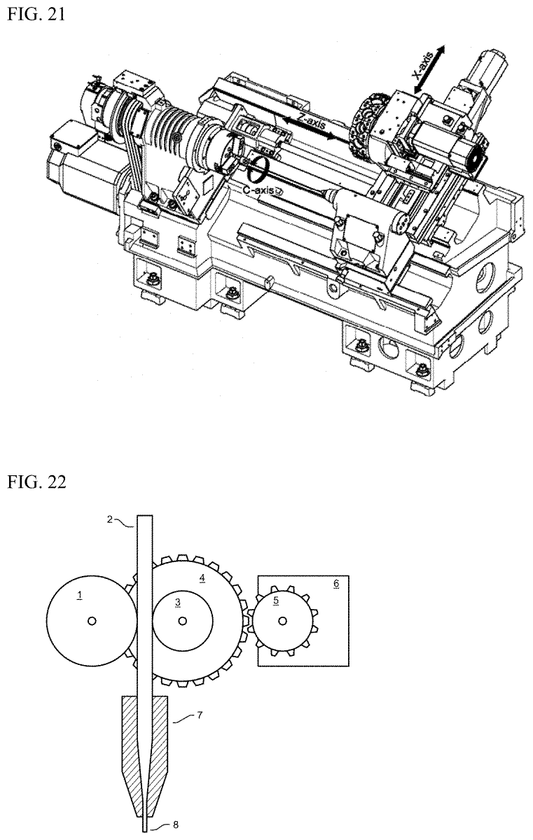

FIG. 21: Exemplary Alternate SCOFAST Forchine Geometry with Axes Labeled

A preferred exemplary SCOFAST (Forchine) machine geometry having multi-axis control and active tooling is shown in FIG. 21.

FIG. 22: Filament Extrusion Mechanism.

FIG. 22 illustrates a mechanism for feeding a bar or filament through a heating head to extrude molten material. FIG. 22 illustrates the following components as indicated by the associated reference numerals:

[1] Filament bearing roller

[2] Filament

[3] Filament drive wheel

[4] Drive wheel main gear

[5] Stepper motor gear

[6] Stepper motor

[7] Heating head

[8] Liquified filament being extruded

FIG. 23: Examples of Common Bearing Types

Examples of several common bearing types that may advantageously be used to distribute and transmit forces while permitting rotation of elements within a SCOFAST machine are shown in FIG. 23.

Advantages of the System and Method

The advantages of the system and method will be apparent to those having ordinary skill in the relevant arts, since they serve to mitigate a number of longstanding problems that arise whenever the manufacture of a part requires that several different operations be performed on different machines.

When two operations are performed on a workpiece that has been moved between two different independent machines, the workpiece features produced will invariably exhibit a loss of concentricity, coaxiality, colinearity, along with angular errors and other geometric errors that accumulate in proportion to the number of axes involved. When the operations are not performed in two independent machines but are instead integrated into a SCOFAST machine, the various machine elements are aligned and calibrated within a common workspace and act upon a workpiece held in a common workholder at a deterministic location and orientation within that workspace. The result in the latter case is guaranteed to be different at least in the precision that can be met across operations. Among other things, coaxiality is assured, thus concentricity error can be minimized. Careful measurement and inspection of manufactured parts permits us to distinguish between those that were made by means of operations integrated within a SCOFAST machine and parts that were made by means of independent operations performed separately in different machines.

The combination of operations in a spatially coherent manner within a SCOFAST machine produces a new and useful result due to the joint and cooperating action of all the elements. This result is not the mere adding together of separate contributions: the relevant operations are integrated together so that they are performed in a manner that achieves improved spatial coherence, improved temporal control (operations can be performed in more rapid sequence), and improved environmental uniformity. The vital union of operations in a SCOFAST machine enables certain results that are a product of the combination and cannot be achieved if the operations are not combined.

A principal advantage is that overall manufacturing costs are reduced when precision parts can be forged and machined together in a single combined set of operations, maintaining precision because the part is continuously held in a spatially coherent context without being dismounted and moved to other machines for secondary operations. Part features can be additively deposited, forged or otherwise formed, then machined and finished to a fully finished condition, and finally inspected all in a single unified SCOFAST machine.

Another advantage is that waste is reduced because part features can be forged to a larger dimension before being machined and finished. This allows the use of material stock significantly smaller than the largest forged feature dimension. The amount of waste material that must be removed is thus much reduced compared to a part that must be made entirely through machining, in which case the stock must exceed the largest dimension of the finished part and all the rest must be cut away.

Another advantage is that labor and equipment costs are reduced compared to manufacturing using separate machines because there is no longer any need to remove parts from one machine, transport them to another machine, load them, and re-index them in order to perform each additional operation of a different type. Furthermore, fewer machines means fewer costly and time-consuming machine setups. The overall savings in labor costs may be substantial, particularly if additional machine operators would be required to operate multiple machines.

Another advantage is that spatial coherence (precise three-dimensional alignment and registration of a part across multiple diverse operations) is maintained at a higher level than otherwise practically achievable, and that it is maintained without additional effort because the workpiece and tooling remain within a single SCOFAST machine and the work is completed within a single job/machine setup.

Another advantage is avoidance of the cost and difficulty associated with establishing and maintaining a correct spatial alignment in a secondary machine to match the workpiece alignment in the primary machine. This advantage is particularly important in scenarios where the maintenance of alignment and registration requires exotic workholding techniques that can add even more cost and difficulty, such as the addition and subsequent removal of special fiducial features to permit or facilitate spatial location and workholding across machines.

Another advantage is the ability to manufacture certain parts that cannot be made (or cannot be made in an economically viable manner) by moving a workpiece from machine to machine for various operations.

Another advantage is that operations may be performed in quick succession at a uniform or uniformly changing temperature without special procedures to establish matching temperatures from machine to machine.

Another advantage is that there is no need to move dangerously hot parts from one machine to another between operations.

Another advantage is the avoidance of dimensional change that occurs when a workpiece changes temperature as a condition of movement to a different machine, or changes temperature during the transition. Such thermal changes in dimension and alignment must be accounted for before a second operation can be performed, adding complexity, cost and waste that is avoided or mitigated when operations are performed together in rapid succession within a SCOFAST machine.

Another advantage is avoidance of unwanted cooling resulting in hardening that can make subsequent machining difficult and costly to the point of being prohibitive.

Another advantage is that higher tolerances are achievable because the workpiece remains in place between operations. Each additional operation requiring part repositioning reduces the achievable tolerances because of small errors in indexing or part repositioning between operations.

Another advantage is that since handling is reduced, errors are reduced, leading to a reduction in the value lost to waste and failed inspection. Every time a part must be handled the risk of errors rises, and the value lost to waste and failed quality metrics rises with it.

Another advantage is that inspection costs may be reduced due to the avoidance of subtle and variable errors due to loss of spatial coherence across machines. Such errors are particularly pernicious because they may manifest as a part that superficially appears to be correct, necessitating a higher level of inspection for every part.

Another advantage is that since errors are reduced, there is a reduced need to remanufacture parts that fail inspection. This results in substantial savings since a part that must be manufactured twice will consume twice as much time, labor, and materials as planned. Additional savings result if remanufacturing would subsequently require an entirely new machine setup, interrupting other scheduled jobs and causing a ripple effect that can have significant economic impact.

Another advantage is a reduction in the floor space required for manufacturing, since work performed in a SCOFAST machine might otherwise require a significant amount of floor space to accommodate dedicated equipment such as forges and presses or upsetters.

Another advantage is an increase in manufacturing capacity density since heated metal parts remain within a single machine, whereas the movement of heated metal parts between separate machines may require additional standoff distances.

Another advantage is a reduction in the need for special safety measures, since heated metal parts remain within a single machine, whereas the movement of heated metal parts between separate machines may require special safety measures.

Another advantage is that since all operations occur within a single machine, a familiar additive or subtractive manufacturing workflow may be maintained despite the fact that forging and/or other forming operations are additionally performed on a workpiece. The addition of additional separate forging and forming equipment to a machining or 3D printing workflow results in a new workflow that is more complex and more costly.

Another advantage is the avoidance of the added logistical difficulty when multiple steps must be performed requiring repeated alternation between two different types of operations, or when many different types of operations must be performed in different sequences. In some cases the advantage is sufficient to make a part economically feasible when it was otherwise prohibitively expensive.

Another advantage is the ability to perform multiple operations of fundamentally different types on a workpiece within a single spatially coherent machine while avoiding or minimizing many of the factors that raise costs, risks, and complexity when operations of those fundamentally different types are performed in separate discrete machines.

Another advantage is an improved ability to machine high-value alloys that are traditionally considered difficult to machine due to high toughness and a high tendency to work hardening; many difficult alloys may be machined with ease in a SCOFAST machine due to the ability to perform multiple operations of different types in a spatially coherent manner within the same machine.

Another advantage is that when forming is integrated with machining, material waste is reduced since forming may increase the dimensions of a part, while in purely subtractive manufacturing waste material must be removed from a workpiece having original dimensions large enough to accommodate the largest feature of the finished part.

Another advantage is a higher quality of manufactured parts, with higher tolerances and increased consistency compared with manufacturing in separate machines.

Another advantage is more efficient use of labor.

Another advantage is more consistent production.

Another advantage is an increase in the number and type of parts that can be manufactured within the range of economic practicability.

Another advantage is that resonance reduction and other methods for reducing movement-associated error (including error due to backlash, overshoot, following error, ringing, tool wear, thermal expansion, loading, inertia, and others) may be applied in a consistent manner across operations performed in a SCOFAST machine.

Another advantage is that when previously separate functions can be combined in a single multitasking machine, both economic and technological advantages may ensue.

Another advantage is that fixturing times are reduced and design tolerances more readily achieved when multiple operations of different types can be performed using the same machine spatial reference.

Another advantage of a SCOFAST machine is improved ability to automate a series of operations, leading to improved process control with reduced transport and dwell times and improved part consistency.

Another advantage is that the system and method may be retrofitted into a variety of existing machines, whether they be multitasking mill-turn machines, CNC turning and/or machining centers, Swiss-type CNC machines, or older turning or machining equipment controlled by cams and switches.

Another advantage of the system and method is that many components of a SCOFAST machine perform more than one functional role, thus reducing functional redundancy and significantly reducing overall weight and space requirements for parts manufacturing. In constrained environments, such as orbital platforms, extraterrestrial locations, or long-transit interplanetary or interstellar environments, the reduction of weight and volume can be critically advantageous or enabling.

Another advantage of the system and method is that higher ISO tolerance ratings may be achieved when multiple operations of different types can be performed using the same machine spatial reference.

Another advantage of the system and method is that in some embodiments, SCOFAST machines are easily integrated into existing manufacturing workflows.

Another advantage is that certain operations may be facilitated by the execution of another operation within a SCOFAST machine. For example, problems such as work hardening and excessive tool wear have limited the usefulness of rotary broaching when working with difficult materials and extremes of size. However, the ability to heat a workpiece within a machining center to reduce yield strength before rotary broaching increases the range of sizes and materials in which the technique may advantageously be used, while increasing speed and reducing tool wear in other situations.

Another advantage is that two or more operations performed together within a SCOFAST machine may alter or enhance the functionality of the operations compared to the ordinary functionality if performed separately. Elements of the machine may be used for new purposes and in new ways that are different from their ordinary and usual purposes and manner of use. They may function in unexpected ways to produce a unique result. They may permit new results that cannot be obtained if the separate operations were applied separately.

In one example of enhanced functionality, an ordinary turning center does not have the purpose of applying or receiving a pressing force sufficient to cause plastic deformation of a workpiece to alter an initial shape into a final shape. Both hardware and software must be modified and optimized to perform these forming actions, thus this is not simple combining of functions.

In another example of enhanced functionality, the usual purposes of a machining center workholding collet do not include serving as an anvil or as one face of a forging die. In embodiments disclosed herein, the collet that ordinarily serves a workholding function within a turning and/or machining center is used for this new purpose that is unrelated to its original or usual purpose. A forchine collet may require or benefit from customization to serve this unique purpose. For example, it may be surface ground for flatness; it may have an recessed or protruding design that is transferred to the surface of the material being forged or formed against the collet; it may be shaped so as to form a portion of a multi-part die. It may need to be constructed of special materials, or in such a way that vulnerable parts are located where they are protected.

In another example, elements used for hot forging have the usual and ordinary intended function of heating and then deforming a workpiece. In several embodiments disclosed herein, elements used for hot forging have the additional new and unexpected function of temporarily placing and maintaining the workpiece in a physical form, a state of enhanced machining susceptibility, and a location that are advantageous for easily machining what would otherwise be a difficult-to-machine metal. After heating (with or without forging) the state of enhanced machining susceptibility is of short duration due to cooling of the workpiece material, which in many cases cannot be reheated without altering its material properties in ways that are disadvantageous. In some embodiments a machining operation performed on high value alloys such as titanium alloys must be completed within 10 seconds after the completion of heating or after the completion of a forging operation, and preferably within 3 seconds. In other embodiments the state of enhanced machining susceptibility is of such short duration that machining must be completed within 2 seconds after the completion of a forming operation, preferably within 1 second.

In another example, certain materials such as titanium alloys are subject to hardening during forging, which may prevent threads from being subsequently rolled onto a forged workpiece. In some cases it is not physically possible to consistently roll threads to meet required specifications. In other cases it is not possible to do so in an economically feasible manner due to excessive tool wear. For this reason, for many manufactured parts the only commercially available forged products have threads that are cut rather than rolled. Threads that are rolled often are preferred to threads that are cut, due to certain superior material and mechanical properties. In an embodiment where forging and machining elements are combined within a SCOFAST machine, thread rolling on a forged titanium alloy workpiece is possible without excessive tool wear because rolling occurs while the forged workpiece remains in a short-lived state of enhanced machining susceptibility. The combination of elements within a SCOFAST machine permits the manufacture of parts that previously could not be made at all and also permits the economically feasible manufacture of certain parts that previously could not be made economically.

For many materials, a state of enhanced machining susceptibility once established cannot be recreated or prolonged because the material cannot be reheated without causing embrittlement. In such cases machining must be completed within a short period of time. The duration of enhanced machining susceptibility after heating, hot forging, or other hot forming depends on many factors including the material used and the size of the workpiece. In some embodiments the duration is up to 60 seconds. In some embodiments the duration is up to 30 seconds. In some embodiments the duration is up to 10 seconds. In some embodiments the duration is up to 5 seconds. In some embodiments the duration is up to 4 seconds. In some embodiments the duration is up to 2 seconds. In some embodiments the duration is up to 1 second. In some embodiments the duration is up to 0.1 second.

Another advantage is that in an embodiment in which forging and machining elements are combined within a SCOFAST machine, a grade 5 titanium alloy workpiece may be forged and then machined while in a state of enhanced machining susceptibility to produce a threaded bolt having, e.g., a hexagonal head and rolled threads, such as the bolt shown in FIG. 4A. A part manufactured in a SCOFAST machine in this manner has certain unexpected unique metallurgic and mechanical properties that only arise when the various elements are combined as described herein. These properties are novel, valuable, not obvious, and do not exist except as a result of the unified elements working in combination. For example, Table X: Unexpected improvement in material properties of Ti-6Al-4V bolt manufactured by Forchine vs traditional methods shows that a part manufactured on a SCOFAST machine combining forging with machining (e.g., a Forchine) has properties that arise uniquely when the operations are combined, and that do not exist when the same bolt is manufactured through separate operations. The unexpectedly enhanced properties in this case include increased surface hardness of the bolt flats (from 20 HRC to 65 HRC), increased minimum torque at failure (from 137 fp to 146 fp), increased average torque at failure (from 140 fp to 148 fp), and increased resistance to penetration by a cobalt drill (from 20 in-lbs to 80 in-lbs).

Those having ordinary skill in the arts will recognize many additional advantages beyond the few examples stated here. As new materials and technologies become available, additional advantages of the System and Method will become equally apparent.

### EMBODIMENTS

For the purposes of example, a number of sizes, shapes, geometries, temperatures, forces, and materials may be specified, but wherever given, these are merely given by way of example. The system and method disclosed may equally well be applied to any materials, any size, shape, and configuration of materials, any machine configurations, machines and workpieces having any geometry. Work may be performed at any temperatures using any forces.

It will be apparent to those having ordinary skill in the art that the processes described in general and in each specific example given are not limited to the specific materials, workpieces, and substrates described herein, but rather that each process and each example may be generalized to situations involving any material or combination of materials, including any now existing as well as those that may be discovered or invented in the future. The techniques and processes set forth herein are independent of substrate, and although the details of force and energy profiles, force/energy application steps, deforming steps, machining steps, additive steps, transforming steps and so forth may vary in their particulars, the fundamental system and method of combining them as a series of operations performed in a spatially coherent manner within a SCOFAST machine is the same as that which has been set forth herein.

### A Preferred Embodiment

A preferred embodiment of a SCOFAST machine is a “Forchine” comprising machine elements that perform heating operations (e.g., induction heating) and forming operations (e.g., hot die forging) combined with machine elements that perform subtractive operations (turning and machining) together with other machine elements that perform transformative operations (treatment for toughness using thermal manipulation and/or chemical treatments). An example of this embodiment is illustrated in FIGS. 3A, 3B, 3C, 3D, 3E showing a SCOFAST “Forchine” Embodiment for manufacture of a titanium bolt, which will be understood with reference to the description of the figure and to the explanation given here. A specific example of the use of such a machine is disclosed, including an exact method by which the shank of a screw or bolt may be turned from barstock and threaded, the head being forged in situ and the part heat-treated and chemically treated for a significant improvement in surface toughness and resistance to failure under torque and tension. In this way a screw or bolt having enhanced performance is made from start to finish in a single operation without ever removing the part from its workholding fixture.

This embodiment comprises a machine configured so that barstock fed from a barstock feeder is automatically forged, machined, and treated for toughness, all in the same machine. After the bar is heated, spatial coherence is maintained across the subsequent operations, permitting a significant reduction in cost for the manufacture of certain fasteners. Any deviation from a colinear axis of rotation between the spindle axis, the forging axis, and the machining axis is held within about 0.0005″ per inch over the entire length of the combined machining and forging workspace, and preferably within about 0.0001″ per inch.

Ti-6Al-4V grade 5 titanium alloy and other high-strength titanium alloys are among the most difficult materials to use in manufacturing due to their high strength even in the annealed state. The combination of high room temperature yield strength (138,000 psi and above), relatively low heat conductivity, high elongation before yield, and relatively high hardness together make cold forming and machining especially difficult. A tendency to rapid work-hardening exacerbates the difficulties. A series of operations performed according to the preferred embodiment illustrates the use of the system and method for manufacturing screws and bolt. The combined operations result in a finished grade 5 titanium bolt complete with forged hexagonal head, with improved material properties achieved through physico-chemical treatment, manufactured automatically on a single SCOFAST “Forchine” machine in a spatially coherent manner through a series of operations comprising heating, forging, machining, and other manufacturing operations, the workpiece never having been removed from its workholder. The method will be explained twice, first in free form and then again with reference to FIG. 2 and FIG. 3.

A cycle begins when cylindrical barstock of any metal, but in this embodiment preferably grade 5 titanium, is fed from an automatic bar feeder into a SCOFAST machine comprising a combined forging-machining center (hereafter “forchine”), passing through the center of a rotating spindle driven by an engine and through a collet secured to the spindle. The barstock is indexed for length and secured by the collet with a portion of the barstock (“the workpiece”) protruding into the working area in front of the collet face. A machining operation faces the workpiece and turns it to rough size for the bolt or screw being manufactured. A transformation operation adds thermal energy to a segment of the workpiece adjacent to the collet, the energy being delivered through an induction coil that is automatically moved into position for heating and retracted when heating is complete.

For this product, the production design calls for a reverse upset, meaning the forming is performed in the middle of the bar, thus the coil moves to a position surrounding the bar adjacent to the collet. The segment of the workpiece within the coil is heated to a temperature that depends on the metal alloy being forged, the size of the forging die, the speed with which forging will occur, and the amount of force available for forging. For titanium alloys being upset forged as described in this embodiment the temperature will preferably be in the range of about 550° C. to about 1350° C., and most preferably in the range of about 850° C. to about 950° C. An upset forging operation is performed in which a forging die moves over the workpiece shaft and compresses the workpiece against the collet with sufficient force to induce plastic deformation of the workpiece shaft into the closed die, thus forming a bolt head on the workpiece.

The force with which the forging die must be forced against the collet is dependent on the projected area of the forging, the temperature to which the metal bar is heated, the strain rate of the forging operation, and losses due to friction, and may be calculated or estimated as described elsewhere in this specification. The strain rate is determined by the speed at which plastic deformation occurs. For a given strain rate, the force must be sufficient to overcome the yield strength of the material and the frictional forces of the die, and must be within the force delivery capabilities of the SCOFAST machine. The temperature to which a workpiece must be heated to achieve a desired yield strength (or the yield strength at a given temperature) is estimated using the equation shown in Table IV and tested empirically for a given operation.

In this embodiment the collet holds a workpiece that has been heated to forging temperature, and the collet system must be capable of withstanding the resulting thermal loads and the forging forces without excessive wear. A number of suitable collet systems are available. In general a collet system that does not require elastomers is preferred, but if a collet system is to contain elastomeric components, high-temperature elastomers may be selected. Suitable elastomers are available that withstand temperatures in the range of about 100 C to 500 C, preferably about 200 C to about 300 C. A preferred solution is a dead-length type collet closer (such as are well known in the industry) mounted behind the spindle tail at location [1] in FIG. 5A. In this embodiment such an arrangement results in a separation of about 20 inches between the active mechanism and the collet face, with a draw tube passing through the spindle to close the collet. In this embodiment the collet and collet chuck are selected to be of tool steel having carbon content between about 0.7% and about 1.5%, which has been hardened and tempered as spring steel. In practice the thermal mass of the workpiece is low and the thermal mass of the collet is high, thus the amount of thermal transfer is not sufficient to raise temperatures to a level of concern. Furthermore, in this embodiment the time of exposure is very brief. Finally, a machining fluid serves as coolant to carry away excess heat quickly.

In this embodiment the collet face serves as the base of the closed die and the forging force is thus transmitted through the collet to the spindle and the spindle bearings, which are of a size and type capable of receiving such forces and of transmitting them through their mounts to the frame of the forchine, which is sufficiently heavy and rigid to receive the force and to resist deformation and vibration sufficiently to maintain design tolerances for the part being manufactured.

A transformation operation is performed in which a chemical mixture is applied to the workpiece, said mixture combining with the hot titanium as it cools, resulting in an increase in the surface hardness and bulk toughness of the part. The chemical mixture used depends upon the material transformation desired. In this embodiment the mixture applied to hot titanium is preferably a Toughening Fluid constituted as previously disclosed. Toughening fluid is directed to the tool-workpiece interface at a pressure in the range of about 5 PSI to about 50 PSI, preferably being about 12 PSI, and a flow rate in the range of about 1 liter per minute to about 10 liters per minute, preferably being about 3.8 liters per minute

A machining operation is performed to create relief segments in the workpiece. Another machining operation is performed to roll threads of a desired pitch onto the shaft of the workpiece. Additional machining operations add chamfers and other machined features. A cleaning operation removes cutting fluid, chemicals used in conditioning treatments, and debris from the workpiece. An optional measuring operation verifies that the finished bolt is within specifications. The collet is opened and the barstock (with the bolt attached) is advanced to an index for cutoff. A machining operation cuts off the completed bolt, facing the bolt head in the process. After the operations are complete, a part-handling operation receives the finished bolt and transfers it to a carrier for any desired subsequent purpose, such as assembly of composite parts, secondary inspection, or packaging.

It will be understood that this preferred embodiment represents only one realized example of a forchine, and that the specific geometry and motive force of this combined forging-machining center are only exemplary. The same functional machine elements could equally well be realized in a machine using another preferred geometry such as that shown in FIG. 21 or any other geometry, with motive and forging force delivered by linear actuators or any other type of motive engine.

The method of manufacturing a Ti-6Al-4V threaded titanium bolt by forging and machining on a Forchine is here given in detail with reference to the modular process diagram in FIG. 2 and the corresponding labeled machine elements shown in FIG. 3.

1. Control Module
Control module [1] initiates a new cycle of bolt manufacturing. In this example the control module is a machine controller that comprises a mixture of analog controls and digital controls governing the action of each machine element, together with wired and wireless communications for monitoring, programming, and process control.

2. Raw material provisioning
Round Ti-6Al-4V titanium bar [3] is pushed by a bar feeder [2] through the headstock [5], workholding spindle [4] and workholding spindle collet [9] of the machine.

3. LIMIT indexing
Turret bonnet [13] rotates to bring a desired tool [12] comprising an indexing stop into position. Turret slide [14] moves forward towards the headstock to a preset position. The collet relaxes and the bar feeder advances the titanium bar until it makes contact with the indexing stop as shown in FIG. 3B. The turret then advances to a different preset position, the bar being pushed back into the collet until the end has been moved to an indexed position suitable for a next series of operations. The collet closes to secure the bar in position.

4. Workholding
The workholding spindle collet clamps tightly onto the bar and holds it securely for all forming and machining operations. The spindle and collet rotate the bar at a speed regulated by the control module.

5. Adjunct material handling
A machining fluid that serves as coolant, lubricant, and treatment fluid is pumped by machining fluid pump [26] through hose and nozzle [11] and is directed over the portion of the bar protruding from the collet. Machining fluid is collected in collection tray [20] and processed in recovery and recycling system [25].

6. Subtractive machining
6.1. Upper tool positioner [6] moves cutting tool [8] toward the bar, machines the bar end square, and retracts, leaving the end of the bar with a smoothly machined face.
6.2. Front cross slide [17] moves cutting tool [31] toward the bar, machines a chamfer on the end of the bar, and retracts. The size of this chamfer is regulated so that the chamfer will serve the multiple purposes of guiding a heating mechanism over the end of the bar, centering a forging die on the bar, centering additional circumferential machining tooling on the bar, and providing a thread chamfer for the finished bolt.

7. LIMIT indexing
The turret bonnet again rotates to bring a desired tool comprising an indexing stop into position. The turret moves to a preset position. The collet relaxes and the bar feeder advances the titanium bar until it makes contact with the indexing stop. The turret then advances to a different preset position, the bar end thus being moved to an index position suitable for the next operations. The collet closes to secure the bar in position.

8. Transforming operation
Upper tool positioner [6] positions induction heating coil [7] over the end of the bar and advances it toward the collet to the desired position for heating the bar, as shown in FIG. 3C. Induction heating system [22] supplies power to the coil, raising the temperature of the portion of the bar that is positioned within the coil (the “heated zone”) while the spindle [4] slowly rotates the bar to ensure even heat distribution. Heating continues until the temperature of the heated zone is high enough to reduce the yield strength of the material into a range of practical formability as defined by the production design specifications. For grade 5 titanium the temperature after heating is in the range of about 800 C to about 1350 C, preferably in the range of about 850 C to 950 C, more preferably about 900 C.

9. LIMIT indexing
The collet relaxes and the turret moves forward with another indexing stop, pushing the bar into its next position with a small portion of the heated zone inside the collet and the remainder of the heated zone protruding from the collet. This ensures that all of the material to be formed by the die is at the required temperature and yield strength. The collet closes, securing the bar in position. This indexing position sets the amount of material protruding from the collet, which must match the total volume of the forming die. For this example, the production design calls for a reverse upset, meaning the forming is performed in the middle of the bar rather than at the end. For this reason, the bar protrudes the full length of the bolt plus an amount sufficient to provide the volume of material needed to form the head. The die will hold the shaft of the bolt as well as the head that is to be forged from the heated section of the bar.

10. Forming operation
The forming operation to be performed is forging. The turret tool bonnet rotates to bring a tool [12] comprising a forging die into position, as shown in FIG. 3D. The turret slide [14] is advanced so the forging die moves forward towards the collet at a rate of about 3 inches per second to about 4 inches per second. The hollow die slides over the workpiece bar and continues to advance until the end of the bar bottoms out in the die, causing an impact transfer of energy to the workpiece. The turret slide continues to advance with a pressing force sufficient to induce plastic deformation of the heated zone of the workpiece [32], causing hot titanium to deform and flow into the die, filling the die cavity. At the end of the turret's forward stroke the die has fully closed the cavity against the collet, which serves as the back face of the die. The pressing force is generated within the turret slide [14] by a hydraulic cylinder [14A] that lies within the turret slide and has a piston shaft anchored to the tool turret base [15]. The force in one direction is transmitted to the bed and frame [19] through the tool turret base [15] and the turret carriage [16]. The force in the other direction is transmitted through the turret slide [14], turret tool bonnet [13], die [12], and the workpiece [3] and is received by the collet [9] and workholding spindle [4]. The workholding spindle is suspended by bearings strong enough to withstand the forces delivered to the collet during the forming operation (e.g., deep collar ball bearings or thrust bearings), as shown in FIGS. 5A, 5B, and 5C. The spindle bearings and spindle mounts then transfer the forging forces to the headstock [20] and thence to the bed and frame [19], each element of the whole being engineered with sufficient strength to resist these forces. The total time required for forging the part described is in the range of about 0.1 second to about 5.0 seconds, and preferably in the range of about 0.1 seconds to 1.0 seconds. When the forging operation is complete, the hydraulic cylinder chamber flows are reversed so that the die is retracted and the turret slide returns to a home position partially retracted into the tool turret base.

11. Transforming operation
As the die retracts after the forming operation, machining fluid comprising a toughening solution is pumped over the hot formed workpiece at a pressure of about 12 PSI and a rate of about 1 gallon per minute. The spindle begins to turn, cooling the workpiece evenly at a controlled rate. The flow rate and temperature of the machining fluid are regulated to adjust treatment parameters as desired.

12. Subtractive operations
With the workpiece still firmly secured in the collet and still at an elevated temperature preferably in the range of about 200 C to about 1000 C, more preferably in the range of about 500 C to 700 C, the shaft of the bolt is machined to provide the desired features, specifications, and tolerances of the product, using tools mounted in the turret tool bonnet [13], front or rear cross slides [17, 27], and/or upper tool positioners [6].

13. LIMIT indexing
With machining finished, the bar is advanced to another indexing stop that is positioned for cutoff

14. Workpiece retrieval
An upper tool positioner [6] advances a cutting tool [8] to cut the manufactured bolt free from the barstock while simultaneously providing a finish cut to the top of the bolt head, as shown in FIG. 3E. A part retrieval chute [33] is positioned and the workpiece drops into the chute and is removed from the forchine.

The example given describes an example of a SCOFAST machine system embodied as a working forchine, together with an actual part that is advantageously manufactured using the forchine and the operational steps through which the method is applied. These specifics are given only by way of example. Those having ordinary skill in the art will recognize that many other forchine machine configurations are possible, and that a similar series of operations may be performed in forchines having different geometries and different machine elements. Those having ordinary skill in the art will also perceive that the system and method may be applied equally well to any part and any material, with or without automatic feed of stock or automatic loading of blanks.

In this embodiment and example, a forchine combines forging, machining, and other operations in a single machine in a spatially coherent manner. The forging force is provided by a driven tool head which must be capable of delivering sufficient force to forge the materials being worked. Forging is facilitated by heating the material to reduce the force required for plastic deformation, using an induction coil formed to a shape that primarily heats the exact area of the bolt that will be forged and thus avoids thermally hardening the shaft of the bolt excessively. The forging die back plate in this embodiment is the collet itself, which must be of a material capable of withstanding both the heat and the force of forging, and must also be mounted to a spindle having spindle bearings similarly capable of withstanding the force of forging and of transmitting that force to the spindle mounts and thereby to the frame of the forchine. FIGS. 5A, 5B, and 5C show examples of spindle modifications to increase axial load capacity with the addition of thrust bearings. FIG. 23 shows examples of alternative bearing types that may be used in a SCOFAST machine.

In this embodiment, the forging energy available comprises an initial energy transfer to the workpiece through deceleration of the die as it makes impact with the workpiece, followed by a pressing force acting over the remaining distance as the die is forced closed. The initial energy transfer depends on the mass and pre-impact velocity of the tool, toolholder, and other elements that are decelerated through the initial impact. The subsequent energy transfer depends upon the pressing force delivered by the forchine, whether through hydraulic, pneumatic, electromagnetic, gravitic, screw drive, or other means.

In this embodiment heat is used to lower the yield strength of the material to facilitate forming. In some embodiments the material being heated and forged is a high-strength titanium alloy. It will be apparent to those having ordinary skill in the art that any material whose yield strength can be reduced by heat could be substituted for the high-strength titanium alloy. Suitable materials include, but are not limited to, metals, glasses, ceramics and plastics. The temperature to which a workpiece must be heated to achieve a desired yield strength (or the yield strength at a given temperature) is estimated using the equation shown in Table IV and tested empirically for a given operation.

In the example given, forging forces are received by the collet, which serves as the rear face of the closed forging die. The spindle of the machine is held in position by heavy deep groove ball bearings able to withstand the forces delivered to the workpiece and thereby through the collet to the spindle during the forming operation. The ball bearings transfer the forging forces to the headstock, which is engineered with sufficient strength to resist these forces. For a Ti-6Al-4V bolt head with a cross sectional area of 0.6362 square inches the required hot forging pressure is in the range of about 1500 to about 4,700 pounds per square inch, thus the linear force against the spindle and bearings is in the range of about 1000 to about 3000 pounds or about 0.5 to 1.5 tons when the die is fully closed. Depending on the momentum of the tool turret and the rate at which kinetic energy Is transferred through impact, peak forces during forging impact may exceed this.

In other embodiments a forging bushing or forging plate may be located between the collet and forging die, the forging bushing or plate being affixed in some manner to the frame of the machine or otherwise stabilized in its location, so that forging forces are received by the plate or bushing rather than by the collet, and are transmitted to the machine frame through dedicated machine elements that are sufficient for the purpose. In such a design the spindle bearings are not required to receive and transmit the entire axial loads associated with forging and press forming.

Forging Force and Hydraulic Pressure

In this embodiment, the SCOFAST machine is a forchine using hydraulic actuators to move a tool turret that is used for both forging and machining. It will be apparent to a person having ordinary skill in the art that an electrically-driven linear actuator, a mechanical actuator, or any other type of actuator may be substituted for a hydraulic actuator. Whether designing a forchine de novo or modifying an existing machining center to create a forchine, the capabilities of the forchine will be bounded by the forging/forming force available. In this particular embodiment the forging force derives from the hydraulic pressure applied to the piston heads of hydraulic cylinders, which must be sufficient to deliver the force (flow stress) necessary to induce and maintain plastic deformation of the material being formed at the temperature and speed used in the process. During a forging operation the forging force per unit area (Pw) acting over the projected deformation area of the workpiece (Aw) will equal the hydraulic force per unit area in the cylinder (Pc) acting over the area of the cylinder piston heads (Ac), thus Pw*Aw=Pc*Ac. The required cylinder pressure given a required forging size is given by: Pc=Pw*Aw/Ac. Alternatively, the maximum forging projection size given a specified cylinder pressure is given by: Aw=Pc/Pw*Ac.

Required Hydraulic Pressure for a Given Forging Die Size

For example, to forge a structural bolt head on an M20 bolt of Ti-6AL-4V at a temperature of 950 C and a strain rate of 1 per second (upset forging with 50% shortening of the heated area in half a second), the relevant stress-strain curve is consulted from FIG. 17 and the required flow stress is determined to be 85 Mpa, or 85000000 newtons per square meter.

The hexagonal head on an ISO metric structural bolt has a maximum (long diagonal) dimension of twice the bolt diameter D, thus the side length is D and the area A is

A=3/2\dot{3}D²

For a 20 mm bolt, the projected forging area of the head is 1039 mm2 or 0.001 square meters. The force needed is found by multiplying the required flow stress (85,000,000 newtons per square meter) by this projected forging area to yield 85000 newtons. This force is then divided by the area of the forchine hydraulic cylinder piston to give the hydraulic pressure required. In the present embodiment the forchine has two parallel cylinders having a total cross sectional area of 0.002 square meters, thus the total required pressure is 42.5 Mpa, or 6527 PSI. Frictional forces may increase this, depending on the complexity of the die used in forging. Higher temperatures or lower strain rates may reduce the pressure required. The required pressure may also be reduced by delivering some portion of the forging energy as kinetic energy in an initial impact phase.

Maximum Forging Die Size for a Given Hydraulic Pressure

In another example, a forchine based on the design of a Hardinge DSMA machining turning center having a total toolholder hydraulic cylinder area of 0.002 square meters is configured to have a hydraulic forging pressure of 3000 PSI. The projected area of the largest element that can be forged is determined by the ratio of machine hydraulic pressure to the required flow stress, multiplied by the hydraulic cylinder area.

When forging elements of a Ti-6Al-4V workpiece at 950 C at a strain rate of 1 per second, the required flow stress has already been determined to be 85 Mpa, equivalent to 12328.2 PSI. The machine hydraulic pressure is 3000 PSI, thus the maximum projected area that may be forged at this temperature and strain rate is 3000/12328*0.002=0.00048 square meters, or 0.73 square inches. The maximum forgeable size may be reduced by frictional forces when more complex dies are used, or increased if a higher temperature or lower strain rate are selected, or if additional (kinetic) energy is transferred from the machine to the workpiece through impact.

Minimum Temperature to Forge Using a Given Die Size at a Given Hydraulic Pressure

To determine the temperature required to forge a bolt head given a desired size and a fixed hydraulic pressure, it is first necessary to select a strain rate. If the portion of the bar to be upset will be shortened by 25% in 250 msec, the strain rate is then 1 per second, corresponding to the set of curves shown in FIG. 17 (c). The force per unit area available to provide flow stress is the hydraulic pressure multiplied by the ratio of the cylinder area to the bolt head area. The stress-strain curves are consulted to determine the minimum temperature that will be required to forge this head size at this strain rate with this amount of force available.

Minimizing Strain Rate Through an Initial Impact Forming Step

If sufficient time is available, slower strain rates will reduce the flow stress required to achieve plastic deformation. The total time available for forging is limited by the cooling time of the workpiece. Increased speed and increased forging capacity may be obtained by adding an impact forming step before the press forming step. This may be accomplished by accelerating the forging head and die into the workpiece to create an initial step of impact forging (in which kinetic energy is transferred) followed by a secondary step of press forming. In an embodiment in which forging and machining are performed on a Hardinge DSMA screw lathe that has been converted to a forchine, the workholding carriage weighs 150 lbs and is accelerated to a terminal velocity of about 5.3 inches per second before making contact with the workpiece and being rapidly decelerated (“impact phase”). The distance through which the workpiece is deformed multiplied by the flow stress being applied to cause that deformation is work that must equal the kinetic energy transferred in the impact. The energy transferred during the impact phase thus accomplishes a large portion of the required deformation, leaving a smaller amount of deformation to be performed over the remaining time (the “pressing phase”), permitting a slower strain rate during the pressing phase.

### Advantages of the Preferred Embodiment

Use of a SCOFAST machine creates many potential advantages that are pointed out elsewhere. Use of a forchine to manufacture titanium parts as described in an example of a preferred embodiment illustrates many of these advantages and exposes some particular unexpected advantages. A number of specific production efficiencies derive from the ability to form and machine difficult-to-machine materials (such as high-strength titanium alloys) where the operations are performed in rapid succession within a SCOFAST machine (in this case, a forchine).

The advantages of the forchine compared with other methods for manufacturing a precision bolt will be apparent to those having ordinary skill in the art. When similar bolts are manufactured entirely by machining, the required barstock size is larger than the largest dimension of the bolt head and the cutting allowance (material waste) is enormous. Manufacture by forging alone is not always capable of achieving the tolerances and features required. Manufacture by forging in one machine with subsequent machining in a different machine introduces substantial additional costs together with locating, indexing, and workholding difficulties, and leads to increased difficulty in achieving the required tolerances. Compared with previously existing options, manufacturing such a bolt in a forchine offers many advantages including reduced material waste, reduced handling, reduced floor space requirements, reduced labor costs, improved tolerances, and many other advantages.

In practical terms, in the case of manufacturing a hex head bolt from a high-strength titanium alloy, the total time of manufacture using a forchine is on the order of 25 seconds from start to finish, less than half of the time required to manufacture the same part by turning from oversize stock on commercially available CNC turning centers. The amount of material required to manufacture this part in a Forchine is similarly less than half the amount used to turn the same part in a currently commercially available turning center. Additional benefits arise because the part is thermally and chemically hardened and toughened during manufacturing. The total manufacturing cost of this part using the system and method disclosed in this specification is in the range of about 50% of the cost of manufacturing by other methods now known.

One advantage is that when machining follows hot forming in quick succession, the workpiece is machined at an elevated temperature that reduces yield strength during machining, resulting in reduced tool wear and improved part surface characteristics.

Another advantage is that the portion of the workpiece that undergoes plastic deformation and flows into the die has advantageous grain flow structure and grain alignment, improving material properties in the final part.

Another advantage is that certain features may be completed or nearly completed through forging or other forming operations. Machining operations therefore may remove a smaller amount of material that would otherwise be necessary. This reduces the amount of swarf and reduces tool wear, allowing the forchine to run unattended for longer periods of time.

Another advantage is that any requirement for inert gas shielding or other method for displacement of oxygen is reduced or eliminated because the forging process occurs within a few seconds after heating and may be performed in an oil-coated or fluid-flooded environment. A further advantage is that vaporized machining fluid displaces oxygen during heating, and subsequent hot machining removes unwanted casing. A further advantage is that the heating coil may comprise a liner, with or without a sealing flange, in order to better trap vaporized machining fluid and better displace ambient atmosphere. In many scenarios there is no need for added inert gas at all, reducing costs in comparison with other manufacturing approaches.

Another advantage is that for some parts, the time between heating and quenching is too short to allow significant oxidation of the workpiece.

Another advantage is that when forging titanium in the Forchine, coolant combines with residual material in the die to produce a lubricating slurry that allows workpieces to freely slide in and out of the die without binding.

Another advantage is that spatial coherence is maintained since the workpiece need not be moved from one machine to another, which would require re-indexing and would inevitably result in loss of spatial coherence, leading to reduced precision and parts that fail tolerances. Since forging and machining are performed using the same tool turret while the workpiece is held in the same workholder on the same spindle axis throughout, the forging and machining operations are perfectly concentric and coaxial, and any deviation with respect to the spindle axis is the same for both.

Another advantage is that there is a significant savings of time because the workpiece does not have to be moved from one place to another from machine to machine. Another advantage is that since the workpiece does not have to be removed from one machine and installed, indexed, and registered in another machine, the periods of time immediately after a first operation are available for performance of a second operation. This is a particular advantage when a first operation leaves a workpiece in a desirable state for the second operation, but the desirable state is of short duration. It is particularly advantageous if a second operation is performed within about 60 seconds after the first, more preferably within about 30 seconds, more preferably within about 20 seconds, more preferably within about 10 seconds, more preferably within about 5 seconds, more preferably within about 1 second, and more preferably within about 0.1 seconds.

Another advantage is that there is no need to store partially manufactured parts in the manufacturing area while they await availability of other machines to perform secondary operations. A part is started and finished in a single connected series of operations performed automatically within a single machine, and when parts leaves the machine they can go directly to another area for packaging or quality assurance.

A particularly important advantage is that the combination of heating, forging, machining, and treating in a single SCOFAST machine (forchine) produces results and outcomes that cannot be achieved by heating, forging, machining, and treating performed as independent operations in separate machines. In the preferred embodiment, forchine manufacturing of bolts made from titanium alloy Ti-6Al-4V, a first (transformative) operation is heating a titanium alloy workpiece above its recrystallization temperature and a second (formative) operation is hot forging the workpiece near the recrystallization temperature. A third (transformative) operation is continuously applying a treatment fluid while rapidly cooling the titanium workpiece below the recrystallization temperature, and a fourth (subtractive) operation is machining features into the workpiece while the temperature remains high enough that the yield strength of the material remains significantly reduced. If the material cools too much, the forged area becomes too tough for ordinary machining, and since the material cools rapidly, the temporal window during which the fourth (machining) operation may be performed is very short. Depending upon the size and material of the workpiece, the advantageous time window for effective machining may be up to about 60 seconds after removal of the forging die in the second operation, more often up to about 30 seconds, more often up to about 20 seconds, more often up to about 10 seconds, more often up to about 5 seconds, more often up to about 1 second, and sometimes up to about 0.1 second.

When the four operations are performed in rapid sequence in a single SCOFAST machine such as the Forchine of this embodiment, the outcome is a perfectly formed titanium bolt having an enhanced toughness profile. However, if the same operations are performed separately in separate machines it is not possible to achieve the same outcome. For example, if the first three operations are performed in the first machine and then the workpiece is removed from the first machine, transported to a second machine just a few feet away and reindexed in the second machine, any attempt at machining will fail because the narrow time window for effective machining will inevitably be missed. When the temporal and thermal window for machining is missed, the workpiece temperature will be far below the desired machining temperature and the toughened material will not be machinable without excessive tool and part damage. It is not possible to re-heat such a workpiece a second time in order to perform the fourth (machining) operation, because a second heating of Ti-6A1-4v alloy causes excessive oxygen embrittlement and leads to part failure due to thread crumbling. FIG. 4A and FIG. 4B show titanium bolts manufactured through such operations. The left image [A] shows a high-test bolt produced with a single cycle of heating, forging, treating, and machining at the correct temperature in a Forchine. The right image [13] shows a failed bolt due to embrittlement and crumbling threads caused by double-heating the workpiece.

Even when the workpiece is not deliberately reheated, a spatial positioning error of as little as 0.005 inches between operations can lead to accidental double heating of the distal bolt, resulting in a failed part. Spatial, temporal, and thermal coherence are critical elements in the manufacture of such parts.

It is therefore evident that combining the two operations so that they are performed in a spatially coherent manner within a SCOFAST machine improves temporal and thermal coherence as well as spatial coherence per se, producing a new and useful result as compared to the “same” operations performed independently. The spatially coherent combined operations produce a result that is different from and distinctly superior to the result obtained if the operations are performed independently.

When a first and a second operation are integrated into a SCOFAST machine, the integrated operations that are performed are not actually the same as the independent operations that would be performed without integration. The operations themselves are different, since they are spatially coherent and capable of perfect coaxiality and concentricity. They are also temporally coherent operations that may be performed in a closely controlled sequence and in much closer temporal succession than would otherwise be possible. They are operations that can be positioned spatiotemporally at the most advantageous positions and times with respect to temporally and spatially varying attributes of the workpiece and the environment.

A further advantage is that the method permits easy manufacture of parts that are notoriously difficult to manufacture, such as grade 5 titanium bolts. U.S. Pat. No. 8,293,032B2, which is incorporated here by reference, recites a list of problems that prevent the economic manufacture of grade 5 titanium bolts and discloses an alternative alloy that is claimed to be easier to machine and therefore better suited to bolt manufacture. The list of problems recited with respect to grade 5 titanium bolts includes:

“A titanium alloy bolt requires a higher level of art for its manufacture than a steel bolt does . . . . The [grade 5] Ti-6% Al-4% V alloy is an alpha-beta alloy which is manufactured by adding an alpha-stabilizing element and a beta-stabilizing element to titanium. The alpha-beta alloy is difficult to work on at room temperature because of its high deformation resistance and low stretch ability. Hot forging performed at a high temperature is, therefore, employed for shaping an alpha-beta alloy by forging, since holding it at a high temperature lowers its deformation resistance and makes it easier to stretch.

However, a product of hot forging at a high temperature is seriously affected by the thermal expansion of the alloy. As a result, the forged product is undesirably low in dimensional accuracy. It is necessary to design a product of hot forging with a sufficiently thick cutting allowance for making up its low dimensional accuracy and a waste of the material is, therefore, inevitable. The hot forging of a titanium material forms scale and oxide layers on its surface as its heavy oxidation takes place at a high temperature. The necessity for the removal of the scale and oxide layers adds to the cost of bolt manufacture.”

It is apparent that there is a long-felt need for a method and system by which to manufacture grade 5 titanium bolts with high dimensional accuracy at an affordable price. However, until now it has not been possible to manufacture such parts without a large capital investment in forges and other specialized equipment. Many small fabrication houses have attempted to do so without success, but almost invariably are forced to fall back on machining from large diameter stock, resulting in a slow process with high waste at a high price. This has resulted in a low expectation of success for those who might attempt such a thing.

The system and method disclosed here make possible the manufacture of grade 5 titanium bolts having high dimensional accuracy and superior performance characteristics without the need for high cutting allowances, forges, annealing ovens, or specialized cutting and threading machines. A Forchine embodiment of a SCOFAST machine described herein performs a fully automatic process comprising induction heating, die forging, machining, and threading of through-spindle bar stock to produce superior bolts in a single general purpose machine, with all operations performed on a workpiece in the same collet on the same spindle. The resulting advantages of speed, reduced waste, and reduced labor costs translate to the manufacture of grade 5 screws and bolts of high dimensional accuracy and superior attributes at a cost approximately 50 percent less than was previously possible, even in short runs. Some superior attributes of bolts manufactured in this way are listed in Table X.

The observed improvements in toughness, hardness, torque at failure, failure location, and resistance to tool damage were unexpected and result largely from the Forchine's ability to perform close-tolerance machining operations in close temporal proximity to a preceding die forging operation so that certain machining operations are performed during previously inaccessible material states, something that was not previously possible. It is apparent that the forchine-manufactured bolt has in some areas an altered crystalline structure that provides unexpected substantial benefits.

The advantage of increased hardness and toughness in a titanium part is of particular importance. Every mechanic knows the pain of stripping out a head or socket, or rounding over the flats on a bolt head. Whether the form of the engagement surfaces is philips head, slotted, hex, star, or another form, improved wear resistance is an attribute greatly desired. In an area of thread engagement, increased hardness contributes to a reduced tendency for galling, which is highly desirable. Bearing surfaces may also benefit from increased hardness and toughness.

TABLE X
Unexpected improvement in material properties of Ti—6Al—4V
bolt manufactured by Forchine vs traditional methods

| Grade 5 Titanium 6Al—4V | Manufactured by | Manufactured by |
|---|---|---|
| Bolt ½-13 × 1″ hex head | separate operations | Forchine |
| Rockwell hardness of head flats | 36 | 65 |
| (HRC) | | |
| Cobalt drill penetration force | 20 | 80 |
| (in-ibs) | | |
| Torque failure location | Junction of | Threaded area |
| | head and shaft | of shaft |
| Avg torque at failure (ft-lb) | 140 | 148 |
| Min torque at failure (ft-lb) | 137 | 146 |

Material properties of bolts manufactured by operations combined in a Forchine compared with properties of the same bolts manufactured by separate operations performed in separate machines. Unanticipated improvements include increased surface hardness of the head flats, drill bit resistance, improved average and minimum torque failure strength, and more distal torque failure location.

Discussion

One reason for which the system and method disclosed herein have not previously been proposed or attempted is that there has been no suggestion or hint in the literature that such a thing would be possible, nor that such a combination would be desirable or produce desirable results.

There are many specific reasons why there would be no expectation of success in attempting to perform hot forging of, e.g., titanium bolts with a forging die driven directly against a workholding collet attached to the main spindle of a machining center. It would be expected that the heat of forging would damage the collet and collet closer, causing warping and binding of the metallic parts and destruction of elastomeric components. It would be expected that the heat of forging would damage bearings in the collet and in the spindle itself. It would be expected that warping due to heat would reduce the alignment and precision of the machine. It would be expected that heating a highly reactive metal such as titanium could be dangerous, particularly with exposure to moisture. It would be expected that a machining center tool axis could not deliver the force needed for successful forging. It would be expected that the collet, collet chuck, spindle, and bearings of a machining center could not withstand either the impact force or the pressing force required for successful forging. It would be assumed that machine rigidity and frame strength would be insufficient to support the forces involved. A forging stroke seems so similar to the impact of a machine crash that it would be assumed the machine would be forced into an error condition and thrown out of alignment. Any attempt to achieve forging within a machining center would confirm those expectations and assumptions, since they would be largely correct: ordinary machining centers cannot deliver or withstand the temperatures (up to 1700 C) and forces (up to 10,000 lbs-force) needed for forging, for all the reasons given here. On many modern machining centers, collets would deform and collet system elastomers would be destroyed on a first attempt at hot forging even at 900 C. On most modern machining centers even 1000 lbs of force will cause bearing damage and loss of machine precision.

Another reason why there would be no expectation of success is that the normal order of operations and operational geometry for manufacturing the common parts desired (e.g., a titanium bolt) would not actually benefit from the addition of forging capability in the same machine, thus no improvement would be anticipated or obtained. The normal expectation is that features will be forged on the exposed end of a bar, but this approach cannot yield a complete part within a forging-capable machining center. In fact, four separate machines are required to make a finished bolt if the head is forged with this traditional operational geometry. The order of operations and operational geometry required for successful manufacture of a titanium bolt within a forchine is unusual and would not easily be conceived. The desired parts can be manufactured automatically within a bar-fed forchine only by first heating the barstock some distance from the collet, then moving the heated portion back into the collet so that a defined portion of the heated section enters the collet, then upset forging the head with the crown against the collet and the shaft protruding into the workspace. This leaves a shaft exposed for subsequent machining to size and thread rolling before the barstock is moved forward and the bolt is cut off as the crown is machined flat. The head forging operation must leave the protruding shaft highly coaxial with the spindle axis and the axis of the machine tool turret. The required precision must be maintained across all operations; an angular error in coaxiality of even 0.001 radians or an linear error of a few thousandths of an inch between the axis of forging, the axis of machining, and the machine spindle axis would render the process useless for part manufacture.

Another reason why there would be no expectation of success is that the method depends on machining at high temperatures. This goes against the common teaching that parts should be kept cool during machining because heating of the parts will lead to increased tool wear. In fact, the method provides unexpected benefits in an unanticipated reduction of tool wear that derives from machining immediately after forging: the reduced yield strength of the part material during this period of time more than offsets the tendency for increased tool wear due to heating. This illustrates unexpected success in the face of prior art teaching away from the invention: success in the form of reduced tool wear was not only unexpected, it was actively discouraged by the teachings of the prior art: that heating of the material being machined should be avoided to reduce tool wear.

Finally, the forging industry is completely different and separate from the machining industry, and it would be uncommon for an expert in machining centers to also be an expert in forging. The equipment used in forging is of a different size and scale and looks completely different from the equipment used in machining. Machinists typically consider forging equipment to be dirty, dangerous and costly in terms of space requirements, while forging workers consider machining equipment to be fussy and fragile.

### Additional Exemplary Embodiments

Forging, Machining, and Bending a Flanged Threaded Screw Hook from Titanium Alloy

In one embodiment a SCOFAST machine has a geometry and elements similar to those shown in FIG. 9A, comprising a primary workholding spindle and a secondary workholding spindle facing each other along the Z-axis of the machine, with tooling positioned on both sides of the working area between the two workholding spindles. This embodiment also includes a tool supply system and a robotic arm configured to function as a tool-changer, similar to that shown in FIG. 7D. One of the live tools in the machine is a hot bending tool [17], the general operation of which is shown in FIG. 8A and FIG. 8B. The part to be manufactured is a hook having a threaded shaft, a flange on the shank immediately above the threads, and a flat chisel formed at the tip of the hook, as shown in FIG. 16.

The manufacture of such a part from titanium alloy Ti-6Al-4V using ordinary equipment and workflows would be labor intensive and therefore expensive, since it would require repeated accurate positioning of the partially completed workpiece in multiple machines. Such parts sometimes are separately forged, machined, and bent, but very often they are machined from barstock larger than the largest finished dimension of the final part and subsequently bent to shape on a bending jig.

Titanium is notoriously difficult to bend at room temperature. The torque required for bending a workpiece is the torque at which the bending stress is equal to the yield strength of the material at the desired strain rate and at the desired temperature. The bending moment for a cylindrical cross-section of material (such as barstock used to make a U-bolt) is given by M=(S*I)/Y where S is the yield stress, Y is the distance from the neutral axis to the point at which the bending load is applied, and I is the second moment of rotational inertia of the workpiece to be bent. For a cylinder, I is calculated as (Pi*r⁴)/4 and Y is just the cross-sectional radius of the cylinder.

Since the yield strength of the material is reduced at elevated temperatures, it may be advantageous to heat the titanium before bending. For a part design that requires hot-bending 10 mm titanium barstock at a strain rate of 1 per second and a temperature of 750 C, FIG. 17 shows that Ti-6Al-4V has a yield stress of 270 Mpa. The torque required will thus be 270*(3.14*5²/4)/5=26 newton-meters. Since active tooling with a stall torque of 100 newton-meters is routinely commercially available, it will be apparent to those having ordinary skill in the relevant arts that torque in the range of forces needed for hot bending even the most difficult materials may be provided within a SCOFAST machine.

A chisel nose hook having a threaded shaft and a flanged base above the threads, such as is shown in FIG. 16, is readily manufactured using the SCOFAST machine described in this embodiment to perform forging, machining, and bending operations in a single spatially coherent machine. Specific tooling used in this example may not be shown in the figures referenced. Cooling, lubrication, and treatment with machining fluid may be used as desired, together with such other ancillary operations as may be advantageous. Numbers given are references to exemplary machine elements shown in FIG. 9A.

1. Position barstock [34] out from the left main spindle [32] to an index position for heating.

2. Heat bar in the region that will be used to forge the flange, using an induction coil

mounted in any convenient tool positioner.

3. Move bar back into the left main spindle collet to an index position for forging the flange.

4. Using two opposing tool positioners, bring the two rear halves (not shown) of a 3-part split die in from the sides to surround and clamp the barstock at the point where it exits the collet.

5. Move the front die [38] held in right main spindle [36] forward towards the workpiece on the Z-axis so that the workpiece enters the die and bottoms out within the die. Apply sufficient force to cause the heated metal to flow and fill the die, forming the flange (upset forging).

6. Move the right main spindle and front die away from the workpiece.

7. Move the two halves of the rear die away from the workpiece.

8. Remove the front die from the right main spindle collet using the robotic tool changing arm.

9. Machine the pre-thread-roll diameter and any additional features desired on the shaft and flange, using any convenient tool positioners.

10. Roll threads on the shaft using any convenient tool positioner.

11. Pick off the workpiece with the right main spindle collet, cutting the workpiece from the barstock using a cutoff tool mounted in any convenient tool positioner. The workpiece is now clamped in the right main spindle with the portion that will form the hook protruding leftward from the collet. The workpiece may be rotated into any desired orientation for each operation.

12. Heat the area that will be forged into the hook chisel tip using an induction coil mounted in any convenient tool positioner.

13. Pinch forge a plate chisel shape into the tip of the hook using dies in a forming tool [55] mounted in any convenient tool positioner.

14. Mill the chisel tip to any desired final shape using pinch milling and other milling techniques, using live tools mounted in any convenient tool positioner.

15. Heat the area that will be formed into the curved portions of the hook using an induction coil mounted in any convenient tool holder.

16. Bend the outer curve using a bending tool [17] mounted in any convenient tool holder.

17. Bend the inner curve using a bending tool mounted in any convenient tool holder.

18. Eject finished part, either picking it up with a robotic arm or catching it in a part collection tray as desired.

Direct Energy Deposition, Compaction, and Machining

In one embodiment the operations performed in a SCOFAST machine comprise an additive operation (direct energy deposition) followed by forming (hot compaction) and machining (milling).

In the following example the workpiece material is titanium alloy, but those having ordinary skill in the art will recognize that any material capable of being deposited by direct energy deposition may be substituted for titanium alloy.

The machine has a bed that can be moved on the X, Y and Z axis. Mounted on the bed is a base plate of titanium alloy. A laser DED mechanism deposits additional titanium alloy on the plate as the machine's bed is moved by CNC control to build up a partially formed workpiece of desired shape, with a selected gas flooding or filling the workspace or introduced in such other manner as may be chosen to shield the material being deposited from an oxidizing atmosphere.

When the additive operation is complete, a forming operation begins. The bed slides to a position in which a tool turret containing a heating coil and a forming press head with a die is positioned directly over the partially formed workpiece. The turret extends until the induction coil is positioned around or adjacent to the workpiece, and the workpiece is heated to a desired temperature. The induction coil is retracted, and a die in the desired shape of the workpiece is brought over the partially formed workpiece and pressed against the base plate with sufficient force to cause compaction and plastic deformation of the workpiece to a near net shape.

When the forming operation is complete, a machining operation begins. The bed slides to a position in which the workpiece may be addressed by a tool turret containing at least one spindle driving a machining tool such as an end mill. The machine bed and/or the end mill are moved under CNC control to machine desired features (such as precision holes or smooth surfaces) into the workpiece.

When the milling operation is complete, the bed slides to a position in which a saw may address the workpiece, removing it from the titanium plate mounted to the bed. A robotic picker or a parts catcher collects the finished product.

The titanium base plate is moved back under the DED mechanism and the process repeats as desired.

Many advantageous variations will immediately be apparent to one having ordinary skill in the art: each and every particular element described in this example is capable of variation while remaining within the sense of the system and method disclosed. The workpiece may be held in a fixed position while the various tools are brought into position. Material may be added to build up the workpiece by an additive operation other than direct energy deposition. The workpiece may be formed in a direction that is not along an axis normal to the base plate. Workpiece removal could be performed by a laser cutter rather than by a saw. The baseplate could be secured to a spindle, and both machining and cutoff could be performed as turning operations. The number of advantageous alternative configurations contemplated is extremely large.

Injection Molding, Machining, Inspection, and Press Stamping

In another embodiment, a first operation is injection molding, a second operation is machining, a third operation is inspecting, and a fourth operation is press stamping.

A limiting factor in the manufacture of parts purely through injection molding is the requirement that a part be removed from the mold after the injected material has solidified. Each mold must be designed in such a way that draft angles in the mold facilitate the removal of the product from the mold. This places severe design restrictions on parts so manufactured. For example, parallel features are precluded by the draft angle requirement. There are other mold design issues as well. For example, straight bores internally in the product or reverse angles within the interior of the product cannot be created through ordinary injection molding.

In this embodiment, a SCOFAST machine contains a workholding spindle that can rotate a workpiece and hold it rigidly in any position. The workholding spindle can also spin the workpiece at rates optimized for turning operations. The machine also contains at least one tool turret mounted in such a manner that it may be moved and rotated in some combination of X, Y, Z, A, and B axes, preferably all of them.

An injection mold is mounted in a workholding spindle in a manner such that one half of the mold is secured to the face of the spindle, while the other half of the mold is mounted on a mechanism that raises and lowers and/or slides back and forth to open and close the mold. If desired, refrigerant or water may flow through the mold to cool the material after injection. The mold is designed in such a way as to leave the workpiece on the spindle half of the mold when the mold opens. Ejector pins are built into the spindle half of the mold and are deployed when the finished product is ready to be ejected from the mold.

Manufacturing commences with the mold closed. With the spindle stationary, material in the injector is heated by heating bands around the injector and the material is compressed by an injector screw. The hot material flows under pressure into the mold. Coolant flows through the mold, solidifying the material. When the material has solidified, the opening mechanism pulls the upper half of the mold away, exposing the workpiece still in the lower half of the mold that is secured to the spindle.

Depending on the machining operations desired, the spindle may turn the workpiece in any direction before stopping for a machining operation performed by a milling head on the tool turret under CNC control. The workholding spindle may also spin the workpiece at high speed, allowing machining to be performed with a cutting tool, grinding bit or sanding head.

With machining operations complete, an automated inspection operation begins. Either the primary tool turret or a secondary head moves in such a manner as to bring a camera and laser measuring tool to bear on the part. The part is slowly rotated and the inspection head changes position and orientation as necessary until all desired images and measurements are captured. Measurements, alignments, and images may be referenced to the spatially coherent zero point for the SCOFAST machine, allowing for precise registration and facilitating image processing and pattern recognition. A computer program analyzes the images and measurements, comparing them to desired specifications and tolerances.

If the part passes automated inspection, either the primary tool turret or a secondary head is positioned to bring a pressing head to bear upon the workpiece. The pressing head is advanced toward the workpiece and makes contact with the workpiece at a speed and pressure sufficient to stamp a required identifying mark into the workpiece at a desired location.

If the part fails to pass automated inspection, alternative marks may be stamped into the workpiece. In this manner it is possible to stamp parts with a grade according to the specifications and the tolerances met.

With all operations complete, the ejector pins in the mold push the finished product out of the mold where it is retrieved by a parts catcher. The mold closes and the process repeats.

Those having ordinary skill in the relevant arts will recognize that any material that can be injection molded may be substituted in the example given, and that many process variations are possible. Instead of mounting half of the mold on a spindle, it could be mounted on a bed that moves in the X, Y and Z axis. In such a variation the bed slides under the second half of the mold that is connected to the injector. The mold and its injector come down toward the bed from above to close the mold. After injection and cooling, the injector and its half of the mold lift and the workpiece in the mold on the bed is moved to the side under a tool head for machining and inspection. A further lateral motion moves the workpiece into position for pressing and stamping. With all operations completed, the workpiece bed moves to a retrieval position and ejector pins in the mold eject the workpiece for retrieval by a parts catcher.

Extrusion, Machining, Punching, and Flaring

In one embodiment a SCOFAST machine comprises continuous extrusion, press punching, press flaring, and machining. The example given is of aluminum extrusion and punching, flaring, and machining, but it will be apparent to one having ordinary skill in the art that any extrudable material and any SCOFAST machine operations may be substituted.

One feature of continuous extrusion is that as an extruded workpiece comes out of the die, it moves continuously at a specific speed and direction. This requires that tooling be moving at the same speed and direction during its interaction with the extruded material.

An aluminum extrusion in the form of an upward-facing U-channel exits a die at a temperature in the range of about 1000 degrees Fahrenheit and moves forward at a constant speed. The extrusion passes below a machining toolhead under CNC control, and a pattern of scalloped cutouts is milled from the upper edges of the extrusion. Another toolhead positioned above the extrusion comprises a forming press with tools for punching and flaring. This press moves at the same speed and in the same direction as the extrusion, while matching dies move in synchrony below the extrusion. A pair of forming operations occur as the bottom of the U-channel extrusion is first punched and then flared. When the forming operation is complete, the press tools and dies move back toward the extrusion die to repeat the forming step on another segment of extrusion. The yield strength of the material is reduced at elevated temperatures, allowing both machining and forming operations to be performed with a significant reduction of energy and tool wear.

The ability to perform the extrusion, forming, and machining operations together within a SCOFAST machine saves production time, machine floor space, energy consumption, tool wear, and labor, resulting in lower production cost along with improved tolerances. Since hot forming and hot machining do not require as much force as cold forming and machining, equipment costs may also be reduced.

It will be apparent to one having ordinary skill in the art that similar embodiments exist with any number of variations, such as a steel workpiece that is hot rolled or cold rolled rather than extruded, in a sheet form rather than a U-channel, and with any number of cutting, drilling, milling, punching, dimpling, grooving, and/or other machining and forming operations applied in the same manner as described above. Surface treatments and/or other transformative operations may equally be added as additional operations.

Rolling, Punching, and Machining

In another embodiment steel plate is roll-formed, punched, and machined in a SCOFAST machine. In this embodiment rolled steel plate is used as an example, however any material that is amenable to rolling may be substituted.

During the manufacturing method of rolling (whether hot or cold rolling) the rolled material is at a prescribed thickness and an elevated temperature as it exits the final set of rolls. It is also moving at a defined rate of speed that is synchronized with the rolls. The elevated temperature lowers the yield strength of the material, reducing the force required for machining, punching, and other operations.

As the material exits the rolls it passes under one or more machining heads that mill features such as grooves, chamfers, round-overs, and bevels into the sheet, which then passes between two drums spanning the width of the plate, one below the plate and the other above. One drum holds female dies and the other holds matching male punches. Both drums turn at the same linear speed as the sheet material so that the dies and punches remain aligned when they come into contact with the sheet of rolled material, causing dimples and holes of various shapes to be punched into the plate at regular intervals. The drums are at such as size as to allow the punches and dies to enter and exit each other smoothly and at the proper tolerances to facilitate clean punching. Oil is sprayed onto the drums to keep the punches and dies lubricated and cool. The formed steel plate exits the drums still hot, with milled, punched, and pressed features now part of the finished product.

High Pressure Die Casting and Machining

In another embodiment, operations performed in a SCOFAST machine comprise high pressure die casting and machining. Engine crankcases are among the many parts that may be produced through high pressure die casting. Under current practice, a die cast crankcase has invariably been removed from its mold and transferred to other machines for further operations such as transverse punching, precision face machining, and drilling and tapping. An example is given in which such operations are advantageously performed within a SCOFAST machine.

In this example the object being manufactured is the magnesium crankcase of a chainsaw, however any material amenable to being die cast as a starting point for a desired part may be substituted. As in traditional die casting, the mold is composed of two halves that mate together. One half of the mold is attached to the mechanism that puts the liquid magnesium into the mold under pressure. This half of the mold also has ejection pins that push the finished crankcase out of the mold. The other half of the mold is on a moving mechanism that opens and closes the mold during casting. The mold is designed in such a way that the workpiece is released from this half of the mold when the mold is opened.

With both halves of the mold closed and heated, liquid magnesium enters the mold under pressure, filling the cavity of the mold completely. Coolant then flows through passages in the mold to speed solidification of the magnesium. When the magnesium is solidified, the mold is opened by the retraction of the moveable half of the mold, exposing the freshly cast workpiece and the face that needs to be precisely machined.

A facing mill cutter on a CNC controlled tool spindle is moved into position and a face milling operation is performed to face off the workpiece. Once the face milling operation is complete, the tool spindle retracts and ejector pins in the mold release the finished chainsaw crankcase out to be retrieved by a parts catcher.

A CNC vacuum head approaches to remove any milled chips, and a die lubricant is blown into the mold, which closes for preheating in anticipation of another die casting cycle.

It will be immediately apparent to one having ordinary skill in the art that the performance of die casting and face milling together in a SCOFAST machine can significantly reduce the cost of manufacturing chainsaw crankcases and similar parts because maintenance of spatial coherence eliminates the need to index each crankcase in a jig on another milling machine. Additional savings come from the reduction in need for factory floor space, the need for fewer machines and machine operators, and the reduction of the space, time, and labor needed to move workpieces from one machine to another.

It will be apparent to one having ordinary skill in the art that every particular of this example is amenable to many variations possible within the System and Method disclosed herein. The material need not be magnesium, the near-net part need not be produced through high-pressure die casting, the machining operation need not be face milling, and additional SCOFAST operations may be performed as desired.

Spin-Welding and Machining

In another embodiment, principal operations performed in a SCOFAST machine comprise spin welding (friction welding) and turn-machining. In this embodiment a SCOFAST machine comprises a main spindle with a workholding element such as a chuck or collet, a partially open induction heating element, a second workholding element mounted on a second spindle that is coaxial with the primary spindle and has motion control allowing it to be moved in the axial direction, and a multi-axis toolholder that permits tools to bear upon workpieces held in either the primary or secondary spindle workholders. A high-speed brake is fitted to the primary spindle. A clutch is fitted to the secondary spindle and configured so that the secondary workholder is locked to the secondary spindle when the clutch is engaged and spins freely when the clutch is disengaged. Two workpieces are secured in the two workholders and each one is faced off by a tool in the tool turret so that the two faces are orthogonal to the spindle. The heating element is optionally deployed to preheat one or both of the workpieces. This is particularly useful if the two workpieces are of different materials or of different sizes. The main spindle is brought to a desired speed that depends on the workpiece material and size. The clutch is engaged and the secondary spindle moves forward until the machined faces of the two workpieces are brought into contact and they are forced together at a desired pressure that depends on the workpiece material and size. As the main spindle workpiece spins, friction between the two workpieces causes them to heat up. When they have reached the correct temperature and the desired amount of workpiece material has flowed (the weld has occurred), the second spindle clutch is disengaged and the primary spindle brake is engaged, allowing the two workpieces to remain pressed together with no further relative rotation between them. The joined workpieces are optionally flooded in a machining fluid, and machining tools are brought forward to machine away any excess material from the welded joint and to machine any desired features into any part of the joined workpiece. Since the operations are performed in a spatially coherent manner, the machined features will retain coaxiality with the unified workpiece.

Food Manufacturing

In one embodiment a SCOFAST machine is configured for use in the food industry. For example, it may be used to manufacture a ham-like product “nuHam” using vat-grown meat paste and artificial bone substrate with the following steps.
1. A bar of osseous material is advanced through a collet and turned to size (“the bone”).
2. The end of the bone is flared to serve as a retention feature.
3. Adhesion-promoting material is applied to the bone surface.
4. A paste of vat-grown meat is deposited around the rotating bone, using an extrusion head.
5. A pressing die and thermal energy are used to press-form the vat-grown meat into a final ham shape.
6. Pressing artefacts are machined away.
7. Surface treatments are applied for color, texture, and consistency.
8. Coatings are added, such as “honey glaze.”
9. The nuHam is trimmed to a finished state.
10. A thermal treatment is applied.
11. The nuHam is sliced with a cutter to produce a spiral slice.
12. A support mandrel is placed inside the bone and a cutoff tool cuts off the finished product.

### OTHER EMBODIMENTS

Many other embodiments are possible.

In one embodiment a SCOFAST machine is configured to perform a first operation comprising forging and a second operation comprising drilling. For example, a support strut is manufactured from a length of round barstock by forging a flat segment at each end and drilling a hole at a precise location and orientation in each flat segment.

In one embodiment a SCOFAST machine comprising a machining element, an induction heating element, and a fluid delivery element is configured to perform a first operation consisting of machining a workpiece and a second operation consisting of surface hardening the workpiece by controlled induction heating and subsequent cooling with or without quenching.

In one embodiment a SCOFAST machine comprises forming elements combined with the geometry and machining functions of a Swiss Screw machine, in which the workpiece is a long bar that passes through both a main spindle collet and a guide bushing. The collet sits behind the guide bushing, and tools sit in front of the guide bushing. To cut lengthwise along the part, tools will move radially inward to a desired depth of cut and the material itself will move back and forth along the main spindle axis. This allows work to be performed on the workpiece close to the guide bushing where deflection is minimized, making the design ideal for working on slender or less rigid workpieces. An advantage of this geometry is that forging may be performed against the guide bushing rather than against the collet directly, and different guide bushings may readily be customized to have different profiles that tolerate and manage high temperatures and high pressing forces (isolating them from the collet and spindle) while serving as a shaped rear face of a forging die.

In one realized embodiment a SCOFAST machine such as a forchine has a geometry similar to that shown in FIG. 21, in which an active tooling turret provides both active and passive machining tools as well as a source of forming force directed along the primary spindle axis. The primary spindle collet or a bushing or forging plate serves as a forging anvil or as the rear face of a forging die. The design can deliver and withstand at least 1.5 tons of forming and forging force in a modern form and frame.

In one embodiment a SCOFAST machine has a geometry similar to that shown in FIGS. 9A, 9B, and 9C.

In one embodiment a SCOFAST machine has a geometry similar to that shown in FIG. 10.

In one embodiment a SCOFAST machine has a geometry providing for a mid-frame carriage that can be moved aside so that more than one carriage may operate colinearly with a main workholding spindle. The advantages of such an arrangement are apparent, including the ability to utilize one carriage and turret for the application of force and another for the positioning and operation of multiple active and passive machining tools that all operate in the same axis. The approach may be generalized to any number of carriages.

In one embodiment a SCOFAST machine comprises a turning, machining, or turn-machining center having an induction heating system that periodically transfers thermal energy to a workpiece (or a portion thereof) to reduce the yield strength of the material sufficiently to facilitate otherwise-difficult machining operations.

In one embodiment a SCOFAST machine is configured in a manner similar to that shown in FIG. 11. Molten material is injected into through a feeder tube [1] to partially fill a die cavity made up of die elements comprising at least one moveable part [6]. A casting ram [4] advances to close off the feed tube and the die while solidification occurs. A pressing element [8] advances to close the die and forge the hot solidified material, causing it to undergo plastic deformation and flow to fill the die cavity. The pressing element retracts the die body [6], exposing the cast and forged workpiece. If advantageous, the die body is removed by a tool-changer (not shown) and replaced by a workholding collet that grasps the workpiece securely. Toolheads holding active and/or passive tooling [7, 9] advance to perform machining operations. Additional operations are performed as described in other embodiments.

In one embodiment a SCOFAST machine is configured in a manner similar to that shown in FIG. 12. A billet of material to be extruded is fed into die [2] and an extrusion force is applied, forcing the material to undergo plastic deformation in the throat of the die and extrude through the collet [4] to form a workpiece [5]. The collet clamps the extrusion securely. An induction coil (not shown) is used to heat the workpiece, which is heated, forged and machined as described elsewhere.

In one embodiment a SCOFAST machine is configured in a manner similar to that shown in FIG. 13. A workpiece [5] is placed in a collet [4] and clamped between a clamping ring [2] and a forming die [6]. A forming punch is pressed against one side of the workpiece and force is applied by hydraulic press [10] while the forming die is pressed firmly against the clamping ring by hydraulic press [8]. When the workpiece material has been fully deformed into the forming die, the die is removed and machining operations are performed as described elsewhere.

In some embodiments a SCOFAST machine comprises components that perform functions and produce effects through the actions of other machines and/or through processes including chemical action and the operation of powers of nature upon materials.

In one embodiment a Forchine comprising an induction heater and a forging head is capable of performing heating and forging operations on a cylindrical billet of grade 5 titanium that is 0.5 inches in diameter and 0.75 inches long, where the induction heater raises the temperature of the billet to about 900 C and the forging head exerts a force sufficient to upset forge the billet to a final length of about 0.5 inches.

In some embodiments a SCOFAST machine includes all devices used or required to control, regulate or operate such a machine, whether connected directly or indirectly, and whether or not dedicated solely to such control, regulation, or operation; together with any jigs, dies, tools, and other devices necessary to the operation of or used in conjunction with that SCOFAST machine. In other embodiments some of the elements described form part of the SCOFAST machine, while others are external elements that communicate or interact with the SCOFAST machine itself

In some embodiments, entirely new manufacturing machines are designed and built according to the system and method disclosed. In other embodiments the system and method are retrofitted to an existing machining, additive manufacturing, or forming center. It will be apparent to those having ordinary skill in the arts that virtually any machining center is capable of being easily modified to take advantage of the system and method disclosed.

In one embodiment, forming and other SCOFAST operations are integrated into a universal multi-axis machining center. One currently commercially available example is the Doosan SMX series of 9-axis machining centers, which is named here simply as a single example of the genus of multi-axis machining centers.

In some embodiments the workpiece is secured by a workholder that remains in a fixed location relative to the earth, while in others it may be held in a workholder that undergoes some combination of deterministic translations and or rotations (i.e., transformations that may be defined by a homogeneous transformation matric such as is commonly used in robotics, mechanics computer graphics, and elsewhere) within the spatially coherent machine.

In various embodiments, the forces used in forming and machining may be derived from any source and any type of source now known or that may be developed in the future. In one embodiment a forming or machining force is derived from hydraulic cylinders. In another embodiment a force is derived from pneumatic cylinders. In another embodiment a force is derived from linear actuators. In another embodiment a force is derived from servo drives. In another embodiment a force is derived from electromagnetic attraction or repulsion. In one embodiment a force is derived from a combination of two or more sources of the same or different types, with forces delivered in a single direction or in multiple directions, each source configured to be activated partially or completely, and all sources configured to be activated together or sequentially or in any desired sequence.

In some embodiments the operations of a SCOFAST machine are controlled manually by a machine operator. In some embodiments the operations of a SCOFAST machine are controlled by mechanical control systems comprising elements such as cams, pawls, switches, and sensors. In some embodiments the operations of a SCOFAST machine are controlled by a computer that may form part of the SCOFAST machine or may be a dedicated or general purpose computer that is external to the machine itself. In some embodiments a SCOFAST machine comprises a computerized numeric control (CNC) system such as is commonly used in automated machinery. In some embodiments a SCOFAST machine executes G-Code or another machine control code. In some embodiments the operation of a SCOFAST machine is controlled by a control language that may be proprietary or may conform to a published standard or may be open source. In some embodiments the operation of a SCOFAST machine is controlled by a multiplicity of methods. In some embodiments the operation of a SCOFAST machine may be controlled by existing methods that are not described here, or by methods that may be developed in the future.

In one embodiment, index positioning of the workpiece is performed manually. In another embodiment index positioning is performed by a robotic arm. In another embodiment index positioning is performed by a spindle or sub-spindle, a sliding collet, an indexing tool in a toolholding turret, or a dedicated indexing machine element.

In one embodiment a workpiece is secured in a first workholder while a series of SCOFAST operations are carried out to form and machine the exposed surfaces, after which the workpiece is subsequently secured by a second workholder and released from the first workholder, after which further forming and/or machining operations may be performed on previously obscured aspects of the workpiece.

In one embodiment a SCOFAST machine includes one or more single-axis or multi-axis robotic arms such as are shown in FIGS. 7A, 7B, 7C, and 7D, each robotic arm being configured to perform some advantageous function as part of operations performed within the SCOFAST machine. In one example, a robotic arm may be configured to have an induction heating coil as a terminal element, to place the induction heating coil in a desired position for heating, and to remove it when heating is complete. In another example, a robotic arm within a SCOFAST machine may be configured to have a spray welder as a terminal element and to perform an additive operation using the spray welder to deposit layers of material on a workpiece.

In one embodiment a SCOFAST machine comprises a virtual reality (VR) display, augmented reality (AR) display, and/or heads up display (HUD) permitting observation of the machine, workpiece, and/or operations that are being performed, will be performed, or have previously been performed within the machine, Such displays may additionally show information about the state of the machine, workpiece, tooling, and/or other information of interest.

In one embodiment a SCOFAST machine comprises a virtual reality (VR) display configured to display current, planned (future), or previously completed (historical) operations using VR modeling techniques such as are known to those having skill in the relevant arts, and additional techniques that may be discovered or invented in the future.

In one embodiment a VR, AR, or HUD display is configured to provide assistance to an operator performing a setup within a SCOFAST machine, an operation or series of operations within a SCOFAST machine, maintenance on a SCOFAST machine, configuration of a SCOFAST machine, programming of a SCOFAST machine, or engaged in any other interaction with a SCOFAST machine.

In one embodiment a SCOFAST machine is a multi-axis machining center in which at least one of the workholding spindles and at least one of the tool turrets, working together, are capable of delivering and receiving an axial forging and pressing force in the range of about 1000 lbs-force to about 50,000 lbs-force, preferably from about 1000 lbs-force to about 6000 lbs-force. In one embodiment such a machine additionally comprises an induction heating apparatus capable of heating a workpiece to facilitate forging and pressing and for other purposes.

In one embodiment a SCOFAST machine comprises a first tool configured to perform an additive operation such as 3D printing, a second tool configured to perform a force-delivering forming operation such as hot die forging, a third tool configured to perform a force receiving operation such as serving as an anvil for hot die forging, a fourth tool configured to perform a subtractive operation such as machining, a fifth tool configured to perform a transformative operation such as heating, a sixth tool configured to perform a measuring operation such as laser optical measuring, a seventh tool configured to perform a marking operation such as laser marking, an eighth tool configured to perform a subtractive operation such as cutoff, and a ninth tool configured to retrieve the finished part for outloading. Each tool is mounted on a toolholding and positioning (THP) device. The position and orientation of each tool is precisely controlled by a control unit operated by a computer. Each tool may be mounted in a different THP device, or multiple selectable tools may be mounted in a single THP device. Each THP is configured to move a tool in at least one axis and preferably in 2, 3, 4, 5, or more axes. A THP may be configured to change tools according to instructions from the control unit, various tools being made available to each THP by means of a tool provisioning unit (TPU). Each THP may optionally comprise a robotic arm.

In one embodiment an active tool within a SCOFAST machine that is configured to perform an additive operation such as 3D printing comprises a filament extrusion mechanism similar to the extrusion mechanism illustrated in FIG. 22.

In one embodiment a series of operations performed within a SCOFAST machine include compacting powders into a die to form a workpiece or a feature of a workpiece, such as a candy, a pill, a carbide blank, a bearing surface, or any other part or feature of a part. Pressures used in cold compacting operations depend on the material being pressed. For certain purposes (e.g., biological and food materials) they may be in the range of about 0.1 PSI to about 1000 PSI, while for others (e.g., blended carbide powders) they are generally in the range of about 10,000 PSI to about 50,000 PSI and preferably about 30,000 PSI. For many materials the pressure required for bonding may be reduced significantly by the addition of thermal energy, particularly when the material is heated to a temperature suitable for sintering the material (“hot compacting”).

In one embodiment, a SCOFAST machine comprises a workholding spindle as well as a tool turret on which multiple mandrels are provided for rotary tools, non-rotary machine tools, and additional machining tools such as lasers or electro-discharge machining tools. Tools are arranged in a tool magazine and are exchanged as needed so that an arbitrary shape may be machined by means of turning, drilling, milling, grinding, hobbing or shaping, laser processing, induction hardening, electro-discharging, and other subtractive operations that are named in this specification together with other subtractive operations that are known to those having ordinary skill in the art or that may be discovered or invented in the future.

In one embodiment a SCOFAST machine incorporates a plurality of workholding spindles and a plurality of work heads, each work head possessing a plurality of toolheads and each capable of performing any of a variety of operations depending what tools are loaded into the toolheads of a work head. Work heads are brought to act upon a workpiece that is secured at a working locus. Work heads may act upon the workpiece either singly or in combination with other work heads.

In one embodiment the system and method are instantiated as a machine element that may be fitted to existing machinery in order to implement a desired SCOFAST element. For example, robotic arms such as are illustrated in FIGS. 7A, 7B, 7C, and 7D may be incorporated into an existing machining center to carry out various operations such as inductive heating and hot forming within the existing spatially coherent work space of the machining center.

In one embodiment a carrier brings a forging die into position, after which a secondary drive (the “forging driver”) is activated. In a preferred embodiment the secondary forging driver is powered by a hydraulic mechanism. In other embodiments it may be powered by a pneumatic mechanism, an electrical linear driver, a magnetic rail driver, a worm gear, a mechanical lever, or any other mechanism now existing or that may arise in the future. The purpose of the forging driver is to move a forging die or platen forward at a desired velocity to deliver a desired amount of force at the moment of contact with a workpiece, with a desired amount of residual force continuing to press the platen forward after an initial contact.

In one embodiment a turret that holds multiple tools may hold one or more additive tools such as a 3-D printing extrusion head, one or more forming tools such as a hot forging die, and one or more active or inactive machining tools such as a chamfering tool or a rotary cutter.

In one embodiment a SCOFAST machine is configured for warm or hot machining. Many high-value alloys are very difficult to machine due to high toughness and a high tendency to work hardening. In this embodiment a workpiece is heated to a temperature sufficient to reduce the yield strength of the material, preferably above about 30% of the absolute recrystallization temperature of the material (warm machining) and more preferably above about 60% of the absolute recrystallization temperature of the material (hot machining), and is then machined at or about said temperature using such tooling and lubricants as may be advantageous at the desired temperature, such as those described in this specification and/or commonly known to those having ordinary skill in the arts, and others now existing or that may be discovered in the future.

In one embodiment a workpiece is heated above a specified temperature that is within a range of temperatures from about 30% to about 90% (inclusive) of the recrystallization temperature of the workpiece material on an absolute scale, the temperature preferably being above about 60% of the recrystallization temperature, and a machining operation is performed while the workpiece remains above that temperature.

In one embodiment the thermal energy content of a workpiece is adjusted to bring the workpiece to a specified temperature that is within a range of temperatures from about 0% to about 30% (inclusive) of the recrystallization temperature of the workpiece material on an absolute scale, the temperature preferably being above about 20% of the recrystallization temperature, and a machining operation is performed while the workpiece remains within that range of temperatures.

In one embodiment a workpiece is heated to a specified temperature that is within a range of temperatures above about 90% of the recrystallization temperature of the workpiece material on an absolute scale, the temperature preferably being about 100% of the recrystallization temperature, and a machining operation is performed while the workpiece remains within that range of temperatures.

In some embodiments operations are performed on more than one workpiece simultaneously within a SCOFAST machine.

In some embodiments induction heating is performed through the use of more than one induction coil, each coil being independently supplied with electrical energy using different parameters. For example, multiple coils applied to a workpiece may each receive a different power and frequency and thus may generate a different field strength. By this means it is possible to create differential heating zones, to improve the evenness of heating in irregularly shaped objects, and to accomplish other advantageous thermal operations that will be evident to those having ordinary skill in the art. In some embodiments different field depths are used to control the distribution of heat throughout the workpiece.

In an embodiment in which an induction coil is used to deliver thermal energy to a workpiece, the induction coil may have any geometry and may be placed in any orientation relative to the workpiece. For example, a closed coil may be used, requiring that the workpiece be moved axially into the coil or that the coil be moved axially over the workpiece. In another example, a partially open coil may be used, the open area allowing it to be moved transversely over and around a workpiece. In another example, a split or hinged coil may be used, allowing the coil to be moved transversely before being closed to form a complete circular or helical wrap around the workpiece. In other examples, any other coil geometry or combination of geometries may be used.

In one embodiment an induction coil used to deliver thermal energy to a workpiece is fitted with a sleeve as illustrated in FIG. 6: Induction heating coil detail showing internal insert. The sleeve (2) may be fitted inside the coil (1) as shown, or it may be fitted around the outside of the coil, or it may extend both inside and outside the coil. The sleeve may serve to add coil rigidity, to establish a uniform standoff (coupling) distance between the coil and a workpiece, to provide a wear surface to protect the coil and/or the workpiece, and/or to retain liquids, gases and vapors such as liquid or vaporized machining fluid, neutral gas mixtures, treatment fluids, vapors, or gases. The sleeve facilitates displacement of an unwanted gas mixture from the volume of space immediately adjacent to the workpiece during heating. The coil sleeve may include a flange as indicated at (3). The flange may serve as a partial or complete seal against a collet or other workholder that secures a workpiece, stabilizing the coil and improving the displacement of unwanted gases such as oxygen or hydrogen during heating of the workpiece.

In one embodiment the energy content of a workpiece and one or more tools are each manipulated independently, for example as when cutting tools are maintained at one temperature, forming dies are maintained at a second temperature, and a workpiece is maintained at a third temperature.

In one embodiment a SCOFAST machine comprises an element performing a function or operation wherein the result or effect is produced by mechanical powers, machines, and devices.

In one embodiment a SCOFAST machine comprises an element performing a process wherein the result or effect is produced by chemical action.

In one embodiment a SCOFAST machine comprises an element performing a process wherein the result or effect is produced by the operation or application of some element or power of nature.

In one embodiment a SCOFAST machine comprises an element performing a process wherein the result or effect is produced by the operation or application of one substance to another.

In one embodiment a workpiece is heated and forged more than once. Additional heatings after the first may be at different temperatures, and forces may be different for each forging operation.

In one embodiment a first operation performed within a SCOFAST machine comprises an additive operation to generate or add material to a flexible workpiece such as a fabric, textile, plastic, or other wearable material, a second operation comprises a forming operation such as hot pressure molding, and a third operation comprises a subtractive operation such as cutting.

In one embodiment a SCOFAST machine is configured to first machine a model of a desired part from a material that may be melted, vaporized, or combusted; then invest that model in a plaster mold; then burn away the model and cast the part in the mold by pouring, injection, vacuum, or other casting technique; then machine the casting to final specifications; and then add surface coatings to the part, all steps being performed within the same machine in a spatially coherent manner.

In another embodiment a SCOFAST machine is configured to first 3D print a model of a desired part from a sacrificial material that may be melted, vaporized, or combusted; then invest that model in a plaster mold; then burn away the model and cast the part in the mold by pouring, injection, vacuum, or other casting technique; then machine the casting to final specifications; and then add surface coatings to the part, all steps being performed within the same machine and in a spatially coherent manner.

In another embodiment a SCOFAST machine is configured to first 3D print and subsequently machine a model of a desired part from a sacrificial material that may be melted, vaporized, or combusted; then invest that model in a plaster mold; then burn away the model and cast the part in the mold by pouring, injection, vacuum, or other casting technique; then machine the casting to final specifications; and then add surface coatings to the part, all steps being performed within the same machine and in a spatially coherent manner.

In one embodiment, a SCOFAST machine is configured to inductively heat the area of a workpiece deep inside a hole. Certain operations, such as drilling a long bore hole in titanium alloy, are notoriously difficult due to work hardening that may be unavoidable in certain geometries and with certain machine constraints. Heating the material to reduce the yield strength in the immediate vicinity of the tooling can facilitate drilling and reduce problems with work hardening.

In one embodiment a SCOFAST machine is so constituted as to fabricate a part having several elements that are separated but may remain captive one to another, such as a bolt with a captive washer, or a shackle with a captive closure.

In one embodiment forging is accomplished with a workpiece situated between a force driver serving as a hammer and a force receiver serving as an anvil, or alternatively between a pair of force drivers aligned in opposing directions, each serving both as hammer and as anvil. The force drivers may be driven by pneumatic or hydraulic cylinders, or by a ram or other electromagnetic apparatus, by arrangements of motors with gears and levers, by falling weights, or by any other mechanism. During the time when a forging blow is struck, the hammers and anvils may be decoupled from their frame attachments to avoid transmitting excessive forces.

In one embodiment of a SCOFAST machine elements necessary for the physico-chemical treatment of materials are integrated into a machining center. Many different physico-chemical treatments are susceptible of being integrated into a machining center in this way. The ability to perform each physico-chemical treatment enables a variety of operations on the part that otherwise would have required removal to a secondary machine. For example, integration of part heating (e.g., with an induction coil) enables the integration of machining with forging, stamping, bending, hardening, stress relief, annealing, anodizing, coating, and many other common tasks that traditionally require parts removal for a secondary operation on a secondary machine.

In some embodiments a SCOFAST machine may be used to manufacture biological parts through operations tailored to biological systems. Additive operations may deposit substrates for biomaterial or may directly deposit biological materials. Other additive operations may involve the accretion or growth of living biomaterials. Subtractive operations may include removal of material through biological interactions as well as removal through chemical and physical effects.

In one embodiment, bone matrix is initially created through additive operations, then machined to a desired shape, and finally formed by being held under stress through forces calculated to distort and deform the matrix, altering trabecular patterns of subsequent growth. Forces applied during operations cause the alignment of microstructures that are important to the function of the part.

In one embodiment a SCOFAST machine is configured to manufacture pharmaceutical products through a combination of additive, formative, subtractive, and/or transformative operations, permitting structures or topographic features such as pass-throughs in multiple directions and underhangs that cannot otherwise easily be produced through a single process or in a single machine.

In some embodiments a SCOFAST machine is configured for use in electronics manufacturing. In one embodiment a SCOFAST machine is used in Chip fabrication and configured such that a forming operation (e.g., bonding or shaping materials around a chip circuit) may be followed by a machining operation, as for example to manufacture an integrated heat sink, to make a part interface with some other structure such as a jack or socket, to create a precision fit within a receiving part, or for any of a variety of other purposes that exist today or may arise in the future, as will be readily apparent to one skilled in the art.

In another embodiment a SCOFAST machine is configured to perform a welding operation where the workpiece is a circuit board and energy and force are applied to cause welding of different components of a circuit (e.g., welding wire attachments or battery connections) and the welding operation is followed by a machining operation (e.g., to remove excess material, to remove oxidation, to alter the surface qualities, to change the shape of some part of the workpiece (e.g., to add threads or keying features) or for any other reason.

In other embodiments multiple operations are performed within a SCOFAST machine to manufacture parts that require encapsulation and must be of a certain form, such as a thermistor, resistive temperature detector, analog thermometer integrated circuit, or digital thermometer integrated circuit that must be encapsulated within a thermally conductive material and machined into the shape of a screw or bolt, or into any other shape that must match a receiving shape in an intended use scenario.

In another embodiment a SCOFAST machine is configured to perform multiple operations in the manufacture of parts made from two or more different materials that must be joined together and then made into a specific shape, such as a thermocouple constructed of two or more dissimilar metals that must be laminated together and made in the shape of a screw or bolt, or into any other shape that must match a receiving shape in an intended use scenario.

In another embodiment a first operation comprises machining that results in formation of a receiving pocket in a first component (the workpiece), and a second operation comprises the application of energy and force to deform a second component such that the second component fits securely within the pocket machined in the workpiece. In essence this represents the machining of a die within the first component followed by forging a portion of the second component into that die. If the die contains features preventing the removal of a part forged within the die, then the second component will be retained within the die after forging. In one example the pocket might be machined with an overhang, such that after the application of energy and force to deform the second component within the machined pocket, the second component is permanently retained in place, its interior dimension being now larger than the overhang that prevents its escape. For example, a part may be manufactured through a first step comprising the machining of a pocket within a workpiece wherein the deeper portion of the pocket is cut away more than the superficial portion of a pocket, and a second step wherein a second component comprising a bar of some deformable material is forged into the pocket with a portion of the bar remaining as a protruding shaft after the step is complete, thus creating a protruding shaft with a retaining head fully embedded within the original workpiece. One obvious advantage of the technique is that the shape of the head will conform to whatever shape the pocket is made, allowing for retention in workpieces having constrained geometries. Further machining steps may be applied to shape the protruding shaft, as for example to cut away relief zones, to add threads, or to introduce keying features.

In some embodiments a SCOFAST machine is configured to manufacture parts through a combination of machining operations and press-fitting operations. For example, it may be desirable to machine a blind or through hole into a workpiece, press-fit a second part into the hole, and then machine portions of second part to establish a final shape with defined spatial relationships to the workpiece, the whole now comprising a compound workpiece that may be the base for further operations in a SCOFAST machine. It will be obvious that (as for every example given within this specification) the process described may be repeated as many times as desired, with new holes being machined and new parts being press-fit into those holes and subsequently machined to shape, and so ad infinitum.

For example, a spatially coherent composite operation might be described as drilling a hole in a Ti 6Al-4V (Grade 5) titanium metal workpiece, heating the workpiece to expand the hole, press-fitting a Ti 6Al-4V titanium metal part into that hole while leaving a protruding stud, welding a retention bead around the base of the metal part, machining away the superficial portions of the bead, and machining threads on the protruding metal stud. Although the example describes specific operations performed using a single alloy of a single metal (titanium), it is obvious that the example generalizes to include other metals and other alloys.

In one embodiment an existing turning machine, milling machine, screw machine, or other machine capable of performing operations used to manufacture parts is retrofitted to serve as a Forchine.

In one embodiment, a material is formed to a near-net-shape through operations including a forming operation, and surface features are milled in a biomachining step.

In some embodiments a SCOFAST machine is configured to perform an operation during which force is applied to achieve elastic deformation without plastic deformation. For example, it may be advantageous to deflect a workpiece or a portion thereof from its original position in order to provide access for a tool that otherwise could not gain access to a desired portion or aspect of a workpiece. In another example, it may be desirable to hold the workpiece in an elastically deformed position while performing a transforming operation such as annealing, heating, cooling, acoustic treatments, radiation exposure, chemical exposure, or any other physical or chemical treatment.

In one embodiment a material is formed into a particular shape before being machined into a final shape without removing the material from the machine.

In one embodiment a treatment is performed that changes a property of the material in one step before machining the material in another step.

In one embodiment a workpiece is formed via injection molding before being altered by machining.

In one embodiment a series of operations performed within a SCOFAST machine comprise casting, forging, machining, and press-fitting.

In one embodiment metal is liquified and delivered under pressure into a split die that is used both for casting and forging. The base die is held in a workholder that can be positioned and rotated as needed. The face die is attached to a press cylinder and is brought forward to mate with the base die. A casting is made with a small excess of material, and when casting is complete the press cylinder applies a force sufficient to cause plastic deformation of the cast workpiece, thus improving the density, precision, mechanical properties, and finish of the workpiece and eliminating defects such as pores and shrinkage cavities. Additional heat may be supplied by means of induction coils that are introduced into the area as needed. Small features that are difficult to cast may be achieved reliably through the addition of the forging step. Once the forging step is complete, one of the dies is retracted and a workholder is moved in place to secure and position the workpiece for further operations. The second die is retracted, allowing machine tool access to one side of the workpiece. Machine tools are brought into position to machine additional features such as undercuts, highly specified surfaces, holes, threaded elements, and other features that cannot easily be cast or forged. If back-machining operations are to be performed, a second workholder is advanced to secure and position the workpiece from the opposite side, and the first workholder is retracted allowing machine access to the other side of the workpiece. When all machining is complete, a gripper positions a bearing at the opening of a cavity in the workpiece, and the press cylinder advances to press the bearing into place. The workpiece is then released by the workholder, held by a gripper that places it into a collection area.

In one embodiment operations performed within a SCOFAST machine comprise a first operation selected from the group of operations comprising all transforming operations and a second operation selected from the group of operations comprising all subtractive operations.

In one embodiment operations performed within a SCOFAST machine comprise a first operation selected from the group of operations comprising all forming operations and a second operation selected from the group of operations comprising all subtractive operations.

In one embodiment operations performed within a SCOFAST machine comprise a first operation selected from the group of operations comprising all transforming operations and a second operation selected from the group of operations comprising all additive operations.

In one embodiment operations performed within a SCOFAST machine comprise a first operation selected from the group of operations comprising all forming operations and a second operation selected from the group of operations comprising all additive operations.

In one embodiment operations performed within a SCOFAST machine comprise a first operation selected from the group of operations comprising all additive operations, a second operation selected from the group of operations comprising all forming operations, and a third operation selected from the group of operations comprising all subtractive operations.

In one embodiment operations performed within a SCOFAST machine comprise a first operation selected from the group of operations comprising all additive operations, a second operation selected from the group of operations comprising all transforming operations, a third operation selected from the group of operations comprising all forming operations, and a fourth operation selected from the group of operations comprising all subtractive operations.

In one embodiment, another part such as a washer, standoff, or sleeve is positioned over the bolt shaft after some or all operations are complete, and an additional operation adds a retention feature such as a crimp or a bead to hold the added part captive.

In some embodiments a SCOFAST machine may include a “forging plate” situated between the workholding collet and the workpiece. A forging plate may be embossed or engraved, thus producing marks on a surface of the forged part. It may also serve as all or part of a forging die. A forging plate may serve as a bushing or may itself serve as a collet to clamp a part. A forging plate may receive support or bracing that serves to transmit forging forces to a frame element, thus reducing or eliminating the component of forming forces that must be transferred through spindle bearings. If a forging plate includes a collet, the main spindle collet may be relaxed during high-force operations such as forging, allowing the forging plate to receive and transmit the entire force with no involvement of spindle bearings.

In some embodiments a toolhead also serves as a pressing head. Whether a toolhead is advanced by a hydraulic cylinder, by a servo drive, by a linear actuator, or by any other method, it may be configured to serve as a presshead as well as a toolhead. All parts of the pressing system must be sized appropriately to deliver the speeds, forces, and precision required for the tasks to be performed. In the case of hydraulics, pump pressure and flow capacity must be sized for the largest force and highest speed required, with pressure and flow controls used to supply lesser hydraulic requirements as necessary. Where the toolhead is servo driven rather than hydraulic, servo drives, worm screws, and the like must similarly be sized for the maximum press forces and speeds required, with control systems adjusting the behavior of the drives for each specific task.

Whatever force is to be applied, all parts of the machine that are involved in the pressing function must be capable of withstanding that force without excessive movement. For example, if the turning apparatus is also to serve as the pressing apparatus then the frame, carriage, pressing head, collet, spindle, spindle bearings, spindle mounts, and other parts of the machine must be sufficiently strong and rigid to support the necessary forces without unwanted deflection.

In some embodiments it is not advantageous desirable to have a toolhead also perform a pressing function, in which case a sub-assembly comprising a hydraulic or servo press with its own pressing frame may be integrated into or mounted to any part of the machine in any orientation desired, being positioned so that the pressing action may be directed along any axis to any desired aspect of the workpiece.

In one embodiment a SCOFAST machine is configured to perform a drawing operation combined with additional operations that may be of any type. Barstock is fed into the machine and passes through a spindle, spindle collet, induction heating coil, and thence to a draw-plate or forming rollers. A gripping tool on a tool positioner grips the barstock and places it in tension, causing the material to be hot drawn or hot rolled to a smaller diameter and potentially a different cross-section compared to the original barstock. Any combination of manufacturing operations may follow. The ability to alter the base diameter or cross-sectional shape of barstock in this manner yields many advantages. For example, multiple sizes of screws and bolts and various stepped diameter features may be manufactured from a single size of barstock without increasing the amount of waste that must be cut away to make the part.

In one embodiment a SCOFAST machine is configured to perform a transforming operation between two other operations, treating a workpiece between a first and second sub-operation so that the first sub-operation benefits from one set of physical properties of the material and the second sub-operation benefits from a second set of physical properties of the material. For example, treating a material before or during the performance of an operation so that the operation benefits from a change in the physical properties of the material.

In some embodiments one or more operations within a SCOFAST machine may be performed in a protective atmosphere or in an atmosphere providing one or more substrates in gas or vapor form. For example, an argon protective atmosphere may be used to reduce or eliminate oxidation. A nitrogen atmosphere may be used to encourage the formation of nitrides. A mixed atmosphere such as one containing titanium tetrachloride with hydrogen and nitrogen may be used for vapor deposition of surface coatings. Many useful gaseous and vapor atmospheres will be known to those having ordinary skill in the art, and any of these may be used to achieve needed outcomes within the scope of the System and Method disclosed.

In some embodiments a SCOFAST machine may comprise a vacuum chamber and operations may be executed within the vacuum chamber under any specified degree of vacuum. This may be advantageous because certain processes must be performed in a vacuum, while others may be more advantageously performed under vacuum. For example, vacuum can control or eliminate surface reactions when a workpiece is heated. Vacuum processing can also remove contaminants from parts, and in some instances can degas or convert oxides found on the material's surface.

In some embodiments one or more SCOFAST operations may be integrated into a material loader such as a barstock feeder. In an embodiment where barstock passes from a barstock feeder through a spindle and collet into a machining center, such operations occur before the stock passes through the spindle.

In one embodiment two different workpieces undergo different operations before being joined in a welding operation. The weld is then finished in a machining operation.

In one embodiment a forming operation stamps marks that may be decorative or informational as well as functional.

In one embodiment barcodes are printed on or etched into a part by a laser.

In one embodiment a workpiece is formed or machined to have a hollow shaft. A wire is inserted into the hollow shaft and the two are joined by swaging.

In one embodiment two workpieces undergo different operations before the two are joined together by press-fitting or heat-shrink fitting a convex feature of one into a concave feature of the other.

In one embodiment a SCOFAST machine is configured to perform operations on wooden materials.

Treatment Fluid

In one embodiment a treatment fluid (“toughening fluid”) is applied to a workpiece during an operation to produce or facilitate a physical or chemical transformation in the workpiece material, resulting in increased toughness. In one embodiment a toughening fluid is used during hot forming and/or machining operations performed on a titanium alloy workpiece. In one embodiment a toughening fluid is a naturally-occurring oil mixture being largely composed of triacylglycerols comprising oleic acid (about 50-85%), linoleic acid (about 3-25%), palmitic acid (about 7-25%), stearic acid (about 0.1-10%), and linolenic acid (about 0-2%); the major prevalence of triacyl combinations being ordinally OOO, POO, OOL, POL, SOO, SOL; and having optional additional components comprising polyphenols including hydroxytyrosol and tyrosol; and having physical properties as follows: Specific Gravity about 0.90-0.93 kg/m³ at 15.5° C., preferably about 0.915-0.925 kg/m³ at 15.5° C.; Viscosity about 78-88 mPa·s at 20° C., preferably about 80-86 mPa·s at 20° C., more preferably about 84 mPa·s at 20° C.; Specific Heat at 20° C. about 1.75-2.05 (J/g·° C.); preferably about 1.97-2.02 (J/g·° C.), more preferably 2.0 (J/g·° C.); Thermal Conductivity at 20° C. about 0.165-0.180 (W/m·K), preferably about 0.17 (W/m·K); Dielectric Constant at 20° C. about 3.0-3.2, preferably about 3.1; Density at 20° C. about 900-930 kg/m³, preferably about 913-919 kg/m³, more preferably about 916 kg/m³; Thermal Diffusivity at 20° C. about 4-12×10⁻⁸ m²/s, preferably about 5.3-8.3×10⁻⁸ m²/s; Boiling Point at sea level about 298-300° C.; and Smoke point about 190-215° C.

Lubricant Pressure

In one embodiment a coolant and/or lubricant (“machining fluid”) is directed over the tool and/or workpiece at a pumping pressure ranging from 0 PSI to about 3000 PSI, but preferably from about 3 PSI to about 12 PSI. In another embodiment the machining fluid is delivered at a pressure below about 3 PSI. In another embodiment the machining fluid is delivered at a pressure between 12 PSI and 100 PSI, inclusive. In another embodiment the machining fluid is delivered at a pressure between 100 PSI and 200 PSI, inclusive. In another embodiment the machining fluid is delivered at a pressure between 200 PSI and 300 PSI, inclusive. In another embodiment the machining fluid is delivered at a pressure between 300 PSI and 500 PSI, inclusive. In another embodiment the machining fluid is delivered at a pressure between 500 PSI and 600 PSI, inclusive. In another embodiment the machining fluid is delivered at a pressure between 600 PSI and 800 PSI, inclusive. In another embodiment the machining fluid is delivered at a pressure between 800 PSI and 1000 PSI, inclusive. In another embodiment the machining fluid is delivered at a pressure between 1000 PSI and 2000 PSI, inclusive. In another embodiment the machining fluid is delivered at a pressure between 2000 PSI and 3000 PSI, inclusive. In another embodiment the machining fluid is delivered at a pressure above about 3000 PSI.

Lubricant Flow Rate

It may also be advantageous to control the rate of flow of a machining fluid. For conventional flooding, a rule of thumb is that the flow should be increased until the temperature of coolant exiting the machine is no more than 4 C higher than that entering the machine. For high pressure spray cooling, flow rates as low as about 0.5 ml per min may be used. For flood cooling when machining superalloys, the flow rate may be about 20 gallons per minute per tool position (or per inch of grinding width). Higher pressures and flow rates may be necessary to carry away swarf, to clean tools, and for other purposes. In one embodiment a coolant and/or lubricant (“machining fluid”) is directed over the tool and/or workpiece at a flow rate between about 0.001 ml per minute and about 10000 liters per minute, but preferably in a range of about 4 liters per minute. In another embodiment the machining fluid is delivered at a flow rate of less than about 1 liters per minute. In another embodiment the machining fluid is delivered at a flow rate of between about 1 liters per minute and 4 liters per minute, inclusive. In another embodiment the machining fluid is delivered at a flow rate of between about 4 liters per minute and 10 liters per minute, inclusive. In another embodiment the machining fluid is delivered at a flow rate of between about 10 liters per minute and 50 liters per minute, inclusive. In another embodiment the machining fluid is delivered at a flow rate of between about 50 liters per minute and 100 liters per minute, inclusive. In another embodiment the machining fluid is delivered at a flow rate of between about 100 liters per minute and 500 liters per minute, inclusive. In another embodiment the machining fluid is delivered at a flow rate of between about 500 liters per minute and 1000 liters per minute, inclusive. In another embodiment the machining fluid is delivered at a flow rate of between about 1000 liters per minute and 10000 liters per minute, inclusive.

Lubricant Temperature

Under some scenarios it is advantageous to control the temperature of a machining fluid. In one embodiment a series of operations performed within a SCOFAST machine comprise inductive heating followed by hot forging and hot machining. In this embodiment it is desirable to maintain the temperature of the workpiece and tools from start to finish with as little heat loss as possible, while still supplying lubrication. In this scenario it may be advantageous to supply machining fluid at a low pressure of about 12 PSI or less and a flow rate just sufficient to provide the desired amount of lubrication and cooling for the operations to be performed. Machining fluid may be heated or cooled using any type of heating or cooling system.

Strike Speed

In some embodiments forming is performed with a force profile that includes an initial impact delivered at a strike speed (velocity at the moment of impact) between about 0.5 meters/second and about 10 meters/second, preferably about 6 meters/second. In one embodiment the strike speed is greater than about 10 m/s. In one embodiment the strike speed is between about 10 m/s and about 8 m/s. In another embodiment the strike speed is between about 8 m/s and about 6 m/s. In another embodiment the strike speed is between about 6 m/s and about 4 m/s. In another embodiment the strike speed is between about 4 m/s and about 2 m/s. In another embodiment the strike speed is between about 2 m/s and about 1 m/s. In another embodiment the strike speed is between about 1 m/s and about 0.5 m/s. In another embodiment the strike speed is less than about 0.5 m/s.

Forming Force Duration

In some embodiments a forming force is applied and the duration of the resulting plastic deformation (irreversible material flow) of a workpiece is between about 0.001 milliseconds and about 100 seconds, preferably between about 5 milliseconds and about 100 milliseconds. In one embodiment the duration is longer than about 100 seconds. In another embodiment the duration is between about 100 seconds and about 50 seconds. In another embodiment the duration is between about 50 seconds and about 10 seconds. In another embodiment the duration is between about 10 seconds and about 5 seconds. In another embodiment the duration is between about 5 seconds and about 2 seconds. In another embodiment the duration is between about 2 seconds and about 1 second. In another embodiment the duration is between about 1000 milliseconds and about 500 milliseconds. In another embodiment the duration is between about 500 milliseconds and about 100 milliseconds. In another embodiment the duration is between about 100 milliseconds and about 50 milliseconds. In another embodiment the duration is between about 50 milliseconds and about 20 milliseconds. In another embodiment the duration is between about 20 milliseconds and about 10 milliseconds. In another embodiment the duration is between about 10 milliseconds and about 1 millisecond. In another embodiment the duration is between about 1 millisecond and about 0.5 milliseconds. In another embodiment the duration is between about 0.5 milliseconds and about 0.1 milliseconds. In another embodiment the duration is between about 0.1 milliseconds and about 0.01 milliseconds. In another embodiment the duration is between about 0.01 milliseconds and about 0.001 milliseconds. In another embodiment the duration is less than about 0.001 milliseconds.

Range of Deformation Mm

In one embodiment a forming force is applied to a workpiece and a resulting plastic deformation causes material to be displaced by a distance between about 100 mm and about 0.001 mm, preferably between about 20 mm and about 1 mm.

In another embodiment material is displaced more than about 100 mm.

In another embodiment material is displaced between about 100 mm and about 50 mm.

In another embodiment material is displaced between about 50 mm and about 10 mm.

In another embodiment material is displaced between about 10 mm and about 5 mm.

In another embodiment material is displaced between about 5 mm and about 1 mm.

In another embodiment material is displaced between about 1 mm and about 0.5 mm.

In another embodiment material is displaced between about 0.5 mm and about 0.1 mm.

In another embodiment material is displaced between about 0.1 mm and about 0.05 mm.

In another embodiment material is displaced between about 0.05 mm and about 0.01 mm.

In another embodiment material is displaced between about 0.01 mm and about 0.001 mm.

In another embodiment material is displaced less than about 0.001 mm

Range of Deformation %

In one embodiment a forming force is applied to a workpiece and a resulting plastic deformation causes material to be displaced by a distance between about 0.1% and about 200% of the workpiece axial length (measured in the axis of the forming force), preferably between about 1% and about 100% of the axial length.

In another embodiment material is displaced more than about 200% of the axial length.

In another embodiment material is displaced between about 200% and about 100% of the axial length.

In another embodiment material is displaced between about 100% and about 75% of the axial length.

In another embodiment material is displaced between about 75% and about 50% of the axial length.

In another embodiment material is displaced between about 50% and about 25% of the axial length.

In another embodiment material is displaced between about 25% and about 10% of the axial length.

In another embodiment material is displaced between about 10% and about 1% of the axial length.

In another embodiment material is displaced between about 1% and about 0.1% of the axial length.

In another embodiment material is displaced between about 0.1% and about 0.01% of the axial length.

Range of Change in One Linear Dimension

In one embodiment a forming force is applied to a workpiece and a resulting plastic deformation causes a change in a linear dimension of the workpiece between about 100 mm and about 0.01 mm, preferably between about 10 mm and about 1 mm.

In another embodiment a linear dimension changes by more than about 100 mm.

In another embodiment a linear dimension changes by between about 100 mm and about 50 mm.

In another embodiment a linear dimension changes by between about 50 mm and about 10 mm.

In another embodiment a linear dimension changes by between about 10 mm and about 5 mm.

In another embodiment a linear dimension changes by between about 5 mm and about 1 mm.

In another embodiment a linear dimension changes by between about 1 mm and about 0.5 mm.

In another embodiment a linear dimension changes by between about 0.5 mm and about 0.1 mm.

In another embodiment a linear dimension changes by between about 0.1 mm and about 0.05 mm.

In another embodiment a linear dimension changes by between about 0.05 mm and about 0.01 mm.

In another embodiment a linear dimension changes by between about 0.01 mm and about 0.001 mm.

In another embodiment a linear dimension changes by less than about 0.001 mm

Range of Percent Change in One Linear Dimension

In one embodiment a forming force is applied to a workpiece and a resulting plastic deformation causes a change in a linear dimension of the workpiece between about 0.1% and about 200%, preferably between about 1% and about 100%.

In another embodiment a linear dimension changes by more than about 200%.

In another embodiment a linear dimension changes by between about 200% and about 100%.

In another embodiment a linear dimension changes by between about 100% and about

In another embodiment a linear dimension changes by between about 75% and about 50%.

In another embodiment a linear dimension changes by between about 50% and about 25%.

In another embodiment a linear dimension changes by between about 25% and about 10%.

In another embodiment a linear dimension changes by between about 10% and about 1%.

In another embodiment a linear dimension changes by between about 1% and about 0.1%.

In another embodiment a linear dimension changes by between about 0.1% and about 0.01%.

Range of Power for Induction Heating

In some embodiments a SCOFAST machine comprises an induction heating system used to heat workpieces as part of warm and hot forming operations, for transforming operations, for additive finishing operations, and for other purposes. The power rating required for an induction heating system used for these purposes depends on the intended workpiece size and materials and the specific operations to be performed. In one embodiment the output power of the induction heating power supply is between about 0.5 KW and about 500 KW, preferably between about 10 KW and about 50 KW, more preferably about 30 KW.

In another embodiment the output power is less than about 0.5 KW.

In another embodiment the output power is between about 0.5 KW and about 1 KW.

In another embodiment the output power is between about 1 KW and about 2 KW.

In another embodiment the output power is between about 2 KW and about 5 KW.

In another embodiment the output power is between about 5 KW and about 10 KW.

In another embodiment the output power is between about 10 KW and about 20 KW.

In another embodiment the output power is between about 20 KW and about 30 KW.

In another embodiment the output power is between about 30 KW and about 50 KW.

In another embodiment the output power is between about 50 KW and about 100 KW.

In another embodiment the output power is between about 100 KW and about 250 KW.

In another embodiment the output power is between about 250 KW and about 500 KW.

In another embodiment the output power is greater than about 500 KW.

Range of Induction Frequency

In some embodiments a SCOFAST machine comprises an induction heating system used to heat workpieces as part of warm and hot forming operations, for transforming operations, for additive finishing operations, and for other purposes. The power frequencies required for an induction heating system used for these purposes depends on the intended workpiece size and materials and the specific operations to be performed. In one embodiment induction frequencies are between about 100 Hz and about 10 MHz, preferably between about 1 KHz and about 100 KHz, more preferably between about 30 KHz and about 80 KHz.

In another embodiment induction frequencies are greater than about 10 MHz.

In another embodiment induction frequencies are between about 10 MHz and about 100 KHz.

In another embodiment induction frequencies are between about 100 KHz and about 80 KHz.

In another embodiment induction frequencies are between about 80 KHz and about 50 KHz.

In another embodiment induction frequencies are between about 50 KHz and about 30 KHz.

In another embodiment induction frequencies are between about 30 KHz and about 10 KHz.

In another embodiment induction frequencies are between about 10 KHz and about 1 KHz.

In another embodiment induction frequencies are between about 1 KHz and about 100 Hz.

Range of Heating Temperature Percent of Recrystallization Temperature

In some embodiments a SCOFAST machine performs a heating operation in which a workpiece is heated to an maximum absolute temperature I that is between about 0.1% and about 200% of the recrystallization temperature (T_{R}) of the workpiece material, preferably between about 50% and about 100%, more preferably between about 60% and about 90%. In one embodiment T_{M} is less than 0.1% of T_{R}. In another embodiment T_{M} is between 0.1% and 1% of T_{R}. In another embodiment T_{M} is between 1% and 10% of T_{R}. In another embodiment T_{M} is between 10% and 20% of T_{R}. In another embodiment T_{M} is between 20% and 30% of T_{R}. In another embodiment T_{M} is between 30% and 40% of T_{R}. In another embodiment T_{M} is between 40% and 50% of T_{R}. In another embodiment T_{M} is between 50% and 60% of T_{R}. In another embodiment T_{M} is between 60% and 70% of T_{R}. In another embodiment T_{M} is between 70% and 80% of T_{R}. In another embodiment T_{M} is between 80% and 90% of T_{R}. In another embodiment T_{M} is between 90% and 100% of T_{R}. In another embodiment T_{M} is greater than 100% of T_{R}.

Forming Temperature

In one embodiment a forming operation is performed while the workpiece is at or below about 30% of the recrystallization temperature of the material on an absolute scale (“cold forming”). In another embodiment forming is performed while the workpiece is between about 30% and about 60% inclusive of the recrystallization temperature of the material on an absolute scale (“warm forming”). In another embodiment forming is performed while the workpiece is at or above about 60% of the recrystallization temperature of the material on an absolute scale (“hot forming”). In another embodiment forming is performed while the workpiece is between about 60% and about 70% of the recrystallization temperature of the material on an absolute scale. In another embodiment forming is performed while the workpiece is between about 70% and about 80% of the recrystallization temperature of the material on an absolute scale. In another embodiment forming is performed while the workpiece is between about 80% and about 90% of the recrystallization temperature of the material on an absolute scale. In another embodiment forming is performed while the workpiece is between about 90% and about 100% of the recrystallization temperature of the material on an absolute scale. In another embodiment forming is performed while the workpiece is at or above the recrystallization temperature of the material on an absolute scale. In some embodiments different zones of a workpiece are brought to different temperatures before forming.

Machining Temperature

In one embodiment machining is performed while the workpiece is at or below about 30% of the recrystallization temperature of the material on an absolute scale (“cold machining”). In another embodiment machining is performed while the workpiece is between about 30% and about 60% inclusive of the recrystallization temperature of the material on an absolute scale (“warm machining”). In another embodiment machining is performed while the workpiece is at or above about 60% of the recrystallization temperature of the material on an absolute scale (“hot machining”). In another embodiment machining is performed while the workpiece is between about 60% and about 70% of the recrystallization temperature of the material on an absolute scale. In another embodiment machining is performed while the workpiece is between about 70% and about 80% of the recrystallization temperature of the material on an absolute scale. In another embodiment machining is performed while the workpiece is between about 80% and about 90% of the recrystallization temperature of the material on an absolute scale. In another embodiment machining is performed while the workpiece is between about 90% and about 100% of the recrystallization temperature of the material on an absolute scale. In another embodiment machining is performed while the workpiece is at or above the recrystallization temperature of the material on an absolute scale. In some embodiments different zones of a workpiece are brought to different temperatures before machining.

Absolute Heating Temperature

In one embodiment a heating element heats a workpiece to a final temperature between about 0 C and about 2000 C, preferably between about 800 C and 1300 C.

In another embodiment the final temperature is between about 2000 C and 1500 C.

In another embodiment the final temperature is between about 1500 C and 1000 C.

In another embodiment the final temperature is between about 1000 C and 800 C.

In another embodiment the final temperature is between about 800 C and 500 C.

In another embodiment the final temperature is between about 250 C and 500 C.

In another embodiment the final temperature is between about 100 C and 250 C.

In another embodiment the final temperature is between about 0 C and 100 C.

Precision

In one embodiment a first operation of one type and a second operation of another type are combined within a SCOFAST machine such that a workpiece acquires a first feature resulting at least in part from the first operation and a second feature resulting at least in part from the second operation, where a precision and tolerance are specified and measured for the second feature with respect to the first feature. In one embodiment precision and tolerance are specified with respect to one or more attributes selected from the group comprising dimensionality, planarity, parallelism, squareness, coplanarity, coaxiality, colinearity, concentricity, roundness, cylindricity, runout, and total runout. In one embodiment the spatial coherence between the first and second operations permits a final error between about 1% and about 0.0001%, preferably between about 0.5% and 0.1%.

In another embodiment the final error is between about 1% and about 0.8%.

In another embodiment the final error is between about 0.8% and about 0.6%.

In another embodiment the final error is between about 0.6% and about 0.4%.

In another embodiment the final error is between about 0.4% and about 0.2%.

In another embodiment the final error is between about 0.2% and about 0.1%.

In another embodiment the final error is between about 0.1% and about 0.05%.

In another embodiment the final error is between about 0.05% and about 0.01%.

In another embodiment the final error is between about 0.01% and about 0.005%.

In another embodiment the final error is between about 0.005% and about 0.0001%.

Concentricity

In one embodiment a forming operation and a machining operation are combined within a SCOFAST machine to produce, at a distance 12 inches from the spindle workholder, a first round feature resulting at least in part from the forming operation and a second round feature, specified to be coplanar and concentric to the first, resulting at least in part from the machining operation, where the first round feature and the second round feature have a center-to-center error between about 1 mm and about 0.001 mm, preferably less than about 0.5 mm, more preferably less than about 0.25 mm.

In another embodiment the center-to-center error is between about 1 mm and about 0.5 mm.

In another embodiment the center-to-center error is between about 0.5 mm and about 0.1 mm.

In another embodiment the center-to-center error is between about 0.1 mm and about 0.01 mm.

In another embodiment the center-to-center error is between about 0.01 mm and about 0.005 mm.

In another embodiment the center-to-center error is less than about 0.005 mm.

Colinearity

In one embodiment two operations are combined in a SCOFAST machine in such a way that the deviation from a colinear axis of rotation between the axis of the first operation and the axis of the second operation is between about 0.00001″ per inch and about 0.005″ per inch along the entire distance over which the two operations may be applied, preferably less than about 0.002″ per inch, more preferably less than about 0.0005″ per inch.

In another embodiment the deviation is less than about 0.00001″ per inch.

In another embodiment the deviation is between about 0.00001″ per inch and about 0.00005″ per inch.

In another embodiment the deviation is between about 0.00005″ per inch and about 0.0001″ per inch.

In another embodiment the deviation is between about 0.0001″ per inch and about 0.0005″ per inch.

In another embodiment the deviation is between about 0.0005″ per inch and about 0.001″ per inch.

In another embodiment the deviation is between about 0.001″ per inch and about 0.002″ per inch.

In another embodiment the deviation is between about 0.002″ per inch and about 0.005″ per inch.

In another embodiment the deviation is greater than about 0.005″ per inch.

Tolerances

In one embodiment a first operation of one type and a second operation of another type are combined within a SCOFAST machine with a degree of spatial coherence between the two operations permitting a part to be manufactured with tolerances meeting at least ISO 286 grade IT18, preferably IT17, more preferably IT16, more preferably IT15, more preferably IT14, more preferably IT13, more preferably IT12, more preferably IT11, more preferably IT10, more preferably IT9, more preferably IT8, more preferably IT7, more preferably IT6, more preferably IT5, more preferably IT4, more preferably IT3, more preferably IT2, more preferably IT0, more preferably IT01.

Time Between Operations

In one embodiment the best achievable time interval between the completion of a first operation of one type and the start of a second operation of another type is between about 1000 seconds and about 0.001 second, preferably between about 100 seconds and about 0.1 second, more preferably between about 10 seconds and about 0.1 second. In another embodiment the interval is between about 500 seconds and about 100 seconds. In another embodiment the interval is between about 1000 seconds and about 500 seconds. In another embodiment the interval is between about 500 seconds and about 100 seconds. In another embodiment the interval is between about 100 seconds and about 60 seconds. In another embodiment the interval is between about 60 seconds and about 30 seconds. In another embodiment the interval is between about 30 seconds and about 20 seconds. In another embodiment the interval is between about 20 seconds and about 10 seconds. In another embodiment the interval is between about 10 seconds and about 5 seconds. In another embodiment the interval is between about 5 seconds and about 0.1 seconds. In another embodiment the interval is between about 0.1 seconds and about 0.01 seconds. In another embodiment the interval is between about 0.01 seconds and about 0.001 seconds. In another embodiment the interval is less than about 0.001 seconds.

Distance Between Operations

In one embodiment a first forming operation and a second machining operation are performed on a workpiece where the sum of the distances between the locations of three non-coplanar fiducial features at the start of the first operation and the locations of the same fiducial features at the start of the second operation is between about 3000 mm and about 0.001 mm.

In another embodiment the sum of the distances is between about 3000 mm and about 1000 mm.

In another embodiment the sum of the distances is between about 1000 mm and about 100 mm.

In another embodiment the sum of the distances is between about 100 mm and about 10 mm.

In another embodiment the sum of the distances is between about 10 mm and about 1 mm.

In another embodiment the sum of the distances is between about 1 mm and about 0.1 mm.

In another embodiment the sum of the distances is between about 0.1 mm and about 0.025 mm.

In another embodiment the sum of the distances is between about 0.025 mm and about 0.01 mm.

In another embodiment the sum of the distances is between about 0.01 mm and about 0.001 mm.

In another embodiment the sum of the distances is less than about 0.001 mm.

Percent Absolute Temperature Drop Between Operations

In some embodiments a workpiece is heated to an absolute temperature T and subsequently a first operation is performed, followed by a second operation. In some embodiments the drop in absolute workpiece temperature (T-delta) from the start time of the first operation to the start time of a second operation is between about 0% and about 90% of T, preferably between about 0% and about 50%, more preferably between about 15% and about 30%. In one embodiment the temperature rises rather than falling. In another embodiment T-delta is between about 0% and about 10% of T. In another embodiment T-delta is between about 10% and about 20% of T. In another embodiment T-delta is between about 20% and about 30% of T. In another embodiment T-delta is between about 30% and about 40% of T. In another embodiment T-delta is between about 40% and about 50% of T. In another embodiment T-delta is between about 50% and about 60% of T. In another embodiment T-delta is between about 60% and about 70% of T. In another embodiment T-delta is between about 70% and about 80% of T. In another embodiment T-delta is between about 80% and about 90% of T. In another embodiment T-delta is between about 90% and about 100% of T.

Motor Type

In one embodiment, a motor forming part of a SCOFAST machine is an electrical motor.

In another embodiment, a motor is a magnetic motor.

In another embodiment, a motor is a hydraulic motor.

In another embodiment, a motor is a pneumatic motor.

In another embodiment, a motor is a mechanically driven motor.

In another embodiment, a motor is an internal combustion motor.

In another embodiment, a motor is a thermal gradient motor.

In another embodiment, a motor is a laser-driven motor.

In another embodiment a motor is a linear actuator.

In another embodiment, a motor is a biological motor such as a protein-driven motor.

In another embodiment a motor is a molecular motor having a size in the range of about 0.01 nanometer to about 1 nanometer, such as a motor comprising a palladium-gallium stator and a single acetylene rotor.

Motor Size

In one embodiment, a motor size is in the range of about 1 nanometer to about 100 meters, preferably in the range of about 1 centimeter to about 50 centimeters.

In another embodiment, motor size is in the range of about 1 nanometer to about 1 micrometer.

In another embodiment, motor size is in the range of about 1 micrometer to about 1 millimeter.

In another embodiment, motor size is in the range of about 1 millimeter to about 1 centimeter.

In another embodiment, motor size is in the range of about 1 centimeter to about 10 centimeters.

In another embodiment, motor size is in the range of about 10 centimeters to about 100 centimeters.

In another embodiment, motor size is in the range of about 100 centimeters to about 1 meter.

In another embodiment, motor size is in the range of about 1 meter to about 10 meters.

In another embodiment, motor size is in the range of about 10 meters to about 100 meters.

Motor Power

In one embodiment, spindle motors, linear actuators, and other motive elements may provide power in the range of from about 1 piconewton Meter/Sec (molecular-scale forces) to more than about 100,000 horsepower.

In one embodiment, the power delivered by a motor is below about 0.001 HP.

In another embodiment, motor power is in the range of about 0.001 to about 0.01 HP.

In another embodiment, motor power is in the range of about 0.01 to about 0.1 HP.

In another embodiment, motor power is in the range of about 0.1 to about 1.0 HP.

In another embodiment, motor power is in the range of about 1 to about 5 HP.

In another embodiment, motor power is in the range of about 5 to about 10 HP.

In another embodiment, motor power is in the range of about 10 to about 50 HP.

In another embodiment, motor power is in the range of about 50 to about 100 HP.

In another embodiment, motor power is in the range of about 100 to about 200 HP.

In another embodiment, motor power is in the range of about 200 to about 300 HP.

In another embodiment, motor power is in the range of about 300 to about 400 HP.

In another embodiment, motor power is in the range of about 400 to about 500 HP.

In another embodiment, motor power is in the range of about 500 to about 1000 HP.

In another embodiment, motor power is in the range of about 1000 to about 10000 HP.

In another embodiment, motor power is in the range of about 10000 to about 100000 HP.

In another embodiment, motor power is in the range above about 100000 HP.

Motor Torque

Within a SCOFAST machine the torque delivered by a motor may be in the range of from about 1 pNm to more than about 10000000 Nm, preferably in the range of about 10 to about 50 Newton-meters.

In one embodiment, motor torque is in the range below 0.01 Nm.

In another embodiment, motor torque is in the range of about 0.01 to about 0.1 Nm.

In another embodiment, motor torque is in the range of about 0.1 to about 1.0 Nm.

In another embodiment, motor torque is in the range of about 1 to about 5 Nm.

In another embodiment, motor torque is in the range of about 5 to about 10 Nm.

In another embodiment, motor torque is in the range of about 10 to about 50 Nm.

In another embodiment, motor torque is in the range of about 50 to about 100 Nm.

In another embodiment, motor torque is in the range of about 100 to about 200 Nm.

In another embodiment, motor torque is in the range of about 200 to about 300 Nm.

In another embodiment, motor torque is in the range of about 300 to about 400 Nm.

In another embodiment, motor torque is in the range of about 400 to about 500 Nm.

In another embodiment, motor torque is in the range of about 500 to about 1000 Nm.

In another embodiment, motor torque is in the range of about 1000 to about 10000 Nm.

In another embodiment, motor torque is in the range of about 10000 to about 100000 Nm.

In another embodiment, motor torque is more than about 100000 Nm.

Press Forces

In some embodiments of SCOFAST machines, pressing/forming forces are in a range from about 0.000001 tons to about 2000 tons, preferably between about 1 ton and about 5 tons, more preferably about 2 tons.

In one embodiment the pressing force is greater than about 2000 tons.

In another embodiment the pressing force is from about 1500 to about 2000 tons.

In another embodiment the pressing force is from about 1000 to about 1500 tons.

In another embodiment the pressing force is from about 500 to about 1000 tons.

In another embodiment the pressing force is from about 250 to about 500 tons.

In another embodiment the pressing force is from about 200 to about 250 tons.

In another embodiment the pressing force is from about 150 to about 200 tons.

In another embodiment the pressing force is from about 100 to about 150 tons.

In another embodiment the pressing force is from about 80 to about 100 tons.

In another embodiment the pressing force is from about 50 to about 80 tons.

In another embodiment the pressing force is from about 25 to about 50 tons.

In another embodiment the pressing force is from about 20 to about 25 tons.

In another embodiment the pressing force is from about 15 to about 20 tons.

In another embodiment the pressing force is from about 10 to about 15 tons.

In another embodiment the pressing force is from about 5 to about 10 tons.

In another embodiment the pressing force is from about 3 to about 5 tons.

In another embodiment the pressing force is from about 2 to about 3 tons.

In another embodiment the pressing force is from about 1 to about 2 tons.

In another embodiment the pressing force is from about 0.5 to about 1 ton.

In another embodiment the pressing force is from about 0.1 to about 0.5 ton.

In another embodiment the pressing force is from about 0.01 to about 0.1 tons.

In another embodiment the pressing force is from about 0.001 to about 0.01 tons.

In another embodiment the pressing force is from about 0.0001 to about 0.001 tons.

In another embodiment the pressing force is from about 0.00001 to about 0.0001 tons.

In another embodiment the pressing force is from about 0.000001 to about 0.00001 tons.

In another embodiment the pressing force is less than about 0.000001 tons.

Press Stroke and Recovery

In some embodiments a pressing/forming element of a forchine has a rapid stroke and recovery. In one embodiment the stroke rate is configured to be in a range of from about 100 minutes per stroke to about 0.001 minutes per stroke.

In one embodiment the stroke rate is less than about 0.01 strokes per minute.

In another embodiment the stroke rate is in a range from about 0.01 to about 1 stroke per minute.

In another embodiment the stroke rate is in a range from about 1 to about 2 strokes per minute.

In another embodiment the stroke rate is in a range from about 2 to about 20 strokes per minute.

In another embodiment the stroke rate is in a range from about 20 to about 60 strokes per minute.

In another embodiment the stroke rate is in a range from about 60 to about 120 strokes per minute.

In another embodiment the stroke rate is in a range from about 120 to about 500 strokes per minute.

In another embodiment the stroke rate is in a range from about 500 to about 1000 strokes per minute.

Clean Area

In some embodiments a clean area of a SCOFAST machine meets ISO 14644-1 requirements between class 1 and class 9 inclusive, preferably class 1. In one embodiment the clean area meets requirements for ISO 14644-1 class 2. In another embodiment the clean area meets requirements for ISO 14644-1 class 3. In another embodiment the clean area meets requirements for ISO 14644-1 class 4. In another embodiment the clean area meets requirements for ISO 14644-1 class 5. In another embodiment the clean area meets requirements for ISO 14644-1 class 6. In another embodiment the clean area meets requirements for ISO 14644-1 class 7. In another embodiment the clean area meets requirements for ISO 14644-1 class 8. In another embodiment the clean area meets requirements for ISO 14644-1 class 9.

In some embodiments a clean area of a SCOFAST machine is controlled to restrict the size of residual particles, having a size restriction between about 1000 microns and about 5 microns, preferably having a size restriction between about 250 microns and about 5 microns.

In one embodiment the size restriction is between about 1000 microns and about 500 microns.

In one embodiment the size restriction is between about 500 microns and about 250 microns.

In one embodiment the size restriction is between about 250 microns and about 100 microns.

In one embodiment the size restriction is between about 100 microns and about 50 microns.

In one embodiment the size restriction is between about 50 microns and about 10 microns.

In one embodiment the size restriction is between about 10 microns and about 5 microns.

In one embodiment the size restriction is below about 5 microns.

In some embodiments a clean area of a SCOFAST machine is controlled to restrict the total quantity of residual particles within the clean area, having a quantity restriction between about 0.1 mg and about 25 mg, preferably between about 1 mg and about 0.1 mg.

In one embodiment the quantity restriction is between about 25 mg and about 20 mg.

In one embodiment the quantity restriction is between about 20 mg and about 10 mg.

In one embodiment the quantity restriction is between about 10 mg and about 5 mg.

In one embodiment the quantity restriction is between about 5 mg and about 1 mg.

In one embodiment the quantity restriction is between about 1 mg and about 0.5 mg.

In one embodiment the quantity restriction is between about 0.5 mg and about 0.25 mg.

In one embodiment the quantity restriction is between about 0.25 mg and about 0.1 mg.

In one embodiment the quantity restriction is less than about 0.1 mg.

### Additional Embodiments

E1. A spatially coherent machine for manufacturing comprising:

a workholding element configured to secure a workpiece;

a toolholding element with at least one axis of motion control configured to perform a subtractive machining operation on the workpiece using a machining tool;

a heating element configured to perform a heating operation in which the thermal energy of the workpiece is raised to a level that reduces the yield strength of the workpiece material; and

a forming element configured to perform a forming operation in which force is applied to the workpiece in an amount that causes plastic deformation of the workpiece material;

wherein the workholding element secures the workpiece during the heating, forming, and subtractive operations such that the heating, forming and subtractive operations are performed in a spatially coherent manner.

E2. A spatially coherent machine for manufacturing comprising:

a workholding element configured to secure a workpiece;

an additive manufacturing element configured to perform an additive operation in which material is added to the workpiece;

a heating element configured to perform a heating operation in which the thermal energy of the workpiece is raised to a level that reduces the yield strength of the workpiece material; and

a forming element configured to perform a forming operation in which force is applied to the workpiece in an amount that causes plastic deformation of the workpiece material;

wherein the workholding element secures the workpiece during the heating, forming, and additive operations such that the heating, forming and additive operations are performed in a spatially coherent manner.

E3. A spatially coherent machine for manufacturing comprising:

a workholding element configured to secure a workpiece;

a toolholding element with at least one axis of motion control configured to perform a subtractive machining operation on the workpiece using a machining tool;

an additive manufacturing element configured to perform an additive operation in which material is added to the workpiece;

a heating element configured to perform a heating operation in which the thermal energy of the workpiece is raised to a level that reduces the yield strength of the workpiece material; and

a forming element configured to perform a forming operation in which force is applied to the workpiece in an amount that causes plastic deformation of the workpiece material;

wherein the workholding element secures the workpiece during the heating, forming, additive and subtractive operations such that the heating, forming, additive and subtractive operations are performed in a spatially coherent manner.

E4. A turning, milling and/or turn-milling machine comprising a subtractive machining element together with a heating element configured to heat a workpiece sufficiently to reduce the yield strength of the workpiece prior to a machining operation, each element being configured to operate in a spatially coherent manner within the machine.

E5. A milling machine comprising a subtractive machining element together with a heating element and a forming element, each element being configured to operate in a spatially coherent manner within the milling machine.

E6. A turning machine comprising a subtractive machining element together with a heating element and a forming element, each element being configured to operate in a spatially coherent manner within the turning machine.

E7. A turning-milling machine comprising a subtractive machining element together with a heating element and a forming element, each element being configured to operate in a spatially coherent manner within the turning-milling machine.

E8. An additive manufacturing machine comprising an element configured to perform an additive operation together with a heating element and a forming element, each element being configured to operate in a spatially coherent manner within the machine.

E9. A manufacturing machine comprising an additive manufacturing element configured to add material to a workpiece, a subtractive machining element configured to remove material from the workpiece, a heating element configured to add thermal energy to the workpiece, and a bulk forming element configured to apply force to cause plastic deformation of the workpiece, each element being configured to operate in a spatially coherent manner within the machine.

E10. A method for producing an advantageous physical and/or chemical material transformation in a titanium or titanium alloy part, the method comprising:

heating the part to a temperature in the range of about 500° C. to about 1500° C., preferably in the range of about 800° C. to about 1100° C., and more preferably in the range of about 850° C. to about 950° C.; and

treating the heated part with a toughening fluid comprising a naturally-occurring oil mixture being largely composed of triacylglycerols comprising oleic acid (about 50-85%), linoleic acid (about 3-25%), palmitic acid (about 7-25%), stearic acid (about 0.1-10%), and linolenic acid (about 0-2%); the major prevalence of triacyl combinations being ordinally OOO, POO, OOL, POL, SOO, SOL; and having optional additional components comprising polyphenols including hydroxytyrosol and tyrosol; and having physical properties as follows: Specific Gravity about 0.90-0.93 kg/m³ at 15.5° C., preferably about 0.915-0.925 kg/m³ at 15.5° C.; Viscosity about 78-88 mPa·s at 20° C., preferably about 80-86 mPa·s at 20° C., more preferably about 84 mPa·s at 20° C.; Specific Heat at 20° C. about 1.75-2.05 (J/g·° C.); preferably about 1.97-2.02 (J/g·° C.), more preferably 2.0 (J/g·° C.); Thermal Conductivity at 20° C. about 0.165-0.180 (W/m·K), preferably about 0.17 (W/m·K); Dielectric Constant at 20° C. about 3.0-3.2, preferably about 3.1; Density at 20° C. about 900-930 kg/m³, preferably about 913-919 kg/m³, more preferably about 916 kg/m³; Thermal Diffusivity at 20° C. about 4-12×10⁻⁸ m²/s, preferably about 5.3-8.3×10⁻⁸ m²/s; Boiling Point at sea level about 298-300° C.; and Smoke point about 190-215° C.

E11. A turning machine comprising a subtractive machining element together with a heating element and a forming element, each element being configured to operate in a spatially coherent manner within the turning machine;

wherein the turning machine is fitted with a clutch and a brake and is configured to perform spin-welding operations.

E12. A turning, milling and/or turn-milling machine comprising a subtractive machining element together with a forming element and a heating element configured to heat a workpiece sufficiently to reduce the yield strength of a workpiece, each element being configured to operate in a spatially coherent manner within the machine;

wherein the forming element is configured to perform bending operations.

What is claimed is:

1. A spatially coherent machine for manufacturing comprising:
a workholding element configured to secure a workpiece;
a toolholding element with at least one axis of motion control configured to perform a subtractive machining operation on the workpiece using a machining tool;
a heating element configured to perform a heating operation in which the thermal energy of the workpiece is raised to a level that reduces the yield strength of the workpiece material; and
a forging element configured to perform a forging operation in which a portion of the forging die presses the workpiece against the workholding element with a force sufficient to cause plastic deformation of the workpiece material, causing it to conform to the shape of the forging die;
wherein the workholding element secures the workpiece during the heating, forming, and subtractive operations; and
wherein all operations are performed under machine control such that the forming and subtractive operations are performed in a spatially coherent manner.

2. The system of claim 1 wherein the workholding element serves as one face of the forging die.

3. The system of claim 1 wherein the interval between the end of a forging operation and the start of a machining operation is in the range of about 0.1 second to about 10 seconds.

4. The system of claim 1 wherein the drop in absolute temperature of a workpiece between the start of a forging operation and the start of a subsequent machining operation is in the range of about 1% to about 50%.

5. The system of claim 1 wherein the machining element and the forging element share a common axis and are driven by the same motion actuator.

6. The system of claim 1 wherein the forging element exerts a force in the range of from about 1000 lbs-force to about 10000 lbs-force.

7. A turning, milling and/or milling-turning machine that comprises a subtractive machining element together with a heating element configured to heat a workpiece sufficiently to reduce the yield strength of the workpiece prior to a machining operation, each element being configured to operate under machine control in a spatially coherent manner within the machine.

8. A method for producing an advantageous physical and/or chemical material transformation in a titanium part, the method comprising:
heating the part to a temperature in the range of about 500° C. to about 1500° C.; and
treating the heated part with a toughening fluid comprising a naturally-occurring oil mixture being largely composed of triacylglycerols comprising oleic acid (about 50-85%), linoleic acid (about 3-25%), palmitic acid (about 7-25%), stearic acid (about 0.1-10%), and linolenic acid (about 0-2%); the major prevalence of triacyl combinations being ordinally OOO, POO, OOL, POL, SOO, SOL; and having optional additional components comprising polyphenols including hydroxytyrosol and tyrosol; and having physical properties including a specific gravity about 0.90-0.93 kg/m³ at 15.5° C., a viscosity about 78-88 mPa·s at 20° C., a specific heat at 20° C. about 1.75-2.05 (J/g·° C.), a thermal conductivity at 20° C. about 0.165-0.180 (W/m·K), a dielectric constant at 20° C. about 3.0-3.2, a density at 20° C. about 900-930 kg/m³, a thermal diffusivity at 20° C. about 4-12×10⁻⁸ m²/s, a boiling point at sea level about 298-300° C.; and a smoke point about 190-215° C.

9. The method of claim 8, wherein the part is heated to a temperature in the range of about 800° C. to about 1100° C.

10. The method of claim 8, wherein the part is heated to a temperature in the range of about 850 C to about 950 C.

11. The method of claim 8, wherein the specific gravity is about 0.915-0.925 kg/m³ at 15.5° C.

12. The method of claim 8, wherein the viscosity is about 80-86 mPa·s at 20° C.

13. The method of claim 8, wherein the viscosity is about 84 mPa·s at 20° C.

14. The method of claim 8, wherein the specific heat is about 1.97-2.02 (J/g·° C.).

15. The method of claim 8, wherein the specific heat is about 2.0 (J/g·° C.)

16. The method of claim 8, wherein the thermal conductivity is about 0.17 (W/m·K).

17. The method of claim 8, wherein the dielectric constant is about 3.1.

18. The method of claim 8, wherein the density is about 913-919 kg/m³.

19. The method of claim 8, wherein the density is about 916 kg/m³.

20. The method of claim 8, wherein the thermal diffusivity is about 5.3-8.3×10⁻⁸ m²/s.
